(19) United States
(12) Patent Application Publication
(10) Pub. No.: US 2015/0047947 A1
(43) Pub. Date: Feb. 19, 2015

(54) Electric Vehicle Refueling System

(71) Applicant: Gordon Roy Tait, London (GB)

(72) Inventor: Gordon Roy Tait, London (GB)

(73) Assignee: BATTERY FUELING LIMITED, London (GB)

(21) Appl. No.: 14/250,876

(22) Filed: Apr. 11, 2014

Related U.S. Application Data
(60) Provisional application No. 61/812,170, filed on Apr. 15, 2013.

(51) Int. Cl. B60S 5/06

(52) U.S. Cl. CPC B60S 5/06
USPC 198/339.1

(57) ABSTRACT

An enclosed two-part computer controlled cyclical and sequential through-flow conveying, usage and metering System (200) is disclosed, for use in the electric vehicle motive power provision industries, for said two-part enclosed System to sequentially convey small-volume rechargeable Cell-Modules by sequential conveyor-means in a metered through-flow sequential conveying manner within said two-part System wherein the first part is a Stationary Part that includes a specially manufactured Cell-Module dispensing Bowser and a specially manufactured Cell-Module Charging-Bay and wherein the second part is a Movable Part that includes a specially manufactured or specially adapted Cell-Module powered electric Vehicle having a specially manufactured Cell-Module Chamber installed within.

A Nozzle (3) and a Portal (4) respectively provide means for the Stationary Part and the Movable Part to exchange a choosable plurality of small-volume rechargeable Cell-Modules (100) and (500).

A System (200) provides a succinct fully enclosed matingly-co-operative interconnection means for the System (200) to sequentially dispense Charged Cell-Modules and remove depleted Cell-Modules. The System also removes faulty Cell-Modules and if necessary extinguishes, and isolates for fire safety purposes, over-heating, deformed, or ignited Cell-Modules.

The invention provides means that parallel, mimic or improve upon the metered bowser dispensing manner by which a choosable sequential plurality of small volumes of fossil fuel are sequentially delivered to a conventional fossil fuel vehicle by a dispensing bowser at a conventional fuel Service Station facility. The invention also provides optional means for Cell-Modules to be recharged in situ by use of a specially manufactured charger.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

For more than a century, the different developments for fossil fuel powered vehicles have been supported by parallel developments for fossil fuel replenishment needs.

Today, drivers of many types of fossil fuel powered vehicles can readily obtain choosable pluralities of precisely metered sequential small volumes of fossil fuel, by the use of the same globally established, globally understood and globally accepted apparatus; the roadside Service Station bowser, also known as the forecourt replenishment bowser.

The driver of a fossil fuel powered vehicle is able to drive into a roadside Service Station, almost anywhere in the world, park his vehicle adjacent a forecourt dispensing bowser, and readily replenish the exact amount of fuel that he needs that suits both his pocket and his time needs at that precise moment, for enabling him to then confidently complete the next stage of his journey.

Typically, the driver is able to replenish sufficient fossil fuel for his immediate journey needs and pay for the metered amount of sequentially dispensed pluralities of small volumes of replenished fuel, all within a few minutes.

The physical processes of inserting a nozzle into a receiving portal, that is set within the outer body of the conventional vehicle, although difficult to explain, is well understood, accepted and experienced by the average driver.

In stark contrast, the driver of a battery powered electric vehicle does not have access to anything like the same roadside Service Station facilities that the driver of a fossil fuel powered vehicle has been able to access and enjoy for many decades.

The driver of a typical modern electric vehicle has no means to readily replenish the exact amount of motive power energy requirements that suit his pocket and time needs at that precise moment, for enabling him to complete the next stage of his journey with any confidence.

The driver of an electric vehicle with a depleted or part depleted battery chamber has to either change the entire battery block with a complete replacement battery block, as exampled by the Chaney U.S. Pat. No. 6,631,775, or wait for several hours and sometimes more than one day to recharge his on-board battery chamber, usually via a domestic electric power outlet, in order to continue the next stage of his journey.

This stark contrast between energy replenishment systems for fossil fuel vehicles and electric vehicles may be the primary factor as to why the significant developments in battery improvements technologies, including for electric vehicles, has not manifested in an upsurge of new electric vehicle sales.

Also, the cost of a complete set of rechargeable batteries, that replicates the equivalent of a full tank of fossil fuel, can represent a prohibitive 50% of a new battery powered electric vehicle's purchase price.

### SUMMARY OF THE INVENTION

It is a primary object of the invention to provide a sequential through-flow System (200) for the sequential supply of individually metered small-volume rechargeable Cell-Modules (100) and (500), that are dispensed in choosable pluralities, by user activated Trigger (39) means, or over-riding Computer-Controlled means, to and from a specially manufactured Cell-Module powered electric Vehicle (1) by means of a specially manufactured Cell-Module dispensing and metering Bowser (2).

The Bowser (2) is preferably but not exclusive situated within the forecourt of a roadside Service Station of the type globally known for the sequential supply of individually metered small-volumes of fossil fuel, that are dispensed in choosable pluralities, by user activated trigger means, to a conventional fossil fuel powered vehicle by means of a conventional dispensing and metering Bowser.

Throughout the invention, the term ‘user’ is used to define the person who is physically activating the Trigger (39), and should be understood to include any person who is activating the Trigger (39) for refuelling a Vehicle (1), including the driver of a Vehicle (1) or an appointed Service Station attendant.

Also throughout the texts, the term ‘choosable pluralities’ should be understood to also include the terms ‘choosably continuous pluralities’ or ‘choosably interrupted pluralities’.

This primary object preferably parallels, mimics and/or improves upon the globally established and globally understood provision whereby a sequential through-flow supply of individually metered small-volumes of fossil fuel are dispensed, in choosable pluralities, to a fossil fuel powered vehicle by conventional roadside or forecourt fossil fuel bowser dispensing means.

The invention is schematically disclosed as an enclosed computer-controlled cyclical through-flow conveyor control System (200), for replenishing Depleted Cell-Modules with New or freshly Charged Cell-Modules when a Stationary Part (A) is temporarily but securely connected by Connector Means (3) and (4), to an Independently Moveable Part (B).

The Stationary Part (A) is visually manifested to include a roadside or forecourt situated Cell-Module dispensing Bowser (2) that is itself serviced by other support equipment, means and know-how, that may well be hidden from view.

Such support equipment, means and know-how will include a Cell-Module Charging Bay (6) and a separate Cell-Module Charging Bay (7), connected to the Cell-Module Bowser (2) by enclosed Conveyors that are Computer-Controlled algorithms for controlling, metering and monitoring the System.

The Independently Moveable Part (B) is a Cell-Module powered electric Vehicle (1) that is temporarily parked adjacent the Stationary Part (A), and temporarily connected to it, specifically for allowing the metered transfer of a choosable plurality of Cell-Modules (100) and (500) between the Parts (A) and (B).

The Stationary Part (A) is temporarily but securely attached the Moveable Part (B) by Connector Means (3) and (4) that respectively are; a Cell-Module dispensing Nozzle (3) attached the Bowser (2) by a flexible Pipe (5) and; a matingly co-operative Cell-Module Nozzle-Receiving Portal (4), attached the outer bodywork of a Vehicle (1), thus again providing means to parallel, mimic and/or improve upon the globally established means provided for fossil fuel bowser dispensing.

The Vehicle (1) is internally provided with at least one through-flow Main-Chamber (15) for receiving Charged Cell-Modules (100) from the Bowser via the Portal (4) and returning Depleted and Faulty Cell-Modules (100) to the Bowser via the Portal (4).

In one example of a Main-Chamber (15), the Main-Chamber is also provided with a separate Thermal-Safety-Chamber (16), for safely storing any Cell-Module (100) that has been removed from a Chamber (15), under suspicion of being faulty.

In another example of a Main-Chamber (15), and/or a separate Thermal-Safety-Chamber (16), both Chambers may be provided with a Fire-Proof-Chamber (FPC1) and/or (FPC2) for safely storing any Cell-Module (100) that is suspected of being a Thermal Runaway Cell-Module (TRCM).

In the early practical applications and uses of a System (200), the Stationary Part (A) may itself be moveable, insofar as a Bowser (2) and a Charging Bay (6) and/or (7) may be installed on or within the internal Container parts of a conventional fossil fuel powered truck, for the providers of the System (200) and/or the Parts (A) and (B) to understand and obtain e.g. know-how for best locations to install a roadside or forecourt dispensing Bowser (2) and a Cell-Module Charging Bay (6) and (7).

In order to achieve this primary object, the present invention discloses and respectively provides Computer-Controllers (350) and (450) that are installed within the Parts (A) and (B), for providing a computer monitored and computer controlled Cyclical-Flow-Conveyor-Control-System (200) that treats a small-volume rechargeable Cell-Module (100) as the smallest measurable unit of ‘metered-for-payment’ motive power input energy that is readily able to be monitored, controlled, used and recycled as it is physically conveyed through the different Parts of the System.

This primary object claims novelty in paralleling, for an individual small-volume rechargeable Cell-Module (100) and (500), the long established object of fossil fuel bowser dispensing; that treats an individual small-volume of fossil fuel as the smallest measurable unit of ‘metered-for-payment’ motive power input energy that is also monitored and controlled as it is physically conveyed through the different parts of its conventional system.

Practical application of this primary object of the invention can dispel the long held rigid belief that a battery powered electric vehicle can only have a large, heavy, cuboid, cumbersome, prohibitively expensive and inaccessible battery block installed.

This primary object is therefore commercially important to future electric vehicle manufacturing, since the vast majority of battery powered electric vehicles being contemporaneously designed are passenger vehicles, that need to take great care to provide the same visual and functional features for electric vehicles that are already available in contemporary fossil fuel powered vehicles.

It is important to note, for this primary object, that the vast majority of modern fossil fuel passenger vehicles rarely, if ever use a fossil fuel chamber of large cuboid form, since its practical required shape often needs to be extremely complex, to fit around other essential vehicle components and requirements, not least passenger safety requirements.

The primary object of the invention, to treat a single small-volume rechargeable Cell-Module (100) and (500) as the smallest unit of ‘metered-for-payment’ motive power input energy, is used in the invention to provide practical means for a Cell-Module (100) and (500) to be treated as a Flow-Unit, just as small volumes of fossil fuel are conventionally treated as flow-units, so that, for example, a plurality of small-volume Cell-Modules (100) and (500) can be easily sequentially conveyed though a small diameter tube or a hollow enclosure, as can a small volume of sequentially conveyed liquid fossil fuel.

It follows therefore, that the invention has great commercial potential for electric vehicle manufacturers to provide Cell-Module Chambers (15) of extremely complex form, as well as simple form, that can readily fit around other essential vehicle components within a Vehicle (1).

The invention can also provide additional commercial value to electric vehicle manufactures, not least where the 50% financial burden of battery ownership may be removed from a new electric vehicle's purchase price and placed with a motive power energy replenishment provider, who may commercially amortise their investment, by way of the continuous cyclical dispensing of Cell-Modules (100) and (500), via the System (200) of the invention, in a similar manner that has been conventionally successfully amortised by non-cyclical Oil Corporations via dispensing bowsers, for more than a century.

### BRIEF DESCRIPTION OF THE DRAWINGS

Eight Embodiments of the System of the invention will now be described with reference to the drawings in which:

FIG. 1 is a schematic plan view of First Embodiments of the System wherein the Moveable-Part of the System is releasably connected to the Stationary-Part of the System for providing the sequential metered through-flow of small-volume rechargeable Cell-Modules.

FIG. 2 is also a schematic plan view of First Embodiments of the System wherein the Moveable-Part is also releasably connected to the Stationary-Part for providing the sequential metered through-flow of small-volume rechargeable Cell-Modules.

FIG. 3 is a more detailed schematic plan view of First Embodiments of the Stationary-Part of the System of FIG. 1 and FIG. 2.

FIG. 4 is a more detailed schematic plan view of First Embodiments of the Moveable-Part of the System of FIG. 1 and FIG. 2.

FIG. 5 is a detailed schematic plan view of First Embodiments of the Nozzle-Parts of the Stationary-Part of the System.

FIG. 6 is a detailed schematic plan view of First Embodiments of the Nozzle receiving Portal-Parts of the Moveable-Part of the System.

FIG. 7 is a detailed schematic plan view of First Embodiments of the Nozzle-Parts and the Portal-Parts of FIG. 5 and FIG. 6 in close proximity to the other.

FIG. 8 is a detailed schematic plan view of First Embodiments of the Nozzle-Parts and the Portal-Parts of FIG. 5 and FIG. 6 in releasable mating co-operation with the other.

FIG. 9 is also a detailed schematic plan view of First Embodiments of the Nozzle-Parts and the Portal-Parts of FIG. 5 and FIG. 6 in releasable mating co-operation with the other.

FIG. 10 is a more detailed schematic plan view of First Embodiments of the Moveable-Part of the System releasably connected to the Stationary-Part of the System for defining the user interfaces.

FIG. 11 is also a more detailed schematic plan view of First Embodiments of the Moveable-Part of the System releasably connected to the Stationary-Part of the System for defining the user interfaces.

FIG. 12 is also a more detailed schematic plan view of First Embodiments of the Moveable-Part of the System releasably connected to the Stationary-Part of the System for defining the user interfaces.

FIG. 13 is a schematic plan view of First Embodiments of the Moveable-Part of the System that is not releasably connected to the Stationary-Part of the System for defining the user interfaces.

FIG. 14 is a different schematic plan view of First Embodiments of the Moveable-Part of the System releasably connected to the Stationary-Part of the System for defining alternative flow paths and orientations of Cell-Modules.

FIG. 15A is a schematic sectional view of First Embodiments of the transfer pipe of the Stationary-Part of the System, as generally shown in FIG. 14.

FIG. 15B is an alternative schematic sectional view of First Embodiments of the transfer pipe of the Stationary-Part of the System, as generally shown in FIG. 14.

FIG. 15C is another alternative schematic sectional view of First Embodiments of the transfer pipe of the Stationary-Part of the System, as generally shown in FIG. 14.

FIG. 15D is a further alternative schematic sectional view of First Embodiments of the transfer pipe of the Stationary-Part of the System, as generally shown in FIG. 14.

FIG. 15E is another alternative schematic sectional view of First Embodiments of the transfer pipe of the Stationary-Part of the System, as generally shown in FIG. 14.

FIG. 15F is one further alternative schematic sectional view of First Embodiments of the transfer pipe of the Stationary-Part of the System, as generally shown in FIG. 14.

FIG. 16 is a schematic plan view of Second Embodiments of the Moveable-Part of the System releasably connected to the Stationary-Part of the System for providing sequential through-flow of small-volume rechargeable Cell-Modules.

FIG. 17 is another schematic plan view of Second Embodiments of the Moveable-Part of the System releasably connected to the Stationary-Part of the System for providing sequential through-flow of small-volume rechargeable Cell-Modules.

FIG. 18 is a more detailed schematic plan view of Second Embodiments of the Moveable-Part of the System releasably connected to the Stationary-Part of the System.

FIG. 19 is a detailed schematic side view of Second Embodiments of the Nozzle-Parts and the Portal-Parts of FIG. 16, FIG. 17 and FIG. 18 in close proximity to the other.

FIG. 20 is a detailed schematic side view of Second Embodiments of the Nozzle-Parts and the Portal-Parts of FIG. 16, FIG. 17 and FIG. 18 in releasable mating co-operation with the other.

FIG. 21A is a schematic sectional view of Second Embodiments of the transfer pipe of the Stationary-Part of the System, as generally shown in FIG. 14.

FIG. 21B is also a schematic sectional view of Second Embodiments of the transfer pipe of the Stationary-Part of the System, as generally shown in FIG. 14.

FIG. 22 is a schematic side view of Third Embodiments of the invention, in which a test-bed Stationary-Part is attached a test-bed Moveable-Part for efficiency testing of sequential through-flow rechargeable Cell-Modules.

FIG. 23 is a schematic perspective view of Fourth Embodiments of the System, wherein the Stationary-Part has a first example of a Cell-Module recharging bay installed therein.

FIG. 24 is another schematic perspective view of Fourth Embodiments of the System, as shown in FIG. 23.

FIG. 25 is a schematic perspective view of Fourth Embodiments of the System, wherein the Stationary-Part has a second example of a Cell-Module recharging bay installed therein.

FIG. 26 is another schematic perspective view of Fourth Embodiments of the System, as shown in FIG. 25.

FIG. 27 is a schematic perspective view of Fourth Embodiments of the System, wherein the Stationary-Part has a third example of a Cell-Module recharging bay installed therein.

FIG. 28 is a schematic perspective view of Fourth Embodiments of the System, wherein the Stationary-Part has a fourth example of a Cell-Module recharging bay installed therein.

FIG. 29 is a schematic plan view of First, Second and Fourth Embodiments of the Moveable-Part of the System releasably connected to the Stationary-Part of the System for providing sequential metered through-flow of small-volume rechargeable Cell-Modules between the Parts.

FIG. 30 is a schematic plan view of First, Second and Fourth Embodiments of the metered dispensing bowser portions of the Stationary-Part of the System for providing sequential metered through-flow of small-volume rechargeable Cell-Modules between the Stationary-Part and the Moveable Part.

FIG. 31 is a schematic plan view of Fifth Embodiments of the Moveable-Part of the System relating to precise computer-controlled positionings of Cell-Modules within the Moveable-Part.

FIG. 32 is a schematic perspective view of Fifth Embodiments of the Moveable-Part of the System relating to precise computer-controlled positionings of Cell-Modules within the Moveable-Part.

FIG. 33 is a schematic perspective view of Sixth Embodiments of a rechargeable Cell-Module of an electric nature and a visually similar rechargeable Cell-Module of a fire safety nature.

FIG. 34 is a schematic perspective view of Sixth Embodiments of a rechargeable Cell-Module of an electric nature and a visually similar rechargeable Cell-Module of a fire safety nature, wherein both types of Cell-Module are being used within a Moveable-Part of the System.

FIG. 35 is a further schematic perspective view of Sixth Embodiments of a rechargeable Cell-Module of an electric nature and a visually similar rechargeable Cell-Module of a fire safety nature, wherein both types of Cell-Module are being used within a Moveable-Part of the System.

FIG. 36 is another schematic perspective view of Sixth Embodiments of a rechargeable Cell-Module of an electric nature and a visually similar rechargeable Cell-Module of a fire safety nature, wherein both types of Cell-Module are being used within a Moveable-Part of the System.

FIG. 37 is a further schematic perspective view of Sixth Embodiments of a rechargeable Cell-Module of an electric nature and a visually similar rechargeable Cell-Module of a fire safety nature, wherein both types of Cell-Module are being used within a Moveable-Part of the System.

FIG. 38 is a further schematic perspective view of Sixth Embodiments of a rechargeable Cell-Module of an electric nature and a visually similar rechargeable Cell-Module of a fire safety nature, wherein both types of Cell-Module are being used within a Stationary Part releasably connected to a Moveable-Part of the System.

FIG. 39 is a schematic side view of Sixth Embodiments of a rechargeable Cell-Module of an electric nature and a visually similar rechargeable Cell-Module of a fire safety nature, wherein both types of Cell-Module are being used within a Stationary Part releasably connected to Moveable-Part of the System.

FIG. 40 is a schematic plan view of Sixth Embodiments of a rechargeable Cell-Module of an electric nature and a visually similar rechargeable Cell-Module of a fire safety nature, wherein both types of Cell-Module are being used within a Moveable-Part of the System.

FIG. 41 is a schematic detailed side view of Seventh Embodiments of the Moveable-Part of the System in close proximity to the Stationary-Part of the System for defining improved safety features for the sequential metered through-flow of small-volume rechargeable Cell-Modules.

FIG. 42 is a schematic detailed side view of Seventh Embodiments of the Moveable-Part of the System releasably connected to the Stationary-Part of the System for providing improved safety features for the sequential metered through-flow of small-volume rechargeable Cell-Modules.

FIG. 43 is a schematic perspective view of Eighth Embodiments for the Stationary-Part of the System in a closed position, for providing temporarily movable means for the Stationary-Part.

FIG. 44 is a schematic perspective view of Eighth Embodiments for the Stationary-Part of the System in a fully open position, for providing temporarily movable means for the Stationary-Part to be positioned in a preferred location as a Stationary-Part.

FIG. 45 is another schematic perspective view of Eighth Embodiments for the Stationary-Part of the System in a fully open position, for providing temporarily movable means for the Stationary-Part to be positioned in a preferred location as a Stationary-Part.

FIG. 46 is a schematic perspective detail view of Fourth and Eighth Embodiments for providing Cell-Module transfer between metered dispensing bowsers of the Stationary-Part of the System.

FIG. 47 is a schematic detailed side view of modifications to Fourth and Eighth Embodiments of the Stationary Part of the System.

FIG. 48 is a schematic detailed perspective view of modifications to Fourth and Eighth Embodiments of the Stationary Part of the System.

FIG. 49 is a further schematic detailed perspective view of modifications to Fourth and Eighth Embodiments of the Stationary Part of the System.

### DETAILED DESCRIPTION OF THE INVENTION

The present invention discloses an Enclosed Computer-Controlled Cyclical Through-Flow Conveyor System (200) for the choosably continuous or choosably interrupted sequential Computer-Controlled-Flow of a very large number of individual small-volume rechargeable Cell-modules (100) and (500) placed within the System (200).

In one practical use, an enclosed System (200) comprises a Stationary Part (A) having an Independently Moveable Part (B) temporarily but securely attached to it, for the computer-controlled metered transfer of Cell-Modules between the Parts (A) and (B).

During through-flow of Cell-Modules within the System, each Charged Cell-Module may be conveyed from Part (A) to Part (B) of the System, for Part (B) to make Computer-Controlled use of the electrical energy stored within a Charged Cell-Module (100) or the pressurised safety facilities stored within a Charged Cell-Module (500).

Preferably synchronous with the previous disclosure, each depleted Cell-Module may be conveyed from Part (B) to Part (A) of the System, for Part (A) to conduct computer-controlled recharging, ready for each freshly charged Cell-Module to be again conveyed within the System for use within another Part (B).

The Stationary Part (A) of an Enclosed System (200) is provided with at least one Entrance-Gate for e.g. New Cell-Modules to enter the System for the first time.

The Stationary Part (A) of an Enclosed System (200) is also provided with at least one Exit-Gate for e.g. Faulty Cell-Modules, Sub-Standard Cell-Modules or damaged Cell-Modules to permanently exit the System.

All aspects of Cyclical Through-Flow of Cell-Modules (100) and (500) within a Stationary Part (A) are controlled by a Computer-Controller (350) that communicates with a Conveyor-Control-Device (300), for the electro-mechanical devices installed within Part (B) of the System to provide essential Through-Flow of Cell-Modules (100) and (500) within the System.

All aspects of the Cyclical Through-Flow of Cell-Modules (100) and (500) within a Moveable Part (B) are controlled by an on-board Computer-Controller (450) that communicates with an on-board Conveyor-Control-Device (400) for the electro-mechanical devices installed within Part (B) of the System to provide essential Through-Flow of Cell-Modules (100) and (500) within the System.

When a stationary Part (A) and a Movable Part (B) are attached each other, all aspects of Cyclical Through-Flow of Cell-Modules (100) and (500) within the Stationary Part (A) are controlled by a Computer-Controller (350) that communicates with the Computer-Controller (450), for the electro-mechanical devices installed within Part (A) and Part (B) of the System to co-ordinate the Through-Flow of Cell-Modules (100) and (500) within the System.

In a preferred example of a System (200), the Stationary Part (A) includes a specially manufactured Cell-Module forecourt dispensing Bowser (2) and the Moveable Part (B) is a specially manufactured or specially modified Cell-Module powered electric Vehicle (1).

A Cell-Module import/export Nozzle (3) is permanently attached a Bowser (2), preferably via a Flexible-Pipe (5), and a Nozzle-Receiving-Portal (4) is permanently attached the outer bodywork of a Vehicle (1), for the Computer-Controlled metered transfer of Cell-Modules between the Parts (A) and (B).

A small-volume rechargeable Cell-Module (100) will have been specifically invented, manufactured, modified or otherwise designated for use within the System, according to required System (200) standards, for novelly adapted use, for providing electric power, and pressurised safety facilities within a specially manufactured Cell-Module powered electric Vehicle (1).

A small-volume rechargeable Cell-Module (500) will have been specifically invented, manufactured, modified or otherwise designated for use with the System, according to required System (200) standards, for novelly adapted use, for providing specific fire safety options, within a specially manufactured Cell-Module powered electric Vehicle (1).

It is a primary feature of the invention that each new or freshly Charged Cell-Module (100) within the System (200) is commercialized for use as the smallest practical measurable unit of energy supply, for metering, monetising and otherwise providing a reliable sequential ‘payment-for-delivery’ replenishable motive-power supply System (200).

This primary feature is intended to perform in a manner that parallels, mimics or improves upon a globally established control system whereby a small volume of fossil fuel is commercialized for use, as the smallest practical measurable unit of energy supply, for metering, monetising and otherwise providing a globally relied upon sequential ‘payment-for-delivery’ fossil fuel motive-power supply system.

In order to best parallel, mimic or improve upon this known sequential ‘payment-for-delivery’ fossil fuel motive-power supply system, an enclosed computer-controlled cyclical through-flow conveyor control System (200) is preferably user activated and preferably user operated in a similar choosably interrupted or choosably maintained manner that is well known by users of fossil fuel bowser replenishment systems; via a user operated Cell-Module dispensing Nozzle (3) having a user activated Nozzle Trigger (39) provided thereon.

Upon achieving secure connection of the Bowser's Nozzle (3) with the Vehicle's Portal (4), a choosable plurality of new or freshly charged small-volume Cell-Modules (100) may, by activation of Nozzle Trigger (39), pass in a sequentially metered manner, from the Bowser to the Vehicle, in a procedure that parallels the globally established procedure for sequentially transferring metered pluralities of small volumes of fossil fuel from a fossil fuel forecourt bowser to a fossil fuel vehicle.

Preferably synchronously, a similar plurality of depleted, part depleted or faulty Cell-Modules (100) are sequentially removed from the Vehicle by the System, via Portal (4) and Nozzle (3), for return to that Geographically Stationary Part of the System.

Faulty Cell-Modules (100) are analysed prior to removal from the System and depleted or part-depleted Cell-modules are optionally recharged within the Stationary Part of the enclosed System, for re-use within another specially manufactured Cell-Module powered electric Vehicle (1) at a later time.

The essential parallels, mimicry and improvements of the System (200) of the present invention, compared to a conventional fossil fuel dispensing bowser, for respectively providing a small volume Cell-Module (100) and a comparable small volume of fossil fuel, where both are used as the smallest practical ‘metered-for-payment’ measurable unit of bowser dispensed motive power energy supply, are now referenced to known electric vehicle and fossil fuel vehicle prior art, to better understand the needs, improvements, benefits and commercial applications that the present invention provides.

In the Berdichevsky et al U.S. Pat. No. 7,433,793, the use of approximately 9,000 small volume rechargeable cylindrical lithium-ion cells are permanently installed within a single rectangular battery block, for providing enough motive power to propel a Tesla Roadster electric sports car 200 miles before the large and heavy battery block needs to be recharged over a considerable practical time period.

The Tesla sports car is comparable in both size and acceleration performance to a Ferrari sports car that travels approximately 20 miles on one gallon of fossil fuel.

In the patent, the 9,000 rechargeable cells are considered to represent 2 gallons of gasoline. Since very few comparable fossil fuel powered sports cars are capable of travelling 100 miles on one gallon of gasoline, the impressive efficiency of the Tesla's electric drive motors, compared to a comparable Ferrari's internal combustion engine's efficiency, must be an important factor, especially when also considering the 900 pounds dead weight of the Tesla's battery block, compared to approximately 20 pounds of dead weight for 2 gallons of fossil fuel in a Ferrari's fossil fuel tank.

Also, when small volumes of liquid fossil fuel are sequentially inserted in the Ferrari by conventionally metered nozzle means, there is no need to consider return of depleted energy to the bowser, since it will have been dissipated to the atmosphere as heat and exhaust.

However, when the 9,000 cells in the Tesla car are fully depleted, their individual physical forms, volumes and weights still exist as if they were fully charged.

The essential removal of depleted small-volume Cell-Modules (100) from a Vehicle (1), to provide essential features of the present invention, is therefore an essential additional factor for disclosure of the System that a conventional fossil fuel dispensing bowser does not have to contend with.

The System of the present invention is therefore essentially different to an established fossil fuel dispensing bowser system in this important regard.

However, since it is an important embodiment of the present invention that the driver of a Cell-Module powered electric Vehicle (1) is provided with parallel or improved forecourt dispensing facilities for perceiving the sequential replenishment of Cell-Modules in the same or similar manner that he now perceives the sequential replenishment of fossil fuel, the additional removal of depleted Cell-Modules from the Vehicle should preferably be a ‘buried value’ factor of the present invention, as will now be generally disclosed.

For the driver of a Vehicle (1) who needs to replenish (say) 9,000 depleted Cell-Modules (100) that may each have similar size and weight of each cylindrical cell type that is practically disclosed in the Berdichevsky et al United States patent, the combined weight transfer that will take place between a Bowser (2) of the System (200) and a Vehicle (1) of the System, for the Computer Controllers (350) and (450) to control and complete the cyclical transfer processes, will approximate 1,800 pounds of transferred weight in total.

In this extreme weight transfer example of use of the present invention, it is important that the driver of such a Vehicle (1) is not made unduly aware that nearly a ton of Cell-Modules are sequentially travelling in two directions between the Bowser (2) and the Vehicle (1) while the user has inserted a Bowser Nozzle (3) into the Vehicle's Nozzle-Portal (4); any more so than he would be unduly aware of the weight of fossil fuel being transferred from a conventional forecourt bowser to the portal of a conventional vehicle, via a conventional bowser nozzle.

To provide practical electro-mechanical Conveyor support for this example of a Computer-Controlled embodiment of the invention, the Stationary Part (A) of the System (200) is provided with a constant electrical Power Input Supply Device (300) that receives sufficient constant electrical power from an external source, for the Computer-Controller (350) to constantly direct sufficient electrical energy supplies to all Main Components and all Conveyor Components for controlling and operating all interacting apparatus incorporated in the Moveable Part (B) of System (200), including a constant electrical power supply to Vehicle (1), via Bowser (2) and Nozzle (3), as a specific embodiment of the invention, when the Vehicle's Portal (4) is temporarily but securely attached a Nozzle (3) of the System.

The Power Input Supply (300) is disclosed as an essential component of the System, not least because the 9,000 depleted Cell-Modules already installed within a Vehicle (1), that is already attached a Bowser (2), cannot be expected to provide the necessary electrical energy input to the Vehicle's on-board Cell-Module Conveyors, for the essential sequential removal of 900 pounds of dead weight of depleted Cell-Modules from the Vehicle, whilst 900 pounds of freshly charged Cell-Modules are also being synchronously transferred from the Bowser for a new installation of 9,000 Charged Cell-Modules to also be received within that Vehicle (1).

In order that this example of use is provided, co-operatively mating Electric Terminal Blocks (320) and (340) are provided on the Nozzle (3) of the Bowser (2), for respective matingly co-operative electrical connection with Electric Terminal Blocks (420) and (440) provided on the Nozzle-Portal (4) of the Vehicle (1).

Specifically, when a Nozzle-Portal (4) of a Vehicle (1) is temporarily but securely attached a Nozzle (3) of the Bowser (2), the Terminal Block (320) is in secure electrical contact with the Terminal Block (420), and the electrical Terminal Block (340) is in secure electrical contact with the Terminal Block (440).

In one embodiment of the System, the electrically connected Terminals (320) and (420) provide practical means for the constant electrical Power Supply (300) situated in the Stationary Part (A) of the System to be directly transferred to the Power-Distributor (400) that is installed within the Independently Movable Part (B).

In another embodiment of the System, the electrically connected Terminals (340) and (440) provide practical means for the Computer-Controller (350) situated in the Stationary Part (A) to communicate directly with the Computer-Controller (450) installed in the Independently Moveable Part (B).

In yet another embodiment of the System, the electrically connected Terminals (320) and (420) and the electrically connected Terminals (340) and (440) together provide co-operative means for the Computer-Controllers (350), (450), in conjunction with the Power Input Supply (300) and the Power Distributor (400) to co-operatively control the physical movements and all data processing of all individual Cell-Modules (100) and (500) as they are conveyed within all parts of the System (200).

From all the above, it should be apparent that, in order for the invention to provide a forecourt Bowser System (200) that provides a parity replenishment system for delivery of choosable pluralities of metered motive-power energy, a significant increase in power to the externally sourced Power Input Supply (300) will be required.

This significant increase in power input requirements for fast replenishment of depleted Cell-Modules with freshly charged Cell-Modules is now directly compared to the other option of recharging, in-situ, the same 9,000 depleted cells within the Cell-Chamber (15) of the same Vehicle, by the use of an on-board battery charger connected to an externally sourced domestic electric power outlet.

The financial, social and commercial advantages of this significant increase in power input requirements, for practical application and use of the disclosed invention, are now further understood by again examining a Tesla electric sports car and a comparable fossil fuel Ferrari sports car covering exactly the same journey of two hundred miles, where both vehicles have entered the same roadside Service Area.

The contemporaneous cost to the Ferrari driver, of replenishing 200 miles worth of fossil fuel via a conventional fossil fuel forecourt bowser at (say) three Dollars per US gallon, will approximate thirty U.S. Dollars.

The contemporaneous cost to the Tesla driver, via a domestic electric power outlet, for replenishing 200 miles worth of rechargeable battery power, will approximate three U.S. Cents, or one thousandth of the cost to the Ferrari driver.

However, this extreme cost differential comes with extreme timing differences.

The Tesla driver may have to wait a commercially unacceptable and a socially unacceptable 28 hours of vehicle ‘dead-time’ before continuation of his journey, whereas the Ferrari driver will be continuing his same journey in less than five minutes.

The extreme price differential that exists between thirty Dollars and three Cents provides a very broad spectrum of commercial propositions for an investor, provider or manufacture of Cell-Modules (100), (500), a Vehicle (1) or a System (200) to understand the need for the improvements that a specially manufactured electric Vehicle (1) and a System (200) of the present invention provides.

This extreme time differential that exists between twenty-eight hours for motive power replenishment and five minutes for motive power replenishment provides a very attractive proposition for an investor, provider or manufacture to also understand how later improvements in some or all parts of the present invention will continue to benefit the present invention.

The invention thus fulfils an urgently required practical need for drivers and users of specially manufactured Cell-Module powered electric Vehicles to obtain parity motive-power replenishment services from Cell-Module Bowser dispensing services, at an otherwise conventional roadside service station environment.

In order to properly define an Enclosed Cyclical-Conveyor-Control-System (200), the enclosed System is generally disclosed as comprising separate Through-Flow Main Components that are either joined to each other or joined by interspaced Through-Flow Conveyor-Components to provide a cyclical Through-Flow of Cell-Modules within the enclosed System.

### First Embodiments

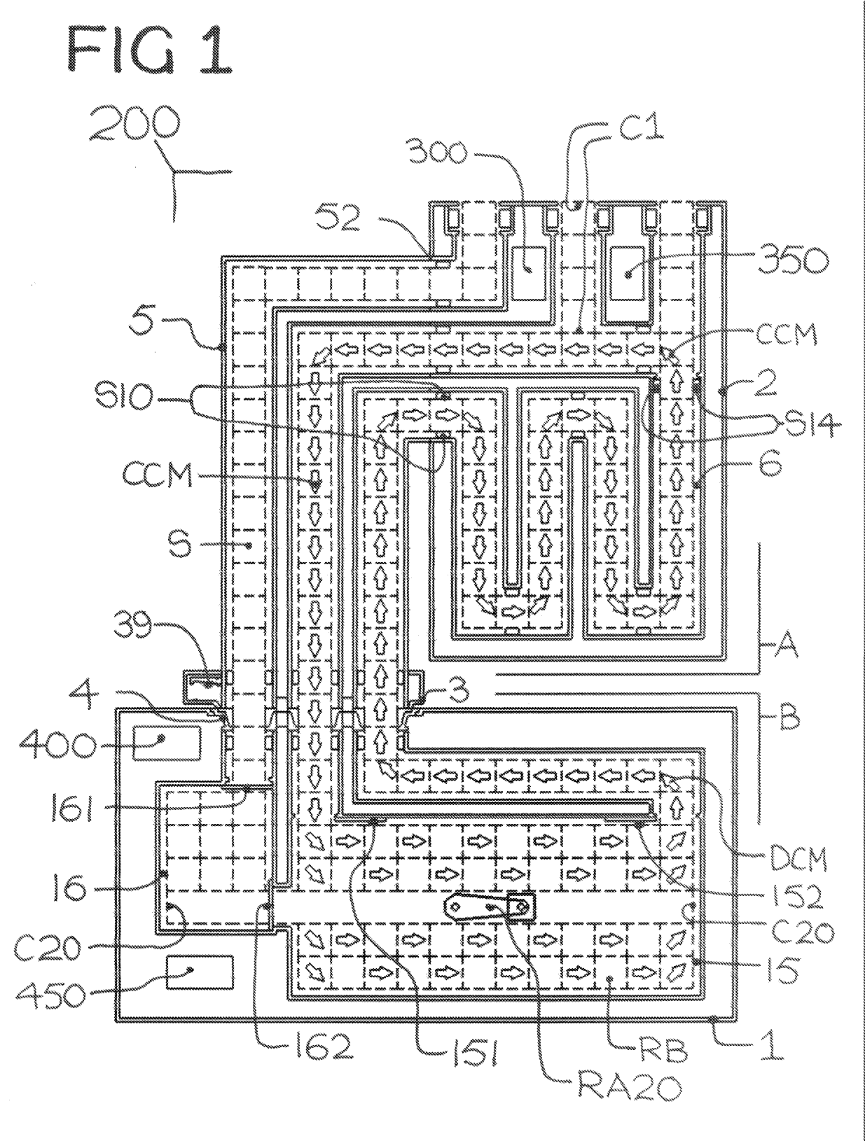

FIG. 1 is a general schematic down-view, for defining in introductory terms, the First Embodiments of an Enclosed Computer-Controlled Cyclical Through-Flow Sequential Conveyor System (200), for the sequential computer-controlled conveyance of a very large number of identical individual small-volume rechargeable Cell-Modules (100) through and within an Enclosed System.

In this drawing, no Cell-Modules (100) are actually shown.

Instead, the physical extremities of each individual Cell-Module (100), that may be disposed within a System (200), is schematically disclosed by the use of four broken straight lines that together form a bounding Square (S).

Each Cell-Module's sequentially conveyed position within a simple version of an Enclosed System (200) is thus illustrated by the use of a sequentially positioned Flow-Direction-Arrow within each bounding Square (S).

An Enclosed System (200) generally comprises a Stationary Part (A) that is shown temporarily but securely attached an Independently Movable Part (B), for the cyclical, sequential and physical conveyance of a plurality of small-volume rechargeable Cell-Modules (100), each shown in the drawing as a one-way Flow-Direction-Arrow, to sequentially flow between the Stationary Part (A) and the Moveable Part (B).

In all Embodiments of the present invention, a Stationary Part (A) preferably includes; a specially manufactured Cell-Module Dispensing Bowser (2) that is provided with a Cell-Module Dispensing Nozzle (3) and; a Movable Part (B) that preferably includes a specially manufactured or specially modified Cell-Module powered electric Vehicle (1) that is provided with a matingly co-operating Nozzle Receiving Portal (4) installed on its outer bodywork.

It is important to disclose at this juncture, for all Embodiments of the present invention, that each Flow-Direction-Arrow not only represents an individual Cell-Module (100), it also represents the smallest measurable unit of motive power that is sequentially flowing within an Enclosed System (200), that the System, especially the Bowser (2) can readily identify, for metering and billing purposes.

It is also important to disclose at this juncture, for all Embodiments of the present invention, that individual Cell-Modules (100), represented by the Flow-Direction-Arrows, may thus be conveyed within a Enclosed System (200) in a manner that parallels, mimics, or improves upon a conventional fossil fuel bowser dispensing system that sequentially dispenses small volumes of fossil fuel that the conventional bowser also readily identifies as the smallest measurable unit of motive power flowing from a conventional fossil fuel dispensing bowser to a conventional fossil fuel powered vehicle, for metering and billing purposes.

In the drawing a Depleted Cell-Module (DCM), whose stored electric energy has been depleted by the Cell-Module powered electric Vehicle (1), is shown sequentially exiting the Vehicle's through-flow Main-Chamber (15), via Exit-Gate (152), where that Depleted Cell-Module, along with others, was previously individually installed within Cell-Module Receiving Bays (RB), for that stored electric energy to have been previously extracted by the Cell-Module powered electric Vehicle (1).

The Depleted Cell-Module (DCM) is shown being sequentially conveyed away from the Main-Chamber (15) towards the Nozzle-Receiving-Portal (4), installed on the outer bodywork of Vehicle (1).

The Depleted Cell-Module is then shown being sequentially conveyed through Portal (4) and the Nozzle (3) that is temporarily secured within it, where it, along with others, are then sequentially conveyed through a Flexible-Pipe (5) towards the casing of Bowser (2).

The Depleted Cell-Modules are then shown sequentially entering the casing of Bowser (2) after passing between Interrogation Sensors (S10), where they sequentially enter a Cell-Module Charging-Bay (6).

The Cell-Module Charging-Bay (6) is schematically disclosed as a ‘W’ shape, or snake-like shape, for schematically portraying an elongate Charging Bay contained within a compact volume, such as the casing of a Cell-Module Dispensing Bowser (2).

The Depleted Cell-Modules are then shown sequentially passing through the snake-like length of the Cell-Module Charging-Bay (6) for being slowly recharged along that conveyed route, for emerging between the Interrogation Sensors (S14) as freshly Charged Cell-Modules (CCM).

The freshly Charged Cell-Modules are then shown being sequentially conveyed towards the Flexible-Pipe (5), for then being conveyed towards Nozzle (3) and Portal (4).

While passing through Nozzle (3) into Portal (4), metering devices (not shown) that are installed within the casing of Nozzle (3) provide all necessary metering and billing data, relating to the sequential flow of individual Cell-Modules, to the Bowser (2) and the Vehicle (1).

After the freshly Charged Cell-Modules (CCM) have passed through Portal (4), they are immediately conveyed through Entrance-Gate (151) of the Vehicle's Main-Chamber (15), where the centrally disposed Conveyor (C20) and its attached Robotic-Arm (RA20), schematically shown as an elongate triangle, sequentially installs each arriving Charged Cell-Module within a vacant Receiving-Bay (RB) of the Main-Chamber, until the choosable plurality of Depleted Cell-Modules that were previously installed in the Main-Chamber have been sequentially replaced with a similar plurality of Charged Cell-Modules, by the System (200) in a sequential through flow procedure.

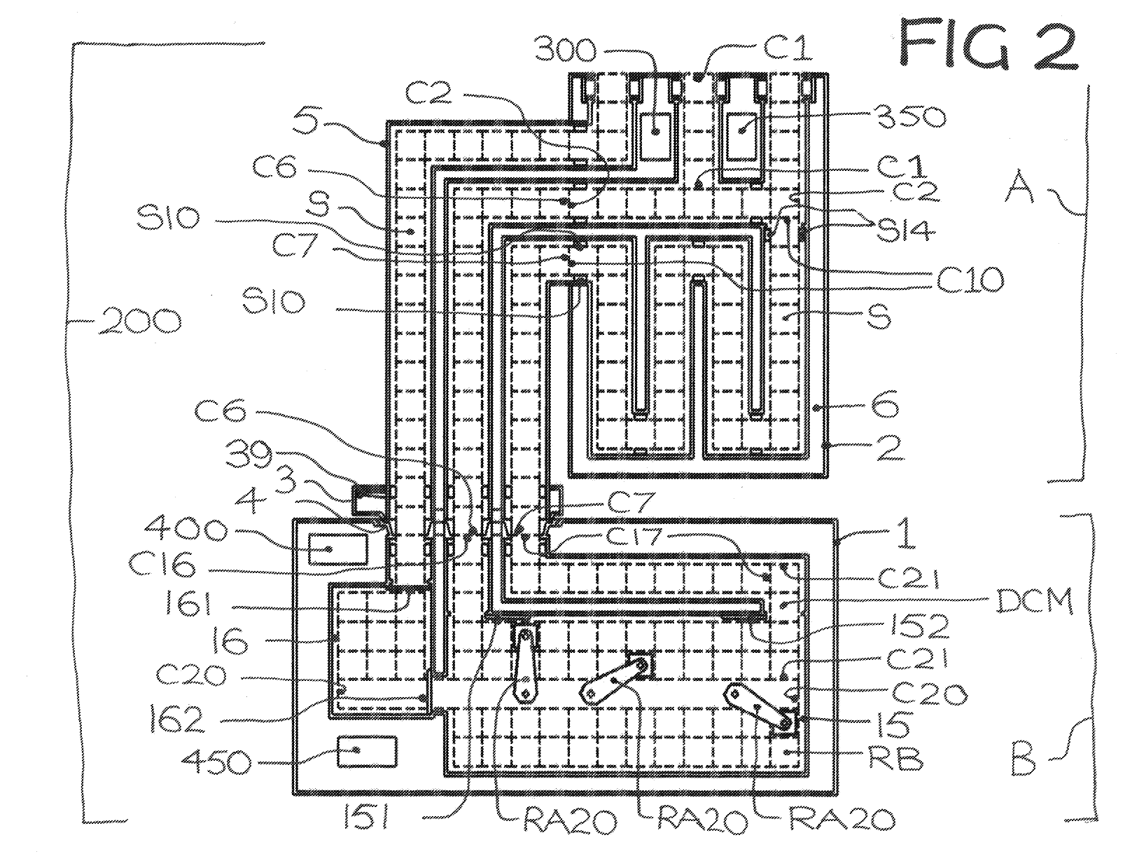

The FIG. 2 drawing schematically discloses the sequentially placed ‘end-to-end’ or ‘end-to-side’ Conveyors that conveyed the Cell-Modules, shown as Flow-Direction-Arrows in the FIG. 1 drawing, through the Enclosed System (200).

To better identify an individual Cell-Module Conveyor in more detailed later drawings, each Conveyor will be schematically disclosed as being exactly one Square (S) wide and, its schematic working length being defined by the visible number of edge-to-edge conjoined Squares.

Where possible, each Cell-Module Conveyor will be twice identified by an Alpha-Numeric moniker, e.g. (C2), throughout the drawings, that points to each remote-end or side of the first and last visible Square on each schematic Conveyor belt, to provide clear disclosures.

Conveyor (C1) may thus be identified in the drawing as being four Squares (S) in length, although its practical length, for a rotating Conveyor, e.g. of endless band type, would be at least nine Squares.

An exception to this rule, which will be enlarged upon in later disclosures, is made for the only bi-directional Conveyor in the System; Conveyor (C20), which can only be understood as being sixteen Squares in visual length by counting the Squares that are disposed above its upper elongate side.

Since the mechanical functions of different types of Cell-Module Conveyors are not part of the invention's disclosures, adjacently placed interacting Conveyors are shown for disclosing the seamless transference of a Cell-Module from the last Square of a first Conveyor onto the first Square of a second Conveyor, as previously shown by referencing certain Flow-Direction-Arrows in the FIG. 1 drawing with this drawing.

Starting at the bottom of the drawing, Conveyor (C20) is shown centrally positioned within the Main-Chamber (15) of Vehicle (1) and also positioned within the adjacently placed Thermal-Safety-Chamber (16), for sharing the role of Cell-Module conveyance for both Chambers.

The Conveyor has a schematic Robotic-Arm (RA20) rotatably affixed its upper movable portions, for providing at least three functions.

In the drawing, the same Robotic-Arm is shown in three separate positions on Conveyor (C20) to indicate means by which the Conveyor and its attached Robotic-Arm can together service any Receiving Bay (RB) installed within a Main-Chamber (15) and within a Thermal-Safety-Chamber (16).

The first service is the removal of a Faulty Cell-Module from a Cell-Module-Receiving-Bay (RB) installed within Main-Chamber (15) and conveying it directly into the Thermal-Safety-Chamber (16), through a Thermal-Safety-Door (162), for being securely retained therein.

The second service is the sequential receiving of a Charged Cell-Module from Conveyor (C16), through the open Entrance-Gate (151) and conveying it and then installing it directly into a Cell-Module-Receiving-Bay (RB) within Main-Chamber (15), for power extraction use by the Vehicle (1).

The third service is the sequential removal of a Depleted Cell-Module from a Cell-Module-Receiving-Bay (RB) and then conveying it directly towards the Main-Chamber's open Exit-Gate (152) for then being conveyed out of Main-Chamber (15) by Conveyor (C21).

Conveyor (C21) sequentially conveys Depleted Cell-Modules out of Main-Chamber (15) and then onto Conveyor (C17), for being conveyed towards Portal (4), where the other remote end of Conveyor (C17) terminates.

Conveyor (C17) then conveys Depleted Cell-Modules towards Portal (4), for removal from the Movable Part (B), by sequential transfer directly onto the Conveyor (C7), whose remote end is installed within the Nozzle (3) of the Stationary Part (A).

The Depleted Cell-Modules are then conveyed through the entire length of Flexible Pipe (5), where they exit Conveyor (C7) adjacent the Interrogation Sensors (S10), installed within the casing of the Bowser (2).

The Depleted Cell-Modules pass through the Interrogation Sensors (S10) for then being conveyed directly onto Conveyor (C10); that is provided with recharging facilities for slowly recharging Depleted Cell-Modules as they traverse the length of Conveyor (C10).

As the Cell-Modules sequentially pass between the Interrogation Sensors (S14), they have been fully charged and exit Conveyor (C10) as freshly Charged Cell-Modules (CCM).

Each freshly Charged Cell-Module is then conveyed directly onto Conveyor (C2) for being conveyed directly towards Conveyor (C6).

After being conveyed directly onto Conveyor (C6), a Charged Cell-Module exits the casing of Bowser (2) and enters the Flexible-Pipe (5).

The Conveyor (C6) sequentially conveys Charged Cell-Modules towards Dispensing Nozzle (3) that has been secured within the matingly co-operative Portal (4) of Vehicle (1).

After passing through Nozzle (3) and Portal (4) each Cell-Module is sequentially directed onto Conveyor (C16) that adjoins the Portal to the Vehicle's Main-Chamber (15).

Each Charged Cell-Module is sequentially conveyed through the opened Entrance-Gate (151) of Main-Chamber (15), to immediately receive the second service of Conveyor (C20) and Robotic-Arm (RA20) as previously described for this drawing.

The FIG. 2 drawing thus discloses in sequential order, how the Conveyors (C20), (C21), (C17), (C7), (C10), (C2), (C6), (C16) and again (C20), provide an Enclosed Cyclical System (200) for the introductory First Embodiments of the present invention.

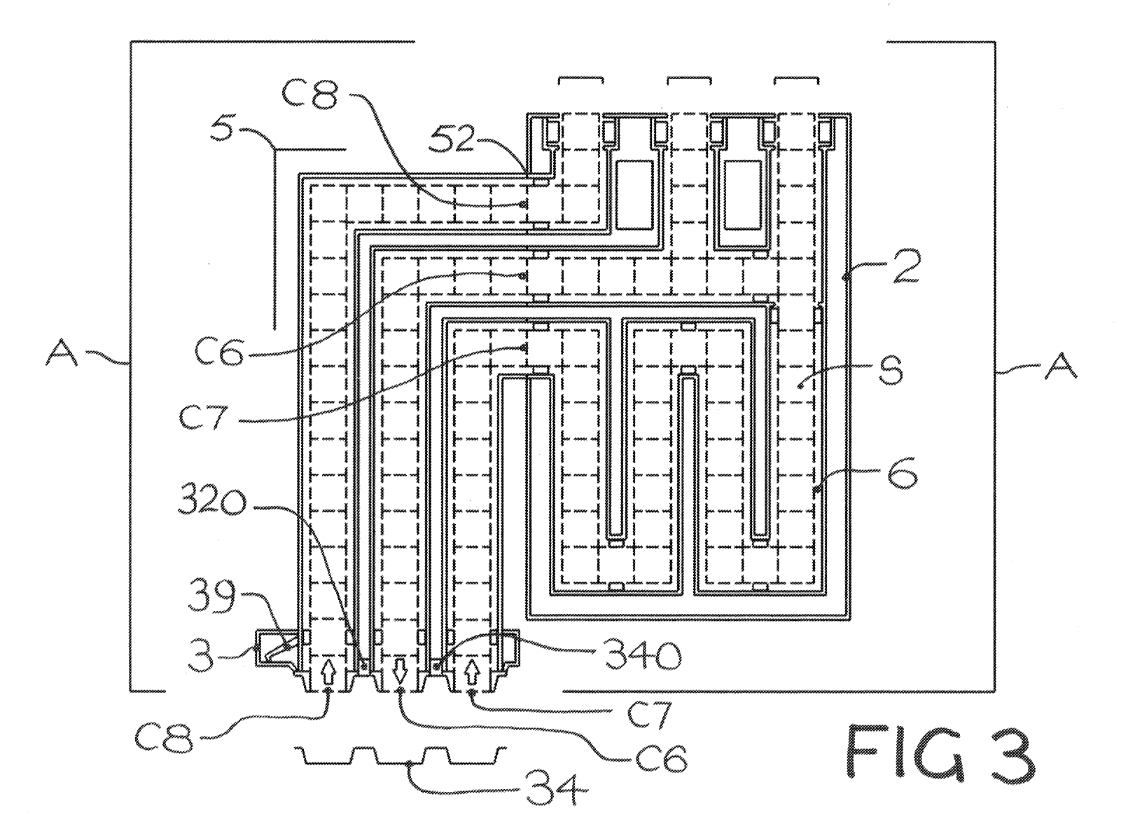

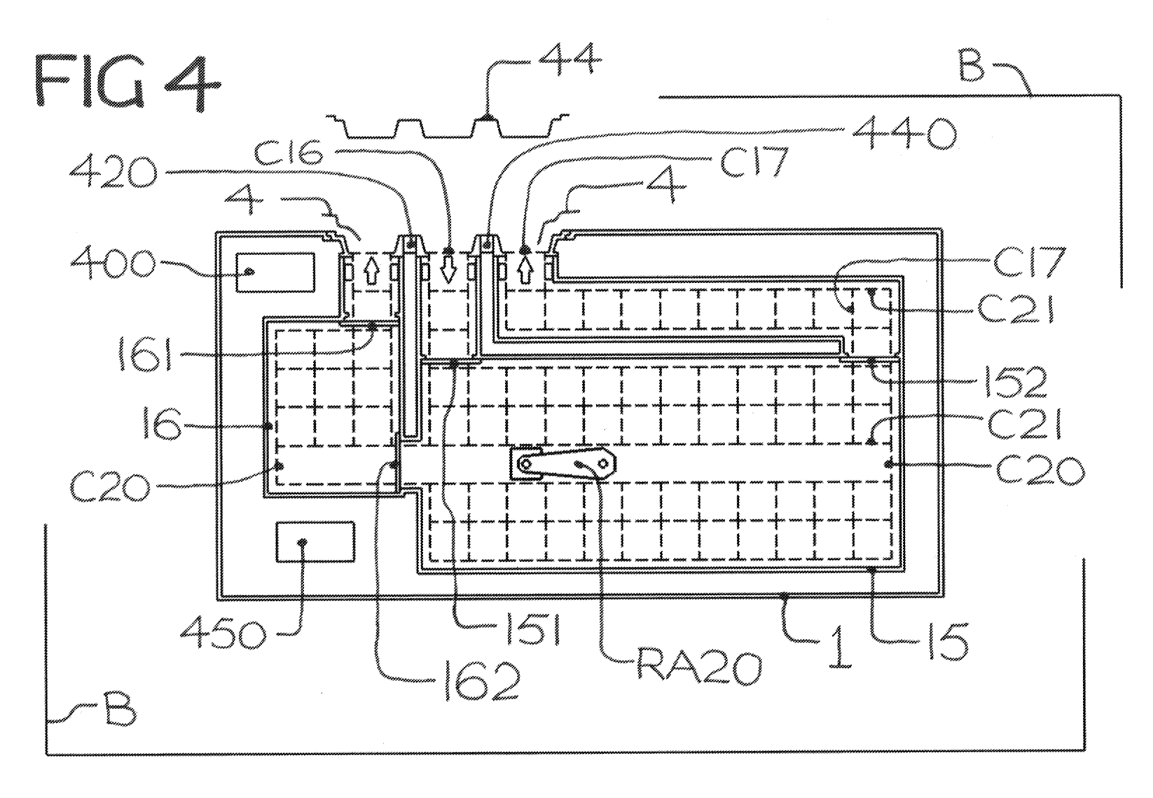

Referring briefly to FIG. 3 and FIG. 4, the drawings respectively show a separate Stationary Device (A) and a separate Movable Device (B), as shown connected to each other in FIG. 1 and in FIG. 2.

In FIG. 3, the Stationary Device (A) includes a Cell-Module Dispensing Bowser (2), whose outer casing has one remote end (52) of a Cell-Module Conveying Flexible-Pipe (5) rotatably attached.

The other remote end of Flexible-Pipe (5) is permanently attached the casing of a male Cell-Module Dispensing Nozzle (3).

The casing of Nozzle (3) is provided with a Nozzle-Trigger (39) that is shown in its non-activated position in this drawing but is shown in the activated position in the FIG. 1 and FIG. 2 drawings.

In FIG. 4, the Independently Movable Device (B) comprises a specially manufactured Cell-Module powered electric Vehicle (1) having a female Nozzle-Portal (4) installed on its outer bodywork for matingly receiving a Cell-Module Dispensing Nozzle (3), when the Vehicle (1) is parked adjacent a Cell-Module dispensing Bowser (2).

Because the Portal (4) of Vehicle (1) is not shown adjoined the Nozzle (3) of Bowser (2), the Entrance-Gate (151) and the Exit-Gate (152) of Main-Chamber (15) are shown in their closed safety positions.

Referring again to FIG. 1 and FIG. 2, it should now be understood, that System (200) becomes an Enclosed Computer-Controlled Cyclical Through-Flow Sequential Conveyor System when the Stationary Device (A) and the Moveable Device (B) are securely attached each other when Cell-Module Nozzle (3) of Bowser (2) has been temporarily but securely inserted into a matingly co-operative Nozzle-Portal (4) of Vehicle (1).

The flow direction of Cell-Modules within a First Embodiment of the System (200) is again referred to, by use of the flow direction Arrows.

Upon activation of the Nozzle-Trigger (39) by e.g. the driver of Vehicle (1), a choosable plurality of Depleted Cell-Modules are shown being sequentially conveyed out of the Vehicle (1) for a similar plurality of Charged Cell-Modules to be sequentially and synchronously conveyed into the Vehicle (1).

From this information it should be understood that the Charged-Cell-Modules entering Vehicle (1) cannot include the same Depleted Cell-Modules that are being synchronously removed from the same Vehicle.

It is important to note at this juncture, that whilst the visual lengths for (e.g.) the Conveyors (C1) and (C20) have been given as exact numbers for direct reference in the drawings and the descriptions, those actual numbers have been used only for clearer and simpler understanding of the through-flow of Cell-Modules through and within any part of the Control System (200) and do not represent actual preferred numbers.

As a particular example of this, FIG. 1 and FIG. 2 disclose a Vehicle (1) having an installed Cell-Module-Chamber (15) that has only 48 Vacant Cell-Module-Receiving-Bays (VRB) schematically installed therein.

For commercial applications of the invention, the actual number of Cell-Module Receiving-Bays installed within a practical Cell-Module-Chamber (15) may range between a few and tens of thousands, entirely dependent on; the type of Vehicle (1); the number of Main-Chambers (15) installed in each Vehicle (1) and; the size, external shape and Electric Terminal configuration needs of the chosen type or types of Cell-Modules that will be used within a practical System (200).

Similarly, commercial applications of Cell-Module Conveyors, for use within a practical System of the invention, may provide enclosed cyclical facilities for sequentially conveying thousands of Cell-Modules at any one time, conveyed either in single file as shown in the drawings, or in plural file form.

The Flow-Direction-Arrows in FIG. 1 have been placed at precise locations within certain Squares (S) to more clearly disclose; for each individual Cell-Module that would be at each of those precise locations at that precise moment in time during Cell-Module conveyance; the transit directions of the generally one-way cyclical sequential conveyed flow of adjacently placed Cell-Modules sequentially passing through those precise locations.

From all the above, it should be apparent, for a practical System (200), that the Arrows also represent the direction flow of the generally one-way cyclical conveyance of great numbers of Cell-Modules through and within the System by practical Cell-Module Conveyors, when a practical System (200) is fully operational.

By following the sequential flow of the Arrows, FIG. 1 thus discloses, in general introductory terms, for later detailed disclosure in other drawings, the different routes by which an individual Cell-Module and large numbers of Cell-Modules may be sequentially conveyed through and within different Embodiments of a System, for use within the System, being recharged within the System and; being sequentially conveyed for entering the System as a New Cell-Module and exiting the enclosed System as a depleted, faulty or damaged Cell-Module.

In all Embodiments of the invention, the Stationary Device (A) includes a specially manufactured Cell-Module dispensing Bowser (2), preferably but not exclusively, installed in an otherwise conventional Service Station Forecourt environment, for sequentially conveying a choosable metered plurality of Cell-Modules (100) and optionally, a choosable metered plurality of Cell-Modules (500), that are disclosed for the Sixth Embodiments, to and from the Movable Device (B), which is a specially manufactured or specially modified Cell-Module powered electric Vehicle (1).

Referring again to FIG. 3, the drawing shows in greater detail a portion of the Stationary Part (A), as generally described in FIG. 1 and FIG. 2.

Stationary Part (A) includes three distinctly different interconnected electro-mechanical Devices; a Cell-Module Dispensing Bowser (2), a Cell-Module Dispensing-Pipe (5) and a Cell-Module Dispensing Nozzle (3).

The drawing shows that Nozzle (3) is permanently attached Bowser (2) by the Dispensing-Pipe (5).

The remote end (52) of Pipe (5) is shown attached the Casing of Bowser (2), such that the Conveyor Devices installed within Pipe (5) are provided with unimpeded flow connections with their respective Conveyor Devices that are installed within the Bowser (2).

A Constant Power Supply Device (300) is shown as a rectangular casing that is permanently installed within the body of the Bowser and is provided with a constant and sufficient electric power supply from an outside source (not shown) to constantly provide all necessary electric power requirements for distribution to all electronic and all electro-mechanical devices that have been installed within the System.

A Computer-Controller (350) is also defined by a rectangular casing that has also been installed within the Casing of a Cell-Module Dispensing Bowser (2).

The Computer-Controller (350) is permanently electrically connected (not shown) to the Power Supply Device (300) for the automated computer-control of all electronic programs, all software programs and all electro-mechanical functions that operate the System.

An Electric Terminal Block (320) is shown as a rectangular casing permanently installed within the Casing of Nozzle (3), such that one of its outer faces forms a part of the convolutions of Nozzle Face (34).

Another Electric Terminal Block (340) is also shown as a rectangular casing permanently installed within the Casing of Nozzle (3), such that one of its outer faces forms another part of the convolutions of Nozzle Face (34).

Terminal Block (320) is directly connected to the Constant Power Supply Device (300) by a permanent wiring loom (not shown).

Terminal Block (340) is directly connected to the Computer-Controller (350) by a permanent wiring loom (not shown).

A user activated Nozzle-Trigger (39) is shown installed within a part of the casing of Nozzle (3).

Referring again to FIG. 4, the drawing shows in greater detail a portion of the Movable Part (B), as generally described in FIG. 01.

The Movable Part (B) comprises a Cell-Module powered electric Vehicle (1) that has several distinctly different interconnected electro-mechanical Devices installed therein, including; a Cell-Module Chamber (15); a Cell-Module Thermal Safety Chamber (16) and; a Cell-Module Nozzle Insertion Portal (4).

These electro-mechanical Devices are interconnected by computer-controlled Conveyors.

An Insertion Portal (4) is shown permanently installed in the outer bodywork of Vehicle (1) in a suitable manner and location for the type of Vehicle (1) that the Portal will be used with.

A Constant Power Receiving & Supply Device (400) is shown as a rectangular casing that is permanently installed within the body of the Vehicle (1) and is provided with a constant and sufficient electric power supply from an outside source (not shown) to constantly provide all necessary electric power requirements for mass distribution of Cell-Modules to all electro-mechanical apparatus that has been installed within the Vehicular part of the System, when the Vehicle is temporarily secured to a Bowser Nozzle (not shown).

A Computer-Controller/Server (450) is also defined by a rectangular casing that has also been installed within the body of the Vehicle (1).

The Computer-Controller/Server (450) is permanently electrically connected (not shown) to the Power Receiving & Supply Device (400) for the automated computer-control of all electronic programs, software programs and electro-mechanical functions that operate the Vehicular part of the System.

An Electric Terminal Block (420) is shown as a rectangular casing permanently installed within the Casing of Portal (4), such that one of its outer faces forms a part of the convolutions of Portal Face (44).

Another Electric Terminal Block (440) is also shown as a rectangular casing permanently installed within the Casing of Portal (4), such that one of its outer faces forms another part of the convolutions of Portal Face (44).

Terminal Block (420) is directly connected to the Constant Power Receiving & Supply Device (400) by a permanent wiring loom (not shown).

Terminal Block (440) is directly connected to the Computer-Controller/Server (450) by a permanent wiring loom (not shown).

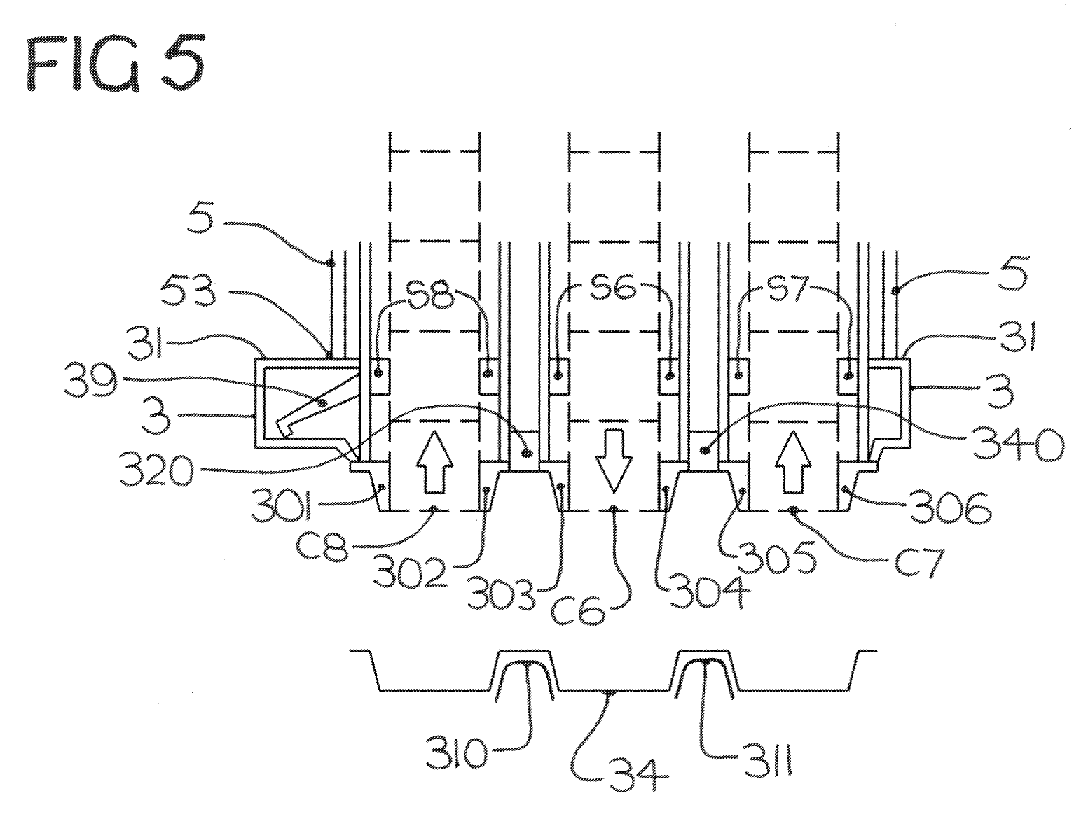

Referring now to FIG. 5, the drawing shows in greater detail, a schematic sectional down-view of a Cell-Module Dispensing Nozzle (3), as generally disclosed in FIGS. 1 to 4.

The remote end (53) of Pipe (5) is shown attached the Rear-Face (31) of a Cell-Module Dispensing Nozzle (3), such that the Conveyors (C8), (C6) and (C7) that are installed within Pipe (5) are provided with unimpeded flow connections, for enabling their remote ends to meet with their respective Nozzle-Ends (301) and (302), (303) and (304) and, (305) and (306).

These six Nozzle-Ends are each provided with outer surface structures that are essential for providing the required convoluted Front-Face (34) of Nozzle (3).

The Nozzle-Ends (301) and (302) are shown mirrored and spaced apart a precise amount to provide means for the remote end (C8) of Conveyor (C8) to convey Faulty Cell-Modules (not shown) through the Nozzle, away from a Vehicle (1), as indicated by the direction of the Arrow placed between these Nozzle-Ends.

The Nozzle-Ends (303) and (304) are also shown mirrored and spaced apart a precise amount to provide means for the remote end (C6) of Conveyor (C6) to convey New or Freshly Charged Cell-Modules (not shown) through the Nozzle, towards a Vehicle (1), as also indicated by the direction of the Arrow placed between these Nozzle-Ends.

The Nozzle-Ends (305) and (306) are also shown mirrored and spaced apart a precise amount to provide means for the remote end (C7) of Conveyor (C7) to convey Depleted or Part-Depleted Cell-Modules (not shown) through the Nozzle, away from a Vehicle (1), as also indicated by the direction of the Arrow placed between these Nozzle-Ends.

An Electric Terminal Block (320) is disclosed as a rectangular casing that is permanently installed between the mirrored outer walls of Nozzle-Ends (302) and (303), such that a Blind-Cavity (310) is formed by these three components.

This Blind-Cavity (310) is schematically replicated within the convoluted line below the Nozzle that defines the shape of the convoluted Outer-Face (34) of Nozzle (3).

In a preferred embodiment, Terminal Block (320) is directly connected by a permanent wiring loom (not shown) to a Constant Power Input Supply Device (300) that that has been permanently installed within the Casing of the Cell-Module Dispensing Bowser (2), as disclosed in FIG. 1 and FIG. 2.

In another preferred embodiment, Terminal Block (320) is provided with a suitable plurality of Terminal-Ends (not shown) on its outer End-Face (321).

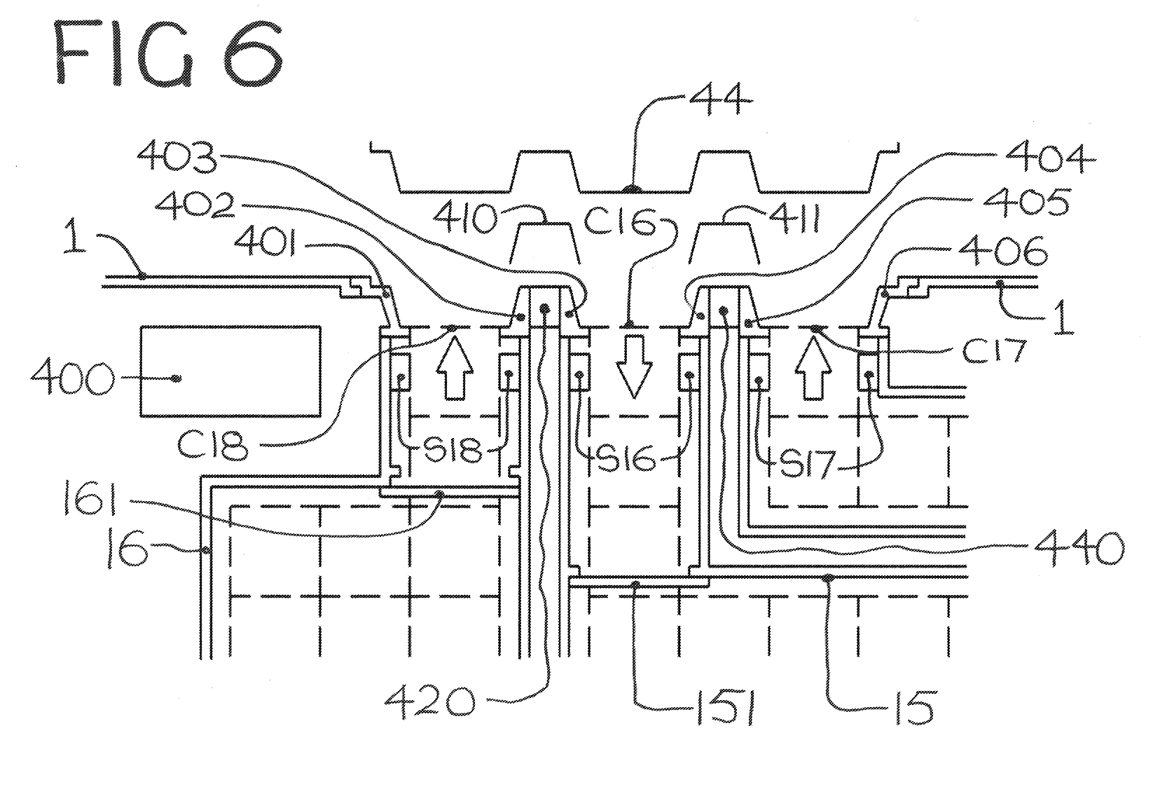

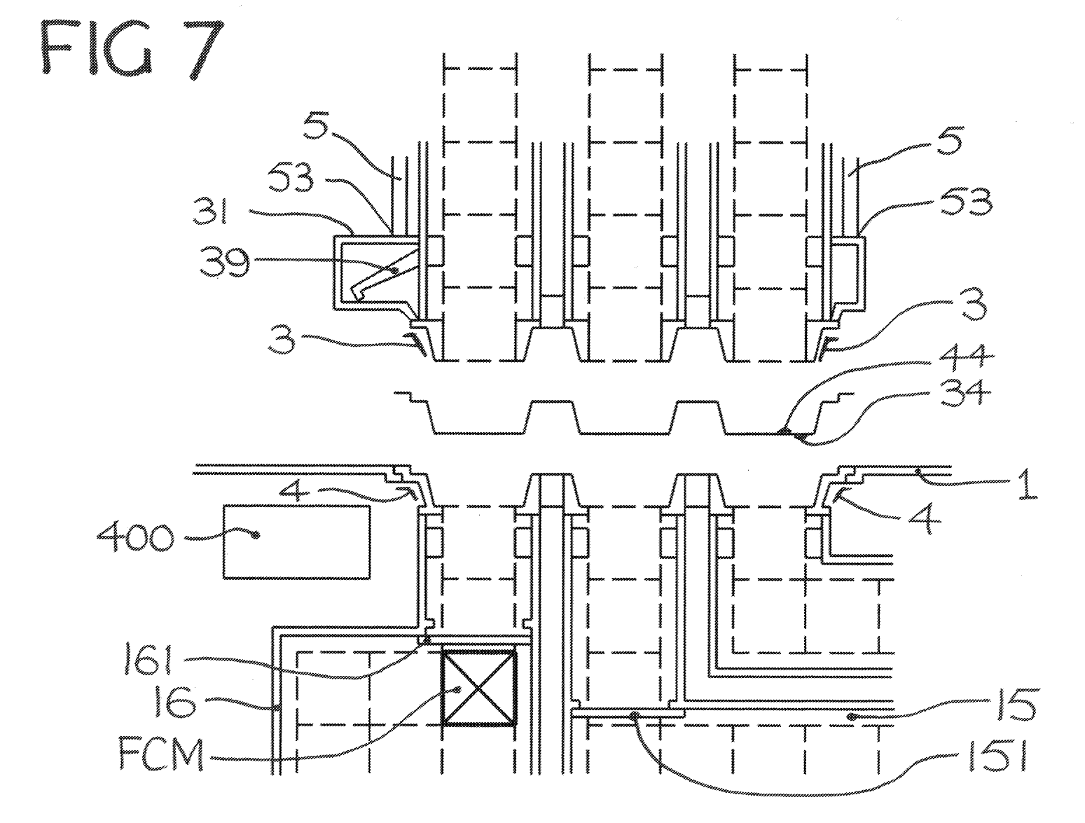

From this disclosure and with initial reference to FIG. 6 and FIG. 7, it should be understood that when Nozzle (3) is inserted and secured within Nozzle-Receiving-Portal (4), the Blind-Cavity (310) is in co-operative close-mating contact with the Ridge (410) provided on Face (44) of Portal (4).

It should be further understood that when Blind-Cavity (310) and Ridge (410) are in co-operative close-mating contact, the Terminals provided in End-Face (321) are in secure electrical contact with the Terminals provided in End-Face (421) that forms the generally planar peak of Ridge (410).

An Electric Terminal Block (340) is also disclosed as a rectangular casing that is permanently installed between the mirrored outer walls of Nozzle-Ends (304) and (305), such that a Blind-Cavity (311) is also formed by these three components.

This Blind-Cavity (311) is also schematically replicated within the convoluted line below the Nozzle that defines the shape of the convoluted Outer-Face (34) of Nozzle (3).

In another preferred embodiment, Terminal Block (320) is connected by a permanent wiring loom (not shown) to a Computer-Controller (350) that has been installed within the Casing of a Cell-Module Dispensing Bowser (2), as also disclosed in FIG. 01 and FIG. 02.

In yet another preferred embodiment, another Terminal Block (340) is provided with a suitable plurality of Terminal-Ends (not shown) on its outer End-Face (341).

From this disclosure and again with initial reference to FIG. 6 and FIG. 7, it should again be understood that when Nozzle (3) is inserted and secured within Nozzle Insertion-Portal (4), the Blind-Cavity (311) is in co-operative close-mating contact with Ridge (411) that is provided on Face (44) of Portal (4).

It should be again further understood that when Blind-Cavity (311) and Ridge (411) are in such co-operative close-mating contact, the Terminals provided in End-Face (341) are in secure electrical contact with the Terminals provided in End-Face (441) that also forms the generally planar peak of Ridge (411).

The electro-mechanical Nozzle Trigger (39), briefly introduced for FIGS. 1 to 3, is disclosed herein as being rotatably installed within the casing of Nozzle (3).

When Trigger (39) is ready to be activated by e.g. the driver of a Vehicle (1), direct electrical connections (not shown) are made between the Trigger (39) and the Computer-Controller (350) to instigate the computer-controlled operations that are necessary for a choosable plurality of Cell-Modules to begin to be conveyed to and from the Vehicle.

Cell-Modules will then continue to be conveyed between the Bowser and the Vehicle, so long as the Trigger continues to be activated by the driver of Vehicle (1) or until the total number of Cell-Modules that the Computer-Controller (350) understands represents a maximum number for that Vehicle has been attained.

When Trigger (39) has been activated and Cell-Modules are being sequentially conveyed by the Computer-Controller (350) and Power-Supply (300), Cell-Module Interrogation Sensors (S6), (S7) and (S8), that are also installed within the Nozzle Casing, are able to interrogate the individual Identity Devices provided on each and every Cell-Module as it passes these Interrogation Sensors, for these Interrogation Sensors to sequentially transmit precise data about each individual Cell-Module to the Computer-Controllers (350) and (450), for every Cell-Module that passes in any direction through the Nozzle (3).

Referring now to FIG. 6, the drawing shows in much enlarged form, a schematic sectional view of a Nozzle Insertion-Portal (4), as generally disclosed in previous drawings.

The Nozzle Insertion-Portal (4) may be described as a female or cavity Portal that is permanently installed within the outer bodywork of a Cell-Module powered electric Vehicle (1) and may be provided with similar visual appearances to a conventional fossil fuel insertion-portal installed on the outer bodywork of a conventional fossil fuel vehicle.

In this and all other drawings the Insertion-Portal's Security Cover has been omitted for clarity purposes.

The convoluted Outer-Face (44) of Portal (4) and the Ridges (410) and (411) are also replicated as convoluted lines above the actual Portal. To show that the Portal is of general planar valley form having two equal sized and equally spaced Ridges (410), (411) rising from the generally planar cavity floor that is generally defined by the remote ends of the Conveyors (C18), (C16) and (C17).

The regular convolutions of Outer-Face (44) are formed by six Portal-Ends (401), (402), (403), (404), (405) and (406) and the remote ends of the Conveyors (C16), (C17) and (C18).

The Portal-Ends (401) and (402) are shown spaced apart a precise amount to provide means for the remote end (C18) of Conveyor (18) to convey Faulty Cell-Modules (not shown) through the Portal, away from a Vehicle (1), as indicated by the direction of the Arrow placed between these Devices.

The Portal-Ends (403) and (404) are also shown spaced apart a precise amount to provide means for the remote end (C16) of Conveyor (16) to convey New or Freshly Charged Cell-Modules (not shown) through the Portal, towards a Vehicle (1), as also indicated by the direction of the Arrow placed between these Devices.

The Portal-Ends (405) and (406) are also shown spaced apart a precise amount to provide means for the remote end (C17) of Conveyor (17) to convey Depleted or Part-Depleted Cell-Modules (not shown) through the Portal, away from a Vehicle (1), as also indicated by the direction of the Arrow placed between these Devices.

An Electric Terminal Block (420) is disclosed as a rectangular casing permanently attached the outer walls of Portal-Ends (402), (403) such that a planar-topped Ridge (410) is formed by these three components.

In a preferred embodiment, Terminal Block (420) is directly connected by a permanent wiring loom (not shown) to a Power Input Supply Device (400) that has been permanently installed within the body of a Vehicle (1), as disclosed in FIG. 01.

In another preferred embodiment, Terminal Block (420) is provided with a suitable plurality of Terminal-Ends (not shown) on its outer End-Face (421).

From these disclosures and with further reference to FIG. 5 and initial reference to FIG. 7, it should again be understood that when Nozzle (3) is inserted and secured within Insertion-Portal (4), the Blind-Cavity (310) is in co-operative close-mating contact with the Ridge (410) provided on Face (44) of Portal (4).

It should be further understood that when Blind-Cavity (310) and Ridge (410) are in such co-operative close-mating contact, the Terminals provided in End-Face (321) are in secure electrical contact with the Terminals provided in End-Face (421) that forms the generally planar peak of Ridge (410).

An Electric Terminal Block (440) is also disclosed as a rectangular casing attached the Portal-Ends (404), (405) such that a planar-topped Ridge (411) is formed by these three components.

In another preferred embodiment, Terminal Block (440) is connected by a permanent wiring loom (not shown) to a Computer-Controlled Server (450) that has been permanently installed within the body of a Vehicle (1), as disclosed in FIG. 1.

In yet another preferred embodiment, Terminal Block (440) is provided with a suitable plurality of Terminal-Ends (not shown) on its outer End-Face (441).

From this disclosure and again with initial reference to FIG. 06, it should be understood that when Nozzle (3) is inserted and secured within Portal (4), the Blind-Cavity (311) is in co-operative close-mating contact with Ridge (411) provided on Face (44) of Portal (4).

It should be again further understood that when Blind-Cavity (311) and Ridge (411) are in co-operative close-mating contact, the Terminals provided in End-Face (341) are in secure electrical contact with the Terminals provided in End-Face (441) that forms the generally planar peak of Ridge (411).

From all the above, when an electro-mechanical Nozzle Trigger (39) (not shown) has been activated by the driver of a Vehicle (1), direct electrical connections (not shown) that have been made between the Trigger and the Computer-Controller (350) will instigate computer control means for electric motive power provided to the Power Input Supply Device (300) installed in Bowser (2) to be transferred to the Power Input Supply Device (400) installed in Vehicle (1), via the connected Terminals (320), (420).

Also from all the above, when an electro-mechanical Nozzle Trigger (39) (not shown) has been activated by the driver of a Vehicle (1), direct electrical connections (not shown) that have been made between the Trigger and the Computer-Controller (350) will instigate computer control means for electronic data and software data provided by the Computer-Controller (350) installed in Bowser (2) to be transferred to the Computer-Controller/Server (450) installed in Vehicle (1), via the connected Terminals (340), (440).

Again from all the above, when an electro-mechanical Nozzle Trigger (39) (not shown) is ready to be activated by the driver of a Vehicle (1), direct electrical connections (not shown) that have been made between the Trigger and the Computer-Controller (350) will instigate control means for electric motive power provided to Power Input Supply Device (400) and Computer-Controlled Server (450), respectively via the connected Terminals (320), (420) and the Terminals (340), (440) to instigate the computer-controlled operations necessary for a choosable plurality of Cell-Modules to be conveyed between the Bowser (2) and the Vehicle (1) in a manner that parallels, mimics or improves upon the manner by which fossil fuel may be conveyed between a conventional fossil fuel and a conventional fossil fuel powered vehicle.

When Nozzle Trigger (39) (not shown) has been activated and Cell-Modules are being sequentially conveyed by the Computer-Controller (400), Cell-Module Interrogation Sensors (S16), (S17) and (S18), that are installed within the Portal Casing, read individual Identity Devices provided on each Cell-Module as it passes the Interrogation Sensors, for the Interrogation Sensors to sequentially transmit precise data about each individual Cell-Module to the Computer-Controller (350) and the Computer-Controller/Server (450), for every Cell-Module that passes through the Portal (4).

In FIG. 7, the Cell-Module dispensing Nozzle (3) is again disclosed in detail, about to be fully inserted and secured within the Nozzle Insertion-Portal (4).

A single convoluted schematic line has been placed between the Nozzle and the Portal, for the lower side of the line to represent the generally male convolutions of the Nozzle's Front-Face (34) and the upper side of the line to represent the generally female or cavity convolutions of the Portal's Front-Face (44).

This single convoluted line thus discloses in a succinct manner the matingly co-operative convolutions of the two Faces (34) and (44), as detailed in FIGS. 5 and 6.

The drawing shows the Nozzle's Trigger (39) in its non-activated position.

It is important to note that, unlike most fossil fuel nozzle triggers, the Nozzle-Trigger (39) of the invention cannot be activated, because the Nozzle (3) has not yet been inserted and secured within the Portal (4) of the Vehicle (1).

This feature provides safety improvements over prior art.

Because Trigger (39) cannot yet be activated, the Thermal-Safety-Exit-Door (161) of Thermal Safety Chamber (16) and the Safety-Entrance-Door (151) of Main-Chamber (15) are both shown in their closed Safety positions.

And because there has yet to be any direct computer-controlled communication between the Nozzle (3) of the Stationary Part and the Portal (4) of the Movable Part, no Charged Cell-Modules or Depleted Cell-Modules are shown within this detailed portion of the System (200).

The drawing shows a portion of the Thermal Safety Chamber (16) and a portion of the Main-Chamber (15), as shown in full in previous drawings.

A Faulty Cell-Module (FCM), denoted by a heavy, solid-lined square, is shown installed within a Receiving-Bay of the Thermal Safety Chamber (16), having previously been assigned to that position by the Vehicle's on board Computer-Controller (350) and Conveyor (C20), (not shown).

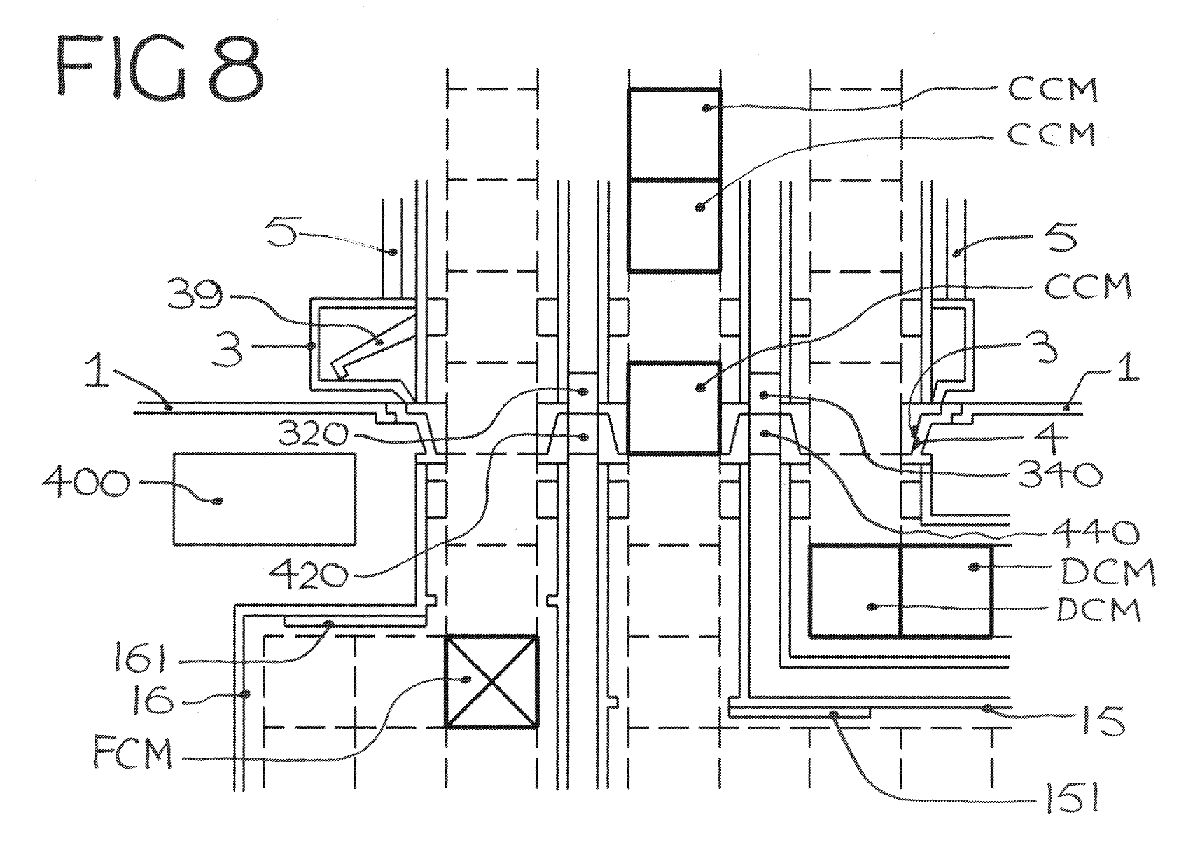

The FIG. 8 drawing represents a short moment in time after the FIG. 7 drawing, showing the Cell-Module dispensing Nozzle (3) now fully inserted and secured within the Nozzle Insertion-Portal (4).

In this drawing, Charged Cell-Modules (CCM) and Depleted Cell-Modules (DCM) are each denoted by a heavy solid-lined square sitting within a Square (S).

Although each Cell-Module is schematically identical in the drawing, its state of charge or state of wellbeing is specifically denoted.

Thus, a New Cell-Module or freshly Charged Cell-Module is denoted by the moniker (CCM), a Depleted Cell-Module is denoted by the moniker (DCM) and a Faulty Cell-Module is denoted by the moniker (FCM).

An additional safety feature of the invention is now disclosed for the Nozzle-Trigger (39) for all Embodiments of the invention.

As soon as the Nozzle (3) has been inserted and secured within the Portal (4), the Electric-Terminal-Blocks (320) and (420) become electrically connected to each other, for the Bowser to communicate directly with the Vehicle.

Similarly, the Electric-Terminal-Blocks (340) and (440) are also electrically connected to each other, for the Bowser to also communicate directly with the Vehicle.

Only after this direct communication between the Bowser and the Vehicle has taken place, can certain computer-controlled functions be operated.

In the drawing, the Thermal-Safety-Door (161) and the Main-Chamber's Entrance-Door (151) have now been opened by the computer-controlled System (200).

The Computer-Controllers have recognised that a Faulty Cell-Module has been detected within the Vehicle and the Bowser has responded by delivering a fully Charged Cell-Module (CCM) to the Bowser side of the Nozzle (3), ready to replace it.

Synchronously, the Vehicle has determined that two Depleted Cell-Modules (DCM) need replacing, and the drawing shows that they have been removed from the Main-Chamber, ready to be removed from the Vehicle.

Also synchronously, the computerised communications between the Vehicle and the Bowser have provided for the conveyance of two more fully Charged Cell-Modules (CCM) towards the Nozzle (3), for replacing the two Depleted Cell-Modules.

The drawing thus shows six Cell-Modules about to be conveyed, for a preferred embodiment of a System (200), where the driver of Vehicle (1) will only be billed for receiving two Charged Cell-Modules (CCM), when the System clearly shows that his Vehicle is about to have three Charged Cell-Modules delivered.

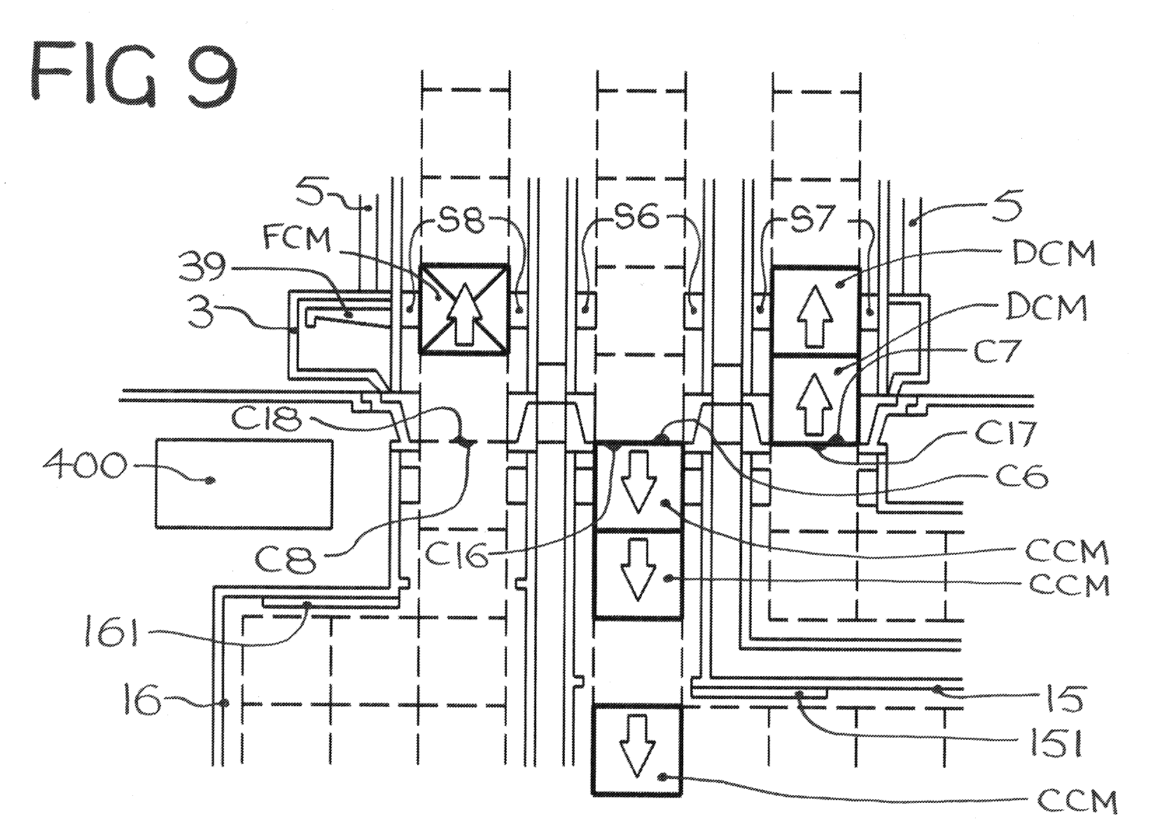

FIG. 9 discloses a slightly later time period than the drawing shown in FIG. 8; immediately after the driver of Vehicle (1) has activated Nozzle-Trigger (39).

In this drawing, the six Cell-Modules shown in the previous drawing have each been conveyed a distance of four Squares (S) in the direction shown by each of the six Arrows, by activation of the Trigger.

The System gives priority to the removal of Faulty Cell-Module (FCM) from the Vehicle (1).

Faulty Cell-Module (FCM) is shown, having been conveyed out of Thermal-Safety-Chamber (16) by Conveyor (C18) for being directly transferred onto Conveyor (C8), installed within the casing of Nozzle (3) and the Flexible-Pipe (5), where it is shown being interrogated by Interrogation-Sensors (S8).

The two adjacent Depleted Cell-Modules (DCM) are shown, having been conveyed out of Vehicle (1) by Conveyor (C17) for being directly transferred onto Conveyor (C7), also installed within the casing of Nozzle (3) and the Flexible-Pipe (5), where they are shown being sequentially interrogated by Interrogation-Sensors (S7).

The three fully Charged Cell-Modules (CCM) are shown, having been conveyed away from Bowser (2) by Conveyor (C6), for being directly transferred onto Conveyor (C17), installed within the casing of Portal (4), where they are shown within Vehicle (1) being sequentially interrogated by Interrogation Sensors (S16).

The single Square gap that exists between the first and second Charged Cell-Module, as shown in the FIG. 08 and FIG. 09 drawings, has been logged by the Interrogation Sensors (S6) within Nozzle (3) and computer confirmed by Interrogation Sensors (S16) within Vehicle (1), for transfer of that data to the sequential metering and billing software installed in computer-Controller (350), for ensuring the accuracy of actual numbers of metered Charged Cell-Modules being transferred between the Bowser (2) and the Vehicle (1).

In a preferred embodiment of the invention, where a single small volume Cell-Module is paralleled with a small volume of fossil fuel, as the smallest measurable ‘metered-for-payment’ unit, a Faulty Cell-Module may be as important to the denigration of the good name of a Cell-Module provider, just as a small volume of contaminated fossil fuel is considered important to denigrating the good name of a fossil fuel provider.

For this very reason, when a Faulty Cell-Module has been removed from a Vehicle (1) by the System, that Faulty Cell-Module would preferably be replaced, gratis, by a Fully Charged Cell-Module.

Therefore, for the computer controlled conveyance example, as disclosed for this drawing, the driver of Vehicle (1) would preferably be billed only for the unit metered cost of dispensing two Charged Cell-Modules (CCM) to Vehicle (1) during that precise transaction.

In an alternative provision to the preferred embodiment, as stated directly above, where the driver of the Vehicle is provided with a choice as to the total number of Cell-Modules he wishes to have installed within the Chamber (15) of his Vehicle, the driver may prefer to have a third Charged Cell-Module (CCM) automatedly installed, so that the number of chosen Cell-Modules installed within his Vehicle has not been diminished by one.

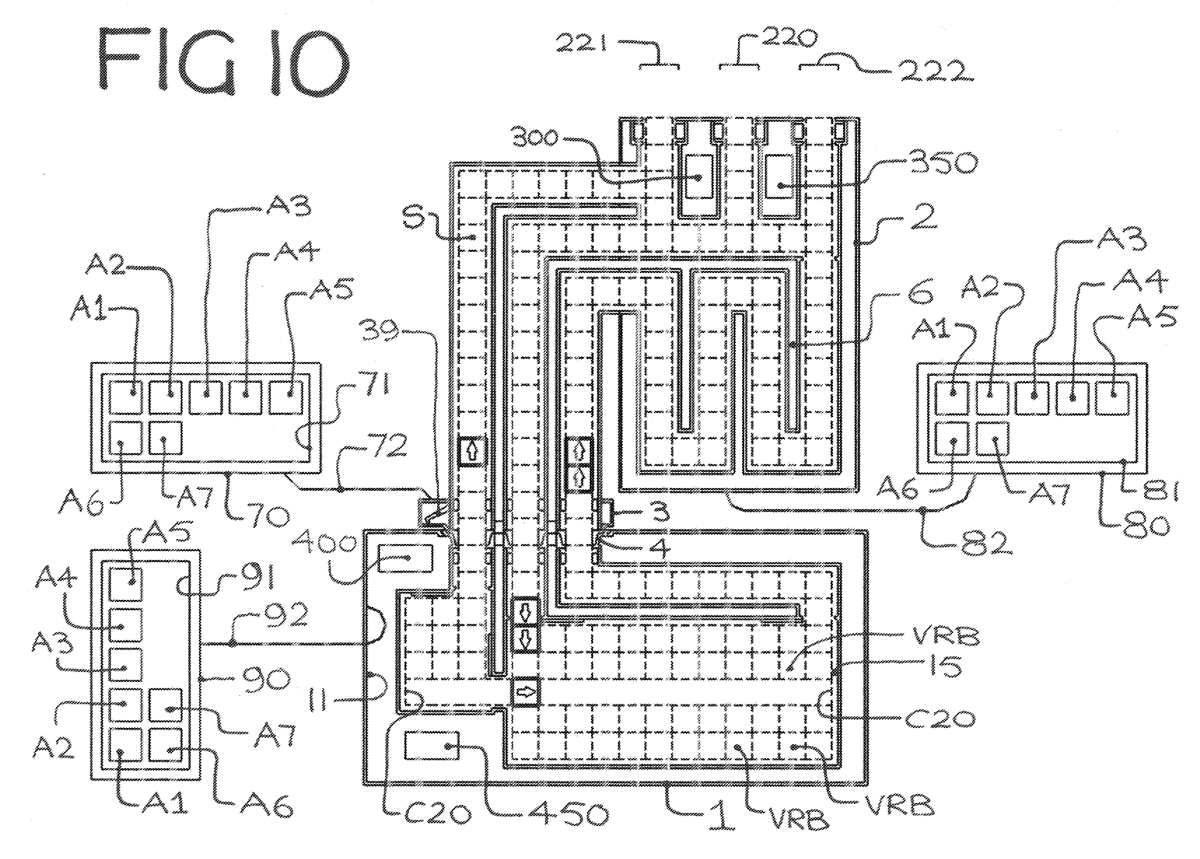

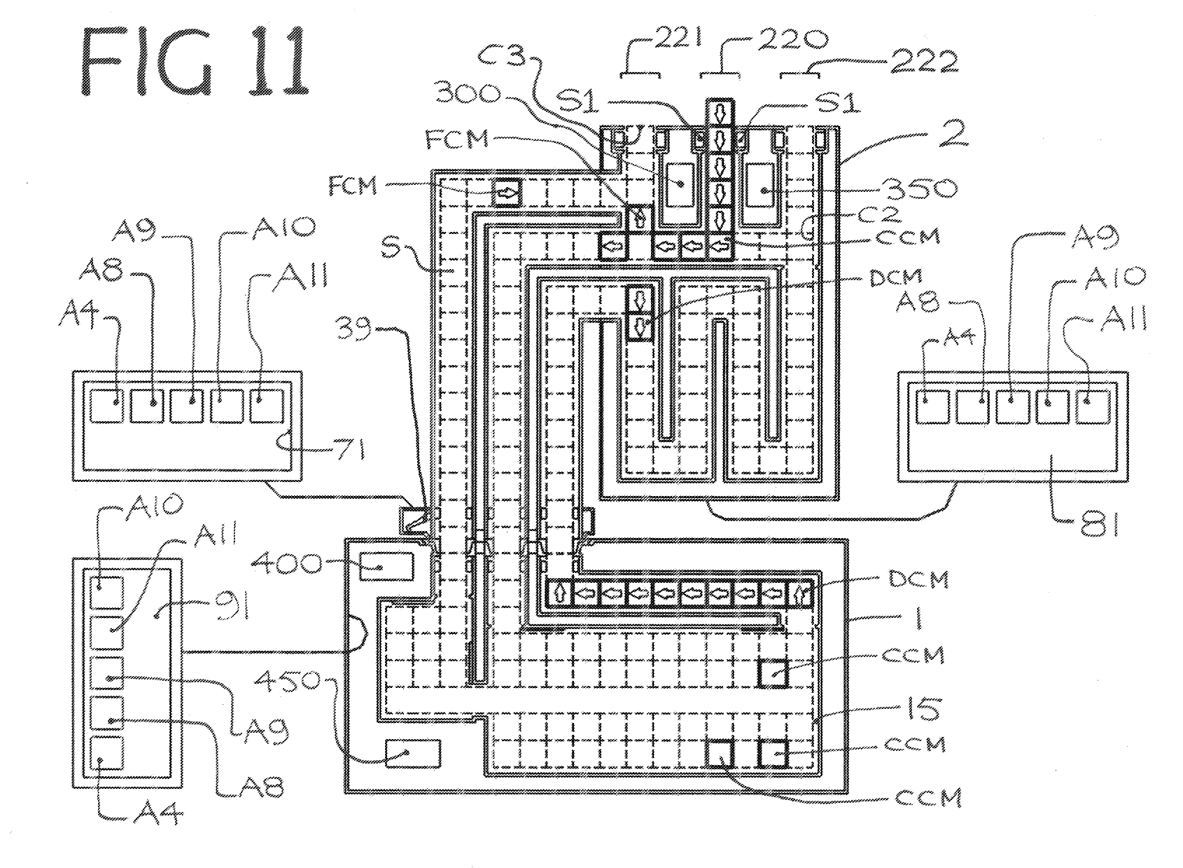

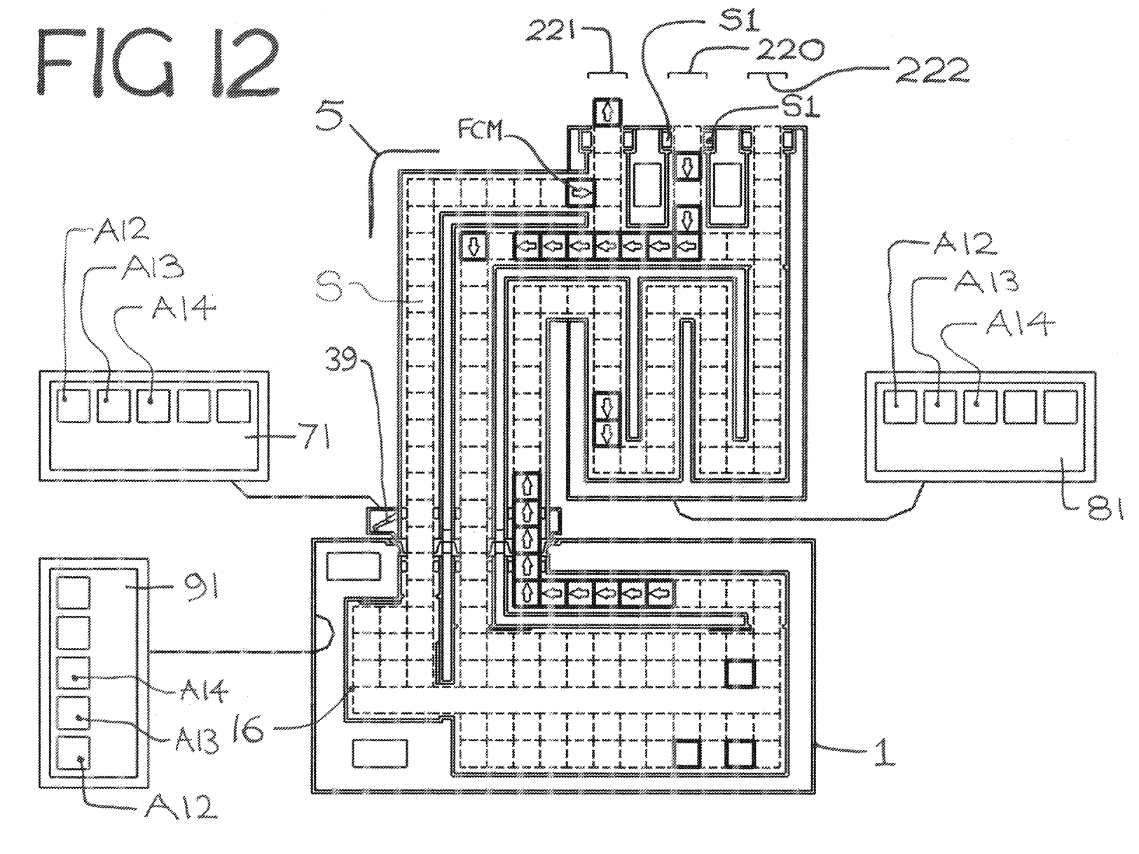

FIG. 10 discloses small modifications to the Bowser's Conveyors and Conveyor paths, near the System Entrance-Gate (220) and the System Exit-Gate (221), for providing alternative Conveyor Flow Paths to those shown in previous Bowser drawings for the First Embodiments, for reasons that will be clarified for FIGS. 11 and 12.

This drawing relates to a precise moment in time that is a slightly later time period than shown for the FIG. 9 drawing; immediately after the driver of Vehicle (1) has chosen to release Nozzle-Trigger (39).

Even though the Trigger is shown to have been released by the driver, and therefore no more Cell-Modules are being extracted from, or inserted into the Vehicle (1), the Computer-Controllers (350) and (450) are still tasked with co-ordinating the continued physical conveyance of all Cell-Modules that have already been transferred between the Stationary Part (A) and the Movable Part (B), by the previous Trigger activation.

By comparing the present drawing with the FIG. 9 drawing, it should be apparent that each of the six Cell-Modules that were shown being transferred in the FIG. 09 drawing have each moved position by exactly two more Squares (S), and are still moving, as shown by the Flow-Direction-Arrows placed within each Cell-Module.

From this drawing and previous drawings and previous separated short time periods, it has been disclosed that only three fully Charged Cell-Modules (CCM) were dispensed to Vehicle (1) by the Nozzle (3) before the driver released the Nozzle-Trigger (39).

From that information, it should be apparent that insufficient motive-power replenishment had taken place.

In such a circumstance, it would be commercially irresponsible and possibly legally irresponsible for the System's computer-controlled sequential Through-Flow procedures to release the Nozzle (3) from the Vehicle's Portal (4), even though the Trigger (39) has been released, without first alerting the driver of such insufficient motive-power replenishment.

In order to provide such essential and responsible alerting, a Bowser (2) of the Stationary Part (A) is also provided with a User-Friendly Interface (70) and/or a User-Friendly Interface (80), for e.g. the driver and the System to be able to properly communicate.

In a preferred example of a User-Friendly Interface (70), the Interface is physically represented as a Visual, Audio-Visual or Touch-Audio-Visual Display-Screen (71) that is permanently attached the upper outer casing of Nozzle (3), as shown by the schematic attachment line (72), such that it is readily able to be seen, read, heard or touched by the driver, when using the Nozzle.

In a preferred example of a User-Friendly Interface (80), the Interface is physically represented as a Visual, Audio-Visual or Touch-Audio-Visual Display-Screen (81) that is permanently attached the outer part of the Casing of Bowser (2) that is preferably nearest the adjacently parked Vehicle (1), as shown by the schematic attachment line (82), such that it is also readily able to be seen, read, heard or physically accessed by the driver.

To additionally provide such essential alerting, a Vehicle (1) of the Movable Part (B) is also provided with a User-Friendly Interface (90), for the driver and the System to be able to properly communicate.

In a preferred example of a User-Friendly Interface (90), the Interface is physically represented as a Visual, Audio-Visual or Touch-Audio-Visual Display-Screen (91) that is permanently attached an internal portion of the Vehicle (1), such as the dashboard (11), such that it is also readily able to be seen, read, heard or physically accessed by the driver, prior to, during or after connection of the Vehicle's Portal (4) to a Nozzle (3).

Referring again to the precise moment in time after the driver of Vehicle (1) chose to release Nozzle-Trigger (39), his actions have activated Computer-Controller (350) to issue a pre-programmed First Alert (A1) to Display-Screen (71) and/or to Display-Screen (81) and/or Display-Screen (91).

First Alert (A1) advises the driver that the amount of replenished fuel dispensed is insufficient for travelling any reasonable extra distance.

A Second Alert (A2) may advise the driver that the three Charged Cell-Modules will allow him to travel only a certain distance (D); that has previously been calculated by the Computer-Controller (350) by interrogation of the Vehicle's Computer-Controller (450) when the Nozzle (3) was first secured to Portal (4).

The Second Alert (A2) will preferably take account of; the known type of Vehicle (1) that the Computer-Controllers (350) and (450) have communicated with each other and; the type of terrain that the Vehicle (1) can expect to encounter for the stored Cell-Module energy assumed to be remaining in the Vehicle's Main-Chamber (15), including the three Charged Cell-Modules about to be inserted therein.

The Third Alert (A3) is a request for the driver to decide whether he wishes to install more Charged Cell-Modules into his Vehicle.

The Fourth Alert (A4) provides the driver with a simple ‘YES/NO’ option on the Display-Screen.

For this drawing, the driver has chosen the ‘NO’ option.

The Computer-Controller (350) then processes the metered unit transactions.

The Computer-Controller then issues a Fifth Alert (A5), advising the driver of the cost of his visit to the Service Station.

Synchronous with all the time-based events after the driver has chosen the ‘NO’ option, Computer-Controllers (350) and (450) are additionally tasked with ensuring that the three Charged Cell-Modules that are now within Chamber (15) are conveyed to three Vacant Receiving Bays (VRB) and installed therein, by use of externally power provided by the Bowser's Constant Power-Distribution Device (400) to the Conveyor (C20) and the Robotic-Arm (RA20), (not shown) via the Nozzle to the Vehicle's Portal.

Computer-Controllers (350) and (450) are also tasked with ensuring that the two Thermal Safety Doors (161) and (162) installed in the Vehicle's Thermal Safety Chamber (16) (shown open in the drawing) will then be secured in their closed positions, as soon as those sequential tasks are completed.

Computer-Controllers (350) and (450) are further tasked with ensuring that the two Safety Doors (151) and (152) installed in the Vehicle's Main-Chamber (15) will also be secured in their closed positions, as soon as those sequential tasks are completed.

A Sixth Alert (A6) then advises the driver that he may now remove the Nozzle from his Vehicle.

A Seventh Alert (A7) may be a ‘Thank You For Your Custom’ Display-Screen while the Computer-Controller (350) processes the remaining actions for completing the entire Computer-Controlled electro-mechanical processes of use of the System (200) by the Vehicle (1).

FIG. 11 discloses the same information for FIG. 10, up to the moment before the driver responds to the third Alert (A3) that provided a simple ‘YES/NO’ on the Display-Screen (71) and/or the Display-Screen (81).

For this drawing, the driver has chosen the ‘YES’ option, for the drawing to show a small time sequence for each Cell-Module in the FIG. 10 drawing to have been conveyed twelve or more squares (S) within the System.

Because the driver has chosen the ‘YES’ option, the programs for Display Screens (71), (81) and (91) immediately bypass Alerts (A5) to (A7), that were only relevant for a ‘NO’ option and immediately issues an Eighth Alert (A8) to the Display-Screens.

Alert (A8) may ask the driver e.g. how many miles (or kilometers) he wishes to travel before his next ‘fill-up’.

A sequential Alert (A9) preferably then provides a Touch-Screen Options Grid that provides a plurality of distance options to the driver.

For this exampled disclosure, the driver has chosen 50 miles.

After the Computer-Controller (350) has cross-referenced the Vehicle's Computer-Controller (450) to ascertain both the physical number and the charge condition of each Cell-Module installed within the Vehicle's Main-Chamber (15), a Tenth Alert (A10) is sent to the Display-Screen(s).

Alert (A10) advises the driver that he needs to install e.g. ten more freshly Charged Cell-Modules (CCM), to ensure an extra distance of 50 miles before needing to refuel again.

A Sequential Alert (A11) may then offer a ‘OK’ button for the driver to accept.

On pressing ‘OK’, the Nozzle-Trigger (39) may optionally be driver activated or Computer-Control activated, depending on the extent of additional information that may be provided within Alert (A11).

The Nozzle-Trigger (39) is therefore shown in its non-active state, that may be over-ridden without human action, for automated activation by the Computer-Controllers (350) and (450).

At this juncture it is important to note that in FIG. 8 to FIG. 10, only six Cell-Modules were shown populating the enclosed System (200), for the sole purpose of defining the sequential movements of that precise number of Faulty, Depleted and Charged Cell-Modules entering and exiting a Vehicle (1) via a Nozzle (3).

The Conveyors of a practical Enclosed System (200) will be continuously populated by large numbers of Cell-Modules in their various states of charge and wellbeing and also their complexly different placement positions or transit route positions within an Enclosed System (200).

It should therefore be understood that the schematic disclosures for the FIG. 11 drawing only provide ten extra Charged Cell-Modules that the driver has requested, to clearly disclose this next sequential example.

In the FIG. 11 drawing, the three Charged Cell-Modules (CCM) that are now shown installed in the three Receiving-Bays that were previously disclosed as Vacant Receiving-Bays (VRB) in the FIG. 10 drawing.

Because the driver has chosen a ‘YES’ response to the advice of Alert (A10), that he needs ten more Charged Cell-Modules to complete his chosen journey distance, and because no Depleted Cell-Modules are within the First Embodiment Charging-Bay (6), ready to be recycled as Charged Cell-Modules, the System has instigated a computer program for ten Charged Cell-Modules to be immediately delivered to Bowser (2) via the System Entrance-Gate (220).

Synchronously, ten Depleted Cell-Modules have been removed from the Vehicle's Main-Chamber (15) and have been conveyed towards Portal (4), ready to be exchanged for the ten newly delivered Charged Cell-Modules, via the System's automated Computer Controlled Means.

Referring now to the first nine of the ten Charged Cell-Modules that have entered the System (200) via System-Entrance-Gate (220), the System-Entrance Interrogation Sensors (S1) have detected a non-compliance Fault in the second Charged Cell-Module and its individual identity has been immediately computer-marked as a Faulty Cell-Module FCM).

Because the second Charged Cell-Module has already entered the System and other Charged Cell-Modules are being conveyed directly behind it, that second Cell-Module is obliged to exit the System as soon as is practical.

The Conveyors and Conveyor Channels nearest the System Exit-Gate (221) and the System Entrance-Gate (220) have been modified for that second Cell-Module (FCM) to be removed from Conveyor (C2) and diverted onto Conveyor (C3) for immediate exit from the System via System Exit-Gate (221).

The Computer-Controller (350) has immediately ordered an eleventh Charged Cell-Module, for replacing the second Charged Cell-Module; to be readied for entering the System, as will be disclosed and provided in the FIG. 12 drawing.

FIG. 12 discloses a very short time period after the disclosures for the FIG. 11 drawing.

In this drawing each Cell-Module has been conveyed exactly four Squares (S), compared to the previous drawing.

At the top of the drawing, the second Charged Cell-Module that the System-Entrance Interrogation Sensors (S1) had flagged as non-compliant, or faulty, has now exited the System via System-Exit-Gate (221).

Also at the top of the drawing, the Faulty Cell-Module (FCM) that had previously been removed from the Thermal-Safety-Chamber (16) of Vehicle (1) is shown nearing the System-Exit-Gate (221), for removal from the Enclosed System.

The eleventh Charged Cell-Module, previously ordered by the Computer-Controller (350), for replacing the non-compliant second Charged Cell-Module, is now shown within the System, having successfully passed the interrogation protocols of System-Entrance Interrogation Sensors (S1).

The drawing therefore shows ten Charged Cell Modules within the Bowser (2) and the Flexible-Pipe (5) being conveyed towards the Vehicle (1), precisely as requested by the Vehicle's driver.

While the ten Charged Cell-Modules are being transferred from the Bowser to the Vehicle and the ten Depleted Cell-Modules are being transferred from the Vehicle to the Bowser, the Computer-Controller issues a Twelfth Alert (A12), similar to the Fifth Alert (A5), advising the driver of the cost of his visit to the Service Station.

As soon as the twenty Cell-Modules have been transferred, a Thirteenth Alert is issued which may be a ‘Thank you for your custom’ greeting.

And as soon as the Computer-Controllers (350) and (450) have completed their pre-programmed procedures, a Fourteenth and Final Alert (A14) is displayed, advising the driver that he may now disengage the Nozzle (3) from the Portal (4).

The disclosures thus far define several means by which the driver of a specially manufactured Cell-Module powered electric Vehicle (1) may obtain choosable amounts of through-flow motive power replenishment, by the use of a specially manufactured metered dispensing Bowser, in either a constant or an interrupted manner than parallels, mimics and also improves upon the manner by which a fossil fuel vehicle may also obtain choosable through-flow amounts of fossil fuel, by constant or interrupted metered dispensing bowser means.

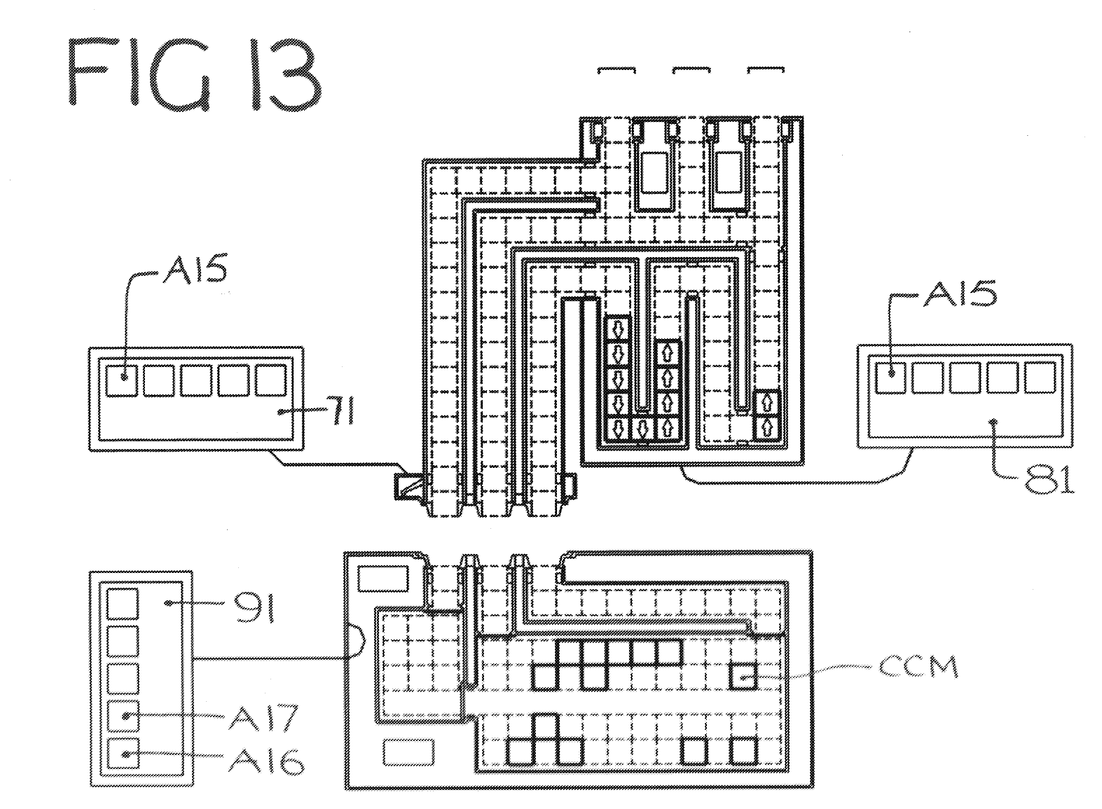

FIG. 13 discloses a short time period after the disclosures for the FIG. 12 drawing, immediately after the driver has removed the Nozzle (3) from the Portal (4) of his Vehicle.

Before disengagement of the Nozzle from the Portal, all ten Charged Cell-Modules will have been conveyed from the Bowser into the Vehicle, for the Conveyor (C20) to have then installed them all in Vacant Cell-Module Receiving-Bays within the Main-Chamber (15) of the Vehicle, as shown in the drawing.

Synchronously, all ten Depleted Cell-Modules will have been conveyed away from all parts of the Vehicle (1), for the Bowser to maintain processing the Depleted Cell-Modules through a Charging Bay (6), after the disengaged Vehicle has left the Service Station.

Immediately after disengagement of the Nozzle from the Portal, there may be a need for the Display-Screens (71) and (81) attached the Bowser to provide entirely different information to that provided for the Display-Screen (91) within the Vehicle.

As specific examples, e.g. where the Bowser is processing a large number of Depleted Cell-Modules through its through-flow System, a Fifteenth Alert (A15) may be displayed, advising the next driver of another Vehicle (1) that has parked adjacent the same Bowser that the System is re-setting, ready to service his needs.

Inside the Vehicle, the driver of the first Vehicle (1) may be provided with a Sixteenth Alert (A16) that reminds him he has only received sufficient through flows of motive power for a 50-mile journey.

A Seventeenth Alert (A17) may ask him if he would like to be reminded (say) every ten miles, of his need to replenish at the next Cell-Module Service Station.

By referencing all the First Embodiments disclosed thus far for a Main-Chamber (15) having 48 Cell-Module Receiving-Bays with a Tesla Roadster electric sports car (as referred to in the Background of the Invention) having nearly 9,000 small volume Lithium-Ion cells installed in its main chamber, each schematic Cell-Module shown in the drawing would represent 200 actual cells used in the Tesla's cell chamber.

And by approximating the 13 Charged Cell-Modules (CCM) now shown installed in the Main-Chamber (15), this number represents a schematic Main-Chamber for a Vehicle (1) that is just over one-quarter ‘full’.

And since the Tesla claims 200 miles of travel on a ‘full tank’ of small-volume cells, the equating of ten additional Cell-Modules requested by the driver of Vehicle (1) to add to the 3 previously installed Cell-Modules, for a 50-mile travel requirement, is schematically accurate in comparative numerical terms.

The FIG. 14 drawing discloses further visualizations and descriptions for the First Embodiment of the invention.

Vehicle (1) is shown, in schematic plan view, as a West facing small passenger car, parked adjacent the casing of a Cell-Module Dispensing Bowser (2), shown as a rectangle.

For the previous drawings, schematic Cell-Modules (100) of identical square form were shown being sequentially conveyed within the cyclical System (200).

In this drawing, schematic Cell-Modules (100) of identical cylindrical form are disclosed within the cyclical System (200).

Small volume rechargeable cylindrical cells of the lithium-ion type are gaining increasing popularity over large conventional lead-acid batteries and nickel-cadmium batteries as the preferred motive power source for a battery powered electric vehicle (BEV), as previously described.

For a clearer visual understanding of cylindrical Cell-Modules (100) being individually conveyed, to and from a Vehicle (1) and a Bowser (2), each Cell-Module is deliberately disclosed in the drawing oversized, by a uniform linear multiplication of three, when compared to the linear dimensions of the preferred sized cylindrical cells.

As such, each conveyed oversized schematic Cell-Module shown in the drawing approximates twenty-five preferred sized small-volume Cell-Modules that would be sequentially conveyed within practical apparatus for use with the First Embodiments of the invention.

For clearer initial visual definitions only, the three enclosed Conveyors (C6), (C7) and (C8) are therefore also shown three-times oversized.

These Conveyors are also shown as direct flow-paths through the side of Vehicle (1) and the front of the Bowser (2) without the connection provisions of a Nozzle (3) or a Portal (4), as already disclosed for the previous drawings.

Enclosed Conveyor (C6) is shown sequentially conveying Charged Cell-Modules (CCM) directly from the Bowser to the Vehicle, as shown by the Arrow direction provided on the top of the Bowser casing.

Enclosed Conveyor (C7) is shown sequentially conveying Depleted Cell-Modules (DCM) directly from the Vehicle to the Bowser, as also shown by the Arrow direction provided on the top of the Bowser casing.

Enclosed Conveyor (C8) is shown sequentially conveying Faulty Cell-Modules (FCM) directly from the Vehicle to the Bowser, as again shown by the Arrow direction provided on the top of the Bowser casing.

From the drawing it can be seen that the cylindrical Charged Cell-Modules (CCM) are being sequentially conveyed in a side-by-side manner, where each Cell-Module's Longitudinal Axis (not shown) is set in an East-West horizontal orientation.

From the drawing it can be seen that the cylindrical Depleted Cell-Modules (DCM) are also being sequentially conveyed in a side-by-side manner, where each Cell-Module's Longitudinal Axis (not shown) is set in an Up-Down vertical orientation.

Also from the drawing it can be seen that the cylindrical Faulty Cell-Modules (FCM) are being sequentially conveyed in an end-to-end manner, where each Cell-Module's Longitudinal Axis (not shown) is set in a North-South horizontal orientation.

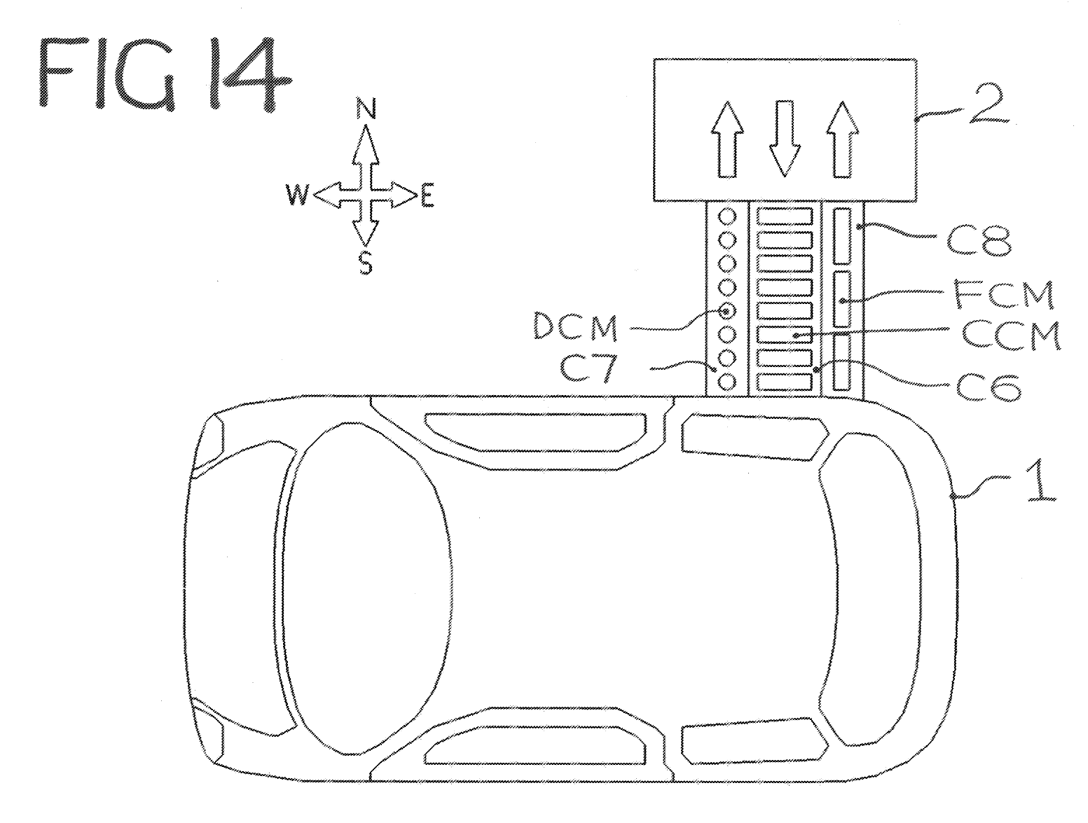

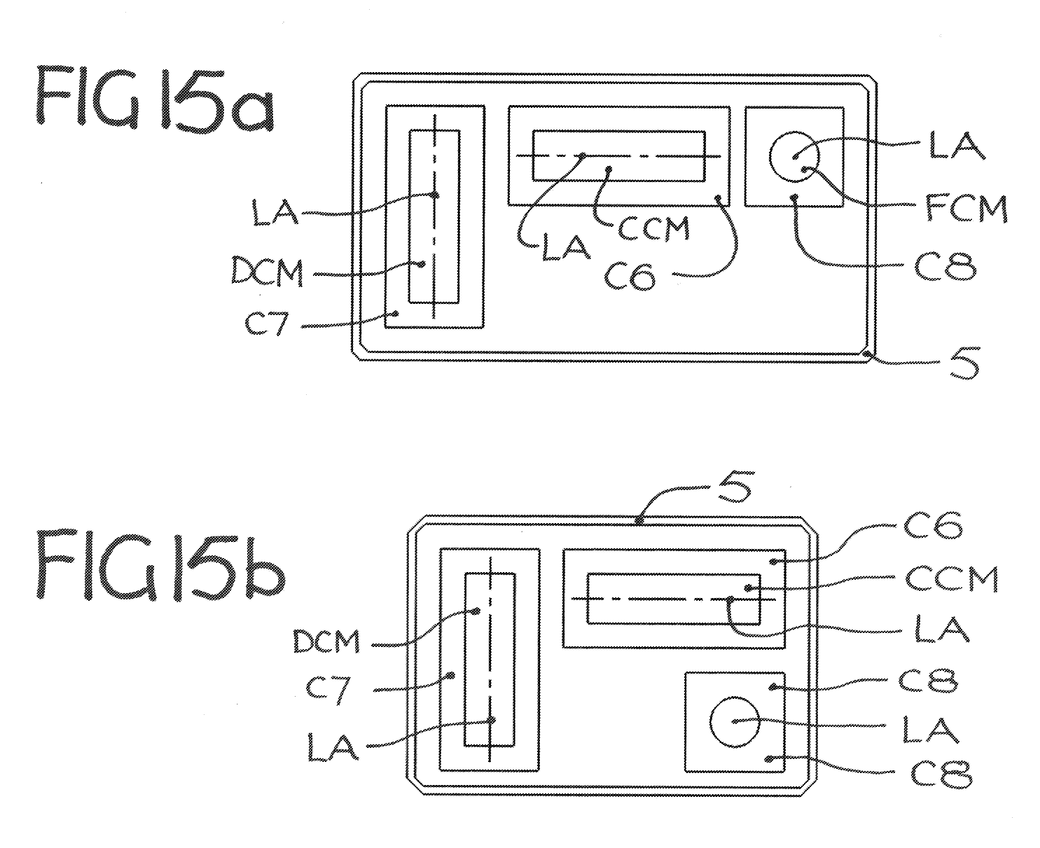

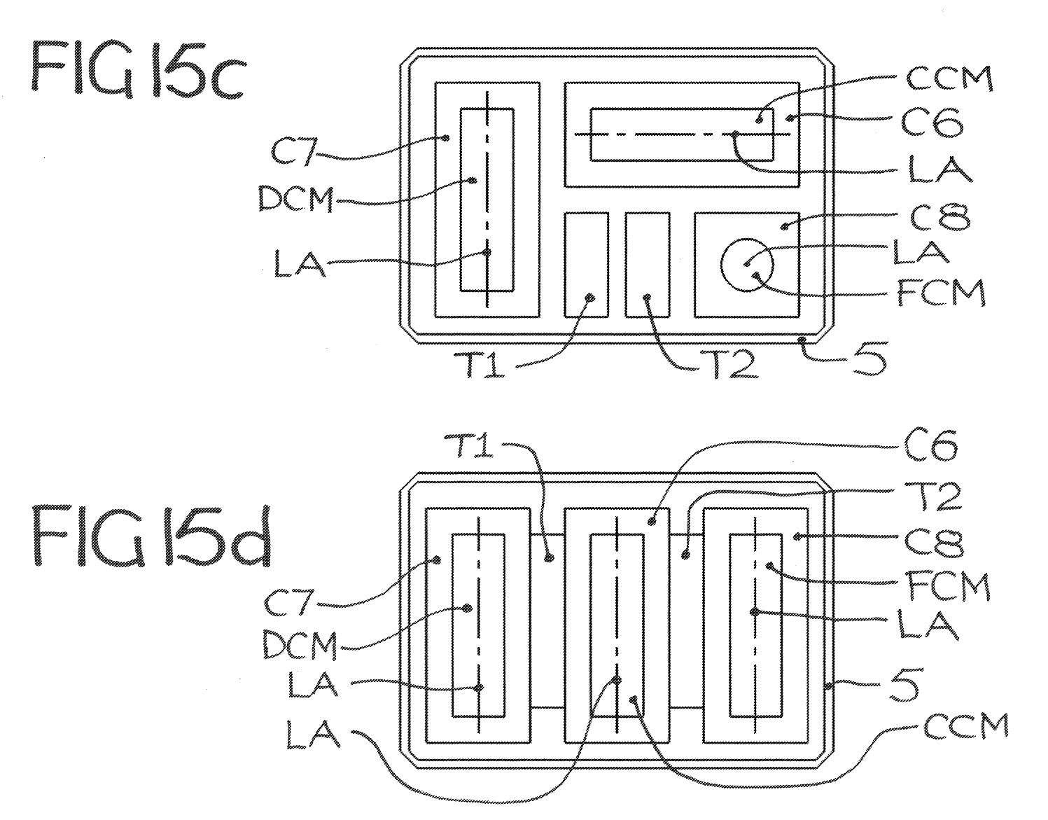

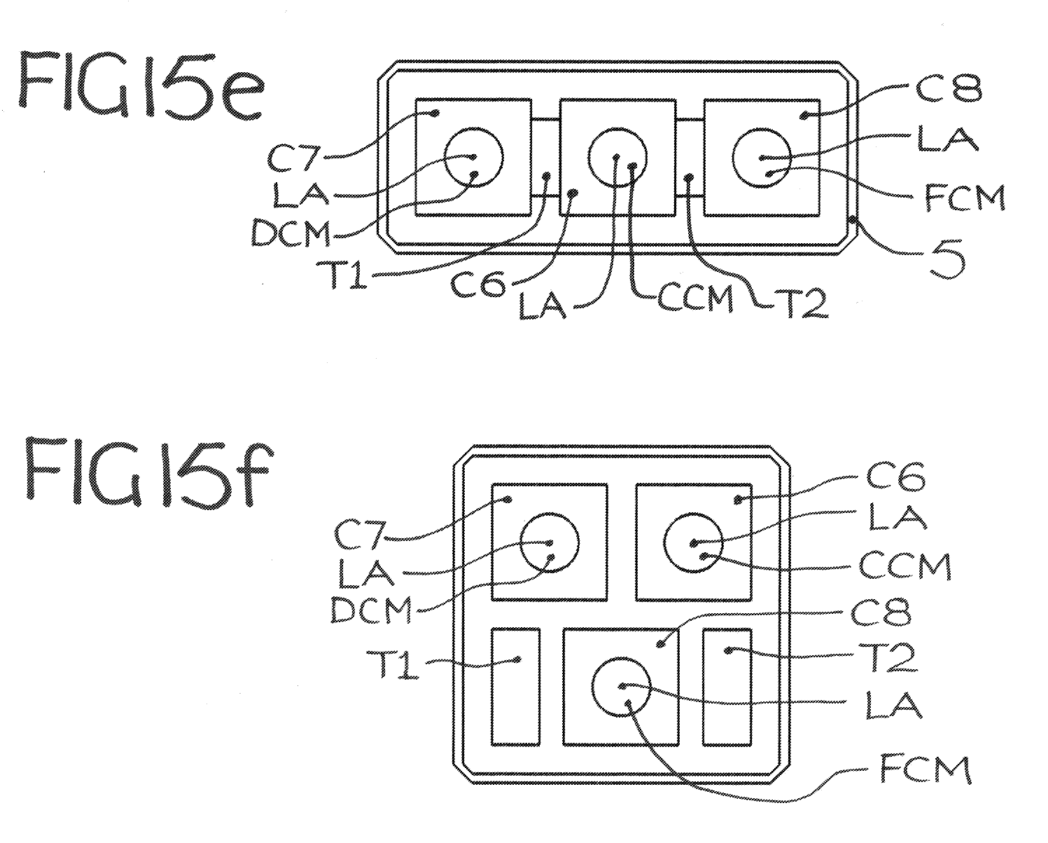

The FIG. 15 drawings are different schematic cross-sections through the Conveyors (C6), (C7) and (C8) that have been shown in introductory terms in FIG. 13.

FIG. 15(a) is a more detailed cross-section of the three Conveyors, (C6), (C7) and (C8), as they are positioned with respect to each other in the FIG. 13 drawing.

The Enclosed Conveyor (C7) shows a Depleted Cell-Module (DCM) disposed within, having a vertical Longitudinal Axis (LA) aligned in an Up-Down direction.

The Enclosed Conveyor (C6) shows a Charged Cell-Module (CCM) disposed within, having a horizontal Longitudinal Axis (LA) aligned in an East-West direction.

The Enclosed Conveyor (C8) shows a Faulty Cell-Module (FCM) disposed within, having a horizontal Longitudinal Axis (LA) aligned in a North-South direction.

FIG. 15(b) shows different positional arrangements of the three Conveyors, (C6), (C7) and (C8), to those shown in FIG. 14(a), showing the Conveyor ((C8) now below the Conveyor (C6) to provide a more regular cross-sectional shape.

A Hollow-Pipe (5), is also shown, for containment of the three Enclosed Conveyors within the Pipe's hollow portions.

FIG. 15(c) shows the same positional arrangements of the three Conveyors, (C6), (C7) and (C8), to those shown in FIG. 14(b).

Two additional Hollow-Tubes, (T1) and (T2) are also shown disposed within the Pipe (5), for retaining the Wiring Looms (WL1) and (WL2), (not shown), that respectively directly connect the Constant Power Supply Device (300) and the Computer Controller (350) to their respective Electric Terminal Blocks (320) and (340), provided within the Nozzle (3).

In FIG. 15(d) the cross-sectional shape of the Conveyor (C8) has been replaced with a cross-sectional shape similar and alignment to that of Conveyor (C7).

Additionally, the Conveyor (C6) has been rotated through ninety degrees, compared with the FIG. 14 (c) drawing.

As can be seen with this configuration, all the Cell-Modules, (DCM), (CCM) and (FCM) have their Longitudinal Axes (LA) all placed in an Up-Down vertical alignment.

The shape of the Hollow-Tubes, (T1) and (T2) have also been made thinner and taller to fit between the three Conveyors.

It should be apparent, without the need for a further drawing, that the Pipe (5) and its contained Devices may be rotated through ninety degrees for all Cell-Modules to have their Longitudinal Axes (LA) all placed in an East-West horizontal alignment.

In FIG. 15(e) the cross-sectional shapes of the Conveyors (C6) and (C7) have been replaced with the same cross-sectional shape and horizontal alignment to that of Conveyor (C8), as shown in FIGS. 14(a), (b) and (c).

As can be seen with this new configuration, all the Cell-Modules, (DCM), (CCM) and (FCM) now have their Longitudinal Axes (LA) all placed in a North-South horizontal alignment, with respect to the West facing Vehicle shown in FIG. 1.

The shape of the Hollow-Tubes, (T1) and (T2) have also been modified to fit between the three Conveyors.

The shape of the Hollow-Pipe (5) has also been modified to the new cross-sections and placements of the three Conveyors.

It should be apparent, without the need for a further drawing, that the Pipe (5) and its contained Devices may be rotated through ninety degrees to provide a letterbox shaped Nozzle and Portal, so that different Vehicle types having horizontal and/or vertically disposed Portals in their bodywork may all use the same Nozzle.

Further, for larger Vehicles, a double letterbox type Portal may be provided, for the sequential replenishment of (e.g.) two Main-Chambers (15), by using the same Nozzle with a first then second Portal.

In FIG. 15(f) the cross-sectional shapes of the Conveyors (C6) and (C7) also have the same cross-sectional shape and horizontal alignment to that of Conveyor (C8), as shown in FIGS. 14(a), (b) and (c).

However, in this drawing, the Conveyors (C6) and (C7) are placed side by side, equidistantly above Conveyor (C8).

The shape of the Hollow-Tubes, (T1) and (T2) have again been modified to each fit in the remaining gap either side of Conveyor (C8).

It should again be apparent, without the need for a further drawing, that the Pipe (5) and its contained Devices may be again rotated at least once through ninety degrees.

For all the FIG. 15 drawings, it should be understood that the positions and alignments of each of the Conveyors, (C6), (C7) and (C8) may be exchanged if required.

However, it should also be well understood that the chosen cross-section of Pipe (5) and the eventual chosen relationships for the Conveyors within the Pipe is a major commercial decision that is not part of the remit of the present invention.

### Second Embodiments

In the First Embodiment disclosures, means were provided for recharging Depleted Cell-Modules (DCM) within the Casing of a Cell-Module dispensing Bowser (2), prior to conveying them directly from the Bowser, as freshly Charged Cell-Modules (CCM) towards another Vehicle (1), for ‘metered-for-payment’ recycled use therein.

In a practical application of such a First Embodiment, the Bowser casing would need to be physically enormous, for containing very large numbers of recharging Cell-Modules, especially if the Bowser was being visited by a continuous number of sequential Vehicles, all needing substantial Cell-Module replenishment.

For the Second Embodiment disclosures, means are specifically not provided for recharging Depleted Cell-Modules (DCM) within the Casing of a Bowser (2).

Instead, Depleted Cell-Modules that have just been removed from an adjacently parked Vehicle (1) would be conveyed straight through the casing of a Second Embodiment Bowser (2), for then being conveyed directly to an enclosed Charging Bay (6) that is physically remote from the casing of the Bowser.

A remote Charging Bay (6) is a vital consideration for the invention to perform according to the largest number of the invention's teachings and is therefore disclosed separately as a Fourth Embodiment of the invention.

The Second Embodiment of the invention therefore discloses a remote Cell-Module Charging Bay (6) in a most simple form, only for providing an enclosed through-flow System that assists in disclosing its other important features and improvements over the First Embodiment.

In the First Embodiment of the invention, three separate Conveyors, (C6), (C7) and (C8) were employed to connect the Bowser to the Vehicle, to respectively convey Charged Cell-Modules (CCM), Depleted Cell-Modules (DCM) and Faulty Cell-Modules (FCM) in physical isolation from each other.

In the Second Embodiment of the invention, only two separate Conveyors, (C7) and (C9) are employed to connect the Bowser to the Vehicle, as will now be described in detail.

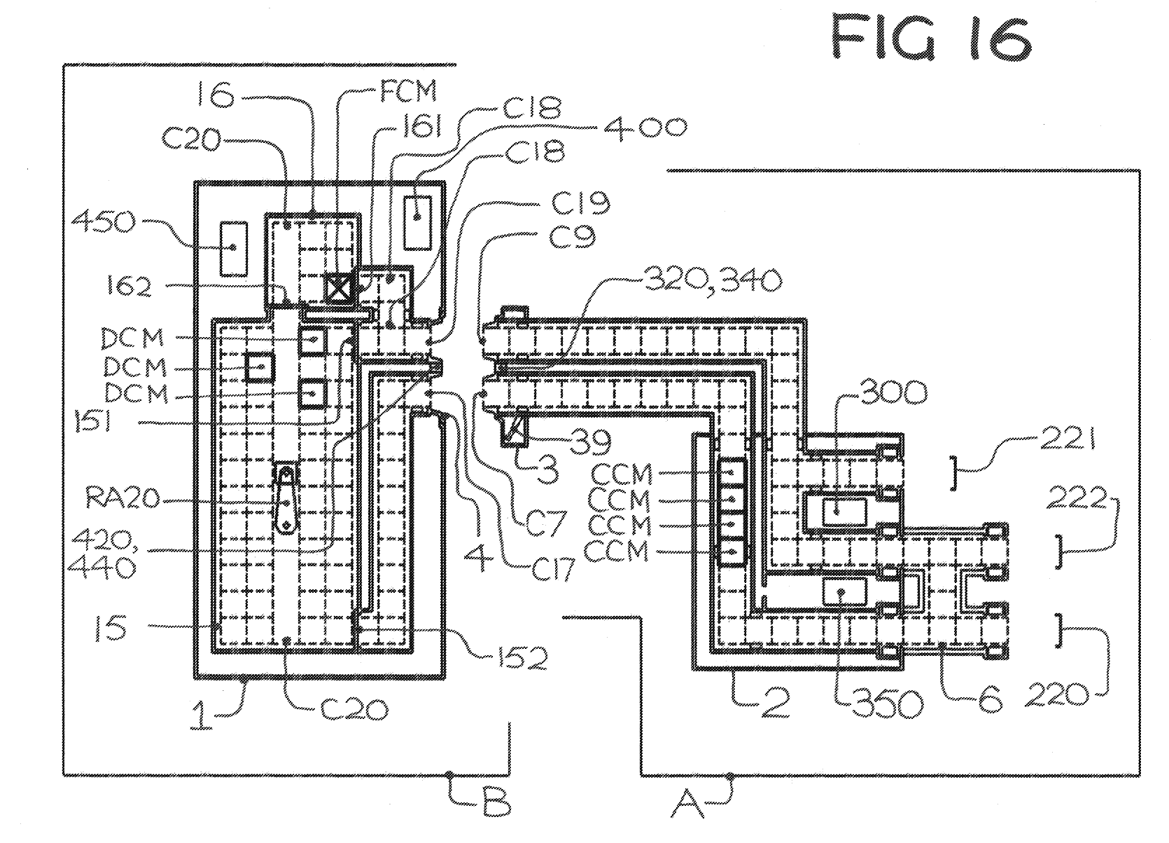

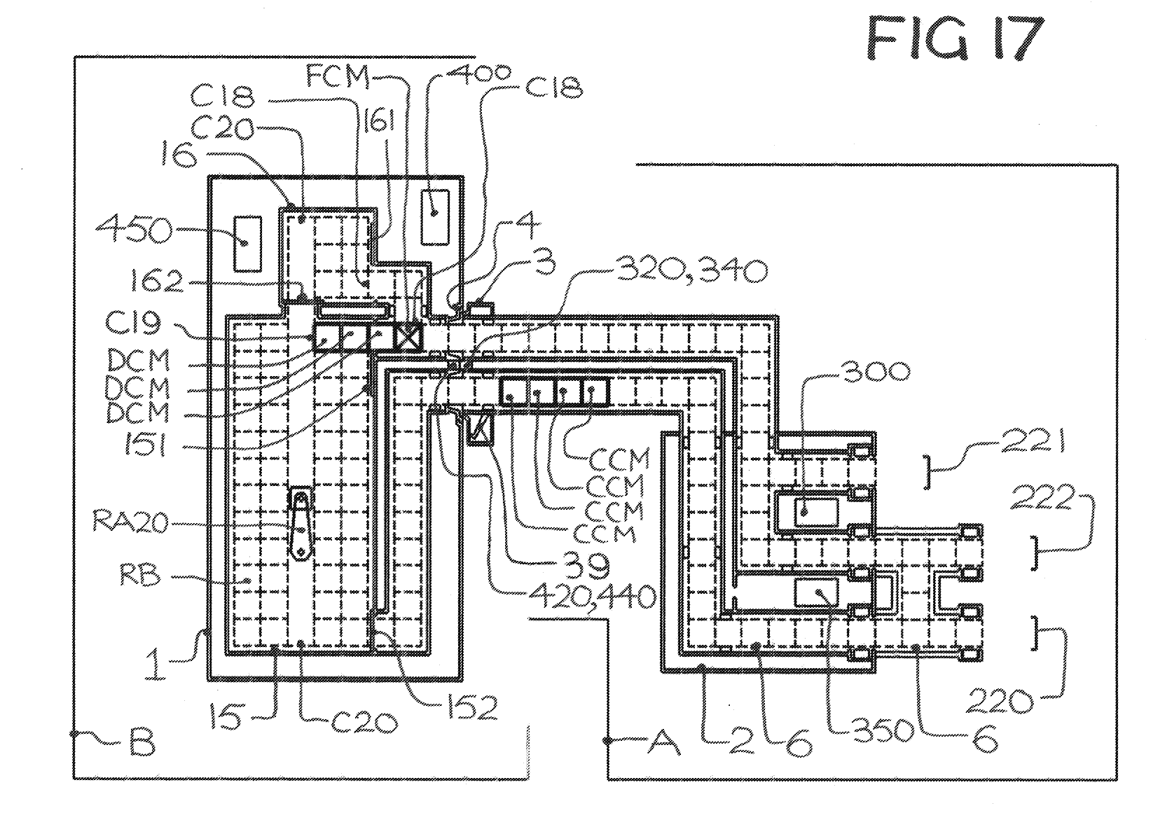

FIG. 16 is an introductory disclosure of Second Embodiments of the invention.

A portion of the Stationary Part (A) of an Enclosed System (200) is shown in separated but close proximity to a Movable Part (B) of an Enclosed System (200), for disclosing simplifications and other improvements over the First Embodiments, including economies in manufacture and usage.

A Second Embodiment Vehicle (1) is shown in schematic plan view, parked adjacent a Second Embodiment Cell-Module dispensing Bowser (2), in preparation for a Second Embodiment Nozzle (3) to be inserted in a Second Embodiment Portal (4).

The drawing shows a first economy or improvement, wherein only two separate Conveyors (C9) and (C7) are now shown within Flexible-Pipe (5).

From this disclosure, it is apparent that only two Conveyors join Bowser (2) with Nozzle (3), thereby requiring only two Conveyors (C17) and (C19) to be installed within Vehicle (1), for joining Portal (4) with the Chambers (15) and (16) installed within Vehicle (1).

Referring to the Stationary Part (A), the Conveyor (C7) conveys Charged Cell-Modules (CCM) in a single direction, away from the Bowser (2) towards the Vehicle (1) and the Conveyor (C9) conveys both Depleted Cell-Modules (DCM) and Faulty Cell-Modules (FCM) in a single direction, away from the Vehicle (1) towards the Bowser (2).

For the Movable Part (B), the Conveyor (C17) conveys Charged Cell-Modules (CCM) in a single direction, away from the Portal (4) towards Main Chamber (15) and the Conveyor (C19) conveys both Depleted Cell-Modules (DCM) and Faulty Cell-Modules (FCM) in a single direction, respectively away from the Main Chamber (15) and/or the Thermal Safety Chamber (16) towards the Portal (4).

Such a provision, for conveying Depleted Cell-Modules (DCM) and Faulty Cell-Modules (FCM) within the same Conveyor (C19) has precise economic benefits to mass production of Bowsers and Vehicles, especially as the System (200) improves through use-derived know-how.

The Second Embodiments of a Thermal Safety Chamber (16) are now disclosed by referencing this drawing with the FIG. 6 drawing.

In this drawing, it can be seen that the Conveyor (C18) no longer conveys Faulty Cell-Modules away from the Thermal Safety Chamber directly towards a three Conveyor Portal (4).

Instead, Conveyor (C18) is shown as ‘L’ shaped, for now directing Faulty Cell-Modules onto the Conveyor (C19), inside Vehicle (1).

Also, the Conveyor (C16) of FIG. 06 has been removed, and replaced with the Conveyor (C19), for now sharing the role of removing Faulty Cell-Modules and Depleted Cell-Modules, respectively from Thermal Safety Chamber (16) and Main-Chamber (15), towards Portal (4).

The directions of the Conveyors (C7) and (C17) have also been reversed, compared to the directions shown for them in FIG. 06; for now delivering Charged Cell-Modules from Bowser (2) towards Main-Chamber (15).

Additionally, the electric Terminal Blocks (320) and (340), that were separated in a horizontal direction in FIG. 05, are now stacked in a vertical direction in FIG. 16. Thus, the electric Terminal Blocks (420) and (440), that were separated in a horizontal direction in FIG. 6, are now stacked in a vertical direction in FIG. 16 for being matingly co-operative when the Nozzle (3) and the Portal (4) are connected and secured.

In this drawing, it should be apparent for Second Embodiments of a Bowser (2) that no Recharging Bay has been installed within its casing, as was disclosed in FIG. 3 for First Embodiments of a Bowser (2).

Instead, an extremely simple schematic Charging Bay (6) is shown attached the rear portion of the casing of the Bowser (2), solely for the purpose of providing an enclosed System.

In a preferred example of the Bowser shown in the drawing, the Bowser will make use of a Charging-Bay (6) using Fourth Embodiments of an Enclosed System (200), that are later disclosed.

A Second Embodiment Bowser (2) therefore offers economies for e.g. size and simplification, for reduction of manufacturing costs over a First Embodiments Bowser.

In the drawing, only four Cell-Modules are shown within the Movable part (B) and only four Cell-Modules are shown within the Stationary part (A), to better disclose the sequential conveyance of Cell-Modules within the Second Embodiments of a System (200).

A single Faulty Cell-Module (FCM) that had previously been removed from Main-Chamber (15) has been secured within the closed Thermal-Safety-Chamber (16).

Three Depleted Cell-Modules (DCM), that the Vehicle's Computer-Controller (450) has already flagged as being in need of replacement are denoted as solid-line squares in the Vehicle's Main-Chamber (15).

Four Charged Cell-Modules, (CCM), are also shown within Bowser (2), ready to be conveyed towards Nozzle (3) via Flexible-Pipe (5), when required.

The FIG. 17 drawing is sequential to FIG. 16 and shows the Nozzle (3) inserted and temporarily secured within Portal (4).

Because the Nozzle and Portal are secured, the electric Terminal Blocks (320) and (340) are respectively able to communicate with the electric Terminal Blocks (420) and (440), for activation of all necessary electro-mechanical devices within the Vehicle by the Bowser's Computer-Controller (350), in communication with the Vehicle's Computer-Controller (450), before any activation of the Nozzle-Trigger (39) by the driver is required; which is an important sequential control feature and safety feature of the Nozzle (3) over conventional fossil fuel nozzles.

The drawing shows that, even before activation of Trigger (39), the Thermal-Safety Control-Door (161) has been opened, to allow the Faulty Cell-Module (FCM) to be conveyed out of Thermal-Safety-Chamber (16) by Conveyor (C18).

Conveyor (C18) has then automatedly transferred Faulty Cell-Module (FCM) onto Conveyor (C19), where it is ready to be conveyed out of Vehicle (1).

Synchronously, the Conveyor (C20) within Main-Chamber (15) has moved the three Depleted Cell-Modules (DCM) from the positions shown in the FIG. 16 drawing, onto Conveyor (C19).

The Computer-Controllers (350) and (450) have ensured that the Main-Chamber's Exit-Door (151) has been opened to facilitate removal of the three Depleted Cell-Modules.

Also synchronously, the four Charged Cell-Modules (CCM) have been conveyed out of Bowser (2) and are now shown inside Pipe (5), adjacent the Nozzle (3), ready to be conveyed inside the Vehicle (1).

It is important to note for this drawing that the conveyed movements of all Cell-Modules within the Enclosed System (200), relative to their positions in the FIG. 16 drawing have all taken place without any activation of the Nozzle-Trigger (39) which is still shown in its non-activated position.

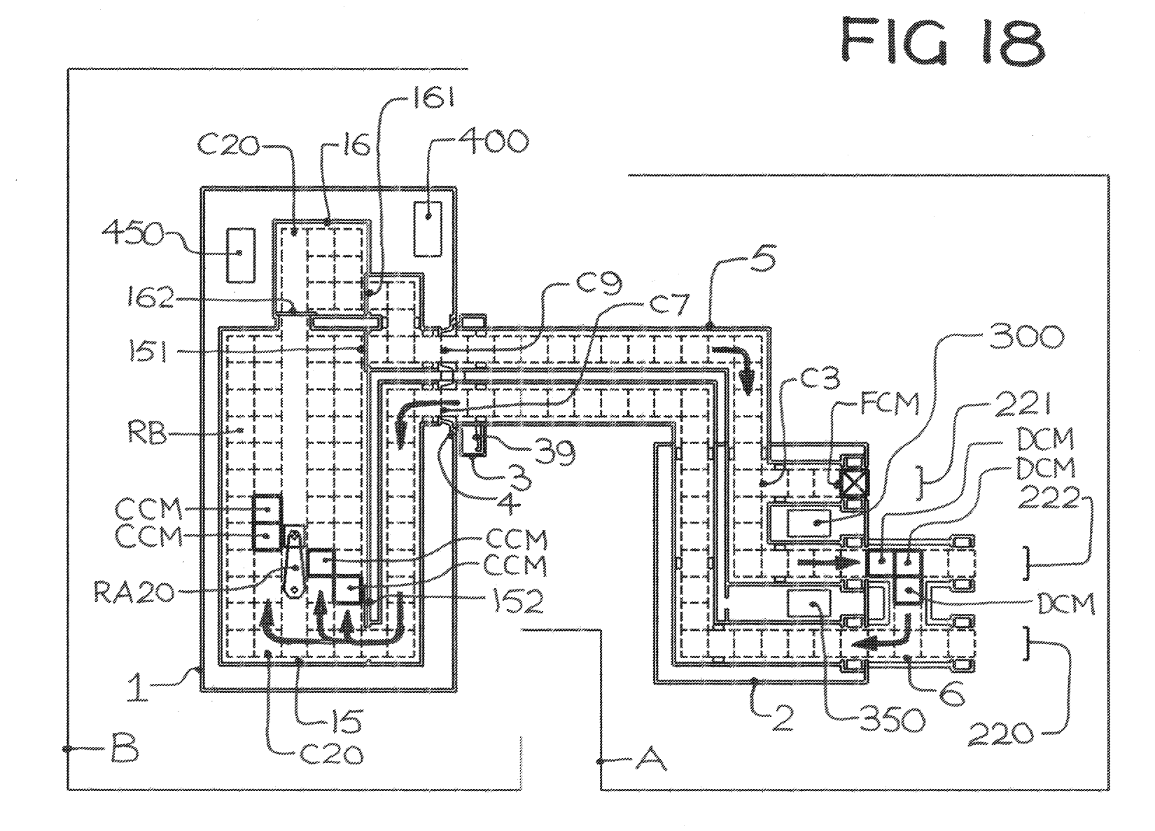

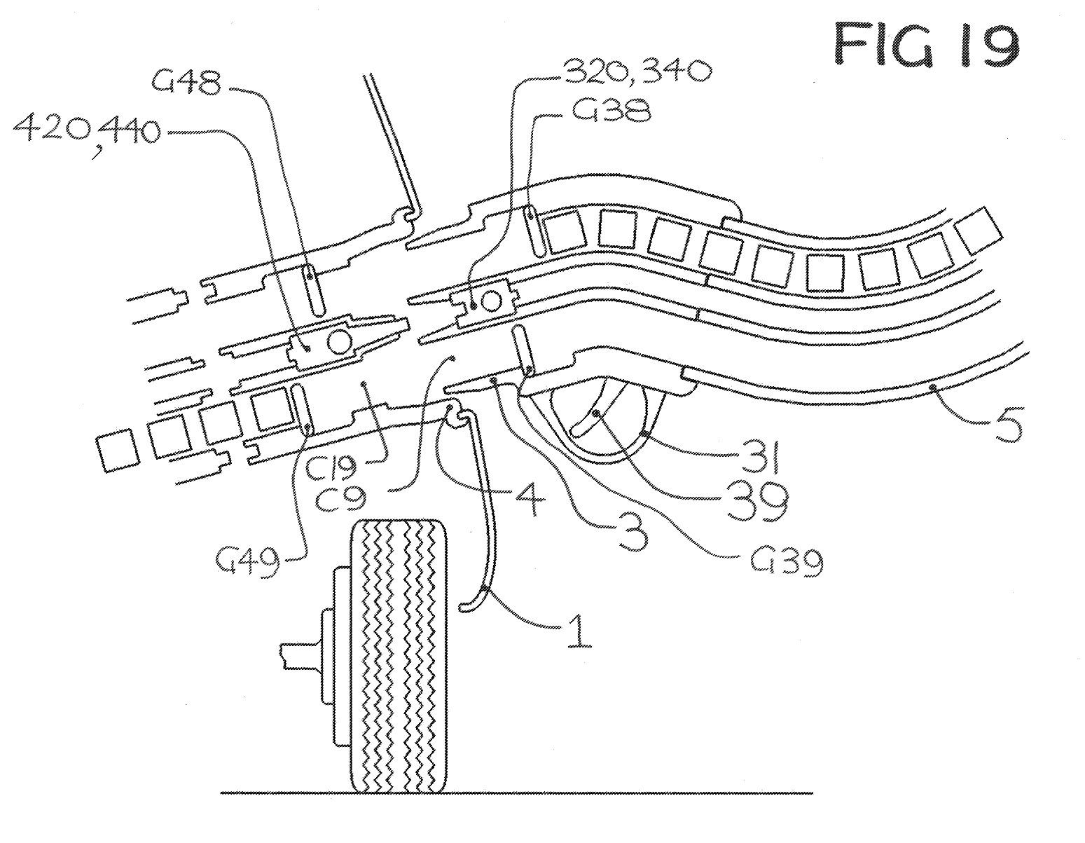

The FIG. 18 drawing is sequential to FIG. 17 and also sequential to the activation of the Nozzle-Trigger (39) by the driver of Vehicle (1).

It should be apparent, without the need for further drawing reference, that the Display-Screens (71), (81) and (91), as defined for the FIG. 10 to FIG. 13 drawings, also have the same relevance for the Second Embodiments disclosures.

As an example, a Display-Screen Alert (A20), not shown, may advise the driver that the Trigger (39) will not be operable for a few moments while the System interrogates the Vehicle. This System interrogation process is essentially the time sequence, as defined for FIG. 17, after the Nozzle (3) has been inserted in the Portal (4) and before activation of the Trigger (39) is allowable.

The drawing shows that the Trigger (39) has been activated.

By comparing FIG. 18 with FIG. 17, it can be seen that, after Activation of Trigger (39), the single Faulty Cell-Module (FCM) has been conveyed from its position inside Vehicle (1) to a position inside Bowser (2), where is has been automatedly transferred onto Conveyor (C3), ready to be ejected from the System (200) via System-Exit-Gate (221).

By again comparing FIG. 18 with FIG. 17, it can be seen that the three Depleted Cell-Modules (DCM) have been conveyed from their sequential positions inside Vehicle (1) to a position inside Bowser (2) where they are in the process of being sequentially re-charged by remote Charging Bay (6), prior to being recycled within System (200), for later metered Bowser dispensation within another Vehicle (1).

And by again comparing FIG. 18 with FIG. 17, it can be seen that the four Charged Cell-Modules (CCM), have been conveyed from their sequential positions inside Pipe (5) to various positions within Main-Chamber (15) of Vehicle (1), where they have been installed in Vacant Receiving-Bays by Conveyor (C20), ready for power extraction use by the Vehicle, after disconnection of the Portal and the Nozzle.

The FIG. 19 drawing is a schematic sectional side view of a Cell-Module dispensing Nozzle (3) about to be inserted in the Cell-Module Receiving Portal (4) of a Cell-Module powered electric Vehicle (1), as also depicted in FIG. 16.

The drawing represents the same moment in time for the Nozzle and Portal areas shown for FIG. 16, except that in this drawing, the Vehicle's electric Terminal Blocks (420), (440) and the Nozzle's electric Terminal Blocks (320), (340) have been placed apart in a horizontal direction, as may be referenced by the FIG. 21(a) drawing.

The electric Terminal Blocks have also been disclosed in greater detail.

Terminal Blocks (420), (440) are shown having male components and Terminal Blocks (320), (340) are shown having matingly co-operative female components.

The square nodule shown on the rear face of each Terminal Block is a schematic representation of the place where the different cable ends of the Vehicle's and Bowser's wiring looms (not shown) are separately joined to the Terminal Blocks, for the respective Terminal Blocks to have direct electrical connection with Bowser's and Vehicle's Controllers, as previously disclosed.

Conveyor (C19) is shown within the body of the Portal (4), having one Faulty Cell-Module (FCM) ready to be removed from the Vehicle. Three Depleted Cell-Modules (DCM) have been sequentially placed behind it, as previously also shown in FIG. 17.

A Control Gate (G49) is also shown for the first time, for preventing the Cell-Modules within the Vehicle from travelling any further towards the Bowser, via Portal (4), when there is no connection with the Nozzle.

Conveyor (C7) is shown having one remote end within the body of the Nozzle (3), and having eight freshly Charged Cell-Modules (CCM) ready to be delivered to the Vehicle.

A Control Gate (G38) is also shown for the first time, for preventing the Charged Cell-Modules CCM from travelling any further towards the Vehicle, via Nozzle (3).

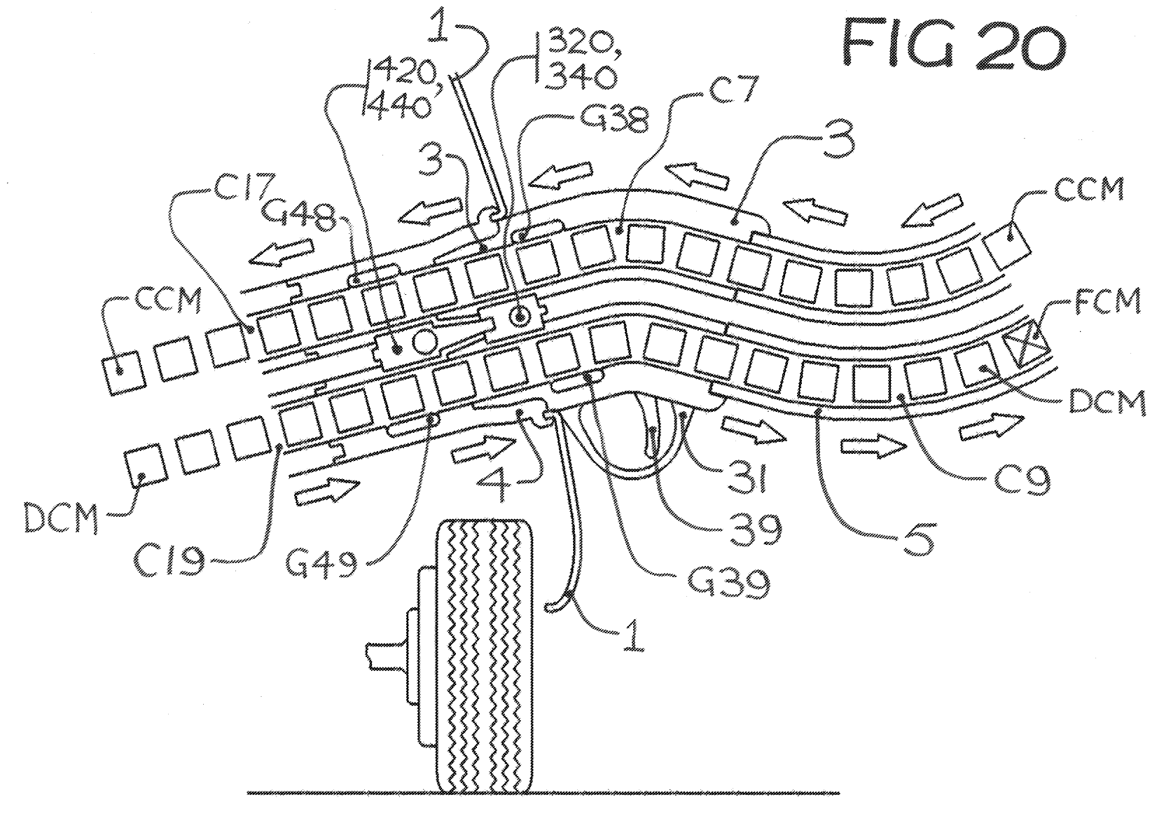

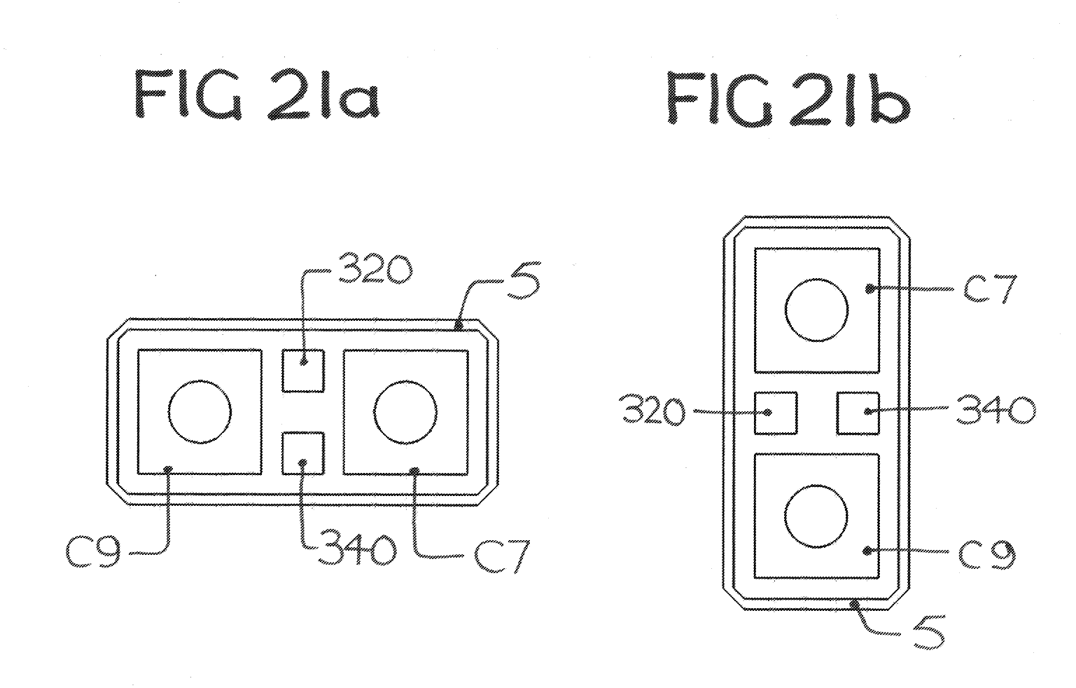

The FIG. 20 drawing is a schematic sectional side view of a Cell-Module dispensing Nozzle (3) that has been inserted and secured within the Cell-Module Receiving Portal (4) of a Cell-Module powered electric Vehicle (1).

This drawing represents the same moment in time for the Nozzle and Portal areas shown in the FIG. 17 down view, except that again, the Vehicle's electric Terminal Blocks (420), (440) and the Nozzle's electric Terminal Blocks (320), (340) have been spaced apart in a horizontal direction in this drawing.

The electric Terminal Blocks have again been disclosed in greater detail.

The Terminal Blocks (420), (440) are shown having their male components in matingly co-operative electrical contact with the Terminal Blocks (320), (340) for the respective Terminal Blocks to now provide direct electrical connection between the Bowser's Controllers (300), (350) and the Vehicle's Controllers (400), (450) (not shown).

Only after Nozzle (3) has been fully inserted and temporarily secured within Portal (4), and the Computer-Controllers (350) and (450), not shown, issue the correct protocols, can the driver activate the Nozzle Trigger (39), as shown in the drawing.

Activation of the Trigger causes the Control Gates (G38), (G39), (G48) and (G49) to open, which in turn activates the Conveyors (C7), (C17), (C9) and (C19) to automatedly co-ordinate sequential flows of Cell-Modules between the Bowser and he Vehicle, according to the driver's requirements.

In the drawing it can be seen that the single Faulty Cell-Module (FCM) that was previously adjacent Control Gate (G49) in FIG. 17, is now at the far right end of Pipe (5), within Enclosed-Conveyor (C9) and heading towards Bowser (2) for removal from the System (200), via System-Exit-Gate (221) as previously disclosed for at least FIG. 18.

It can also be seen from this drawing that the driver has this time chosen to remove seventeen Depleted Cell-Modules (DCM) from his Vehicle.

From this driver's choice of replenishment amount, the Bowser is shown delivering eighteen freshly Charged Cell-Modules (CCM) to the Vehicle along Conveyor (C7) within Pipe (5).

One of those eighteen Charged Cell-Modules may be delivered to the Vehicle gratis, to replace the single Faulty Cell-Module, as previously disclosed for the First Embodiments; for providing one means for establishing a Quality Control and Quality Consistency Standard for consistent Cell-Module energy delivery.

The FIG. 21 drawings are schematic cross-sections through a Flexible-Pipe (5) for the Second Embodiments of the invention.

FIG. 21(a) represents a cross-section described for FIGS. 16, 17 and 18.

FIG. 21(b) represents a cross-section described for FIG. 19 and FIG. 20.

From this information, it should be most apparent that the cross-section as shown for FIG. 20(a) is the same as FIG. 20(b), except that the Pipe (5) has been rotated through ninety degrees.

From this information, it should be understood that the descriptions for FIG. 16 are directly applicable to FIG. 18 and vice versa. The same understandings should be made between FIG. 17 and FIG. 19.

### Third Embodiments

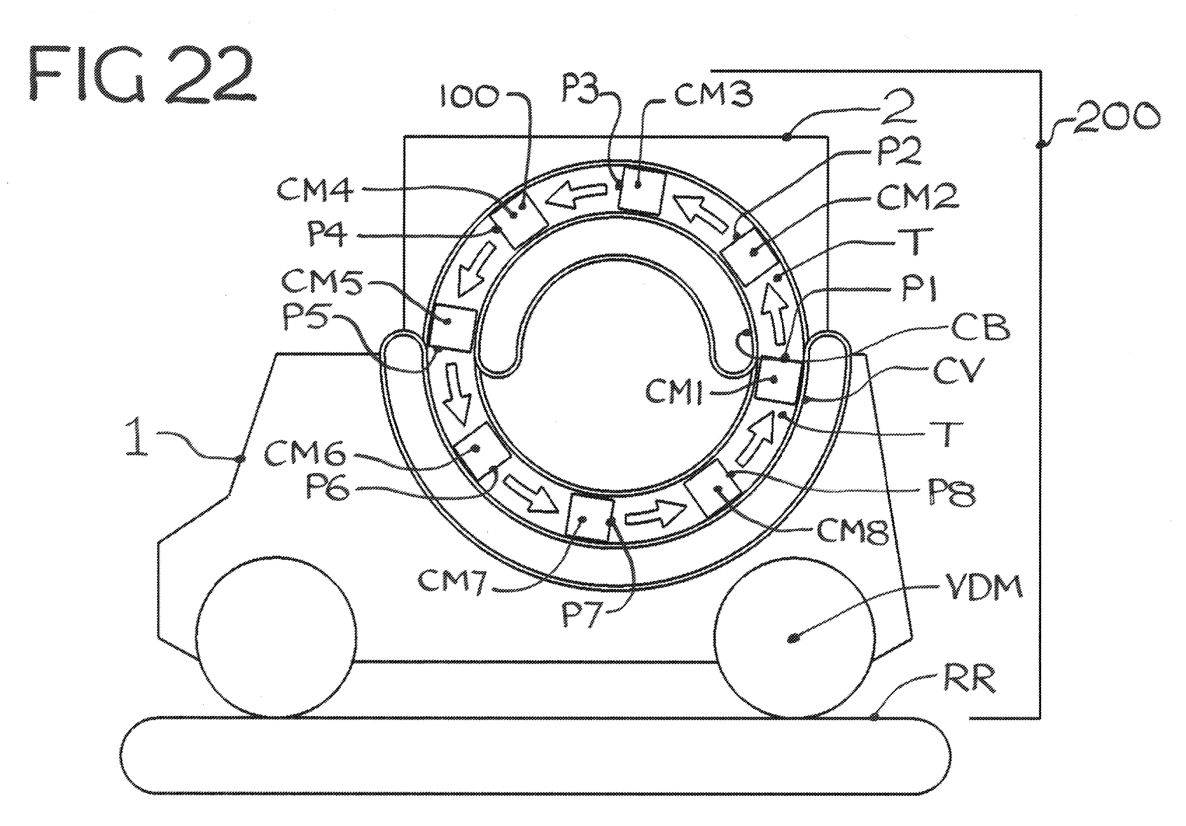

FIG. 22 represents, in its most whittled down visual form, the simplest schematic disclosures for Third Embodiments of an Enclosed Cyclical System (200).

All the different interacting Conveyors that were previously disclosed for the Stationary part (A), have been reduced to a single semi-circular Conveyor (CB) of endless belt form, that has been installed within the Casing of a simple Cell-Module dispensing Bowser (2).

Similarly, all the different interacting Conveyors that were previously disclosed for the Movable part (B), have also been reduced to a single semi-circular Conveyor (CV) of endless belt form, that has been installed within the Bodywork of a simple Cell-Module powered electric Vehicle (1).

The drawing also discloses that when the simple Bowser (2) is temporarily adjoined the simple Vehicle (1), the semi-circular Conveyor (CB) is shown as an arch and the semi-circular Conveyor (CV) is shown as a bowl.

Eight Cell-Modules (100) are each depicted by four solid straight lines that contain a square shape, as previously disclosed for the First and Second Embodiments.

It should be understood, without the need for a further drawing, that the eight Cell-Modules (100) could also be cylindrical, elongate or of other preferred shape, without detracting from the disclosure.

The eight Cell-Modules are shown being sequentially conveyed between the Bowser and the Vehicle, in a continuous through-flow manner by the two interacting Conveyors (CB), (CV), within an enclosed circular route that may be defined as a hollow Torus (T).

The upper half of the Torus is installed with the Casing of the Bowser and the lower half of the Torus is installed within the Body of the Vehicle.

In order that this schematic disclosure is kept as simple as possible, no regard at this stage has been given for imperfect Cell-Modules and thus no provision for; insertion of New Cell-Modules into the System; removal of Faulty Cell-Modules from the System or; any degradation of Cell-Module quality during the continuous recharges and depletions of the rechargeable Cell-Modules (100) as they continuously flow around the Enclosed Cyclical System (200) that is contained within the Torus (T).

Nozzle and Portal interfacings between the Vehicle and the Bowser are also omitted for simplification and clarity.

A single vertical line, shown touching the topmost external part of the Bowser casing, represents the only part of the Enclosed System that is external to the System; the power input from the vitally important Constant-Power-Supply, necessary for recharging depleted Cell-Modules.

In the drawing, eight identical Cell-Modules (100) are equidistantly spaced with the hollow Torus and are shown being continuously rotated counter-clockwise within the enclosed circular System (200) by the two interacting Conveyors.

The drawing thus shows eight sequentially conveyed positions for the identical Cell-Modules (100) that are each positioned 45 degrees apart.

Position (P1) shows a Fully Depleted Cell-Module (CM1) about to exit Vehicle (1) and enter (Bowser (2), for immediately beginning a schematic Four-Stage recharging cycle.

Position (P2) therefore shows a One-Quarter Charged Cell-Module (CM2).

Position (P3) shows a Half Charged Cell-Module (CM3) at the top of the Torus.

Position (P4) shows a Three-Quarter Charged Cell-Module (CM4).

Position (P5) shows a Fully Charged Cell-Module (CM5) about to exit Bowser (2) and enter Vehicle (1), for immediately beginning a schematic Four-Stage depletion cycle.

Position (P6) therefore shows a One-Quarter Depleted Cell-Module (CM6).

Position (P7) shows a Half Depleted Cell-Module (CM7) at the bottom of the Torus.

And: —Position (P8) shows a Three-Quarter Depleted Cell-Module (CM8).

It is important to understand from the drawing and the descriptions for each of these eight sequentially conveyed positions, that as each identical Cell-Module is conveyed counter-clockwise exactly 45 degrees, it acquires the exact State-of-Charge description of the Cell-Module that was previously in that position.

Put another way, the eight equidistantly spaced cyclical positions (P1), (P2), (P3), (P4), (P5), (P6), (P7) and (P8) will always be sequentially occupied by a Cell-Module in the exact same state of charge as its predecessor.

All the disclosures thus far for this drawing only have practical relevance for the previous disclosures, as they relate to the Stationary part (A) and so far, not for the Movable part (B).

This is because Charged Cell-Modules that were disclosed being installed within a stationary Vehicle (1), for the First and Second Embodiments, would not be undergoing the depletions as shown in FIG. 22, when attached a Bowser (2).

In order that the all disclosures shown for the FIG. 22 drawing have important introductory relevance to the First Embodiment and also provide further understanding for use with the Second Embodiment of the invention, the Vehicle (1) is now disclosed as a ‘test-bench’ Vehicle, driving along a Rolling Road (RR), such that, whilst being stationary, relative to the stationary Bowser (2), the Vehicle's Motive Power Drive motor is preferably depleting Cell-Modules at the exact same rate that the Bowser is able to recharge them, in harmony with the rotational speeds of the interacting Conveyors (CB) and (CV), the speed of the Rolling-Road (RR) and the power output requirements of the Vehicle Drive Motor (VDM).

The FIG. 22 drawing and disclosures thus provide a first ‘test bench’ research environment for understanding how small-volume Cell-Modules (100) may be best employed with the invention, for providing efficient replenishable motive power to electric Vehicles as sequential, choosable and meterable amounts of small-volume energy through-flow, just as metered fossil fuel has been traditionally provided for more than a century.

This test bench knowledge acquisition therefore has important lead-on know-how ramifications for the separate and combined features, apparatus and inventive steps that the invention offers.

From the teachings for this drawing, it should be apparent that adaption of the Enclosed Cyclical Computer-Controlled System (200), to allow faulty Cell-Modules, badly degraded Cell-Modules or Cell-Modules that do not adhere to efficient or stringent recharging and depletion requirements, from knowledge that has been accrued from experience gained know-how, to now be removed from this version of a System (200) and replaced with new Cell-Modules; all in a manner most suitable to understanding practical test-bench conditions and requirements.

### Fourth Embodiments

The Fourth Embodiments of the invention disclose a System (200) that provides a descending series of Stepped-Hoppers that provide separate and combined means for a central or hub Charging-Bay (6) to receive Depleted Cell-Modules from single or plural radially disposed positions, for centrally recharging them within the Charging-Bay before redistributing them as Charged Cell-Modules to single or plural radially disposed positions, within an Enclosed System (200).

These Embodiments may again parallel, mimic or improve upon a conventional fossil fuel storage tank that distributes replenishing motive power from a central or hub refuelling tank to single or plural radially disposed positions.

A central or hub Charging-Bay (6) can either service a single Cell-Module dispensing Bowser (2) or simultaneously or sequentially service a plurality of Cell-Module dispensing Bowsers (2) that are situated within the same forecourt or Service Station location, just as a central fossil fuel storage tank can service a single fossil fuel bowser or simultaneously service a plurality of fossil fuel dispensing bowsers.

To provide these separate and combined means, the Stationary Part or Parts (A) of an enclosed System (200) have Cell-Module Hoppers incorporated that are adjacently and sequentially stepped or step-interspersed between certain Cell-Module Conveyors.

The purpose of adjacently stepping at least three Cell-Module containment Hoppers is to provide a descending interconnecting Hopper-Train mechanism for both holding means and constant flow means for Cell-Modules within the Charging Bay (6) of an enclosed System (200).

In Computer-Controlled combination and co-ordination, the stepped or interspersed Cell-Module Hoppers are able to mass-receive and temporarily store a required plurality Charged Cell-Modules, Depleted Cell-Modules and optionally, Faulty Cell-Modules in a dynamic manner that also provides means for the on-demand mass release of those Cell-Modules from specific Hoppers, into another adjacently placed Stepped-Hopper, or onto an adjacently placed Conveyor, by the System's Computer-Controllers.

These Computer-Controlled mass-receipt, storage and mass-release Stepped-Hoppers provide on-demand supply to certain Conveyors for maintaining an optimum required flow of Cell-Modules in both directions between the Stationary Part or Parts (A) and the Movable Part or Parts (B), especially when a plurality of Bowsers (2) are simultaneously servicing a plurality of Vehicles (1) within the same Cell-Module Service Station facility.

In all the Fourth Embodiments drawings, these Hoppers are all schematically disclosed as having similar sizes and shapes.

In practice, these Hoppers will be of very different sizes and formations for providing optimum required sequential through-flows for a System (200).

In all drawings for the Fourth Embodiments, small-volume rechargeable Cell-Modules (100) flowing through the System are shown in cylindrical form.

However, any practical shape that makes use of the System's disclosures is also considered advantageous.

Certain prior art, and in particular, FIG. 1 of the Seragnoli U.S. Pat. No. 3,435,940, discloses hopper apparatus and transfer means for approximately 4,000 freshly manufactured cigarettes to be sequentially and continuously process-conveyed every sixty seconds.

These very large numbers of freshly manufactured cigarettes are continuously sequentially rolling off the end of a first conveyor, into the top portions of three adjacent hoppers, for those cigarettes to then automatedly emerge at their constricted open ended lower portions, for their sequential release as three separate layers, respectively of 7, 6 and 7 cigarettes, in an automated sequential packaging system incorporated on a second conveyor.

The Cell-Module receiving Hoppers for use in the Fourth Embodiments of the invention are preferably disposed in a three-step staircase arrangement between two constant-flow Conveyors.

The upper constant-flow Conveyor provides constant in-flow to the Upper-Hopper and the lower constant-flow Conveyor provides constant out-flow to the Lower-Hopper.

The Upper Stepped-Hopper and the Lower Stepped-Hopper are set in fixed positions in a first-direction and the Central Stepped-Hopper is attached a horizontally disposed Hopper-Conveyor for providing movement in a second-direction that is perpendicular to the first-direction.

The Central Stepped-Hopper is provided with second-direction movement for travelling through the void between an Upper Stepped-Hopper and a Lower Stepped-Hopper and stopping precisely within that void, for two Precise Functions.

The First Precise Function is to provide Stepped-Hopper means for distributing Cell-Modules from an Upper Stepped-Hopper set within a first System (200) to a Lower Stepped-Hopper that is also set within a first System (200).

The Second Precise Function is to provide Stepped-Hopper means for distributing Cell-Modules from an Upper Stepped-Hopper set within a first System (200) to a Lower Stepped-Hopper that is set within a second or subsequent System (200).

It is a preferred aspect of providing three Stepped-Hoppers that temporary Hopper storage will not impede general through-flow at that position, and will also allow the Computer-Controlled mass-release of Cell-Modules, on demand, preferably using gravitational assistance for the improved fast transfer of large numbers of Cell-Modules from that Hopper for then being again conveyed towards other internal parts of the System (200).

In one example of a Fourth Embodiment Hopper, a Charged Cell-Module Stepped-Hopper may be placed directly above a Cell-Module dispensing Bowser (2), and in particular its constricted lower end portions placed directly above the Bowser end of a Cell-Module dispensing Pipe (5), for providing gravitational assistance in the mass-release of large numbers of Charged Cell-Modules from a Bowser (2), through the Pipe (5), into an attached Vehicle (1).

In another example of a Fourth Embodiment Hopper, a Depleted Cell-Module Stepped-Hopper may be placed directly below a Cell-Module dispensing Bowser (2), and in particular, its open upper portions placed directly below the Bowser end of a Cell-Module dispensing Pipe (5), for providing gravitational assistance in the mass-receipt of large numbers of Depleted Cell-Modules from a Vehicle (1), through the Pipe (5), into that Bowser (2).

In other examples of Fourth Embodiments of the invention, a roadside Service Station facility comprising a plurality of Cell-Module dispensing Bowsers (2) that are serviced by a central or hub Charging-Bay (6), is provided with; a roof void for the safe containment of a Charged Cell-Module Hopper directly above a Cell-Module Bowser's dispensing Pipe (5) and; a floor void for the safe containment of a Depleted Cell-Module Hopper, directly below a Cell-Module Bowser's dispensing Pipe (5).

Optionally, a separate Faulty Cell-Module Hopper, representing an Upper Stepped-Hopper, may also be placed directly below the Bowser end of a Cell-Module Bowser's dispensing Pipe (5).

Means for removing Faulty Cell-Modules from a System (200) have been sufficiently disclosed for the previous Embodiments and are therefore not included.

Whilst the drawings for the Fourth Embodiments relate mainly to further disclosures for Cell-Module retrieval, recharging and distribution for Second Embodiments of the invention, it should be apparent, without the need for further drawings that these same disclosures are readily understandable for First Embodiments of the invention.

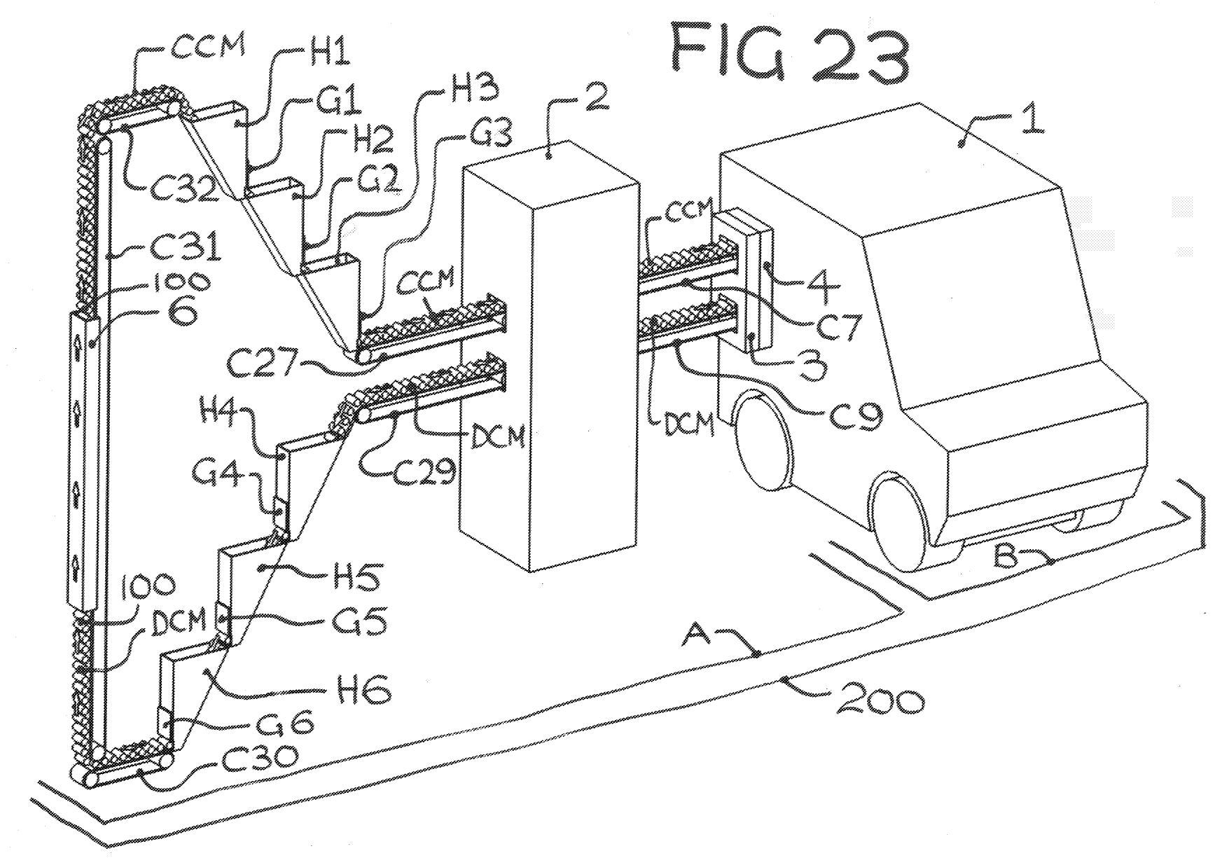

FIG. 23 introduces schematic visuals of Fourth Embodiments of an Enclosed Computer-Controlled Cell-Module Through-Flow System (200) that incorporates a central or hub Charging-Bay (6) for servicing a single remote Cell-Module dispensing Bowser (2) that is also situated within the same forecourt or Service Station location.

In the drawing, a Second Embodiment Vehicle (1) is shown parked adjacent a Second Embodiment Bowser (2).

The Bowser's Nozzle (3) is shown inserted and secured with the Vehicle's Portal (4), and the Nozzle-Trigger (39), not shown, has been activated for a sequential plurality of Depleted Cell-Modules (DCM) to be conveyed out of Vehicle (1) via Conveyor (C9) and a similar plurality of Charged Cell-Modules (CCM) to be conveyed into Vehicle (1) via Conveyor (C7).

The Flexible-Pipe (5) between the Bowser (2) and the Nozzle (3), that is shown housing the Conveyors (C7) and (C9), in at least FIG. 20 and FIG. 21(b), has been omitted to aid clarity.

All electric cabling and Electric-Terminals, for the Stationary Part (A) and the Moveable Part (B) to communicate with each other when Nozzle (3) and Portal (4) are connectively secured, as disclosed for at least FIG. 20, have also been omitted.

The drawing discloses two separate groups of Stepped Cell-Module Hoppers.

The first group of three Stepped-Hoppers, (H4), (H5) and (H6) are shown in a sequential vertically disposed stepped group arrangement in the lower left hand area of the drawing.

The Upper Stepped-Hopper (H4) in the stepped group is shown sequentially receiving Depleted Cell-Modules (DCM) that have been conveyed to it, from the adjacently parked Vehicle (1) that is temporarily but securely attached the Bowser, by connected use of the Nozzle (3) and the Portal (4).

The Depleted Cell-Modules are being sequentially received by the Upper Stepped-Hopper (H4), after Conveyor (C9) has removed them from Vehicle (1); and then conveyed them through the Bowser (2) onto Conveyor (C29), which then provides end-means for the Depleted Cell-Modules (DCM) to sequentially flow directly into the upper open parts of the Upper Stepped-Hopper (H4).

A Computer-Controlled Hopper-Gate (G4) is shown in the open position, at the constricted lower portions of the Hopper, for the Upper Stepped-Hopper (H4) to provide gravitational means for the direct through-flow of Depleted Cell-Modules through its internal parts.

The Depleted Cell-Modules (DCM) then sequentially flow out of the open Hopper-Gate (G4) and then flowing directly into the upper open parts of the Central Stepped-Hopper (H5).

A Computer-Controlled Hopper-Gate (G5) is also shown in the open position, at the constricted lower portions of the Hopper, for the Central Stepped-Hopper (H5) to provide gravitational means for the direct through-flow of Depleted Cell-Modules through its internal parts.

The Depleted Cell-Modules (DCM) then sequentially flow out of the open Hopper-Gate (G5) and flowing directly into the upper open parts of the Lower Stepped-Hopper (H6).

A Computer-Controlled Hopper-Gate (G6) is also shown in the open position, at the constricted lower portions of the Hopper, for the Lower Stepped-Hopper (H6) to provide gravitational means for the direct through-flow of Depleted Cell-Modules through its internal parts.

The Depleted Cell-Modules (DCM) then sequentially flow out of the open Hopper-Gate (G6) and then flow directly onto the first remote end of a horizontally disposed Conveyor (C30).

The Depleted Cell-Modules (DCM) are then shown being sequentially transferred from the second remote end of the horizontally disposed Conveyor (C30), onto the first remote end of a vertically disposed Conveyor (C31).

Vertical Conveyor (C31) then sequentially conveys the Depleted Cell-Modules (DCM) inside the casing of Charging-Bay (6).

Conveyor (C31) then sequentially conveys the Cell-Modules (100) through the vertical length of the casing of Charging-Bay (6) where they are sequentially charged by known sequential charging processes as they pass through the length of the casing. Conveyor (C31) then sequentially conveys the Cell-Modules (100) out of the casing of Charging-Bay, where they emerge as freshly Charged Cell-Modules (CCM).

The vertically disposed Conveyor (C31) then sequentially transfers Charged Cell-Modules (CCM) from its upper or second remote end, directly onto the first remote end of a horizontally disposed Conveyor (C32).

The second group of three Stepped-Hoppers, (H4), (H5) and (H6) are also shown in a sequential vertically disposed stepped group arrangement, in the upper left hand area of the drawing.

The Upper Stepped-Hopper (H1) in the stepped group is shown receiving freshly Charged Cell-Modules (CCM) directly from the second remote end of the horizontally disposed Conveyor (C32), where they sequentially flow directly into the upper open parts of the Upper-Hopper (H1).

A Computer-Controlled Hopper-Gate (G1) is shown in the open position, at the constricted lower portions of the Hopper, for the Upper-Hopper (H1) to provide gravitational means for the direct through-flow of Charged Cell-Modules through its internal parts.

The Charged Cell-Modules (CCM) then pass sequentially through the open Hopper-Gate (G1) and flow directly into the upper open parts of the Central-Stepped-Hopper (H2).

A Computer-Controlled Hopper-Gate (G2) is also shown in the open position, at the constricted lower portions of the Hopper, for the Central Stepped-Hopper (H2) to provide gravitational means for the direct through-flow of Charged Cell-Modules through its internal parts.

The Charged Cell-Modules (CCM) then flow sequentially through the open Hopper-Gate (G2) and flow directly into the upper open parts of the Lower Stepped-Hopper (H3).

A Computer-Controlled Hopper-Gate (G3) is also shown in the open position, at the constricted lower portions of the Hopper, for the Lower-Hopper (H3) to provide gravitational means for the direct through-flow of Charged Cell-Modules through its internal parts.

The Charged Cell-Modules (CCM) then sequentially flow out of the open Hopper-Gate (G3) and flow directly onto the first remote end of a horizontally disposed Conveyor (C27).

The Charged Cell-Modules (CCM) are then shown being sequentially transferred inside the casing of Bowser (2) where they are then transferred, by previously disclosed Second Embodiment means, onto the Conveyor (C7) for then being conveyed inside the Second Embodiment Vehicle (1) that is shown attached the Bowser (2).

The drawing thus discloses introductory sequential sequences for Fourth Embodiments of the Stationary Part (A) of an Enclosed System (200), that encompass at least two groups of vertically disposed Stepped-Hoppers, for replenishing a chosen plurality of Depleted Cell-Modules with a similar chosen plurality of Charged Cell-Modules between a single Charging-Bay (6) and a single Vehicle (1).

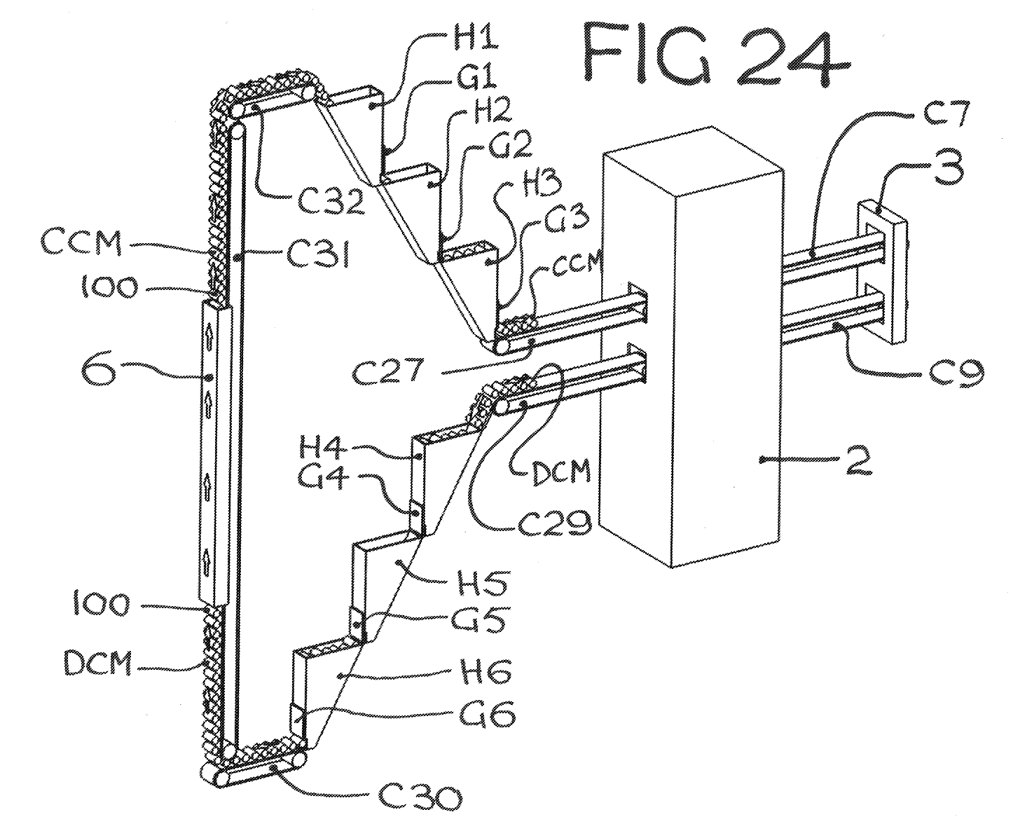

FIG. 24 discloses the same components for the Stationary Part (A), as shown in FIG. 23, except that in this drawing, the vertically disposed group of Stepped-Hoppers (H1), (H2) and (H3) and the vertically disposed group of Stepped-Hoppers (H4), (H5) and (H6) are additionally Computer-Controlled, for each Stepped-Hopper to also act as a mass-receipt Hopper, a mass-storage Hopper and a mass-release Hopper, rather than being used only as a through-flow Hopper, as disclosed for FIG. 23.

For this drawing, previous usage situations are explained for the Bowser (2), prior to the contemporaneous time that the drawing portrays.

The Bowser (2) has not been used for a precise time period.

Hence, no attached Vehicle (1) is attached the Bowser's Nozzle.

Prior to that precise time period, the Bowser had been used in quick succession by two different Vehicles (1), that had previously been successfully serviced by the Bowser.

Both Vehicles have left the Service Station area, having replenished a required plurality of Charged Cell-Modules for completing the next stages of their journeys.

The Bowser (2) had therefore been previously tasked with delivering two separate pluralities of Charged Cell-Modules to those two Vehicles and had also been tasked with receiving two separate similar pluralities of Depleted Cell-Modules from those two Vehicles.

The drawing will now disclose sequential means by which those two separate pluralities of Charged Cell-Modules were mass-released by the Stepped-Hoppers (H1), (12) and (H3), for their metered and monitored insertion into those Vehicles.

The drawing will also now disclose sequential means by which those two separate similar pluralities of Depleted Cell-Modules are mass-received by the Stepped-Hoppers (H4), (H5) and (H6), after their metered or monitored removal from those two Vehicles.

Referring first to the casing of the sequential Charging-Bay (6), the Depleted Cell-Modules (DCM) that are about to enter the hollow portions at the base of the casing represent the first Depleted Cell-Modules that were the first to be extracted from the first of the two sequential Vehicles (1) described above.

Referring now to the Stepped-Hoppers (H4), (H5) and (H6), the plurality of Depleted Cell-Modules shown near the top of the relatively full Lower Stepped-Hopper (H6) generally represent the last of the Depleted Cell-Modules that were previously extracted from the first of the two Vehicles that had previously visited the Bowser (2).

Similarly, the plurality of Depleted Cell-Modules shown near the top of the relatively full Upper Stepped-Hopper (H4) generally represent some of the last Depleted Cell-Modules that were previously extracted from the second of the two Vehicles that had previously visited the Bowser.

Importantly, the Central Stepped-Hopper (H5) has a primary function to act as a specialised Transfer-Hopper between the Upper Stepped-Hopper (H4) and the Lower Stepped-Hopper (H6); that will be further disclosed in later Fourth Embodiment drawings.

Referring again to the Lower Stepped-Hopper (H6), it will be seen that the Hopper-Gate (G5), positioned directly above Hopper (H6), is set in the closed position, providing means for the Central Stepped-Hopper (H5) to act as a specialised buffer zone that prevents overflow of Depleted Cell-Modules into Hopper (H6) without any need for the Computer-Controllers to halt rotation of any of the System's Conveyors.

Referring now to the Upper Stepped-Hopper (H4), it will be seen that the Hopper-Gate (G4) is also set in the closed position, for providing temporary storage of the Depleted Cell-Modules that were received from the second Vehicle (1) that had previously visited the Bowser (2).

From this information, it should be apparent that, as soon as space becomes available in the Lower-Hopper (H6), because Depleted Cell-Modules are being continuously sequentially conveyed inside the casing of the Charging-Bay (6), the Computer-Controllers will open the Hopper Gate (G4), for allowing more Depleted Cell-Modules to be mass-released from Hopper (H4) into Hopper (H5) and optionally, directly through Hopper (H5), by the separate Computer-Controlled opening of Hopper-Gate (G5), in order that continuous through-flow between the Stationary Part (A) and the Movable Part (B) is always available when a Vehicle (1) is connected to a Bowser (2).

Also from this information, it should be understood that the Charging-Bay (6) of the System (200) is not intended to provide a sufficiently fast recharging period for the same Depleted Cell-Module to exit a Vehicle (1), then be conveyed through the Stationary Part (A), for then being sequentially recharged within the Charging-Bay (6), and then be returned to the same Vehicle (1) as a freshly Charged Cell-Module, all within the very short time period that the same Nozzle (3) remains connected to the same Portal (4).

Put another way, Cell-Modules that have been extracted as Deleted Cell-Modules from a Vehicle (1) by a Bowser (2) will not be the same Cell-Modules that will be inserted into that same Vehicle (1) by that same Bowser (2) during the time period that the Bowser's Nozzle (3) is connected to the Vehicle's Portal (4).

FIG. 24 specifically discloses a Fourth Embodiment Enclosed System (200) where the vertically disposed groups of Stepped-Hoppers provide means for there to be more Cell-Modules within the Stationary Part (A) than the total number of available Cell-Module spaces that are provided on the total number of Conveyors within the Stationary Part (A).

To provide means as disclosed above, the Computer-Controllers are tasked with providing four separate priorities or improvements.

The First priority is ensuring that Depleted Cell-Modules are conveyed away from the Bowser (2) area, towards the Charging-Bay (6) area, whether or not a Vehicle (1) is attached the System.

The Second priority is ensuring that the Charging-Bay (6) is maintained with a constant sequential supply of Depleted Cell-Modules (DCM).

The Third priority is ensuring that a sufficient number of Charged Cell-Modules are ready and waiting to be rapidly mass-released from the Bowser (2), towards another Vehicle (1), as soon as its Portal (4) is connected to the Bowser's Nozzle (3).

The Fourth priority is ensuring that a sufficient number of Cell-Modules are temporarily retained within specific Stepper-Hoppers so that the number of Cell-Modules that need to be conveyed on the Enclosed System's Conveyors is never greater than the number of physical spaces available on those Conveyors.

Referring now to the Stepped-Hoppers (H1), (H2) and (H3) and in particular the Lower Stepped-Hopper (H3), it can be seen that the Lower Hopper (H3) is full and that the Hopper's Hopper-Gate (G3) has only just been opened by the Computer-Controllers.

This is evidenced in the drawing, wherein the first four Charged Cell-Modules (CCM) are shown leading the mass-release of a large plurality of Charged Cell-Modules from the Hopper (H3), onto Conveyor (C27).

These released Charged Cell-Modules are shown being conveyed on Conveyor (C27), for then entering the casing of the Bowser (2), in readiness for being conveyed through the Bowser, for then being conveyed by Conveyor (C7) in another Vehicle (1) by sequential metering means, when its Portal (4) is attached the Nozzle (3).

The Upper Stepped-Hopper (H1) is shown with its Hopper-Gate (G1) in the open position and the Central Stepped-Hopper (H2) is shown with its Hopper-Gate (G2) in the closed position, for receiving through-flow Charged Cell-Modules (CCM) from the Charging-Bay (6), via the through-flow facilities thus provided by the Upper Stepped-Hopper (H1).

Importantly, the Central Stepped-Hopper (H2) has a primary function to act as a specialised Transfer-Hopper between the Upper Stepped-Hopper (H1) and the Lower Stepped-Hopper (H3); that will be further disclosed in later Fourth Embodiment drawings.

The FIG. 24 drawing thus discloses a few of many examples of how two separate groups of Stepped-Hoppers, placed either side of a Charging-Bay, may act as both dynamic storage means and on-demand mass-release and mass-receiving means for Fourth Embodiments of the invention.

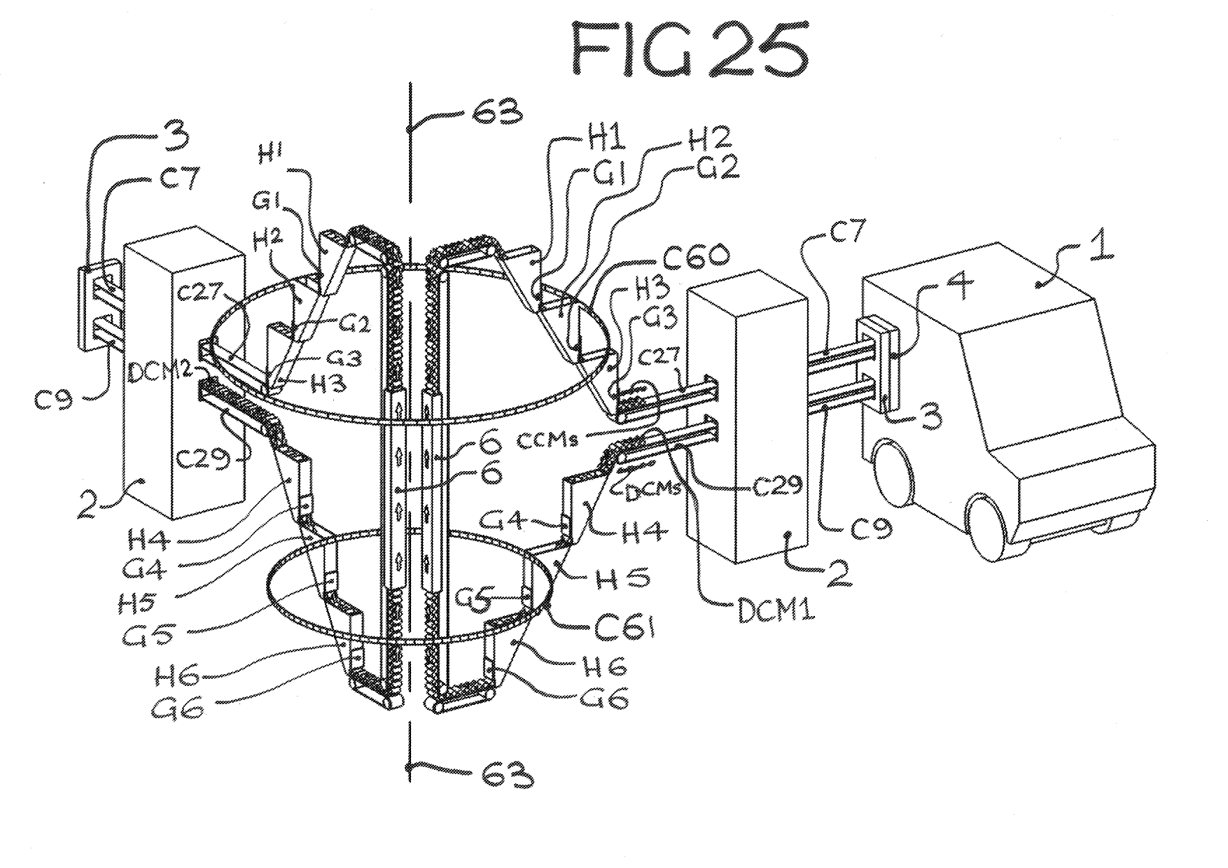

Referring now to the FIG. 25 drawing, a second Computer-Controlled Enclosed System (200) has been placed perpendicular the first Computer-Controlled Enclosed System (200), as disclosed in the FIG. 24 drawing, such that the two Charging-Bays (6) have been placed in close proximity.

The two Systems (200), at first glance, appear to be physically separate Systems.

However, both Systems have been provided with a single Computer-Controller (350), as previously disclosed in at least FIG. 11, that is now being used for synchronising the Computer-Controlled electronic and electro-mechanical functions of both Systems.

Therefore, both Systems (200) are conjoined by the same Computer-Controller.

The Bowser parts of the two Enclosed Systems (200) have been positioned so that they generally radiate from the centrally placed twinned Charging-Bays (6).

For Fourth Embodiments of the invention, the Computer-Controlled synchronising of both Systems (200), by a single Computer-Controller (350), situated within the central Charging-Bay area, rather than inside a Bowser, may provide economic and efficient co-ordination of best Cell-Module through-flow over Second Embodiments of the invention, for also making best use of the total number of available Charged Cell-Modules and Depleted Cell-Modules in both Systems, rather than those Cell-Modules that are separately available in each separate System.

In order that the best through-flow use of the total number of available Charged Cell-Modules and Depleted Cell-Modules for both Systems may be provided in a practical manner, Cell-Modules need to be physically exchanged between the two Systems.

Conveyor means (C60) and (C61), for respective separate horizontal rotation of the Central Stepped-Hoppers (H2) and (H5) are now disclosed, for providing this physical exchange facility between the two Systems such that a more complex, but nevertheless as single enclosed System (200) is maintained.

As previously disclosed, the Stepped-Hopper groupings, (H1), (H2), (H3) and (H4), (H5), (H6) provide sufficient internal volumes to temporarily store large numbers of Cell-Modules, so that they are then available to be released, in a vertical downwards direction.

In this drawing, the Conveyor (C60) provides precise means for the right hand Central Stepped-Hopper (H2) to temporarily store large numbers of Charged Cell-Modules, so that they may then be removed from the right hand System (200) by rotation about axis (63), for then being released directly into the left hand Lower Stepped-Hopper (H3) of the left hand System (200).

The Conveyor (C60) also provides precise means for the left hand Central Stepped-Hopper (H2) to temporarily and separately store large numbers of Charged Cell-Modules, so that they may then be removed from the left hand System (200) by rotation about axis (63), for then being released directly into the right hand Lower Stepped-Hopper (H3) of the right hand System (200).

Synchronously or separately, the Conveyor (C61) provides precise means for the right hand Central Stepped-Hopper (H5) to temporarily store large numbers of Depleted Cell-Modules, so that they may then be removed from the right hand System (200) by rotation about axis (63), for then being released directly into the left hand Lower Stepped-Hopper (H5) of the left hand System (200).

The Conveyor (C61) also provides precise means for the left hand Central Stepped-Hopper (H5) to temporarily and separately store large numbers of Depleted Charged Cell-Modules, so that they may then be removed from the left hand System (200) by rotation about axis (63), for then being released directly into the right hand Lower Stepped-Hopper (H5) of the right hand System (200).

For a Central Stepped-Hopper (H1) and/or (H5) to safely rotate from e.g. the left hand System towards the right hand System, such that Cell-Modules cannot escape the Enclosed System during rotation about axis (63), the Computer-Controller must be further tasked with controlling and co-ordinating each and every Hopper-Gate that is provided on every Stepped-Hopper within each enclosed System.

Referring directly to the drawing, FIG. 25 shows a horizontally disposed circular Conveyor (C60) placed above a horizontally disposed circular Conveyor (C61), such that they share a common vertical axis-of-rotation (63).

The left hand System (200) is positioned relative the position of the right hand System (200) for similar parts of each Central Stepped-Hopper (H1) in each System to be permanently attached the circular Conveyor (C60).

Similarly, the left hand System (200) is positioned relative the position of the right hand System (200) for similar parts of each Central Stepped-Hopper (H5) in each System to be permanently attached the circular Conveyor (C61).

In the drawing, the right hand System (200) shows similar Depleted Cell-Module positions that were disclosed for FIG. 24, except that the Hopper-Gates (G4) and (G5) that were shown closed in the FIG. 24 drawing are now shown as open in this drawing, to provided continued through flow.

Also in the drawing, a new Vehicle (1) is shown having its Portal (4) attached the right hand Nozzle (3) of the right hand System (200), and ready to exchange Depleted Cell-Modules for Charged Cell-Modules.

However, the Computer-Controller has been alerted to a supply shortage of Charged Cell-Modules for the right hand System (200).

The new Vehicle (1) attached the right hand Bowser (2) requires more Charged Cell-Modules to replenish its Cell-Module Chamber than the right hand System (200) has had sufficient time to recharge and return towards that Bowser.

This situation is schematically evidenced in the drawing by observing that the three Stepped-Hoppers (H1), (H2) and (H3) in the right hand System are all shown as being devoid of sufficient numbers of Charged Cell-Modules to send to the right hand Bowser, even though a free through-flow of Charged Cell-Modules, from the topmost parts of the right hand Charging-Bay (6) right through to the front end of the Conveyor (C27), that conveys Charged Cell-Modules directly into the right hand Bowser (2) is clearly shown to be underway.

In such a circumstance, the Computer-Controller is immediately tasked with urgently obtaining Charged Cell-Modules from the currently underused left hand System (200) for mass-delivery to the right hand System, for immediate use by the right hand System.

Referring now to the Upper Stepped-Hopper (H1) within the left hand System, it should be clear that it is almost full of freshly Charged Cell-Modules and that its Hopper-Gate (G1) is shown closed.

It should also be apparent that no Charged Cell-Modules are urgently required to be delivered from the left hand Charging-Bay to its Bowser, as no Vehicle is shown attached the left hand Bowser Nozzle (3).

Referring now to the Lower Stepped-Hopper (H3) within the left hand System, it should be also clear that it is also nearly full of freshly Charged Cell-Modules, ready to be mass-released onto Conveyor (C27), for then being conveyed towards the left hand Bowser (2).

Now referring to the Central Stepped-Hopper (H2) within the left hand System, it should be clear that it is devoid of freshly Charged Cell-Modules and that its Hopper-Gate (G2) is also closed.

From the above three referrals, it should be clear that the Central Stepped-Hopper (H2) in the left hand System (200) is ready to be instructed by the Computer-Controller.

In order to expedite a Charged Cell-Module exchange from the left hand System to the right hand System, the Computer-Controller checks, activates and confirms the following processes.

The Hopper-Gate (G2) of the left hand Central Stepped-Hopper (H2) is closed.

The Hopper-Gate (G1) of the left hand Upper Stepped-Hopper (H1) is opened, to allow a predetermined number of Charged Cell-Modules to flow from the left hand Upper Stepped-Hopper (H1), into the left hand Central Stepped-Hopper (H2).

The left hand Upper Hopper-Gate (G1) is then immediately closed.

Such closure of Gate (G1) provides means for freshly Charged Cell-Modules to still flow into the left hand Upper Stepped-Hopper (H1) whilst also providing Computer-Controlled means for capturing a pre-determined large number of Charged Cell-Modules within the left hand Central Stepped-Hopper (H2).

Synchronous with the above, the Hopper-Gate (G1) of the right hand Upper Stepped-Hopper (H1) is also closed, for temporarily preventing further Charged Cell-Modules from exiting that Hopper, whilst also allowing a continuous supply of freshly Charged Cell-Modules to be sequentially delivered from the right hand Charging-Bay (6), directly into the now-closed right hand Upper Stepped-Hopper (H1).

The Hopper-Gate (G2) of the right hand Central Stepped-Hopper (H2) is temporarily left open, only for allowing the remaining Charged Cell-Modules to pass through the right hand Central Stepped-Hopper (H2).

The Computer-Controller then closes the Hopper-Gate (G2) of the empty right hand Central Hopper (H2).

All the above Computer-Controlled procedures have ensured that; both Central Hoppers (H2) are now closed Hoppers and that; the left hand Central Stepped-Hopper (H2) is full and that the right hand Central Stepped-Hopper (H2) is empty.

The Computer-Controller then activates rotation; for clockwise through 90 degrees; of the circular Conveyor (C60), to which both Hoppers are permanently affixed.

After clockwise rotation through 90 degrees, the previously described left hand Central Stepped-Hopper (H2) is now centered in the precise position that the right hand Central Stepped-Hopper (H2) had previously occupied.

As soon as the newly positioned and newly named right hand Central Hopper (H2) has been positioned between the right hand Upper Stepped-Hopper (H1) and the right hand Lower Stepped-Hopper (H3), the Computer-Controller is ready to open the Hopper-Gate (G2) of the newly named Central Stepped-Hopper (H2), for the Charged Cell-Modules within it, to be mass-released into the right hand Lower Stepped-Hopper (H3) directly below it.

In order that no air gap is left between the left hand Upper Stepped-Hopper (H1) and the left hand Lower Stepped-Hopper (H3), after the Conveyor (C60) has been rotated clockwise through 90 degrees, the Conveyor (C60) is required to have two additional Central Stepped-Hoppers (H2) equidistantly spaced about the Conveyor (C60) and also permanently attached.

Those two additional Central Stepped-Hoppers (H2); that should be shown permanently attached the front part and the left hand part of the circular Conveyor (C60); have been omitted from the drawing, solely to prevent their physical structures from masking other essential features being disclosed behind those positions.

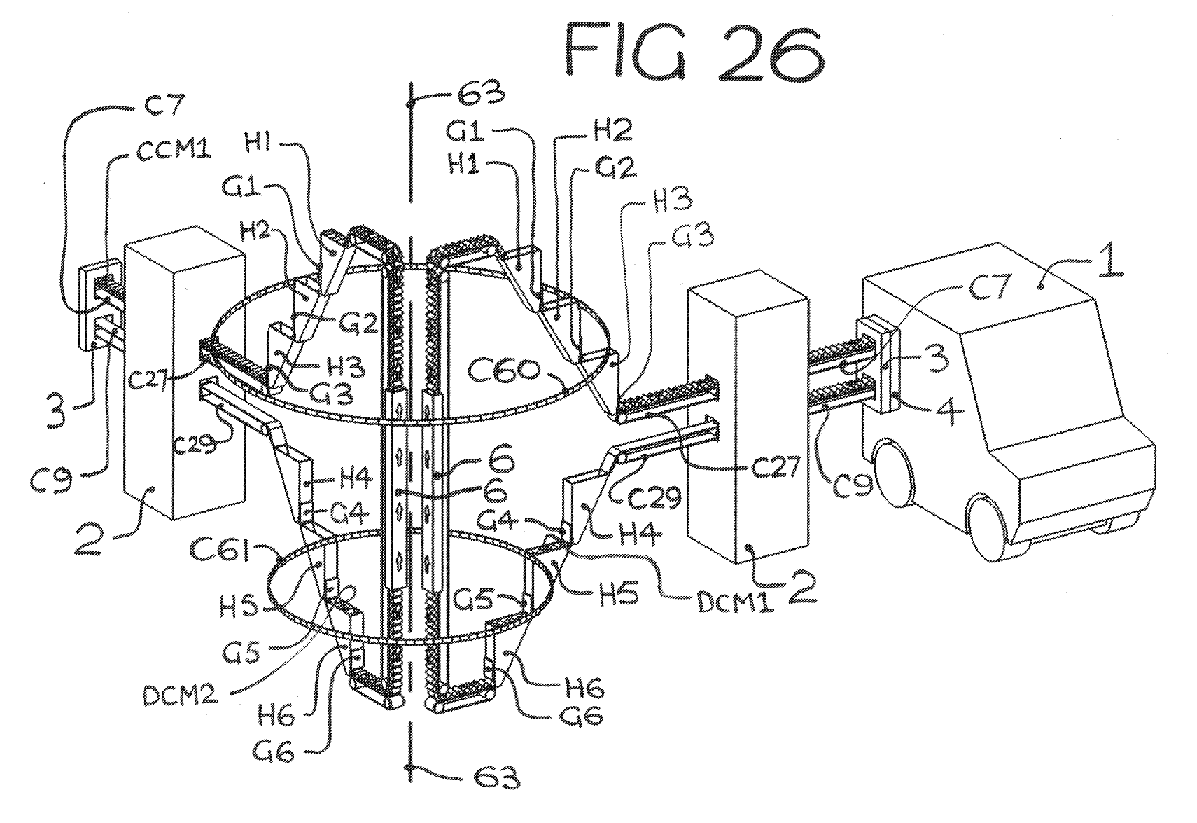

In the FIG. 26 drawing, the Computer-Control of the electro-mechanical functions of all Charged Cell-Module Hoppers and all Charged Cell-Module Conveyors for the left hand System (200) and the right hand System (200) are disclosed as being sequential to the Computer-Control procedures disclosed for FIG. 25.

The Charged Cell-Modules that were shown stored within the full left hand Central Stepped-Hopper (H2) in the previous drawing have now been transferred to the right hand System and mass-released by the newly positioned and newly named right hand Central Hopper (H2) into the open upper portions of the right hand Lower Stepped-Hopper (H3), directly below it.

By referring this sequential drawing with the previous drawing, it can be seen that the four Charged Cell-Modules (CCMs), that in FIG. 25 were shown near the left hand remote end of the right hand Conveyor (C27), adjacent the open right hand Hopper-Gate (G3), have now passed completely along the right hand Conveyor (C27), through the internal parts of the right hand Bowser (2), along the entire length of the right hand Conveyor (C7) and inside Vehicle (1).

Those four Charged Cell-Modules have also been sequentially followed by a large number of the Charged Cell-Modules that had previously been transferred from the left hand System to the right hand System, after they had exited the right hand Lower Stepped-Hopper (H3).

By again referring this sequential drawing to the previous drawing, it can also be seen that the Charged Cell-Modules that were stored in the left hand Lower Stepped-Hopper (H3) have been mass-released from that Hopper (H3) by the Computer-Controller (350) opening the left hand Hopper-Gate (G3).

These first of these mass-released Charged Cell-Modules (CCM1) is now shown just inside the left hand Nozzle (3), ready to be installed within the next Vehicle (1) that will eventually park adjacent the left hand Nozzle (3), for then having its Portal connected to it.

That first Cell-Module (CCM1) is shown in that position, backed up by a queue of many other Charged Cell-Modules that were also mass-released from the left hand Lower Stepped-Bowser (H3), that were then also sequentially conveyed towards the left hand Nozzle (3), after being sequentially conveyed through Bowser (2) onto Conveyor (C7), by Computer-Controlled procedures that have previously been disclosed for the Second Embodiments of the invention.

From further observation of the FIG. 26 drawing, it is apparent that the Conveyors (C7) and (C27) cannot hold any more Charged Cell-Modules or convey any more Charged Cell-Modules towards the left hand Nozzle (3) until another Vehicle (1) has had its Portal (4) attached that left hand Nozzle; and that left hand Nozzle has been activated.

The Computer-Controller has therefore halted rotations of the Charged Cell-Module Conveyors (C7), (C27) and also halted all rotations of all Charged Cell-Module Conveyors that are within the left hand Bowser (2).

The Computer-Controller (350) has additionally closed the left hand Hopper-Gate (G3) to prevent further Charged Cell-Modules from exiting the left hand Lower Stepped-Hopper (H3).

The Computer-Controller has also ensured that both the left hand Hopper-Gate (G2) and the left hand Hopper-Gate (G1) are open, to allow the freshly Charged Cell-Modules shown in the nearly full left hand Upper Stepped-Hopper (H1) to sequentially flow, by gravitational assistance, into the open left hand Central Stepped-Hopper (H2), and then again sequentially flow, by gravitational assistance, through the left hand Central Stepped-Hopper (H2), into the closed left hand Bottom Stepped-Hopper (H3).

When the left hand Lower Stepped-Hopper (H3) is again full, the Computer-Controller closes the left hand Hopper-Gate (G3) for allowing Charged Cell-Modules to now fill the left hand Central Stepped-Hopper (H2).

Thus, the left hand System (200) is ready to provide the next Vehicle (1) that visits the left hand Bowser (2) with sufficient choosable pluralities of small-volume Charged Cell-Modules for the sequential metered replenishment of motive power in a manner that parallels, mimics or improves upon a conventional Bowser's sequential metered replenishment of small volumes of fossil fuel.

It is now necessary to again reference this sequential drawing with the previous drawing, this time with particular regard to Depleted Cell-Module flows.

It can be seen that the right hand Depleted Cell-Module Conveyor (C9), that connects the Vehicle (1) to the right hand Bowser (2); that was devoid of Depleted Cell-Modules in the FIG. 25 drawing; is now entirely populated by Depleted Cell-Modules (DCM) in the FIG. 26 drawing.

Those Depleted Cell-Modules that now populate the right hand Conveyor (C9) have been conveyed out of Vehicle (1) by sequential replenishment procedures that were disclosed for the Second Embodiments of the invention.

It is important to note at this juncture that when the Computer Controller was tasked with transferring Charged Cell-Modules from the left hand System to the right hand System, it was also being tasked with preparing to transfer a similar plurality of Depleted Cell-Modules from the right hand System to the left hand System.

In the previous drawing, the last Depleted Cell-Module (DCM1) that had been conveyed out of a previously replenished Vehicle (1) was shown near the remote left hand end of the right hand Conveyor (C29).

In the FIG. 26 drawing, that same last Depleted Cell-Module (DCM1) has passed into and entirely through the right hand Upper Stepped-Hopper (H4), where it can now be seen at the top of the right hand Central Stepped-Hopper (H5), whose right hand Hopper-Gate (G5) has now been closed by the Computer-Controller.

It can also be seen that the right hand Upper Stepped-Hopper (H4) is now empty, and its Hopper-Gate (G4) has also been closed by the Computer-Controller, in preparation for receiving and temporarily storing the Depleted Cell-Modules that are currently being conveyed out of the Vehicle (1) on the right hand Conveyor (C9).

By again referring briefly to the FIG. 25 drawing, it can be seen that the last of the Depleted Cell-Modules (DCM2); that was previously shown about to exit the rear casing of the left hand Bowser (2), via the furthest remote end of the left hand Conveyor (C29); is now shown in the FIG. 26 drawing having passed entirely through the internal parts of the left hand Upper Stepped-Hopper (H4) and also the internal parts of the left hand Central Stepped-Hopper (H5), where it is now shown near the top of the almost full left hand Lower Stepped-Hopper (H6), adjacent the now closed left hand Hopper-Gate (G5).

By way of the System's Interrogation Sensors, as previously disclosed, having acknowledged that the Depleted Cell-Module (DCM2) has passed through, the left hand Hopper-Gate (G4) of the now empty left hand Upper Hopper (H4) is shown, having been closed by the Computer-Controller.

From the above information, it should be apparent that the empty left hand Central Hopper (H5) and the full right hand Central Hopper (H5) have been made safe, ready to be rotated by the circular Conveyor (C61).

Without the need for a further drawing, it should be apparent that when the full right hand Central Stepped-Hopper (H5) is rotated 90 degrees anti-clockwise by Conveyor (C61), into the position currently occupied by the empty left hand Central Stepped-Hopper (H5), the newly positioned full Hopper (H5) will be able to mass-release Depleted Cell-Modules into the left hand System (200), by the Computer-Controller's automated procedures.

In order that no air gap is left between the right hand Upper Stepped-Hopper (H4) and the right hand Lower Stepped Hopper (H6) when the Conveyor (C61) has rotated the right hand Central Hopper (H5) anti-clockwise through 90 degrees, the Conveyor (C61) is required to have a minimum of four equidistantly spaced Central Hoppers (H1) permanently attached.

The two missing Central Stepped-Hoppers (H5), that should be shown permanently attached the front part and the left hand part of the circular Conveyor (C61), have been omitted from the drawing, solely to prevent their physical structures from masking other essential features being disclosed behind those positions.

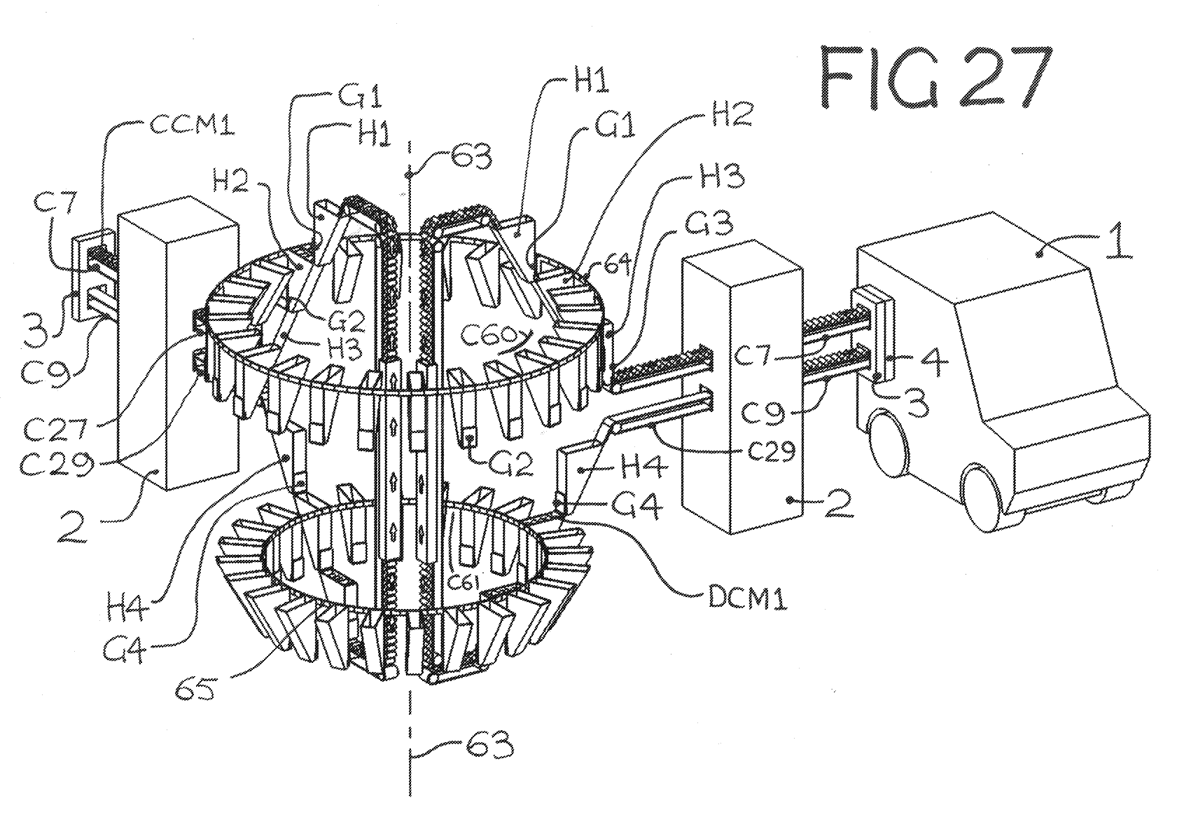

The FIG. 27 drawing discloses additional apparatus and means for the previously disclosed Fourth Embodiments to greatly improve Cell-Module through-flow between a central or hub Charging-Bay (6) and a plurality of Cell-Module dispensing Bowsers (2) that generally radiate from the Charging-Bay.

Specific procedures are disclosed in the drawing for using the additional apparatus; on the one hand to provide specific improvements for increased Cell-Module through-flow within an enclosed System to a place of most need; and on the other hand to minimise or prevent Cell-Module queuing within an enclosed System, by providing specific through-flow safeguards.

The disclosed additional apparatus and means all relate to efficient, economic, fast, reliable and compact means for a central, or hub, Charging-Bay (6), to deliver flexible, on-demand, choosable pluralities of Charged Cell-Module motive power to many different types of Cell-Module powered electric Vehicles (1) that may inconstantly arrive in inconstant numbers at any one of the available plurality of provided Bowsers, for each Vehicle (1) to then require vastly different pluralities of small-volume Charged Cell-Modules to be replenished, via individually metered Cell-Module Bowser provision.

The additional apparatus generally relates to a much-increased number of Central Stepped-Hoppers (H2) and (H5) compared to the minimum number of Central Stepped-Hoppers (H2) and (H5) that were disclosed in the FIG. 26 and the FIG. 27 drawings.

In the FIG. 26 and FIG. 27 drawings a minimum number of Central Stepped-Hoppers were equidistantly attached each of the circular Conveyors (C60) and (C61) for transferring Cell-Modules between the otherwise perpendicularly separated left hand System and right hand System.

In the FIG. 27 drawing, the much-increased number of Central Stepped-Hoppers permanently attached each circular Conveyor is preferably the maximum available number.

The drawing shows 24 Central Stepped-Hoppers (H2) equidistantly spaced about the Circumferential-Band (64) of Circular Conveyor (C60) and also shows 24 Central Stepped-Hoppers (H5) equidistantly spaced about the Circumferential-Band (65) of Circular Conveyor (C61).

An odd number of equidistantly spaced Central Stepped-Hoppers is also an option.

Radial piston engines use an odd number of cylinders; generally five, seven or nine; that are equidistantly disposed about a central crankshaft, for a logical distribution of balanced power strokes about that shaft, for providing efficient power outputs.

By observing the spaces between the 24 equidistantly spaced Hoppers, it should be apparent that a maximum of 48 Hoppers could be attached the disclosed circumference of each Circular Conveyor.

From this observation it should also be apparent that the gaps have been provided between each attached Hopper for better understanding of the workings of numbered apparatus situated directly behind it.

With the exception of the additional Central Stepped-Hoppers (H2) and (H5), the FIG. 27 drawing should be considered as being essentially the same as the FIG. 26 drawing and immediately sequential to it.

Thus, apparatus and Cell-Module positions that have been obscured in the FIG. 27 drawing may be directly referred to in the FIG. 26 drawing.

In the last reference to Charged Cell-Modules for the FIG. 26 drawing, the left hand Upper Stepped-Hopper (H1) had its Hopper-Gate (G1) open for enabling the through flow of Charged Cell-Modules from the left hand Charging-Bay (6) directly into the closed left hand Central Stepped-Hopper (H2).

Since no Vehicle (1) has been connected to the left hand Bowser (2), no Charged Cell-Modules or Charged Cell-Module Conveyors are moving within the Bowser parts of the left hand System.

The Computer-Controller is obliged to enact specific sequences to deal with Charged Cell-Modules continuously falling into the upper open part of the left hand Upper Stepped-Hopper (H1) but unable to leave the Lower Stepped-Hopper (H3).

The Computer is provided with a precise time span for dealing with this situation.

The first half of the precise time span is the time taken for the through-flowing Cell-Modules to fill the closed Central Stepped-Hopper (H1), before the Upper Stepped-Hopper's Hopper-Gate (G1) is automatedly closed.

The second half of the precise time span is the critical-time taken for Charged Cell-Modules to fill the Upper Stepped-Hopper (H1)

The Computer-Controller's time-critical task is therefore to rotate the full left hand Central Stepped-Hopper to a precise new position, so that an empty Central Stepped Hopper that is also attached the Circular Conveyor (C60) immediately replaces it.

The Computer-Controller may only then open the Hopper-Gate (G1) for the Charged Cell-Modules within the Upper Stepped Hopper to be mass-released into the new and empty Central stepped Hopper that is now directly beneath it.

It should be readily understood, from the above time-critical disclosures, that this sequential process may need to be repeated several times, or until another Vehicle (1) uses the left hand Bowser (2), to replenish Cell-Modules.

From these disclosures for FIG. 27, the lateral rotational movement of the Circular Conveyor (C60), to replace a full Central Stepped-Hopper with an empty Central Stepped-Hopper, provides precise through-flow safeguards to physically prevent further Charged Cell-Modules joining a static queue, so that the static queue length is not increased beyond pre-defined acceptable queue lengths.

The specific through-flow safeguards directly relate to the physical diversion of Charged Cell-Modules away from a First-Direction towards a Second-Direction or Subsequent-Direction.

The physical rotation of Charged Cell-Modules away from a First-Direction to a Second-Direction is provided by a much larger plurality of rotatable Central Stepped-Hoppers (H2) than the minimum number of equidistantly spaced and permanently attached Central Stepped-Hoppers (H2) that were disclosed in FIG. 25 and in FIG. 26.

The first improvement concerns a large plurality of Central Stepped-Hoppers (H2) that are each shown equidistantly spaced in close proximity to each other and permanently attached a horizontally disposed circular Conveyor (C60).

Each Central Stepped-Stepped Hopper (H2) is provided with a Computer-Controlled Hopper-Gate (G2) that can be independently opened or closed by the Computer-Controller only when a Central Stepped-Hopper (H2) is positioned directly above a Lower Stepped-Hopper (H3).

The second improvement concerns providing continuous means for a continuous flow of freshly Charged Cell-Modules, that would normally flow in a downward vertical direction towards a Cell-Module dispensing Bowser (2), to optionally be temporarily retained within one of the larger plurality of closed rotatable Central Stepped-Hoppers (H2), for then being horizontally rotated from a First-Direction, to a Second-Direction, for temporarily holding at that Second-Direction position.

From all the information provided for FIG. 27, it should be understood that when a circular Conveyor (C60) is being rotated, the Upper Hopper-Gates (G1) must be closed and that when a circular Conveyor (C60) is being rotated, the Upper Hopper-Gates (G1) must be closed.

These improvements and safeguards are first provided by a much larger plurality of rotatable Central Stepped-Hoppers (H2) than the minimum number of equidistantly spaced and permanently attached Central Stepped-Hoppers (H2) that were disclosed in FIG. 25 and in FIG. 26.

This much larger plurality of equidistantly spaced Central Stepped-Hoppers (H2), provides precise means for the temporary lateral storing of a very large number of Charged Cell-Modules.

It should be apparent, from the FIG. 26 drawing, that if no more Charged Cell-Modules can exit the left hand Central Stepped-Hopper (H2) and that if Charged Cell-Modules are still flowing from the Charging-Bay (6) into the left hand Upper and Central Stepped-Hoppers (H1) and (H2), that the only option available for the Computer Controller (350) to prevent eventual Cell-Module overflow, is to halt rotation of the left hand Charging-Bay (6).

The Computer-Controller will be programmed with the ability to undertake this ultimate Failsafe task.

However, such halting of rotation of the left hand Charging-Bay is not beneficial to maintaining a through-flow System (200) and means are now addressed for resolving this situation.

Referring now to the FIG. 27 drawing, sequential disclosures are provided for preventing eventual Cell-Module overflow by providing essential Cell-Module overflow storage facilities.

A plurality of Central Stepped-Hoppers (H2) is shown attached the circular Conveyor (C60), for the temporary lateral storage of Charged Cell-Modules that are continuously being supplied by the left hand Charging-Bay (6).

Returning briefly to the FIG. 25 and FIG. 26 drawings, the use of four rotatable Central Stepped-Hoppers (H2) and (H5) offered a very small number of arithmetically possible alternatives to rotating the circular Conveyors (C60) and (C61) through only 90 degrees.

For the Fourth Embodiment improvements shown in the FIG. 27 drawing, the use of twenty-four rotatable Central Stepped-Hoppers (H2) and (H5), on the respective circular Conveyors (C60) and (C61) provide many millions of arithmetically possible routes for finding optimal means for a central or hub Charging-Bay (6) to receive, store, move and distribute Cell-Modules to and from radial positions.

The third specific improvement therefore relates to the use of Computer-Control logistics software for calculating current positions of Cell-Modules within the System (220) and separately within a Fourth Embodiments Charging-Bay (6) for best route planning of those Cell-Modules' next positions.

Logistics companies use different types of complex computer programs for determining the most efficient way of delivering goods from a central base to a plurality of customers who are all seen as being radially placed, relative to the base position of their warehouse or warehouses.

These computer programs are used for discovering or optimising best sequential routes out of many millions of different route choices and are generically referred to as ‘the travelling salesman problem’ or ‘ant colony optimisation routes’ that also consider issues including high demand periods, low demand periods, public holidays and weather predictions.

Such programs are also known as ‘self learning programs’ that are more generally used for time saving and/or fuel saving in the most diverse industries; from truck deliveries of products between a home base and distant cities to gravitational slingshots of data gathering satellites from an Earth base to distant planets.

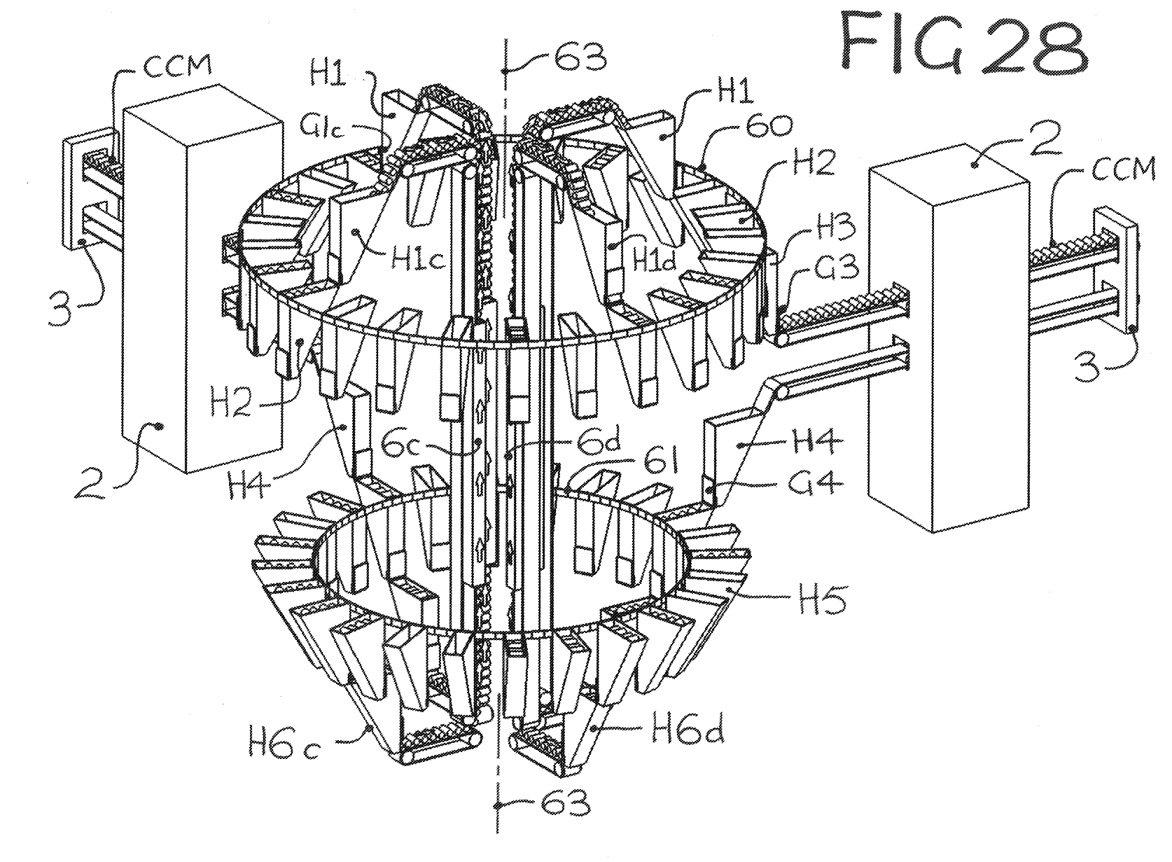

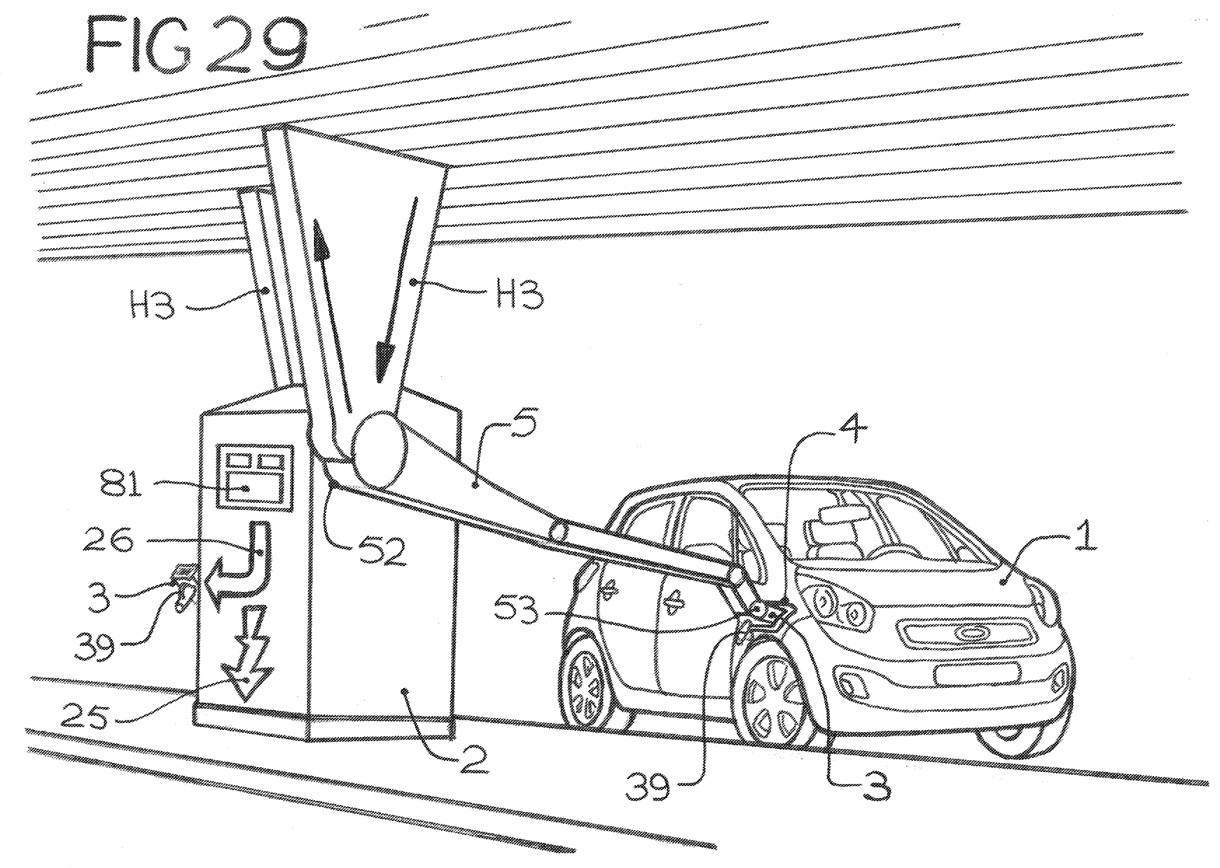

The FIG. 28 drawing discloses additional apparatus and know-how to the disclosures for the FIG. 27 drawing; and also represents a time period some time after the disclosures for the FIG. 27 drawing.

The drawing shows that no Vehicle has been attached either Bowser (2) for sufficient periods; for Depleted Cell-Modules to have been cleared from Conveyors that are adjacent or within the Bowsers and; for a complete supply of Charged Cell-Modules to have been delivered to each Nozzle (3) as disclosed for the FIG. 27 drawing.

For this drawing, proprietary or prior art logistics-software, for use as disclosed in the previous drawing, has been provided the Computer-Controller, for it to have made a great number of autonomous decisions on planning and then instigating best through-flows of all Cell-Modules within the System (200), especially best through-flows of all Cell-Modules within the Stationary Part (A) of the System.

The Computer-Controller's logistic software has taken account of all Cell-Module transactions that have taken place between Vehicles (1) that have made use of the left hand Bowser and the right hand Bowser, in the time period that has passed between the two drawings.

The drawing therefore shows significant pluralities of Charged Cell-Modules temporarily stored in some of the 24 Central Stepped-Hoppers (H2) and also shows significant pluralities of Depleted Cell-Modules temporarily stored in some of the 24 Central Stepped-Hoppers (H5).

Referring first to the Circular Conveyor (C60), the Computer-Controller's logistics-software has directed a large plurality of Charged Cell-Modules to be temporarily stored in some of the closed Central Stepped-Hoppers (H2), so that those temporarily stored Charged Cell-Modules are ready and waiting to be rotated towards a Lower Stepped-Hopper (H3), for being mass-released into that Hopper (H3) for then being immediately conveyed towards the Bowser (2), as soon as it requires them.

Referring secondly to the Circular Conveyor (C61), the Computer-Controller's logistics-software has independently directed a large plurality of Charged Cell-Modules to be temporarily stored in some of the closed Central Stepped-Hoppers (H5), so that those temporarily stored Depleted Cell-Modules are ready and waiting to be directed towards a Lower Stepped-Hopper (H6), for then being mass-released into that Hopper (H6), for then being conveyed towards a Charging-Bay (6) as soon as it requires them.

The drawing also shows additional apparatus in the form of two extra Charging-Bays (6c) and (6d) that are specifically not radially aligned with a Bowser.

The additional Charging-Bays (6c) and (6d) have been positioned about the vertical axis-of-rotation (63), such that all four Charging-Bays are now equidistantly spaced about it.

The Charging-Bays (6c) and (6d) have been provided to assist in best-flow logistics management, especially the complex logistics of through-flow of Depleted Cell-Modules towards the Charging-Bays during peak periods or unexpected excessive periods of Cell-Module Bowser use, in order that the already stored supply of constantly available Charged Cell-Modules is not diminished.

The Charging-Bay (6c) is therefore only provided with a Lower Stepped-Hopper (H6c) that cannot receive Depleted Cell-Modules by through-flow from a Bowser, but only from a Central Stepped-Hopper (H5) that already has Depleted Cell-Modules temporarily stored therein.

The Charging-Bay (6c) is also only provided with an Upper Stepped-Hopper (H1c) that cannot deliver Charged Cell-Modules by direct through-flow through an open empty Central Stepped-Hopper towards a Bowser, but only into an empty Central Stepped-Hopper (H5) that has been rotated to be directly underneath it, for the temporary storage of Cell-Modules therein.

From the above disclosures for Charging-Bay (6c) it should be apparent that the same disclosures are directly applicable for Charging-Bay (6d).

With reference to the Fourth Embodiments drawings disclosed thus far, no provision has been disclosed for a Fourth Embodiments System (200) to receive new Cell-Modules or Charged Cell-Modules from a source outside the System or also to send Depleted Cell-Modules to an outside source for recharging there.

It should be most apparent, without the need for a further drawing, that an enclosed Conveyor from an outside source may readily deliver required pluralities of new Cell-Modules or freshly Charged Cell-Modules directly into any empty Central Stepped-Hopper H2), under the control of the logistics-software.

It should similarly be most apparent, without the need for a further drawing, that an enclosed Conveyor from an outside source may also readily remove required pluralities of Depleted Cell-Modules, also under the control of the logistics-software, by the use of an additional Lower Stepped-Hopper (H6) that is placed directly beneath any Central Stepped-Hopper (H5), where a fixed Lower Stepped-Hopper (H6) is not already positioned.

Fourth Embodiments thus provide a System (200) with the optimum number of rotatable Central Stepped-Hoppers (H2) and (H5), for providing an extensive range of facilities for the most efficient, economic and compact means for exchanging Cell-Modules between an expandable plurality of Systems.

Fourth Embodiments also provide precise means by which a vary large number of Charged Cell-Modules (CCM) and optionally, a similar very large number of Depleted Cell-Modules (DCM) may be stored within a central, or hub, Charging-Bay area, ready for immediate deployment to a position of urgent need.

Fourth Embodiments also provide improved means for a very large number of Charged Cell-Modules to be stored and ready for use within a central storage facility near a plurality of Cell-Module dispensing Bowsers (2), for the sequentially metered replenishment of motive power to a Cell-Module powered electric Vehicle (1), in a manner that parallels, mimics or improves upon the means by which small volumes of fossil fuel are stored and ready for use within a central storage facility near a plurality of conventional dispensing bowsers, for the sequentially metered replenishment of fossil fuel to fossil fuel powered vehicles.

In all the Fourth Embodiments drawings disclosed thus far, a left hand Bowser (2) and a right hand Bowser (2) was used to describe a plurality of Bowsers radiating from a central or hub Charging-Bay (6).

It should be understood, without the need for a further drawing, that a greater plurality than two Bowsers is possible and sometimes preferable.

It should also be understood, without the need for a further drawing, that if the Circular Conveyors (C60) and (C61) were changed to become Elongate Conveyors (C60) and (C61), for example taking the elongate form of Conveyor (C29), that Bowsers may be also be adjacently distributed in elongate form, as is globally known for conventional Service Station bowsers.

It should also be importantly understood from the Fourth Embodiments drawings that if the Conveyors (C60) and (C61) and their associated Stepped-Hoppers were respectively positioned at sufficient heights above an adjacently parked Vehicle's ground level, and sufficient depths below an adjacently parked Vehicle's ground level, essential parts of a central or hub Charging-Bay (6) could be incorporated within the roof void or within the hollow ground void of an otherwise conventional roofed Service Station area.

FIG. 29 is an in-situ visualisation of a Second Embodiments Cell-Module dispensing Bowser (2) that also incorporates Fourth Embodiments of the invention.

The Bowser has been given a general outer appearance of a conventional fossil fuel dispensing bowser that is further exemplified by being installed on what appears to be a conventional forecourt separation plinth beneath a specially manufactured roof-void that also has the outer visual appearance of being a conventionally roofed roadside Service Station environment.

The Pipe (5) may optionally be provided with proprietary or conventional weight and inertia counterbalancing mechanisms for enabling ease of use of movement of the Nozzle (3), when the Nozzle end of the Cell-Module containing Pipe (5) is being manipulated by the user, away from the Bowser, towards the Vehicle's Portal (4).

The Pipe has been schematically visualised in the drawing as a multi-jointed swinging arm device.

However, other types of Flexible-Pipe (5) or Articulated-Pipe (5) are applicable for use with the invention.

In the drawing the Nozzle (3) has been shown inserted in the Portal (4) of the adjacently parked Vehicle (1).

The Bowser, its Pipe, the user friendly Nozzle and the environment that the other non visible parts of the Stationary Part (A) have been installed within, are thus purposely visualised to parallel, mimic or improve upon the globally established functions and globally accepted visualizations of a conventional bowser that has been installed within a conventional forecourt environment.

The Bowser casing thus provides all drivers and riders of road vehicles with other required or expected needs that are readily understandable; including an exampled Trade Logo (25), an information Graphic (26) and a Data Display Screen (81), as also disclosed for the Second Embodiments.

The remote end (52) of Flexible Pipe (5) is shown affixed the side casing of the Bowser, as also disclosed for the First and Second Embodiments of the invention.

No practical teachings for flexing the outer parts of a Flexible Cell-Module dispensing Pipe (5) in three dimensions, between the Bowser (2) and a Vehicle's Portal (4), are disclosed in the drawing.

The rotatable joints therefore represent just some examples of methods of accurately and safely positioning the Nozzle (3) within a Portal (4) after the user has removed the Nozzle from its parked position on the Bowser.

Additionally, the different adjacent parking distances of a Vehicle (1) adjacent a Bowser (2), vis-à-vis similar different adjacent parking distances known for parking a conventional fossil fuel vehicle adjacent a conventional fossil fuel bowser, will also be applicable; for the Nozzle (3) of a Pipe (5) to be inserted in the diverse physical positions of a Portal (4) on the outer bodywork of a diverse range of Cell-Module powered electric Vehicles (1).

The remote end (53) of Flexible Pipe (5) furthest from the Bowser is shown affixed the outer casing of a Cell-Module Insertion Nozzle (3), as also disclosed for the First and Second Embodiments.

In the drawing, the top parts of a Lower Stepped-Hopper (H3), as disclosed in previous Fourth Embodiments drawings, are shown affixed certain ceiling portions of the roofed Service Station, directly above the Cell-Module dispensing Bowser (2).

This disclosure provides additional means for the enclosed void (not shown) between the ceiling and the roof of the Service Station to serve as an optional installation position for at least the Circular Conveyor (C60) parts of a central or hub Cell-Module Charging Bay (6), as previously disclosed, for using the Service-Station roof void to assist in providing gravitational assistance in the mass-delivery of Charged Cell-Modules to a plurality of radially positioned Bowsers (2).

The lower rear parts of the outer casing of a Lower Stepped-Hopper (H3) are shown affixed the nearest side of the casing of the Bowser (2), such that Charged Cell-Modules may be temporarily stored therein, ready for being mass-released towards a Vehicle (1), via a Pipe (5), as indicated by the downward pointing arrow on the outer casing of Hopper (H3).

The Lower Stepped-Hopper (H3) has been internally provided with a Hopper-Gate (G3), not shown but as previously disclosed, for the precise purposes of being closed to temporarily store Charged Cell-Modules close to the place of required delivery and; being opened by Trigger (39), for activating the Computer-Controller to provide the unimpeded sequential flow-through of Charged Cell-Modules (100) along the full length of Pipe (5), according to the teachings of the First and Second Embodiments.

Affixed inside the casing of Bowser (2), and therefore also not shown in this drawing, is an Upper Stepped-Hopper (H4), as disclosed in previous Fourth Embodiments drawings.

Entirely dependent on the required physical layout of the Charging-Bay (6), not shown, Depleted Cell-Modules (100) may be conveyed in a downwards direction, away from Hopper (H4), into an enclosed floor void beneath the Bowser (2), or conveyed upwards, away from Hopper (H4), into the enclosed roof void above the Bowser (2).

In the more economic provisions of such a Bowser, an internal portion of Stepped-Hopper (H3), furthest from the Vehicle (1), may be physically separated to provide internal Conveyor means for conveying Depleted Cell-Modules (100), that have been previously emptied into Hopper (H4), away from Hopper (H4) in an upwards direction towards the roof void, as indicated by the upwards pointing arrow on the outside casing of Hopper (H3).

Where Depleted Cell-Modules (100) are conveyed away from a Hopper (H4) in a downwards direction, a Circular Conveyor (C61), as disclosed in previous Fourth Embodiments drawings, will necessitate the Circular Conveyor (C61) being installed beneath the floor area of the Service Station.

Where Depleted Cell-Modules (100) are conveyed away from a Hopper (H4) in an upwards direction, a Circular Conveyor (C61), as disclosed in previous Fourth Embodiments drawings, will necessitate the Circular Conveyor (C61) also being installed concentric the Circular Conveyor (C60), within the enclosed roof void above the Service Station area.

Referring again to the Vehicle (1), the Nozzle (3) is shown temporarily but securely inserted within a Nozzle Receiving Portal (4) that has been installed within the outer bodywork of the parked Vehicle, in a manner that again parallels, mimics or improves upon a conventional fossil fuel nozzle inserted in the insertion portal of a conventional vehicle.

The drawing shows the Vehicle's insertion Portal (4) attached the front part of the Vehicle's outer bodywork, to signify that a Portal (4) may be installed on any part of the Vehicle's outer bodywork, as well as the conventional positions known for fossil fuel portals.

The drawing portrays a moment just before the Nozzle Trigger (39) is activated, for Charged Cell-Modules to sequentially flow from the Bowser towards the Vehicle and, Depleted Cell-Modules to sequentially flow from the Vehicle towards the Bowser.

Before leaving this drawing, it is necessary to disclose that a separate Lower Stepped-Hopper (H3) and a separate Cell-Module Insertion Nozzle (3) with Trigger (39) have also been provided adjacent the far face of the casing of Bowser (2).

The second Nozzle (3) is shown in its latched or stored position on the Bowser, just as a conventional nozzle has a latched or stored position on a conventional bowser.

From this information, it should be apparent that the Bowser (2) could readily be provided with two opposed front faces, wherein each opposed face is also provided with a Logo (25), a Graphic (26) and a Display Screen (81); when another Vehicle (1), has parked on the other side of the forecourt separation plinth, to also be independently replenished.

And from this information, it should again be apparent that the Bowser (2) provides yet more means to parallel, mimic or improve upon a conventional double-faced bowser having two opposed faces, also installed on a conventional forecourt separation plinth.

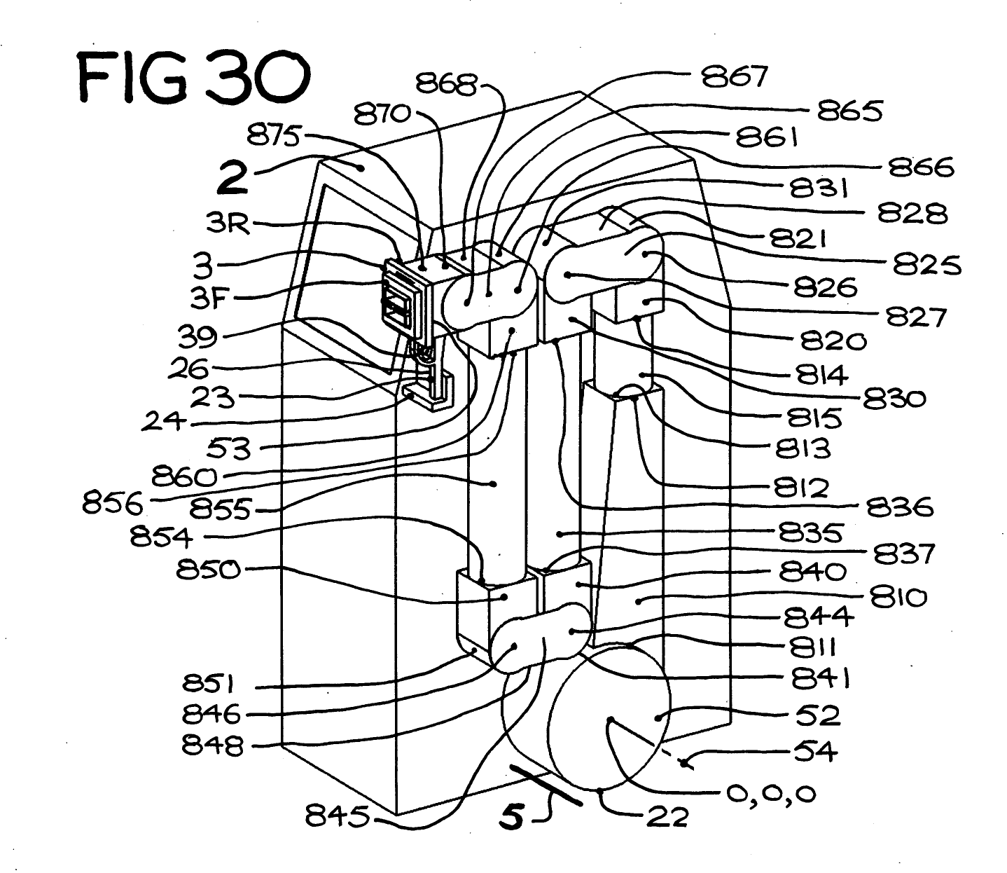

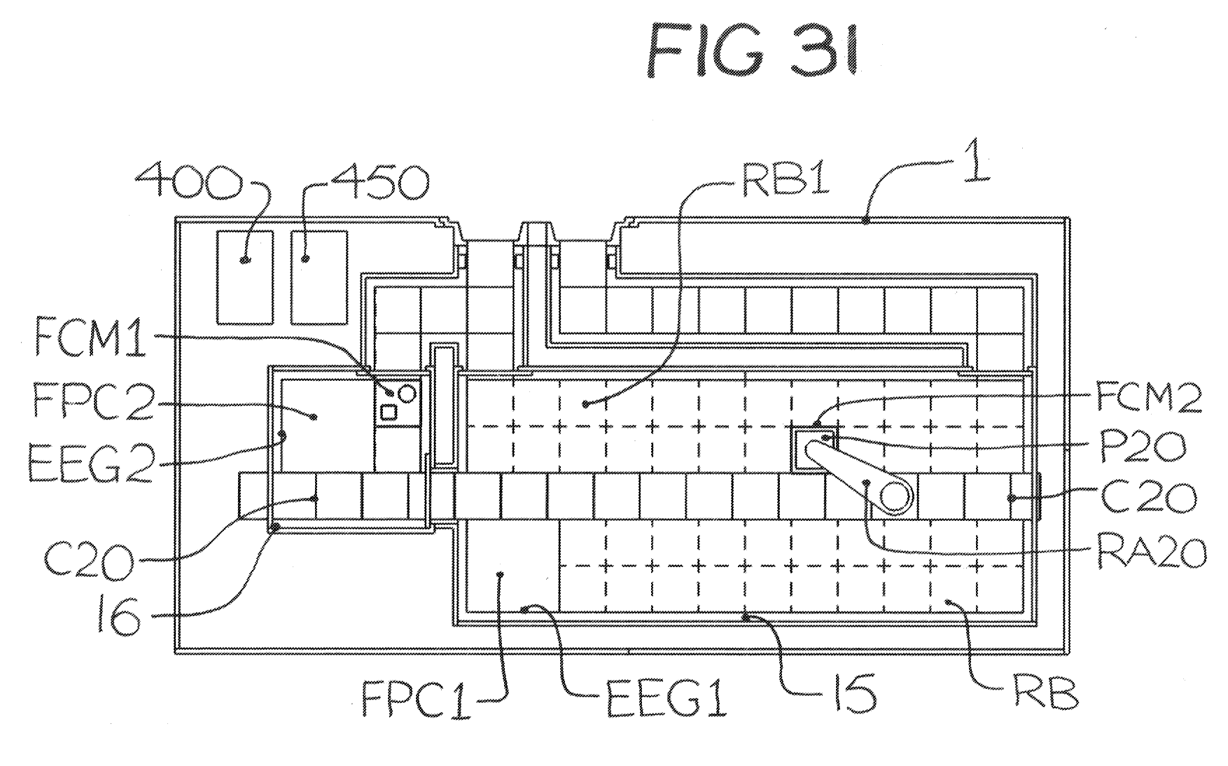

FIG. 30 shows in much greater detail a Flexible-Pipe (5) of the invention, as generally disclosed for FIG. 29, except that in the present drawing, the entire Pipe has been inverted, for the Remote-End (52) to now be shown rotatably installed near the base of the Bowser (2).

The Pipe (5) is again of hollow robotic arm type, as generally disclosed in FIG. 29, for moving its remote-end (53); that is rotatably affixed the Nozzle (3); to and from a substantial variety of Computer-Controlled power-assisted positions in three-dimensional space with respect to its other remote-end (52); that is rotatably affixed the rigid casing of the Bowser (2).

The Remote-Ends (52) and (53) of Pipe (5) are respectively shown in their Precise-Rest-Positions (22) and (23), when the Nozzle-Manipulation-Handle (26), attached the casing of Nozzle (3), has been placed in its Bowser-Holster (24), when no longer in use.

The hollow Remote-End (52) of Pipe (5) is shown as a hollow cylinder that has been rotatably affixed the lower parts of the Bowser's right hand casing, for being rotated about a horizontal axis-of-rotation (54).

The Lower-End (811) of a hollow, vertically disposed Lower-Elongate-Arm (810) is shown rigidly affixed the outer casing of Remote-End (52).

The Upper-End (812) of the Elongate-Arm (810) is shown rotatably attached the Lower-End (813) of an Upper-Elongate-Arm (815).

The Upper-End (814) of Upper-Elongate-Arm (815) is shown rigidly attached the Lower-End of a Hollow-Joint (820).

The upper Joint-End (821) of the Hollow-Joint (820) is shown rotatably attached the right-hand Joint-End (826) of a First-Rotator (825).

The First-Rotator (825) has been provided with a horizontally disposed Planar-Surface (828), that the Computer-Controlled electro-mechanical robotics have been instructed to maintain, as always horizontally disposed, when any part of the robotic arm (5) is being moved.

The left-hand Joint-End (827) of First-Rotator (825) is shown rotatably affixed the upper Joint-End (831) of a Hollow-Joint (830).

The lower end of Hollow-Joint (830) is shown rigidly attached the Upper-End (836) of an Elongate-Hollow-Arm (835).

The Lower-End (837) of Elongate-Arm (835) is shown rotatably attached the Upper-End of a Hollow-Joint (840).

The lower Joint-End (841) of the Hollow-Joint (840) is shown rotatably attached the right-hand Joint-End (844) of a Second-Rotator (845).

The Second-Rotator (845) has been provided with a horizontally disposed Planar-Surface (848), that the Computer-Controlled electro-mechanical robotics have been instructed to maintain, as always horizontally disposed, when any part of the robotic arm (5) is being moved.

The left-hand Joint-End (846) of Second-Rotator (845) is shown rotatably affixed the lower Joint-End (851) of a Hollow-Joint (850).

The upper end of Hollow-Joint (850) is shown rotatably attached the Lower-End (854) of an Elongate-Hollow-Arm (855).

The Upper-End (856) of Elongate-Arm (855) is shown rigidly attached the Lower-End of a Hollow-Joint (860).

The upper Joint-End (861) of the Hollow-Joint (860) is shown rotatably attached the right-hand Joint-End (866) of a Third-Rotator (865).

The Third-Rotator (865) has been provided with a horizontally disposed Planar-Surface (868), that the Computer-Controlled electro-mechanical robotics have been instructed to maintain, as always horizontally disposed, when any part of the robotic arm (5) is being moved.

The left-hand Joint-End (867) of Third-Rotator (865) is shown rotatably affixed the right hand Joint-End (870) of a Nozzle-Connector (875).

The left-hand Remote-End (3R) of Nozzle-Connector (875) is rotatably affixed the rearmost portions of the Nozzle (3) casing, for also providing the Pipe (5) and the Nozzle with an optional Yaw rotation.

Computer-Controlled electro-mechanical means for individually and jointly maintaining of the Planar-Surfaces (828), (848) and (868) in a horizontal plane during the complex moves of the various joint and arm articulations, when the Pipe (5) is being complexly manipulated, will provide precise triangulation means for determining the position, direction and inclination of the Nozzle (3) with respect to each Planar-Surface and a Nodal-Point (0,0,0), set on the fixed position of the axis-of-rotation (54) of Remote-End (52).

Sensors installed on or near the three Planar-Surfaces may additionally provide constant triangulation calculations, for transmission to the Computer-Controllers (350) and (450), not shown, for additional feedback relating to all necessary aspects of a safe refuelling procedure.

Thus, all the jointed hollow parts between the Front-Face (3F) of Nozzle (3) and the Nodal-Point (0,0,0) of the Pipe's Remote-End (52) are able to use suitable Computer-Controlled algorithms, in conjunction with known robotics power assistance know-how, for the user of a Nozzle (3) to manoeuvre the heavy Pipe (5) towards the Portal of an adjacently parked Vehicle (1), with the same ease and experience that he has previously learned and used to manoeuvre the nozzle of a fossil fuel bowser towards the portal of a conventional vehicle.

The FIG. 30 drawing thus discloses details for a Pipe (5) of the articulated hollow arm and hollow joint type, for sequentially conveying Cell-Modules within.

It should be apparent to a skilled reader that other types of practical Flexible-Pipe (5) between a Bowser (2) and a Nozzle (3) would also be suitable for the invention.

A first example of a suitable Pipe (5) incorporates the novel adaptation of the various vacuum tube systems that were invented and commercialized in the late nineteenth and early twentieth century for distributing cash within department stores.

Use of such novel adaptations may be limited to vacuum tube operation between the Bowser and the Nozzle or may be novelly adapted to move Cell-Modules within a Vehicle's Cell-Chamber or between other parts within an entire System (200).

A second example incorporates the novel adaptation of the tapered bottomless bucket system, for the gravitational removal of rubble from the top parts of a building site, directly into a dumpster at ground level.

Novel adaptations of such interfitting bottomless and topless structures may eventually provide more economic means than an articulated hollow arm type of Flexible-Pipe (5) for conveying Cell-Modules within.

A third example incorporates novel adaptations of three dimensional chain-type conveyors moving through the hollow parts of a flexible hose, similar to the type of flexible hose that is currently incorporated between a conventional bowser and a conventional fossil fuel nozzle.

Novel adaptations of such flexible hoses will provide further means for a System (200) to parallel, mimic or improve upon the globally established means by which fossil fuel is now expected to be bowser replenished.

### Fifth Embodiments

The Fifth Embodiments of the invention particularly relate to Computer-Controlled Robotics installed within the Cell-Module Chambers (15) and (16) of a Vehicle (1), including for the emergency removal of a potentially overheating or already overheating Cell-Module from a through-flow part of a System (200) that is inaccessible to human reach.

This overheating phenomenon is known as thermal propagation that may lead to a progressively disastrous situation known as thermal runaway.

It is well known, from many examples of practical use of lithium-ion batteries, including small-volume lithium-ion rechargeable cells of the type that may be incorporated for use as Cell-Modules (100) within a System (200) of the present invention, that their casings are prone to age-old casing distortion issues and casing fracture issues that can cause serious fire or explosion hazards.

From the days of steam based motive power; when experience based know-how determined that a hollow cylinder, rather than a hollow sphere, provided the second-best choice, but offered the most economic production means, for containing the maximum steam pressure and volume, using the least amount of materials; cylindrical encasements have dominated many industrial processes.

It is therefore no co-incidence that small-volume rechargeable lithium-ion cells, now dominant in electric vehicle developments, are cylindrical and not spherical.

However, when an excessive electrical input or output is placed upon an individual lithium-ion rechargeable cell, excessive heat build-up can occur within that cell, for that heat build-up to also be transferred to closely packed neighbouring cells.

This excessive heat build-up may be due to excessive over-charging of depleted lithium-ion cells, or excessive power extraction from charged lithium-ion cells, and is known to begin a process of oxygen gas production within the overheating cell.

The increasing gas pressure generated from continued oxygen production can cause a physical bulging of the cell's cylindrical metal casing; that in essence, tries to turn that casing from cylindrical to spherical—a disastrous pressure increase situation that dates back to the steam age.

This pressure-based bulging of a rechargeable cell may in turn lead to metal fatigue in the casing.

Further oxygen gas generation can then cause fracture of the already deformed and degraded casing, often resulting in a spark being generated at the moment of metal fracture, which immediately ignites the escaping pressurised oxygen, causing fire and/or explosion.

Even if fracture, fire or explosion has not occurred in such a thermal propagation or thermal runaway cell, the physical bulging of that cell's metal casing will have a serious detrimental effect on the ability of that distorted cell or that distorted Cell-Module to then be conveyed through a practical System (200) of the invention, for normal procedures for being removed from the System, even if that cell could first be successfully cooled by known means.

And since a log jam, caused by just one distorted Cell-Module within any part of the Computer-Controlled logistics based automated through-flow System (200) could debilitate or compromise the entire System, solutions are now disclosed.

FIG. 31 is a schematic down-view of a Second Embodiments Vehicle (1) that has had new Fifth Embodiments apparatus incorporated in its Cell-Module Chambers (15) and (16), for the emergency removal of a deformed Cell-Module (100) from the through-flow parts of a Cell-Module powered Vehicle (1).

The new apparatus concerns a Fire-Proof-Chamber (FPC1) that has been installed within the Main-Chamber (15), in a position previously occupied by four Cell-Module Receiving-Bays (RB).

The new apparatus also concerns a Fire-Proof-Chamber (FPC2) that has been installed within the Thermal-Safety-Chamber (16), in a position previously occupied by four Cell-Module Receiving-Bays (RB).

Each Fire-Proof-Chamber is provided with a Computer-Controlled Fire-Proof Emergency-Exit-Gate (EEG1), (EEG2) for isolating and sealing a suspect Cell-Module inside the Fire-Proof-Chamber.

The drawing shows a Faulty Cell-Module (FCM1) installed within the Thermal-Safety-Chamber (16).

The Faulty Cell-Module is functionally similar to previously disclosed Cell-Modules, including the Faulty Cell-Modules disclosed for the First Embodiments, but in this drawing have additionally been provided with a square Positive-Terminal and a circular Negative-Terminal.

That Faulty Cell-Module (FCM1) has been recently conveyed to that installed position, by the Computer-Controller (450) previously instructing the Robotic-Arm (RA20), to move it from its previous position, installed within the Receiving-Bay (RB1) of Main-Chamber (15) to its present position.

The Computer-Controller has also deemed a second Faulty Cell-Module (FCM2) to be faulty and the drawing shows that the Robotic-Arm (RA 20) has been positioned and readied for removing it from its Receiving-Bay within Main-Chamber (15) and conveying it towards and into Thermal-Safety-Chamber (16).

The Pick-Up Pad (P20) has made gripping contact with the upper parts of Faulty Cell-Module (FCM1).

Heat Sensors attached the underneath face of Pick-Up Pad (P20) have informed the Computer-Controller (450) that the surface temperature of the Cell-Module it is testing, is above the temperature parameters acceptable for a Faulty Cell-Module.

The Computer-Controller has therefore issued new instructions to the Robotic-Arm.

The Robotic-Arm will no longer convey the Faulty Cell-Module (FCM2) into the Thermal-Safety-Chamber (16), as was undertaken for the previous Faulty Cell-Module (FCM1).

The temperature readings received by the Computer-Controller from the Pick-Up-Pad Computer have upgraded the Cell-Module's status from being a Faulty Cell-Module (FCM2), to being a Safety-Risk Cell-Module (SRCM).

The Robotic-Arm (RA 20) will therefore now convey the Safety-Risk Cell-Module directly towards the Emergency-Escape-Gate (EEG1) that has been installed within the Cell-Module Chamber (15).

A Fifth Embodiments definition of a Safety-Risk Cell-Module (SRCM) is an overheating Cell-Module that has no outward signs of physical distortion from the norm.

However, since its external temperature is above pre-determined safety algorithms, it external casing structure is no longer rated as being viable for sequential through-flow within any part of a System (200).

The Computer-Controller has therefore opened the Emergency-Exit-Gate (EEG1), ready for the Robotic-Arm to place the Safety-Risk Cell-Module (SRCM) into the Fire-Proof-Chamber (FPC1) directly below it.

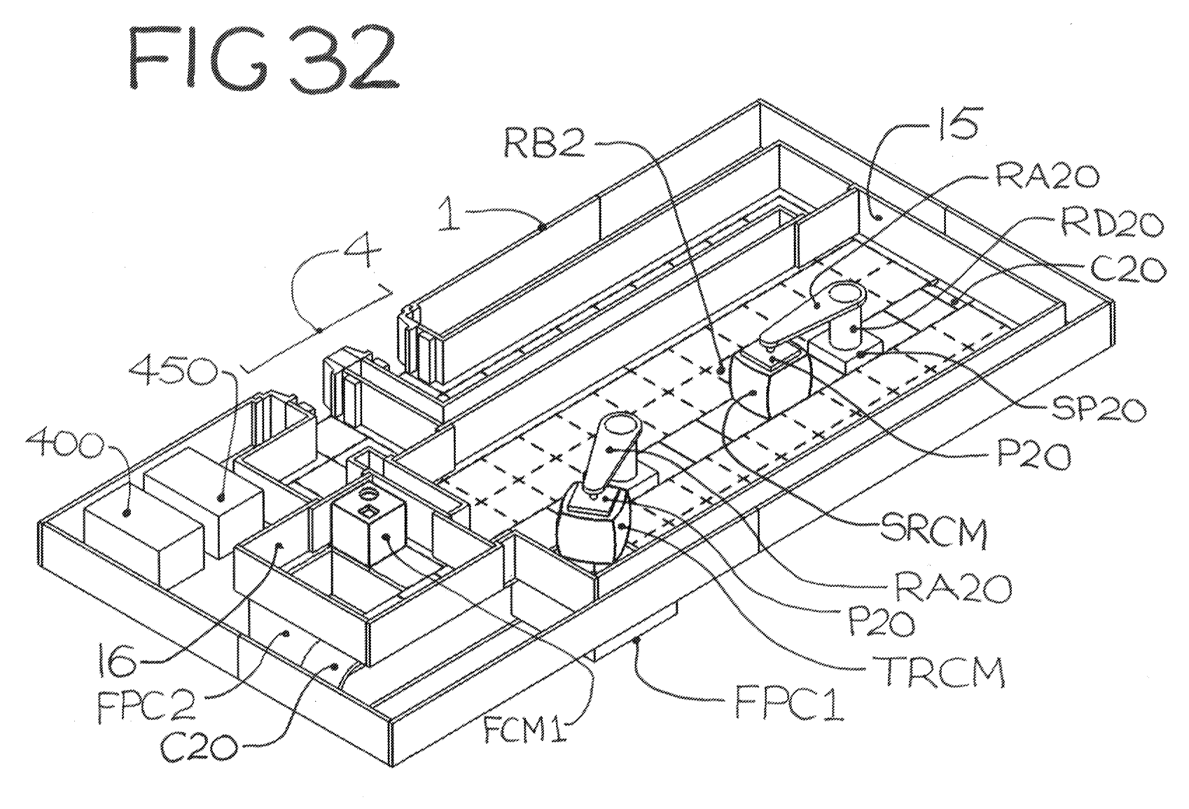

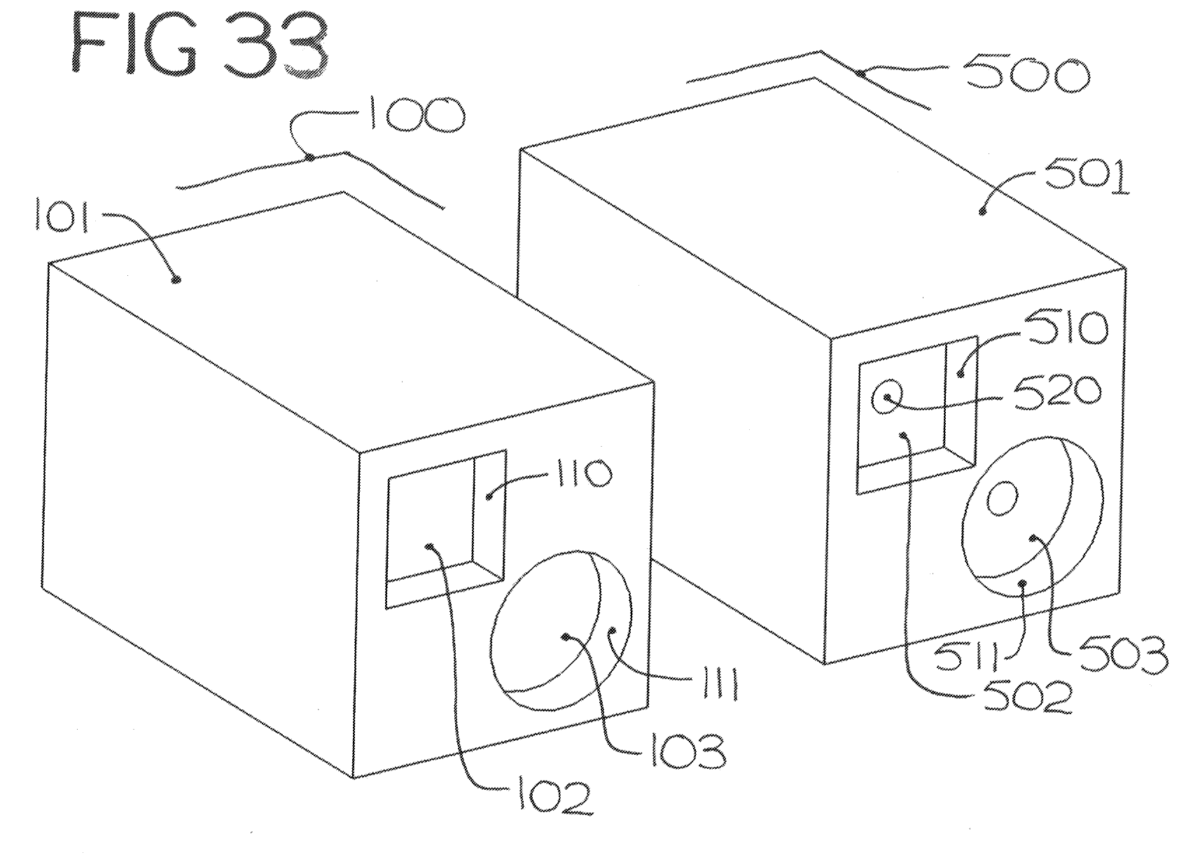

The FIG. 32 drawing is sequential to the FIG. 31 drawing and shows the previously disclosed Fifth Embodiments means and apparatus in greater three-dimensional detail.

The same Robotic-Arm (RA 20) is shown in the FIG. 32 drawing in two sequential positions.

The first position, shown on the right hand side of the drawing, is sequential to the position shown in the FIG. 31 drawing.

The second sequential position is shown near the center of the drawing.

The Robotic-Arm (RA 20) is now shown as the uppermost part of a Robotic-Device (RD 20), that is also provided with a Square-Plinth (SP 20) whose underneath portions are permanently attached an upper portion of Conveyor (C20), now shown in the present drawing as an endless-belt Conveyor.

The upper portions of the Square-Plinth are provided with a vertical shaft casing, for enabling the vertical shaft that is permanently attached the underneath face of the Robotic-Arm's Big-End to be horizontally rotated in both directions through any choosable angle.

The central upper portions of a Pick-Up Pad (P20) are provided with a vertical shaft casing, for enabling the vertical shaft that is permanently attached the underneath face of the Robotic-Arm's Small-End, in order that it may also be horizontally rotated in both directions through any choosable angle.

The length of the Robotic-Arm (RA 20) is such, that by the Computer-Controlled co-ordinations of the independent rotations of the Robotic-Arm (RA 20), the Pick-Up Pad (P20) and the bi-directional linear movements of Conveyor (C20), the Pick-Up Pad may be positioned directly above any Cell-Module that lies within the confinement walls of a Main-Chamber (15) and/or a Thermal-Safety Chamber (16).

In the previous drawing, the Robotic-Arm was preparing to uninstall the Faulty Cell-Module; that has been upgraded to a Safety-Risk Cell-Module (SRCM); from the Receiving-Bay now marked as (RB2).

In the FIG. 32 drawing, it can be seen that the Robotic-Arm has uninstalled the Cell-Module (SRCM) from its Receiving-Bay and rotated and moved it, to be now shown held directly above the Conveyor (C20).

The drawing also shows that the casing of the Cell-Module (SRCM) is beginning to distort from a square to a circular form, indicating abnormal internal heat and pressure.

By referencing the present and previous drawings, it should be understood that the Fire-Proof-Chambers (FPC1), (FPC2) and their respective Emergency-Exit-Gates (EEG 1), (EEG2) that have been installed within the Chambers (15) and (16), have each taken over the physical space of four schematic Cell-Module Receiving Bays that were disclosed for the First and Second Embodiments.

This extra size requirement for an Emergency-Exit-Gate represents a schematic provision for the realistic expectation that an overheated or overheating cell or Cell-Module, whether or not it has reached the stage of thermal runaway, may have become physically enlarged, relative to its normal dimensions, due to e.g. oxygen gas expansion within that Cell-Module.

Referring now to the same Robotic-Arm (RA20) that has reached the second sequential position directly above the Fire-Proof Chamber (FPC1), it can be seen that the casing of the held Cell-Module has further distorted, compared to its previous position, indicating further heat and pressure increases.

The heat sensors on the underneath face of Pick-Up Pad (P20) have registered further heat increase to the Computer-Controller (450), for it to upgrade the status of the Safety-Risk Cell-Module (SRCM) to a Thermal-Runaway Cell-Module (TRCM).

The Computer-Controller then instructs the Pick-Up-Pad (P20) to deliver the Cell-Module (TRCM) inside the Fire-Proof-Chamber (FPC1) as a priority; for the Computer Controller to then immediately close the fire-proof Emergency-Exit-Gate (EEG1), for that potential Thermal-Runaway Cell-Module (TRCM) to be immediately quarantined within the Fire-Proof Chamber.

From the above information, an individual Cell-Module's upgrading of risk, from a Faulty Cell-Module (FCM) progressing towards being a suspected Safety-Risk Cell-Module (SRCM) and again progressing towards being a suspected Thermal-Runaway Cell-Module (TRCM), will immediately stage-prioritize Computer-Controlled procedures for immediately removing that Cell-Module from its current position towards a Thermal-Safety Chamber or a Fire-Proof-Chamber via an Emergency Exit Gate.

It should also be understood from the FIG. 32 drawing, without the need for detailed description, that the Computer-Controlled protocols for removing a Faulty Cell-Module (FCM2) from a Main-Chamber, equally apply to protocols for removing a Faulty Cell-Module FCM1) from a Thermal-Safety-Chamber.

### Sixth Embodiments

The Sixth Embodiments of the invention relate to a specially manufactured rechargeable Cell-Module (500), for the Computer-Controlled delivery and release of choosable sequential volumes of pressurised coolant, fire-retardant and/or fire-expellant from any internal part of an enclosed System (200) to any other internal part that is inaccessible to human reach.

The outer casing, outer features and outer fixtures of a Cell-Module (500) are preferably dimensioned and proportioned to replicate the outer casing, outer features and outer fixtures of a Cell-Module (100).

By being so provided, a Cell-Module (500) may be conveyed in either direction between a Bowser (2) and a Vehicle (1) by the same Conveyor means that were previously disclosed for conveying a Cell-Module (100) within a System (200).

The known prior art for cooling a large number of tightly packed lithium-ion cells within a large battery block essentially proposes mitigating the risk of thermal runaway by pumping a piped liquid coolant between as many batteries as possible within the entire battery block.

The Matsuhisa et al U.S. Pat. No. 8,017,266 proposes minimising the risk of thermal propagation within an individual rechargeable cell, by providing an internally disposed temperature coefficient element to internally isolate the cell's positive terminal when its casing temperature reaches a pre-determined number.

However, non of these patents propose externally introduced means for the Computer-Controlled cooling of a specifically identified individual overheating small-volume rechargeable cell, or specifically identified group of adjacent small-volume rechargeable cells, that have been positioned deep within a cell-chamber that is inaccessible to immediate human reach.

The Sixth Embodiments of the invention provide precise means for a Computer-Controller (450) to deliver a Cell-Module (500) to a precise position within a Vehicle (1), to individually target a potentially overheating or knowingly overheating Cell-Module (100) that has been installed deep within a System (200) that is inaccessible to human reach.

The invention also provides precise means for a Computer-Controller (450) to have already installed one or more Cell-Modules (500) within specially provided Receiving-Bay positions installed within a Vehicle's Main-Chamber, Fire-Proof-Chamber and/or Thermal-Safety-Chamber as a pre-emptive method of providing a ‘Just-In-Time’ coolant, fire-retardant and/or fire-expellant to an individually targeted Cell-Module (100) or an adjacent group of targeted Cell-Modules (100), deep within any part of a System (200) that is inaccessible to human reach.

The invention additionally provides means for a Computer-Controller (350) and/or (450) to convey a sequential plurality of Charged Cell-Modules (500) from a Bowser (2), into an adjacently parked and attached Vehicle (1), for the express-purpose of providing a constantly piped, and target released coolant, fire retardant or fire-expellant to constantly flow through the Cell-Module-Chambers of a Vehicle (1), until such time that the Computer-Controller considers that a temperature increase situation has been resolved.

In such an express-purpose, the Conveyors within the Vehicle would be Computer-Controlled by Controllers (350 and (450) to ensure constant through-flow of Cell-Modules (500) through the Chambers as the Cell-Modules (500) controllably release their pressurised contents.

An important provision of all the above is that Computer-Controlled algorithms are able to provide unique safety-features for a Vehicle (1), a Bowser (2) and a System (200) to be automatedly applied as priorities.

As one example of a unique safety-feature, the driver of a Cell-Module powered electric Vehicle (1) may attach a Bowser (2) to his adjacently parked Vehicle, with the intention of purchasing Bowser dispensed Cell-Module motive power, only to find that his Vehicle is first being automatedly flushed with a constant supply of coolant, by a train of Cell-Modules (500) that are being pumped in and out of his Vehicle, as a priority process of cooling the Cell-Chambers, before Cell-Module (100) refuelling commences.

Referring now to FIG. 33, a Cell-Module (500) is shown adjacent a Cell-Module (100).

Each Cell-Module (100) and (500) has been provided with the same outer dimensions, contours, features and fixtures.

To clarify and expand upon this disclosure, a Cell-Module (100) is provided with a casing (101) and a Cell-Module (500) is provided with a similarly dimensioned and contoured casing (501).

Also, a Cell-Module (100) is provided with a Positive-Terminal fixture (102) and a Cell-Module (500) is provided with a Release-Valve fixture (502) that is similarly dimensioned and contoured to replicate the shape and convolutions of a Positive-Terminal fixture (102).

Also, a Cell-Module (100) is provided with a Negative-Terminal fixture (103) and a Cell-Module (500) is provided with a Re-charge-Valve fixture (503) that is similarly dimensioned and contoured to replicate the shape and convolutions of a Negative-Terminal fixture (103).

The external shape of the Cell-Module (500) and positions and shapes of the Positive and Negative Terminals are schematic and do not represent preferred shapes or positions.

The Release-Valve Fixture (502) is schematically disclosed as a square cavity having Cavity-Walls (510) separating the cavity's square blind-end from the Casing (501).

Positioned at the centre of the cavity's blind-end is the small diameter Remote-Outer-End (520) of an internally disposed Pressure-Release-Valve (510), not shown.

The remote end of the Valve is visually disclosed in its closed position, as a circle whose plane is flush with the plane of the cavity's square blind-end.

The Valve will be visually disclosed in its open position only when Schematic-Flow-Arrows, shown in later drawings, portray the release of pressured coolant from that opened Valve.

A Pressure-Release-Valve (520) may be opened to release its pressurised contents, by the use of at least four separate Computer-Controlled-Operations that are important to separately disclose.

The First Computer-Controlled Operation for opening the Release-Valve (520) is applicable only when a Cell-Module (500) has first been installed within a Receiving-Bay of a Cell-Module Chamber of a Vehicle (1).

After being so installed, the Sixth Embodiments provide means for a Release Device, installed within the Positive Terminal fixture of a Receiving-Bay (RB) to engage with the Pressure-Release-Valve (520), for controlled release of the Cell-Module's pressurised contents into that Receiving-Bay.

The Second Computer-Controlled Operation for opening the Release-Valve (520) is applicable only when a Cell-Module (500) has first been grabbed by a modified version of the Pick-Up Pad (P20), as disclosed in the Fifth Embodiments.

After being so installed, the Sixth Embodiments provide means for a modified Pick-Up Pad (P20) to have a Release-Device, installed on the modified Pad, to engage with the Pressure-Release-Valve (520) of the grabbed Cell-Module (500), for controlled release of that Cell-Module's pressurised contents into the moving local area, while the Cell-Module (500) is also being maneuvered by the Robotic-Device (RD20).

The Third Computer-Controlled Operation for opening the Release-Valve (520) is applicable only when a Cell-Module (500) is being conveyed on a specially adapted Conveyor within the System (200).

A specially adapted Conveyor is provided with electro-magnetic means for a Computer-Controller (350) or (450) to magnetically induce the Release-Valve (520) to open, while a Cell-Module (500) is being conveyed along that Conveyor.

The Fourth Computer-Controlled Operation for opening the Release-Valve (520) is applicable to a wireless Release-Valve-Actuator that has been installed within the Casing (501) of a Cell-Module (500).

The Release-Valve (520) is activated to open, only by wireless instruction transmitted from the Computer-Controller (350) or (450) and received by a Release-Valve-Actuator installed within that Charged Cell-Module (500).

For the Sixth Embodiments of the invention, a Cell-Module (500) should also be considered as a specially manufactured miniature carbon-dioxide (CO²) fire extinguisher or other type of fire extinguisher for sequential piped use where live electricity is present in an enclosed environment inaccessible to human reach.

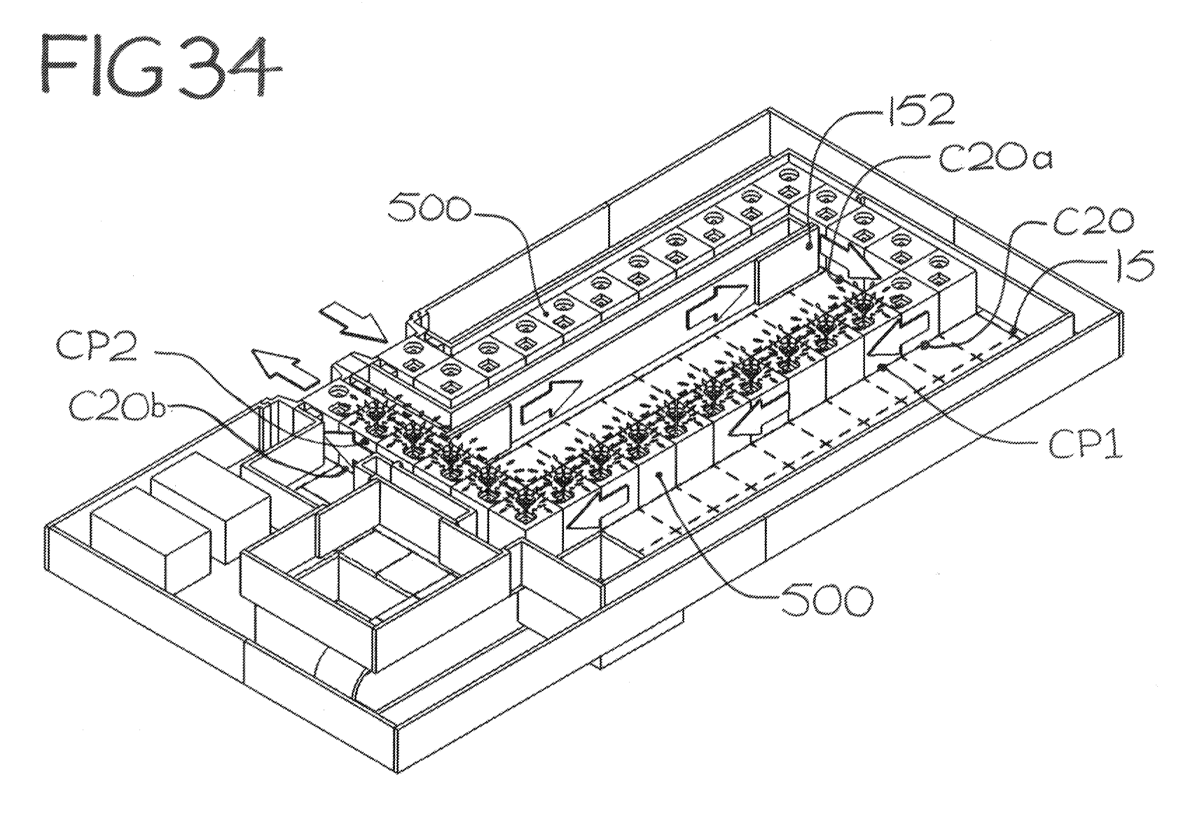

The FIG. 34 drawing discloses means for the Third Computer-Controlled Operation to open the Release-Valve (520) when a Cell-Module (500) is being conveyed on a specially adapted Conveyor within the System (200), and in so doing also discloses Cell-Module through-flow improvements for the Main-Chamber (15) of a Sixth Embodiments Vehicle (1).

A constant flow of Charged Cell-Modules (500) is shown entering the Portal (4).

Each Cell-Module (500) has sequentially arrived at that Portal (4) entrance position by same means disclosed for the Second Embodiments conveying of Charged Cell-Modules (100) towards a Vehicle (1).

A constant flow of Depleted or part-Depleted Cell-Modules is also shown exiting the Portal (4).

Each Depleted or part-Depleted Cell-Module (500) has sequentially arrived at that Portal (4) exit position by Sixth Embodiments Conveyor means.

A Sixth Embodiments Main-Chamber (15) provides means for assisting the through-flow movements of Cell-Modules (100) and (500) along the length of the Conveyor (C20) without the use of a Robotics-Device (RD 20).

The Charged Cell-Modules (500) first travel along the Conveyor (C17), by the same means disclosed, in at least FIG. 18, for Second Embodiments conveying of a Charged Cell-Module (100).

The Charged Cell-Modules (500) are then conveyed away from Conveyor (C17) by a newly provided Conveyor (C20a) that has been installed at the rear end of Chamber (15) to sequentially convey Charged Cell-Modules (500), away from the Computer-opened Main-Chamber-Gate (152), directly towards and onto Conveyor (C20).

As the Charged Cell-Modules (500) travel along the Conveyor (C20), from the back towards the front of the Chamber (5), electro-magnetic devices installed within or underneath Conveyor (C20) are Computer-Controlled to magnetically induce the opening of the Release-Valve (520) installed within each Cell-Module (500), as disclosed for FIG. 30.

The precise length of time that a Release-Valve is magnetically induced to open, is signified in the drawing by the length of 14 Cell-Modules (500).

14 Release-Valves (520) have been magnetically induced to sequentially open, as they travel along Conveyor (C20) and then onto Conveyor (C20b).

The 14 magnetically opened Release-Valves sequentially release separate sprays of a pressurised gas coolant, shown as 14 radiating groups of arrows, into the immediate required area of the Main-Chamber (15).

From this information, it should be understood that the Computer-Controllers (350) and (450) have decided to open the Release-Valves (520) of 14 Cell-Modules at any one time period, as an indication of the severity of thermal increase within a Main-Chamber (15).

Thus, for a minor threat, the Computer-Controllers (350) and (450) may decide to open the Release-Valves (520) of 1, 2 or possibly 3 Cell-Modules at any one time period.

From this information and the drawing, it should be understood that a Charged Cell-Module (500) is first magnetically induced to release pressurised coolant at Conveyor-Position (CP1) on Conveyor (C20).

It should also be understood that a Depleted or Part-Depleted Cell-Module (500) is magnetically disengaged at Conveyor-Position (CP2) on the newly installed Conveyor (C20b), to prevent further release of pressurised coolant, before that Cell-Module leaves the Vehicle.

The FIG. 34 drawing thus discloses Bowser dispensed means for providing a precisely required amount of coolant, fire-retardant or a fire-expellant in a through-flow sequential manner within an enclosed System (200).

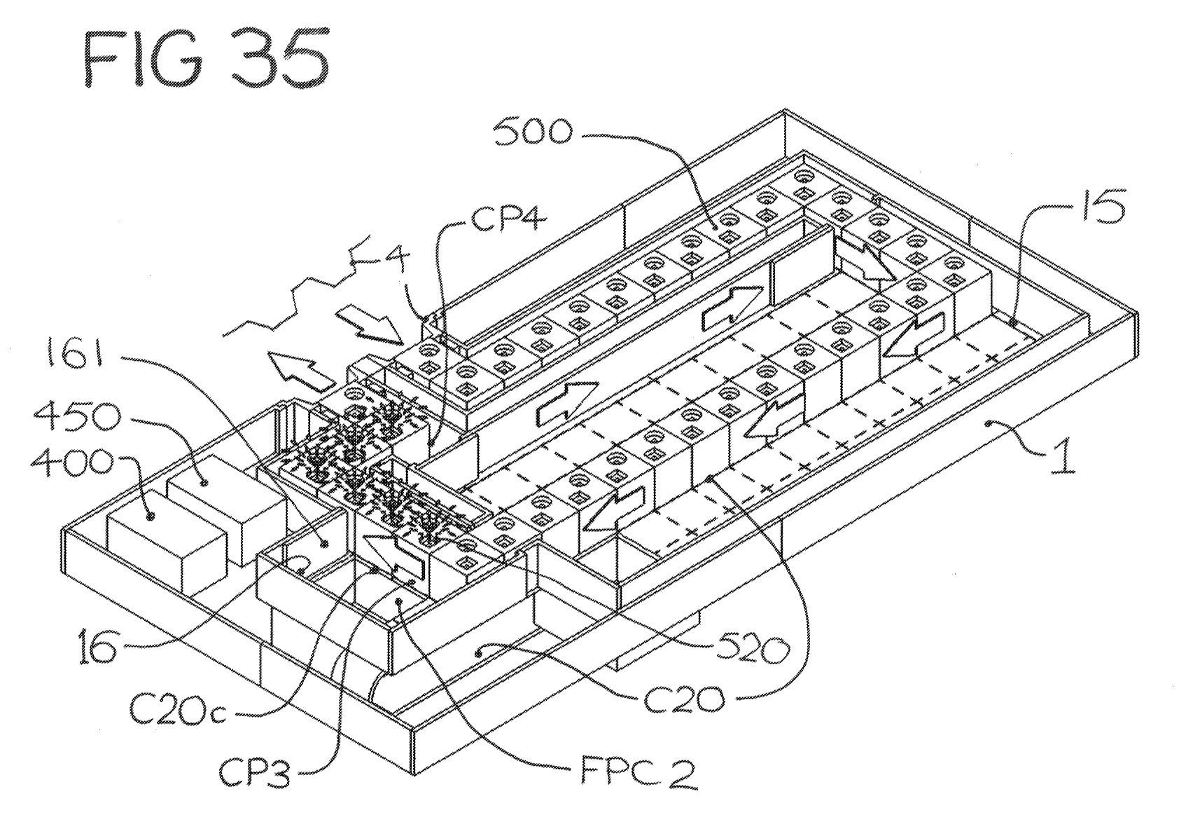

The FIG. 35 drawing also discloses means for the Third Computer-Controlled Operation to open the Release-Valve (520) when a Cell-Module (500) is being conveyed on a specially adapted Conveyor within the System (200), and in so doing also discloses Cell-Module through-flow improvements for the Thermal-Safety-Chamber (16) of a Sixth Embodiments Vehicle (1).

The same sequential conveying of Charged Cell-Modules (500) into a Vehicle (1) and onto a Conveyor (C20) is the same as disclosed for FIG. 33.

In this drawing, it can be seen that the Release-Valves within the Charged Cell-Modules (500) have not been induced to release a pressurised coolant whist being conveyed on Conveyor (C20).

The Charged Cell-Modules (500) have remained in their Charged state on the Conveyor (C20), in order to be sequentially delivered directly into the Thermal-Safety-Chamber (16) for only then being induced to release their contents.

A newly provided Conveyor (C20c) is shown within the Thermal-Safety-Chamber (16) for receiving Charged Cell-Modules (500) from Conveyor (C20) and conveying them through Chamber (16) towards the Chamber's opened Gate (161).

As soon as a Charged Cell-Module (500) has been transferred onto the new Conveyor (C20c) electro-magnetic devices or other devices installed on, within or beneath Conveyor (C20c) are Computer activated to induce the Release-Valve (520) installed with that Cell-Module, to open.

The drawing therefore shows a Charged Cell-Module releasing a pressurised coolant as soon as it has been transferred onto Conveyor (C20c).

The drawing shows that six Cell-Modules (500) have had their Release-Valves (520) opened.

The Computer-Controllers (350), (450) have determined that six Cell-Modules (500) should continually be opened while they are being sequentially conveyed through Chamber (16), based upon pre-determined criteria previously provided to the Computer-Controllers by the System's distributed Interrogation-Sensors, as disclosed for previous Embodiments.

A Cell-Module (500) is shown having its Release-Valve first opened at Cell-Module-Position (CP3) on Conveyor (C20c).

The same Cell-Module is shown having its Release-Valve closed at Cell-Module-Position (CP4), before that Cell-Module leaves the Vehicle.

The release of continuous pressurised coolant, fire retardant or fire expellant from six sequentially conveyed Cell-Modules (500), at any one moment in time, indicates a severe threat to the safety of the Vehicle (1), relating to the integrity of any Faulty Cell-Module already stored with Chamber (16) or Fire-Proof-Chamber (FPC2).

An indication of a modest problem within a Thermal-Safety-Chamber (16) that Interrogation-Sensors would have informed the Computer-Controllers to gently release CO² gas from just one Charged Cell-Module (500) into the local Thermal-Safety-Chamber environment, as a precise temperature reduction procedure.

Thus, only the first and sixth Charged Cell-Modules reaching Cell-Module position CP3 would have their Release-Valve (520) opened at that position, whereas the second, third, fourth and fifth Cell-Modules would not have their Release-Valves opened at that position.

The FIG. 35 drawing thus discloses Bowser dispensed means for providing a coolant, a fire-retardant or a fire-expellant from one Chamber of a Vehicle to another Chamber in the Vehicle, in a through-flow manner.

Referring now to both the FIG. 34 and FIG. 35 drawings, it should be apparent that a moving train of conveyed Cell-Modules (500), either as a separate group or interspersed with Cell-Modules (100), provides precise means for assisting or inundating a specifically chosen region of an enclosed System (200) with sufficient supplies of CO² gas or other acceptable materials.

At one end of this Sixth Embodiments provision, a single Cell-Module (500) may thus be directed to a precise region within an enclosed System (200), especially for the gentle release of a coolant into a warm part of a Vehicle's Cell-Module Chamber (15) and/or (16).

At the other end of this Sixth Embodiments provision, a moving train of conveyed Cell-Modules (500) may thus be directed to a precise region within an enclosed System (200), for the emergency piped swamping of a coolant, fire retardant or fire expellant into a dangerous area of a Vehicle's Cell-Module Chamber (15) and/or (16).

A constant flow of Depleted, part-Depleted or still Charged Cell-Modules (500) is thus shown exiting the Portal (4), wherein each Cell-Module (500) has sequentially arrived at that exit position by Sixth Embodiments means.

A Sixth Embodiments Thermal-Safety-Chamber (16) thus provides precise means for the movement of Cell-Modules (100) and (500) along the length of the Conveyor (C20), for through-flow through Chambers (15) and (16) without the use of a Robotics-Device (RD 20), as disclosed in previous drawings.

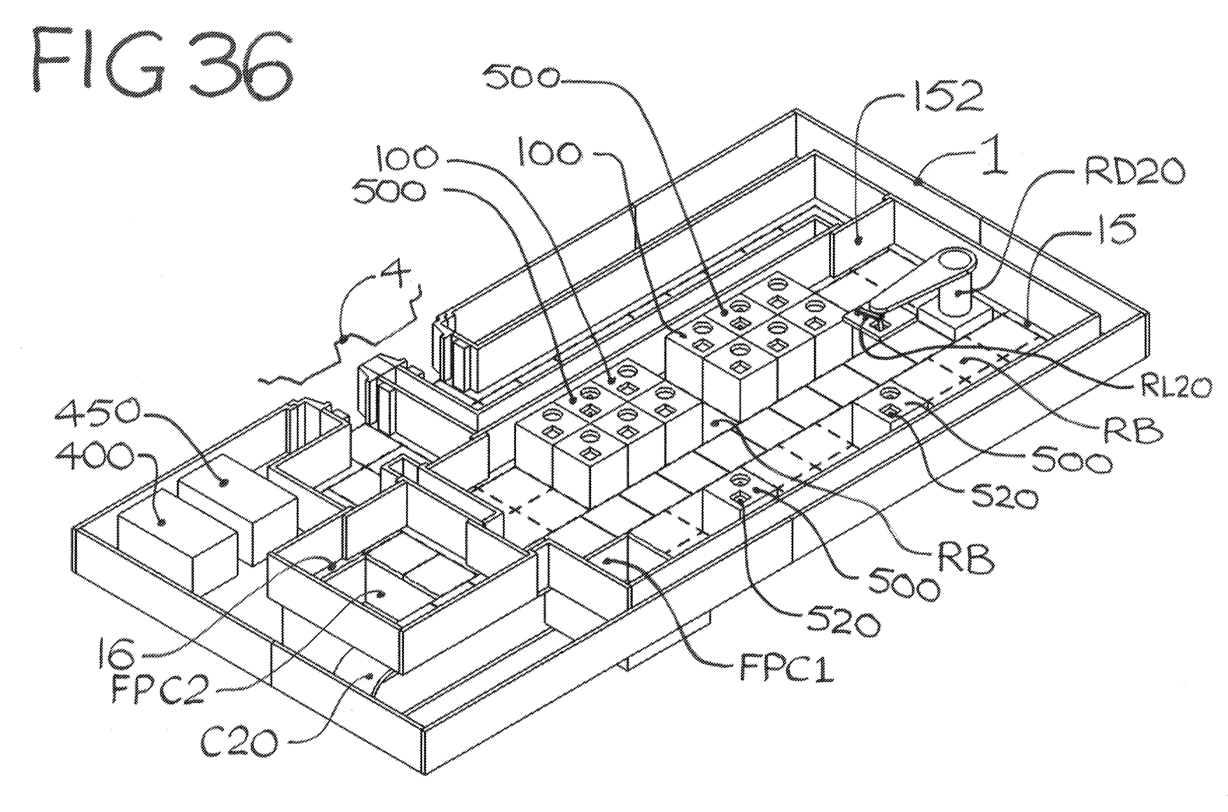

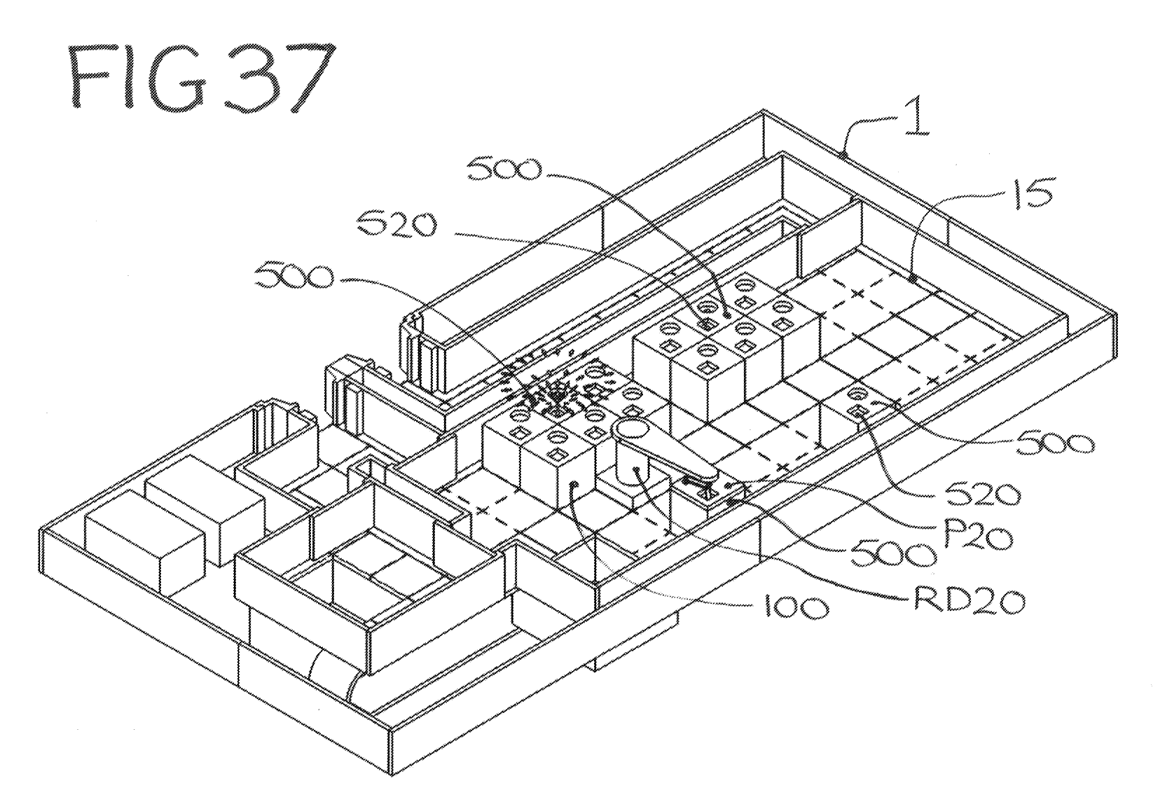

The FIG. 36 drawing discloses means for the First Computer-Controlled Operation, where the Computer-Controlled opening of the Release-Valve (520) of a Charged Cell-Module (500) is only applicable after a Charged Cell-Module (500) has first been installed within a Receiving-Bay of a Cell-Module Chamber (15), (16), (FPC1) and (FPC2) of a Vehicle (1).

The drawing discloses precise schematic means for the Release-Valve (520) of an installed Cell-Module (500), as disclosed in FIG. 32, to be opened by a Sixth-Embodiments Receiving-Bay (RB) installed with Chamber (15).

A Sixth-Embodiments Receiving-Bay (RB) is provided with an installed Release-Valve-Actuator, not shown.

In one of many practical applications of a First Computer-Controlled Operation, a Sixth-Embodiments Cell-Module (500) is provided with a Terminal (502) and (503) at each opposite end, such that its underneath installed face is a mirror-opposite of the uppermost face shown in the drawing.

A double-ended Sixth-Embodiments Cell-Module (500) installed in a Chamber's Receiving-Bay (RB) would thus be provided with a Release-Valve (520) within the square cavity on its underneath face, whose remote outer-end is then in adjacent contact with the remote outer end of the installed Cell-Module's Release-Valve (520).

At the command of the Computer-Controller (350) and/or (450), a Release Valve-Actuator places physical pressure on the installed Release-Valve's remote end, for the controlled release of some or all of that Cell-Module's pressurised contents, directly into that Receiving-Bay or directly into that Receiving-Bay's immediate environment for radial distribution.

The drawing shows two separate but visually similar groups of six Cell-Modules that had previously been installed in those positions by the now dormant Robotic-Device (RD20), shown parked at the rearmost remote end of Conveyor (C20).

Before becoming dormant, the Robotic-Device had previously received eight Cell-Modules from the Portal (4) and a (now disconnected and removed) Cell-Module dispensing Nozzle.

The Robotic-Device had first received the two Charged Cell-Modules (500) that the Computer-Controllers had instructed the Robot to separately install near the front and rear portions of the left hand side of Chamber (15).

The Robotic-Device had then received a third and fourth Charged Cell-Module (500) that the Computer-Controllers had instructed the Robot to separately install near the front and the rear portions of the right hand side of Chamber (15).

The Robotic-Device had then received a first group of five Charged Cell-Modules (100) that the Computer-Controllers had instructed the Robot to individually install adjacent the third Cell-Module (500), in order to surround Cell-Module (500).

The Robotic-Device had then received a second group of five Charged Cell-Modules (100) that the Computer-Controllers had instructed the Robot to individually install adjacent the fourth Cell-Module (500), in order to also surround that Cell-Module (500).

Having completed these eight separate tasks, the Computer-Controllers then closed the Main-Chamber-Gate (152) and ordered the Conveyor (C20) to move the Robotic-Device (RD20) to its dormant position, as shown.

FIG. 37 is sequential to the FIG. 36 drawing and shows the particular benefits of a Charged Cell-Module (500) being surrounded by a plurality of Cell-Modules (100) installed within adjacent Receiving-Bays (RB) of a Main-Chamber (15).

For a situation where any one of the installed Cell-Modules (100) is found to be overheating, the surrounded Cell-Module (500) is able to deliver Computer-Controlled dosed volumes of gaseous coolant, shown as radiating groups of arrows, into that immediate environment.

The drawing shows the Charged Cell-Module (500); that was the third to be installed in the FIG. 36 disclosures; discharging a dosed coolant over its five adjacent Cell-Modules (100).

The drawing also shows the Robotic-Device (RD20) in active mode, preparing to move the Charged Cell-Module (500); that was the first to be installed in the FIG. 36 disclosures; towards the overheating Cell-Module (100), in readiness to also release coolant onto that overheated Cell-Module from a position outside the surrounded positions of the five Cell-Modules (100).

It should be apparent, without the need for a further drawing, that a First Computer-Controlled-Operation is also applicable to the Robotic-Device (RD20) installing one or more Cell-Modules (500) within a Cell-Module Chamber other than Chamber (15).

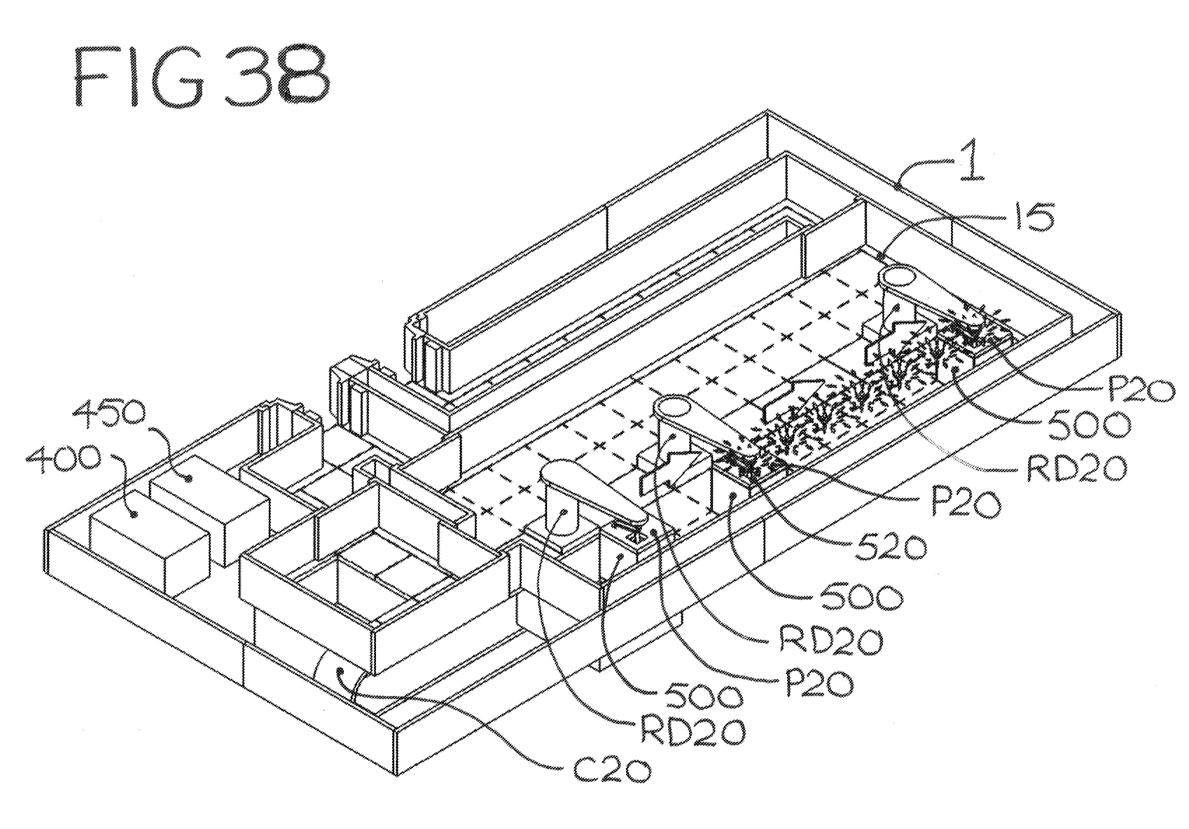

Referring now to the FIG. 38 drawing, the drawing shows the same Robotic-Device (RD20) and the same Cell-Module (500) in three sequential positions, for disclosing the Second Computer-Controlled Operation for opening the Release-Valve (520) of a Cell-Module (500).

The Second Computer-Controlled-Operation for opening the Release-Valve (520) is applicable only when a Charged or part Depleted Cell-Module (500) has first been grabbed by a modified version of the Pick-Up Pad (P20), as disclosed in the Fifth Embodiments.

This Computer-Controlled-Operation, like the other three Operations, may be activated by the Computer-Controllers (350) and/or (450), whether or not a Vehicle (1) is connected to a Bowser (2).

A Sixth Embodiments Pick-Up Pad (P20) provides fulcrum means and other means for a Release-Valve-Lever to be installed on the modified Pad, for its remote-end to engage with remote-end of the Pressure-Release-Valve (520) of the grabbed Cell-Module (500), for Computer-Controlled release of that Cell-Module's pressurised contents into the moving local area, while the Cell-Module (500) is also being maneuvered by the Robotic-Device (RD20), as it is also being conveyed along Conveyor (C20).

In the first sequential position the Pick-Up Pad (P20) of Robotic-Device (RD20) has grabbed a Charged Cell-Module (500) at the front left-hand side of Chamber (15). The Computer-Controllers (350) and/or (450) have instructed the Pick-Up Pad (P20) to move the Charged Cell-Module to the rear left-hand side of the Chamber (15), where heat increase has been detected.

The Pick-Up Pad (P20) therefore begins to move the Charged Cell-Mode (500) towards the second sequential position without releasing its pressurised contents.

At the second sequential position, the Pick-Up Pad (P20) is instructed to activate the Release-Valve-Lever, situated on the upper parts of the Pad.

This Computer-Controlled action releases a controlled emission of coolant that is shown in the drawing to continue for a distance covered by seven Cell-Module position movements.

At the third sequential position, near the rear of the Chamber (15), the Computer-Controller de-activates the Release-Valve-Lever.

Thus, means for providing a Computer-Controlled sequential movement of coolant, fire retardant and/or fire expellant, through a required part of the Main-Chamber (15), has been disclosed.

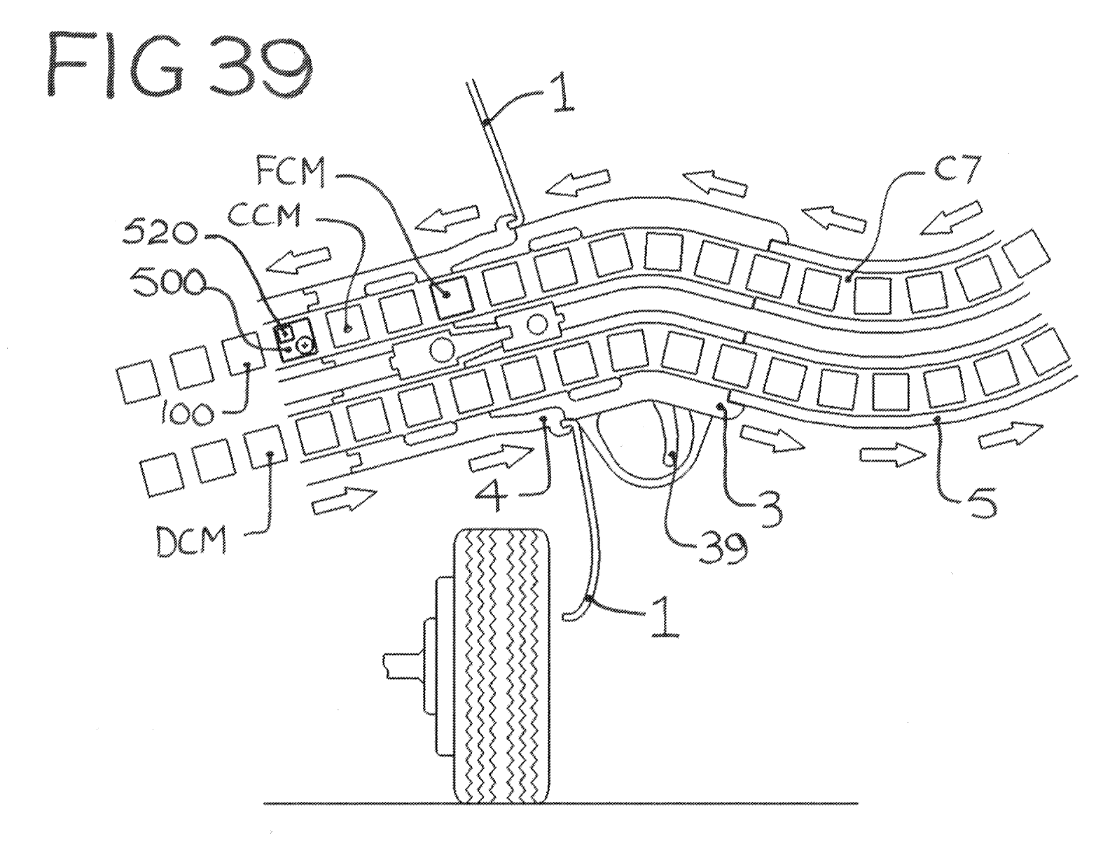

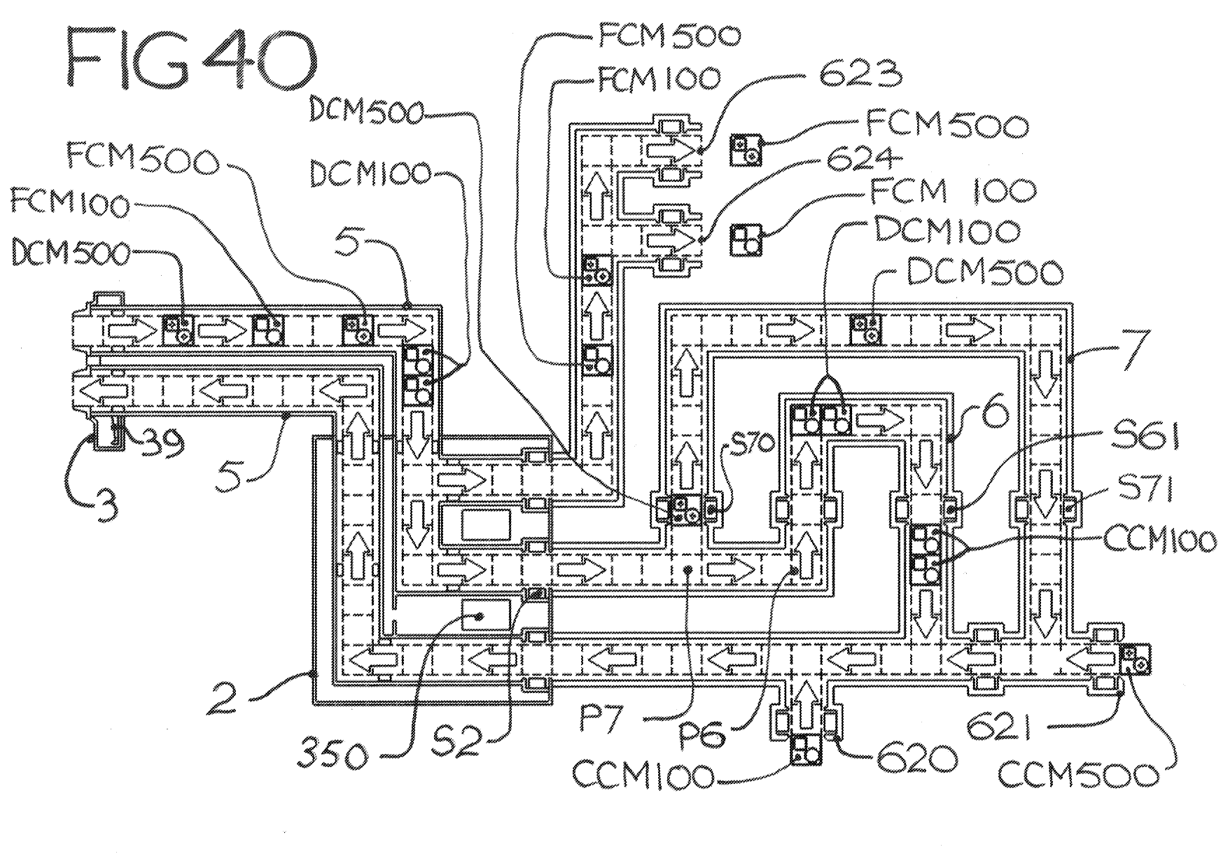

FIG. 39 discloses the Fourth Computer-Controlled Operation, for opening the Release-Valve (520) of a Charged Cell-Module (500), no matter where that Charged Cell-Module is situated within an enclosed System (200).

The Fourth Computer-Controlled Operation is particularly suitable for opening the Release-Valve (520) of a Charged Cell-Module (500), when that Cell-Module has not been installed within a Receiving-Bay of a Vehicle's Chamber or been grabbed and held by the Pick-Up Pad of a Robotic-Device (RD20), as previously disclosed.

The Fourth Computer-Controlled Operation therefore relates to remote means, or non-contact means between a Cell-Module (500) and a System (200), for e.g. a Computer-Controlled wireless instruction to be transmitted to a Cell-Module (500) by a Computer Controller (350) and or (450).

The Release-Valve (520) may thus be activated to open by way of a Release-Valve-Actuator that has been installed within that Charged Cell-Module (500), according to specific instructions received by that individual Cell-Module (500), for distributing its pressurised contents within the immediate enclosed environment in which it is currently situated.

The FIG. 39 drawing schematically shows just one of many practical applications for use of the Fourth Computer-Controlled Operation.

An individual Cell-Module (500) has been included among a sequential supply of Charged Cell-Modules (100) being conveyed from a Bowser (2) to an adjacently parked and connected Vehicle (1), as previously disclosed in at least FIG. 20.

Referring directly to the FIG. 38 drawing, a freshly Charged Cell-Module, being conveyed towards a Vehicle (1) along Conveyor (C7) within Bowser-Pipe (5) has been highlighted by Interrogation-Sensors as an overheating risk.

The System (200) has immediately upgraded that Charged Cell-Module to a suspected Faulty Cell-Module, marked in the drawing by the moniker (FCM).

An individual Charged Cell-Module (500) that is shown being conveyed three positions in front of the newly designated Faulty Cell-Module (FCM) has received a wireless instruction to gently release its pressurised coolant as it travels along Conveyor (C7) towards Vehicle (1).

The Charged Cell-Module (500) has been provided with an internally installed Release-Valve-Actuator, according to Fourth Computer-Controlled Operation procedures, for releasing pressurised coolant at Computer-Controlled command.

In the FIG. 39 drawing, release of the coolant will be emitted from the opened Release-Valve (520), such that when the Faulty Cell-Module (FCM) reaches that position, its outer surfaces will be continuously bathed by coolant being dispersed directly in front of it, for as long as the Computer-Controllers deem necessary.

From the disclosures provided for FIG. 39, it should be understood without the need for a further drawing, that the same Sixth Embodiments improvements for the FIG. 20 drawing would be also be applicable to all Fourth Embodiment drawings, for an individual Cell-Module (500) to be continuously sequentially provided within each and every Conveyor and Stepped-Hopper, for providing continuous sequential insurance against an overheating Cell-Module discovered in any Stationary Part (A) of an enclosed System (200).

An essential component for the Sixth Embodiments of the invention is a Cell-Module Charging-Bay (7) for use only in recharging Depleted Cell-Modules (500).

In a preferred Sixth Embodiment, a newly introduced Charging-Bay (7) provides specific improvements to all previously disclosed Embodiments of the Stationary Part (A) of a System (200).

A Charging-Bay (7) is schematically, functionally, visually and sequentially similar to Fourth Embodiments disclosures for a Charging-Bay (6) with the important distinctions that; Depleted Cell-Modules (100) are Computer-Controlled to only be recharged within a Charging-Bay (6) using electrical recharging processes and that; Depleted Cell-Modules (500) are Computer-Controlled to only be recharged within a Charging-Bay (7) using pressurised gas recharging processes.

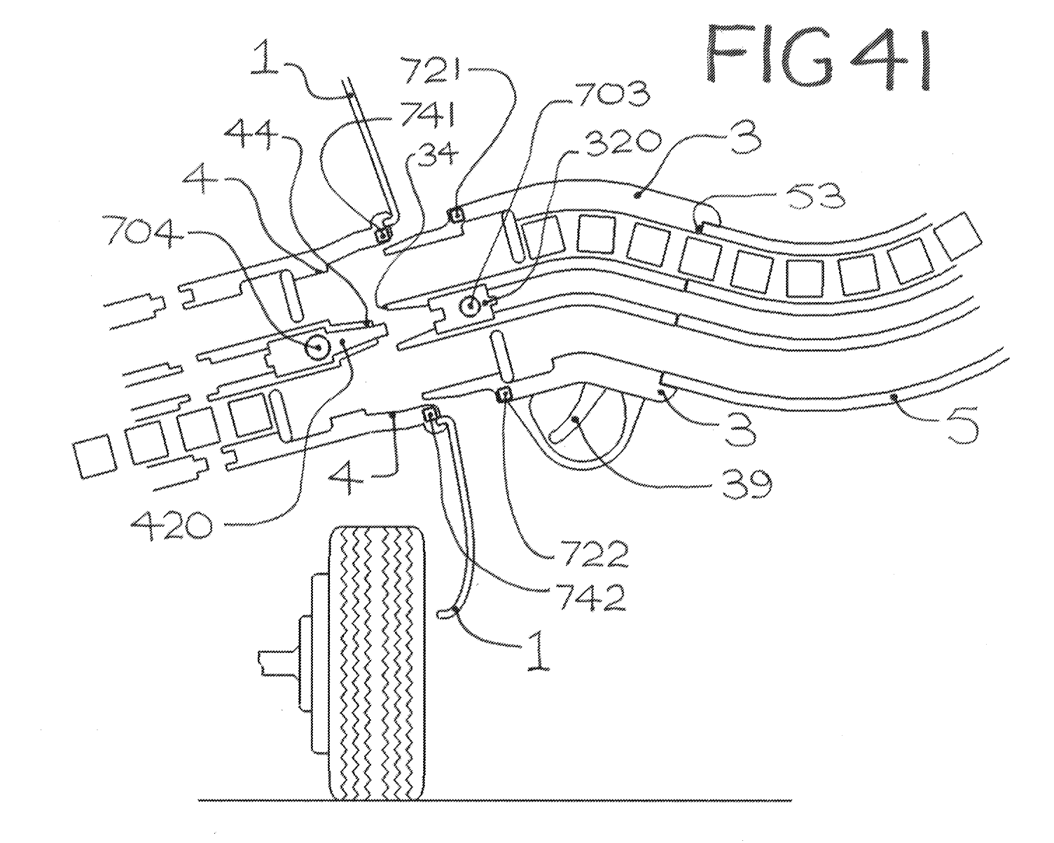

Referring generally to FIG. 40, the drawing shows Sixth Embodiments additions and/or improvements to the Stationary Part (A) of a Second Embodiments System (200), as disclosed in at least FIG. 18.

By comparing FIG. 40 with FIG. 18, it should be clear that the Bowser (2) and the Bowser-Pipe (5) are the same in both drawings.

It should also be clear that methodologies for a Bowser (2) to receive Cell-Modules from an outside source and return Cell-Modules to an outside source have been significantly added to and improved.

From the above, it should be understood without the need for a further drawing, that these Sixth Embodiments additions and/or improvements are equally applicable for use within a First Embodiments Bowser (2), as disclosed for at least FIG. 12, wherein a previously disclosed Charging-Bay (6) and a newly provided Charging-Bay (7) of similar size and construction would both be incorporated within the Bowser's casing and not outside it.

The drawing thus discloses additions and/or improvements that are particularly directed to disclosing the Computer-Controlled conveying of Cell-Modules (500) between a Bowser (2) and a newly provided Charging-Bay (7), in precisely the same manner that Cell-Modules (100) were previously disclosed being conveyed between a Bowser (2) and a Charging-Bay (6).

To aid the disclosures, a small but precise number of Cell-Modules (100) and (500), in various states of charge and condition, are shown being conveyed within the Stationary Part (A) of a Sixth Embodiments System (200) that has been built upon Second Embodiments of the invention.

A Sixth Embodiments Bowser-Pipe (5) is provided with the same electro-mechanical devices as disclosed for a Second Embodiments Bowser-Pipe (5).

However, a Sixth Embodiments Bowser-Pipe (5) will also be provided with additions and/or improvements relating to Interrogation Sensors that are able to readily distinguish between a Cell-Module (100) and a Cell-Module (500), including immediate understanding of that Cell-Module's condition status, for immediate use by the Sixth Embodiments Computer-Controller (350) and/or (450).

Similarly, a Sixth Embodiments Bowser (2) will also be provided with additions and/or improvements relating to internally provided Interrogation Sensors that are able to distinguish between a Cell-Module (100) and a Cell-Module (500), including immediate understanding of its condition status, for immediate use by the Sixth Embodiments Computer-Controllers (350) and/or (450).

Referring directly to the FIG. 40 drawing, the same group of five different Cell-Modules are shown in three separated, Sequential-Progressions within and external to, a Stationary Part (A).

In the First Sequential Progression, the group of five different Cell-Modules are all shown within a Sixth Embodiments Bowser-Pipe (5).

The group is shown being conveyed within the Pipe, in sequential order, towards a Bowser (2).

Two adjacent Depleted Cell-Modules (DCM 100) head the conveyed group, followed by a Faulty Cell-Module (FCM 500), a Faulty Cell-Module (FCM 100) and a Depleted Cell-Module (DCM 500).

In the Second Sequential-Progression, the two adjacent Depleted Cell-Modules (DCM 100) are now shown within the Charging-Bay (6) and the two Faulty Cell-Modules (FCM 500) and (FCM 100) are now shown being conveyed towards their respective System-Exit-Gates (623) and (624), while the Depleted Cell-Module (DCM 500) is shown adjacent the Interrogation-Sensors (S70) for then entering the Charging-Bay (7) for recharging.

In the Third Sequential-Progression, the two adjacent Cell-Modules are shown exiting the Charging-Bay (6), for being returned to the Bowser (2) as freshly Charged Cell-Modules (CCM 100).

Also in the Third Sequential-Progression, the Faulty Cell-Modules (FCM 500) and (FCM 100) are shown completely removed from the System (200), having exited the System via respective System-Exit-Gates (623) and (624) and their respective Interrogation-Sensors.

Also in the Third Sequential-Progression, the Depleted Cell-Module (DCM 500) is now shown undergoing Computer-Controlled recharging within the newly disclosed orbital Charging-Bay (7).

Importantly for the Third Sequential-Progression, the Stationary Part (A) of a Sixth Embodiments System is additionally provided with a System-Entrance-Gate (620), with System-Entrance-Sensors, for a new Charged Cell-Module (CCM 100) to be introduced within the System, to replace the Faulty Cell-Module (FCM 100).

Also important for the Third Sequential-Progression, the Stationary Part (A) of a Sixth Embodiments System is additionally provided with a System-Entrance-Gate (621), with System-Entrance-Sensors, for a new Charged Cell-Module (CCM 500) to be introduced within the System, to replace the Faulty Cell-Module (FCM 500).

From the drawing, it should be apparent that when a Depleted Cell-Module (100) and/or a Depleted Cell-Module (500) is being conveyed out of a Bowser (2), it must first pass between the Interrogation-Sensors (S2), for the Sensors to immediately provide the Computer-Controllers (350) and/or (450) with precise-information.

That precise-information determines the Computer-Controlled conveying of a Depleted Cell-Module (DCM500) directly from the Sensors (S2) to the Position (P7) in the drawing, for then being immediately conveyed inside the schematically orbital Charging-Bay (7).

That same precise-information separately determines the Computer-Controlled conveying of a Depleted Cell-Module (DCM 100) directly from the Sensors (S2) to the Position (P6) in the drawing, for then being immediately conveyed inside the schematically orbital Charging-Bay (6).

Referring now to all the above Sixth Embodiments disclosures, a Sixth Embodiments Vehicle (1) differs from a First Embodiments Vehicle (1), a Second Embodiments Vehicle (1) and a Fifth Embodiments Vehicle (1) with regard to the following additions and/or improvements.

For the first addition/improvement, the Pick-Up Pad (P20), that was shown in FIG. 31 rotatably attached the remote end of the Robotic-Arm (RA20) in a First Embodiments Vehicle (1), is now provided with additional means, including a Computer-Controlled Release-Lever (RL20), best shown in FIG. 36, for engaging directly with the Release-Valve (502) of the Charged Cell-Module (500) that the Pick-Up Pad is holding, for the express purpose of releasing pressurised expellant, contained within that held Cell-Module (500), directly into the immediate adjacent environment of the enclosed System.

For the second addition/improvement, a specific plurality of Receiving-Bays (RB), installed within a Second Embodiments Main-Chamber (15) are now each provided with additional means, including a Computer-Controlled Release-Trigger (RT15), for engaging directly with the Release-Valve (502) of the Charged Cell-Module (500) that has been installed in that Receiving-Bay (RB), for the express purpose of releasing pressurised expellant, contained within that installed Cell-Module (500), directly into the immediate adjacent environment of the enclosed System.

For the third addition/improvement, a specific plurality of Receiving-Bays (RB), installed within a Second Embodiments Thermal Safety-Chamber (16) are now each provided with additional means, including a Computer-Controlled Release-Trigger (RT16), for engaging directly with the Release-Valve (502) of the Charged Cell-Module (500) that has been installed in that Receiving-Bay (RB), for the express purpose of releasing pressurised expellant, contained within that installed Cell-Module (500), directly into the immediate adjacent environment of the enclosed System.

For the fourth addition/improvement, at least one specially provided Cell-Module Receiving-Bay (RB) is installed within the Fire-Proof-Chamber (FPC1) of a Fifth Embodiments Main-Chamber (15), for receiving and retaining a Charged Cell-Module (500).

For the fifth addition/improvement, a Charged Cell-Module (500) is provided with internal release devices for the Computer-Controller (350) and/or (450) to release its coolant, fire retardant and/or fire expellant, without being connected to a Pick-Up Pad (P20) and without being installed within a Cell-Module Receiving-Bay (RB).

Each specially provided Receiving-Bay (RB) is provided with additional means, including a Computer-Controlled Release-Lever (RL150), not shown, for engaging directly with the Release-Valve (520) of the Charged Cell-Module (500) that has been installed within that Receiving-Bay (RB), for the express purpose of releasing pressurised expellant, contained within that installed Cell-Module (500), directly into the immediate adjacent environment of the enclosed System.

For the sixth addition/improvement, because a Charged Cell-Module (500) will always have its pressurised contents released into an enclosed System (200), a pressure differential balancing Pipe may be provided between any relevant internal part or parts of a System (200) and the atmosphere that is external to the System (200).

In one example of a sixth addition/improvement, because a Charged Cell-Module (500) is able to release its pressurised contents released into a small volume Fire-Proof-Chamber (FPC1) that may also be a sealed environment, a pressure differential balancing Pipe is essential between the Chamber (FPC1) and the atmosphere that is external to the Vehicle's outer bodywork.

For the seventh addition/improvement, at least one specially provided Cell-Module Receiving-Bay (RB) is installed within a Fire-Proof-Chamber of a Fifth Embodiments or Sixth Embodiments Vehicle (1), for receiving and retaining at least one Charged Cell-Module (500), wherein each specially provided Receiving-Bay (RB) is provided with additional means, including a Computer-Controlled Release-Trigger for engaging directly with the Release-Valve (520) of the installed Charged Cell-Module (500), for the express purpose of releasing pressurised expellant, contained within that installed Cell-Module (500), directly into the immediate adjacent environment.

For the eight addition/improvement, the Pick-Up Pad (P20) of a Robotic-Arm (RA20) is able to receive, hold and install a Charged Cell-Module (500) into a vacant Receiving-Bay (RB) of a Main-Chamber (15) and/or a Thermal-Safety-Chamber (16) in the same previously disclosed manner by which a Charged Cell-Module (100) is received, held and installed.

For the ninth addition/improvement, a Computer-Controller (350) and/or (450) will be able to instruct the Pick-Up Pad (P20) of a Robotic-Arm (RA20) to uninstall a Charged Cell-Module (500) from a first position Receiving-Bay (RB) within a Main-Chamber (15) and/or a Thermal-Safety-Chamber (16), then move it towards and install it within a second position vacant Receiving-Bay (RB) that is adjacent a suspected Cell-Module (100) that the Computer-Controller (450) has reclassified from being a Faulty Cell-Module (FCM), to being a Safety-Risk Cell-Module (SRCM) or a Thermal-Runaway Cell-Module (TRCM).

For the tenth addition/improvement, the Computer-Controller (350) and/or (450) is able to release some or all of the pressurised contents of a Charged Cell-Module (500) at any Computer-Controlled choosable time, while the Pick-Up Pad (P20) is physically holding the Cell-Module (500).

For the eleventh addition/improvement, the Computer-Controller (350) and/or (450) is able to convey Cell-Modules (500) from a Bowser (2) towards a Vehicle (1) or from a Vehicle (1) towards a Bowser (2) in precisely the same manner disclosed for conveying a Cell-Module (100) within an enclosed System (200).

For the twelfth addition/improvement, a System (200) will provide a separate Recharging-Bay (7) external to a Bowser (2), for the recharging of a Depleted or part Depleted Cell-Module (500).

For the thirteenth addition/improvement, the Computer-Controller (350) and/or (450) is able to recognise the difference between the visually similar Cell-Modules (100) and (500), for conveying a Depleted Cell-Module (100) towards a Charging-Bay (6) and conveying a Depleted Cell-Module (500) towards a separate Charging-Bay (7).

### Seventh Embodiments

The Seventh Embodiments of the invention relate to precise Safety-Improvement-Features, including methods, means and apparatus for use in conjunction with the previously disclosed Embodiments of the invention.

Before disclosure is made of these individual Safety-Improvement-Features, it is important to first highlight global acceptances of inaccurately perceived safety when a member of the public refuels a fossil fuel vehicle by bowser means.

The general safety standards for the sequential dispensing of highly inflammable fossil fuel, from the nozzle of a bowser into the portal of a fossil fuel vehicle are, in practice, arcane and lax.

It is possible for the user of a fossil fuel nozzle to readily operate its flow trigger, in a public area where many thousands more gallons of fossil fuel are stored, before that nozzle has even entered the vehicle's insertion portal.

At the current time, the only known safety device for preventing nozzle trigger action, before it has been inserted into a vehicle portal, is via a cashier over-ride switch that temporarily switches off the bowser's pumping motor.

Its use is inconsistent with formal safety practice and would seem to relate more to the Service Station cashier ensuring that payment has first been received from the previous user of that bowser, rather than to genuine safety considerations.

However, after that pumping motor has been cashier activated, it is still entirely possible for the user to keep the flow trigger held open and therefore allow fossil fuel to be pumped out of the nozzle, after the nozzle has been removed from the portal, for as long as the user chooses.

The public's perception of safe dispensing of fossil fuel at a global level would seem to be predicated, not on effective safety regulations or improved safety dispensing features, but on luck and the common responsibility of each and every′ user, and not on overseeing safety features.

If fossil fuel dispensing bowsers were a recent invention, it is very likely that far more stringent safety regulations, for the continuously safe sequential dispensing of such a highly inflammable material, would be thoroughly investigated and then enforced with sufficient safety features.

A separate disclosure for the Seventh Embodiments of the invention therefore relates to direct adaptation of the co-operative safety features that have been described in previous Embodiments for the safe sequential insertion, interconnection and Trigger (39) activation of a Nozzle (3) of the invention with a co-operating Portal (4) of the invention; for use in also providing those same improved safety features for use in dispensing sequential amounts of metered fossil fuel between a fossil fuel bowser trigger, nozzle and a co-operating portal of a fossil fuel vehicle.

The FIG. 41 drawing discloses first and second Safety-Improvement-Features that are readily installable within a Nozzle (3) of the invention, in harmonic conjunction with other installed electrical devices, as previously disclosed.

The drawing also discloses third and fourth Safety-Improvement-Features that are readily installable within a Portal (4) of the invention, in harmonic conjunction with the other installed electrical devices, as previously disclosed.

The first Safety-Improvement-Feature concerns a Light-Sensor (703) that has been installed within the convoluted Front-Face (34) of a Nozzle (3), and optionally installed within the Electric Terminal Block (320), as denoted by a small circle.

The Sensor (703) has an independent primary role in ensuring that the Computer-Controllers (350) and/or (450), not shown, cannot authorize activation of the Nozzle-Trigger (39) while any light is able to fall upon it.

The second Safety-Improvement-Feature concerns Electro-Magnetic Switching-Devices (721) and (722) that have been installed within the outer rigid casing parts of the convoluted Front-Face (34) of a Nozzle (3), as denoted by the two small squares.

The Switching-Devices have a co-ordinated and independent primary role in ensuring that the Computer-Controllers (350) and/or (450) cannot authorize activation of the Nozzle-Trigger (39) unless both of them are under magnetic influence at the same time.

The third Safety-Improvement-Feature concerns a Light-Sensor (704) that has been installed within the convoluted Front-Face (44) of a Portal (4), and optionally installed within the Electric Terminal Block (420), as also denoted by a small heavy lined circle.

The Sensor (704) has an independent primary role in ensuring that the Computer-Controllers (350) and/or (450) cannot authorize activation of the Nozzle-Trigger (39), as shown, while any light is able to fall upon it.

The fourth Safety-Improvement-Feature concerns Electro-Magnetic Switching-Devices (741) and (742), that have been installed within the outer rigid casing parts of the convoluted Front-Face (44) of a Portal (4), as also denoted by two small squares.

The Switching-Devices have a co-ordinated and independent primary role in ensuring that the Computer-Controllers (350) and/or (450) cannot authorize activation of the Nozzle-Trigger (39) unless both of them are under magnetic influence at the same time.

The drawing shows that the Nozzle (3) and the Portal (4) have not joined.

Light is therefore still able to penetrate the cavity of the Portal, thus denying authorization for the Computer-Controllers to activate the Nozzle Trigger (39), as shown in the drawing.

Also because the Nozzle (3) and the Portal (4) have not joined, the co-operative Electro-Magnetic Switching-Devices (721) and (741) are unable to exert magnetic influence upon the other.

Similarly, because the Nozzle (3) and the Portal (4) have not joined, the co-operative Electro-Magnetic Switching-Devices (722) and (742) are also unable to exert magnetic influence upon the other.

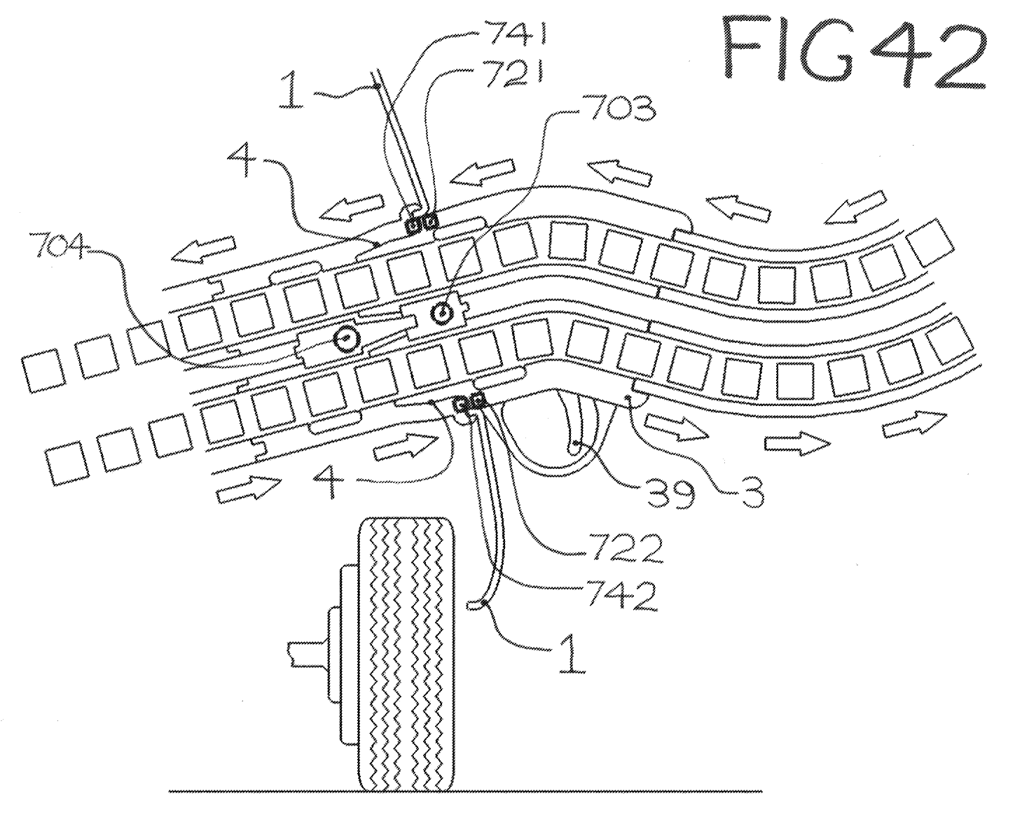

The FIG. 42 drawing is sequential to the previous drawing and shows that the convoluted male parts of the Nozzle (3) have been successfully inserted and safely secured within the co-operating female parts of the Portal (4).

For this disclosed situation, it should be apparent that light is no longer able to penetrate the enclosure that has been formed by the union of the Nozzle (3) and the Portal (4).

The Light-Sensors (703) and (704), independently and in combination, are therefore able to authorize the Computer-Controllers (350) and/or (450) to activate the Nozzle-Trigger (39).

Also for this disclosed situation, it should be apparent that the Electro-Magnetic Switching-Devices (721) and (741) are now in mating contact with each other and that the Electro-Magnetic Switching-Devices (721) and (741) are also in mating contact with each other.

Only because both pairs of co-operating Switching-Devices are in mating contact, not only pair, the four Switching-Devices, in combination, are therefore able to authorize the Computer-Controllers (350) and/or (450) to activate the Nozzle-Trigger (39).

From these disclosures, six independent or combinable safety procedures are available for use by the Computer-Controllers (350) and/or (450) to authorize activation of the Nozzle-Trigger (39), as shown.

Conversely, the moment that the Nozzle (3) is separated from the Portal (4) for any reason, the Computer-Controllers (350) and/or (450) to denied permission to keep the Nozzle-Trigger (39) activated.

From all the Seventh Embodiments disclosed thus far, it should also be understood that the disclosures have direct application for use with a novelly modified fossil fuel dispensing bowser and a novelly modified co-operating fossil fuel receiving portal, to prevent inappropriate activation of a fossil fuel nozzle trigger until all automated Safety-Improvement-Features and procedures have been successfully completed.

The fifth Safety-Improvement-Feature primarily relates to spark prevention devices for installation within the Cell-Module Chambers of a Vehicle (1), to add a specific safety improvement to previously disclosed Embodiments when a Cell-Module (100) is being automatedly installed within a Receiving-Bay (RB) or is being automatedly removed from a Receiving-Bay (RB) that is inaccessible to human reach.

It is known, from Fifth Embodiments disclosures and from prior art knowledge, that the prevention of sparking within a chamber containing a plurality of cells or batteries is very desirous for improving the safety of a Cell-Module powered electric Vehicle (1), especially where lithium-ion rechargeable Cell-Modules are used.

The electronics industry has developed a number of such anti-spark safety devices that are generally known as ‘First Make-Last Break’ (FMLB) devices, that will not allow electrical connections to be made between an installed electrical component and its power supply or power outlet, until all the component's terminals are fully seated in their correct positions or housings.

Practical applications for all Embodiments of the present invention therefore assume that such FMLB devices will be incorporated in at least the Receiving-Bay (RB) of a Main-Chamber (15) and the Thermal Safety Chamber (16) of the invention.

It may also be preferable to have FMLB devices installed with a Charging-Bay (6) of the invention.

It may also be preferable, where appropriate, to have FMLB devices installed on or within individual Cell-Modules (100).

### Eighth Embodiments

The Eighth Embodiments of the invention relate to additions and/or improvements to the previous Embodiments for providing particular needs and benefits to early commercial, promotional and research developments for practical applications of an Enclosed System (200).

It is likely that the commercial needs and benefits of the present invention, and particularly the Stationary Part (A) of a System (200) will not initially be commercially provided within a conventional roadside Service Station environment.

For a System (200) and particularly the Stationary Part (A), there may be unwillingness or hostility towards installing a Bowser (2), with or without its recharging facilities (6) and (7), in a conventional Service Station environment, as the System (200) may initially be perceived as being in direct competition with conventional bowser based fossil fuel replenishment systems.

Also for early developments of the System, investment in extensive refurbishment of a conventional Service Station to accommodate a Stationary Part (A) within a conventional roadside Service Station environment may be considered financially prohibitive, when the benefits to the owner or provider are commercially unknown.

The Eighth Embodiments of the invention therefore specifically relate to an independent Stationary Part (A) of an Enclosed System (200) that is itself capable of occasional mobility.

India's first mass manufactured battery powered car, the Reva E20, is currently promoting the vehicle's benefits by the use of a dashboard installed road-map system that parallels, mimics or improves upon an aircraft's ‘Point-of-no-Return’ (PNR) fuel gauge.

The promotion claims that the vehicle has a range of up to 100 km on a fully charged battery block and the dashboard map system provides a circle of e.g. 50 kilometers radius for the vehicle to complete a round trip on a permanently installed charged lithium-ion battery block and an outer circle of e.g. 100 kilometers radius for a one-way journey.

The needs for commercial developments of the Eighth Embodiments of the invention within a country such as India, where electric vehicle sales are flourishing, are twofold.

The first commercial need would involve installation of an occasionally mobile Stationary Part (A) at radial positions that are set between 40 kilometers and 100 kilometers from mass population centers.

The second commercial need is provided by the immediate installation of a Stationary Part (A) at any new position that is revealed to be commercially viable, from road traffic survey analyses.

Other commercial needs of the Eighth Embodiments present invention involve promoting the benefits of the present invention in a commercially practical manner that trade professionals and members of the public can immediately understand, by presenting the benefits of the Stationary Part (A) within a mobile enclosable environment such as a shipping type Container or e.g. the hollow box Container of a large commercial vehicle, including the articulated type of Container.

The Eighth Embodiments of the invention therefore specifically relate to a shipping type Container that will have at least one Stationary Part (A) installed within its container portions, for providing at least one Cell-Module dispensing Bowser (2), according to the teachings of the plural Embodiments of the invention.

When in its closed state, the Container will be provided with the necessary structural requirements for that Container to be safely transported by conventional transportation means, including road, rail, sea or air cargo means.

When in its opened state, the Container will preferably have the visual appearance of a conventional or upgraded roadside Service Station environment of the type that is visually understood throughout the world.

A plurality of Cell-Module powered electric Vehicles (1) would preferably also be made available in a promotional environment; such as a test drive promotion, for a prospective purchaser of a Vehicle (1) to first ‘have a go’ at first driving the Vehicle, and then ‘have a go’ at replenishing it with Charged Cell-Modules, in a manner that parallels, mimics, or improves upon the globally understood method for conventional metered bowser replenishment.

A so adapted Container (40) thus provides significant commercial or promotional advantages in being positioned e.g. in or at car showrooms, car exhibitions, renewable energy expositions etc, to promote the advantages of the invention in a practical and thoroughly understandable manner.

The Eighth Embodiments of the invention thus relate to a self-contained Stationary Part (A) of a System (200) that includes a plurality of Bowsers (2), Charging-Bays (6) and (7) and associated Conveyors, Pipes (5) and Nozzles (3) that are all installed within a single enclosure (40) such as a Container, Container Truck or a specially manufactured commercial vehicle, whose purpose is to demonstrate and promote the invention's plural means, for small-volume chargeable Cell-Modules, that parallel, mimic or improve upon the globally established means by which small volumes of fossil fuel are sequentially metered by dispensing bowsers to conventional fossil fuel vehicles.

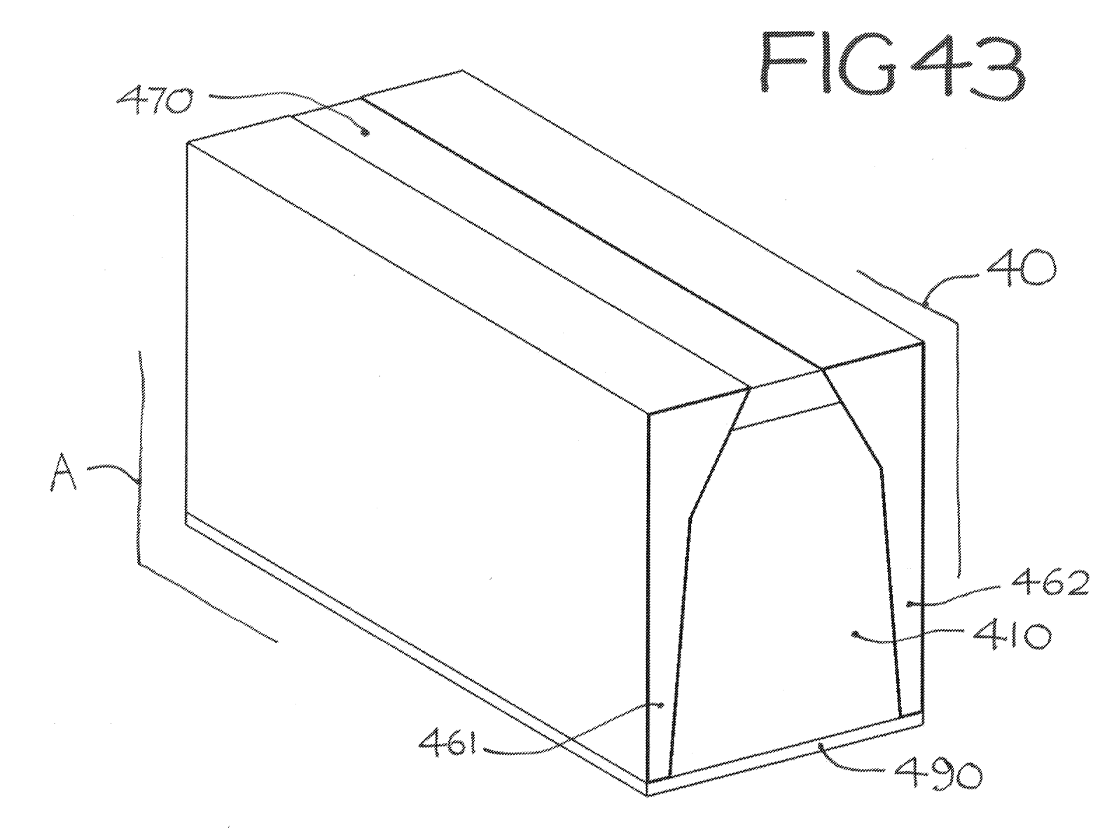

Referring first to FIG. 43, the drawing shows a general overview of Eighth Embodiments of the invention.

A First-Example and Second-Example closed box Container (40) is disclosed, whose external portions are optionally harmonious with the dimensions provided for a standard shipping container, so that the closed Container may be readily and safely transported by road, rail, sea or air, from its place of manufacture to a place of need, or from one place of need to another place of need.

The external and internal portions of the Container have been novelly modified to advantageously provide at least one Stationary Part (A) of a System (200) that has been installed within the Container (40) according to the tenets of all appropriate Embodiments of the invention.

Two elongate enclosed hollow side walls (461) and (462) are hingedly attached a Central Roof-Void (470).

The lower parts of the Central Roof-Void (470) is rigidly attached the upper parts hollow Plinth-Void (490) by either a single internally disposed Enclosed Central Wall-Void (50), not shown, or two internally disposed Enclosed Central Wall-Columns (57) and (58), not shown.

The base parts of the Central Wall parts (57) and (58) or (50) are rigidly attached the upper parts of the Plinth-Void (490) that forms the rigid structural base or chassis of the Container (40).

The front and back End-Walls (410) provide secure means for maintaining the previously disclosed parts in their closed positions while the Container (40) is in transit.

FIG. 43 thus discloses in introductory terms a Stationary Part (A) of the invention that is itself capable of occasional mobility.

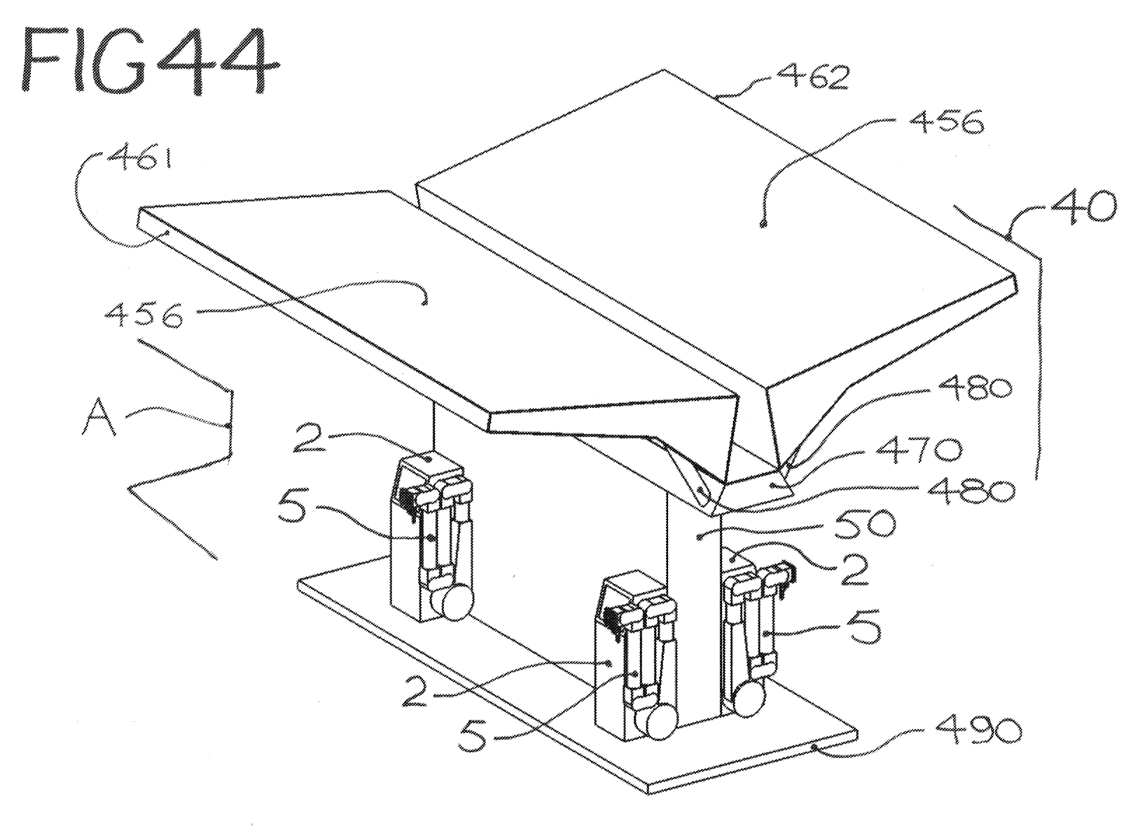

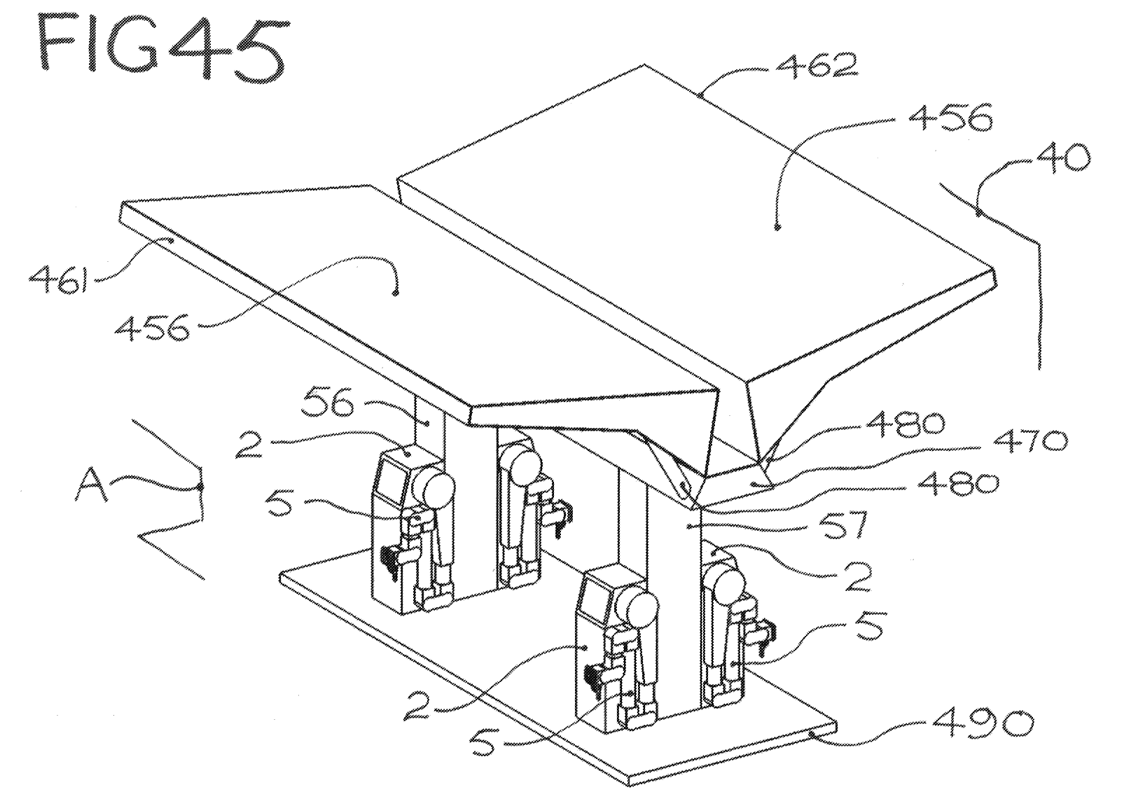

FIG. 44 shows a First-Example of the same Container (40) shown in the previous drawing that is now shown in its opened state.

The two elongate sides (461) and (462) of the closed Container are now shown in their preferred elevated positions to now provide the aesthetic, structural and practical features of two Enclosed Gull-Wing type Roof-Voids (461) and (462).

The elevated Enclosed Gull-Wing Roof-Voids (461) and (462) have been hinged against a respective elongate upper side portion of the Enclosed Central Roof-Void (470) that is itself rigidly affixed the upper parts of an elongate Enclosed Central Wall-Void (50), that is shown elongately traversing some but not all of the Container's overall length.

Two of the four Roof-Elevation-Devices (480) are shown near the hinge ends between the Gull-Wing Roof-Voids (461) and (462) and the back upper end of the Central Roof-Void (470).

The Roof-Elevation-Devices may be suitable hydraulic ram devices or screw thread devices for safely opening and then maintaining the Roof-Voids in their secure opened positions.

The base parts of the elongate Central Wall-Void (50) are shown rigidly affixed the top central parts of a raised Plinth-Void (490).

The Plinth-Void (490) is intended to parallel, mimic or improve upon the visual types of solid plinth that are known the world over for installing conventional fossil fuel dispensing bowsers upon.

Although not shown in the present drawing, the Front and Back-Walls (410) that were shown for securing the Container (40) in its closed position in the previous drawing, are also optionally provided for hinging down, or otherwise provided, to add a tapered front and back portion for the Plinth-Void (490), as is conventionally provided for a tapered solid plinth within a roofed fossil fuel service station.

It should be apparent that the raised Plinth-Void (490) therefore forms the rigid structural support base for use with the Container (40), when it is in its closed state and as the rigid structural support base for use with the Roofed Service Station of the invention when it is in its opened state.

Also, the internal portions of the Plinth-Void (490) may optionally be provided with inclines, to separately provide a more horizontally disposed Stepped-Hopper system within, than the more vertically disposed Stepped-Hopper system that was disclosed in at least FIG. 23, for the Fourth Embodiments of the invention.

The drawing also shows that four Bowsers (2) of the invention have been provided in spaced apart positions on the common Plinth (490), as is common for conventional fossil fuel bowler placement on a single conventional raised plinth.

The only clear visual difference between the opened Container (40) and a small roofed service station of the conventional fossil fuel type is that there is no walkway available across the Plinth, between the front positioned and back positioned Bowsers (2).

Each Cell-Module dispensing Bowser (2) has been provided with a parked or holstered long-reach Flexible-Pipe (5), of the type detailed in the FIG. 30 drawing.

The four independently operated Cell-Module dispensing Bowsers (2), three of which are visible in the drawing, are independently and jointly serviced by a central or hub Charging-Bay (6) and a central or hub Charging-Bay (7), not shown, that have been installed within the Enclosed Central Wall-Void (50).

The Enclosed Central Wall-Void (50) provides practical means for the Bowsers (2) to be independently and jointly serviced by a central or hub Charging-Bay (6) and a central or hub Charging-Bay (7), not shown, that have been installed therein, for Enclosed Charging-Bay means according to the teachings for the Fourth and Sixth Embodiments of the invention, including as disclosed for FIG. 24.

The Enclosed Hollow-Roof-Voids (461) and (462), may also provide means for the Bowsers (2) to be independently and jointly serviced by a central or hub Charging-Bay (6) and a central or hub Charging-Bay (7), not shown, that have been installed therein, for enclosed hollow-roof-void use according to the teachings for the Sixth Embodiments of the invention, including as disclosed for FIG. 29.

The Enclosed Roof-Voids (461) and (462) of the invention are preferably each securely held in the open position at an angle other than horizontal, as shown in the drawing, for optionally providing efficiently inclined inner enclosures for a longer and thinner Stepped-Hopper system than was disclosed in the Fourth Embodiments.

By being inclined at an angle other than horizontal, the roof parts of the Enclosed Roof-Voids (461) and (462) also provide rain run-off means for it to be then directed onto the Central Roof-Void (470), for being removed from there by conventional downpipe means.

The upper surfaces of the raised Enclosed Roof-Voids (461) and (462) provide excellent surfaces for installing e.g. photo-voltaic solar panels (456) thereon, for assisting in providing electrical energy supplies to the Stationary Part (A) of the System (200) that the Container (40) provides.

Where applicable, the opened Container (40) may also be provided with an externally sourced electrical power supply, for maintaining constant power to the Constant Power Supply Device (300), as disclosed in previous Embodiments.

Where not applicable, the opened Container (40) may also be provided with a small fossil fuel powered generator, for providing sufficient constant electric power for servicing the Constant Power Supply Device (300), as disclosed for previous Embodiments.

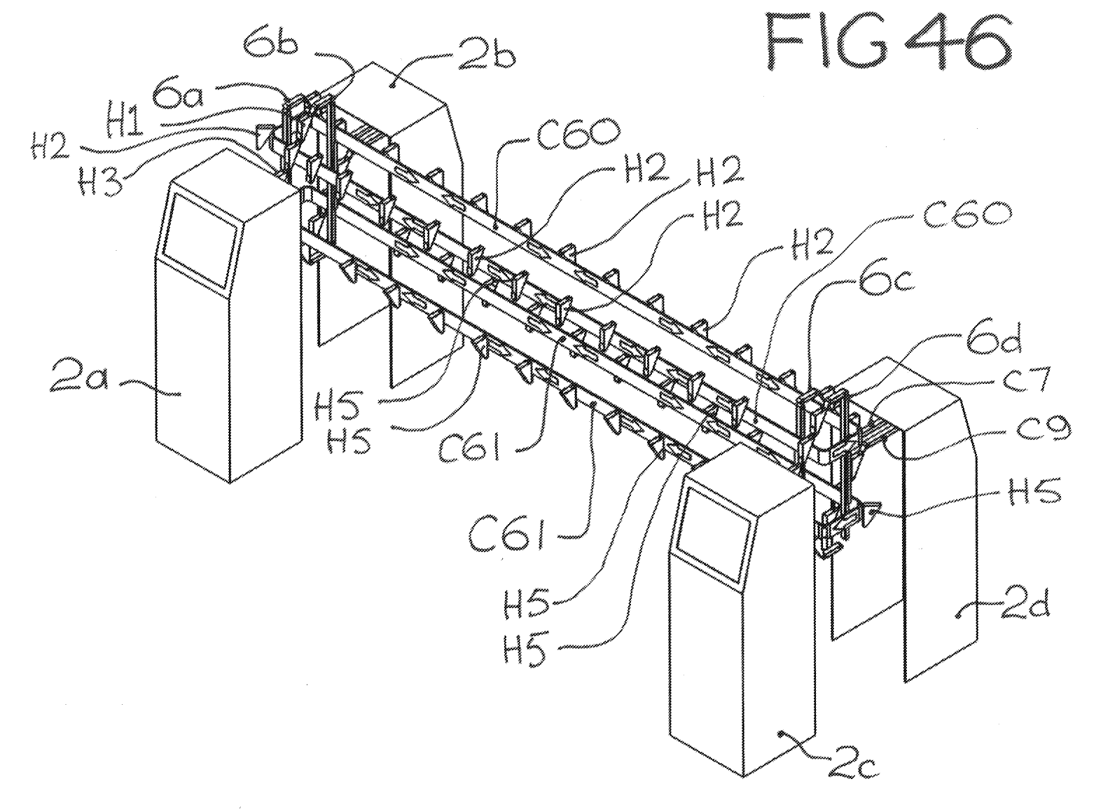

Referring now to FIG. 45, the drawing shows a Second-Example of the same Container (40), now also shown in its opened state.

In this Second-Example, front and back Central Enclosed Column-Voids (56) and (57) have replaced the single Central Wall-Void (50) that was shown in the previous drawing.

Again, the parts of the Container (40) that provide a rigid chassis when in its closed state are now shown in its open state to again offer a rigid Enclosed Plinth-Void (490) that parallels, mimics or improves upon the solid type of plinth that is visually known the world over for installing conventional bowsers upon.

The two elongate sides of the closed Container are again shown in their elevated positions to provide the aesthetic, structural and functional features of the Enclosed Gull-Wing type Roof-Voids (461) and (462).

The drawing also shows that four Bowsers (2) have again been provided in suitable spaced apart positions on the common Plinth, as is standard for conventional fossil fuel bowser placement.

From this drawing, it is clear that the two Column-Voids (56) and (57) now provide an unencumbered walkway across the central parts of the Plinth, just as is provided for a conventional plinth within a small roofed Service Station area of the conventional fossil fuel type.

Four Cell-Module dispensing Bowsers (2) are again spaced apart in suitable positions on the Plinth, for being independently and jointly serviced by a central or hub Charging-Bay (6) and a central or hub Charging-Bay (7), not shown, that have been installed within at least one of the Enclosed Roof-Voids (461) and (462).

Each Cell-Module dispensing Bowser (2) has been provided with a parked or holstered shorter-reach Flexible-Pipe (5) that is a modified version of the type detailed in the FIG. 30 drawing.

From this disclosure it should be most apparent that a long-reach Flexible-Pipe (5) or a shorter reach Flexible-Pipe (5) can be provided a Bowser (2) that has been installed within either a First-Example Container (40) or a Second-Example Container (40).

The FIG. 46 drawing shows substantial modifications to a Fourth Embodiments hub or central Charging-Bay (6), for use within the Enclosed Central Wall-Void (50) of a Container (40).

The substantial modifications first relate to replacing the Circular Conveyors (C60) and (C61), as best defined in FIGS. 25 to 27, with Elongate Conveyors (C60) and (C61).

The substantial modifications secondly relate to mirroring two pairs of slightly offset Charging-Bays, for providing compact means for installing at least four separate Charging-Bays (6) within the narrow confines of a Central Wall-Void (50), not shown.

The positions of the four Bowsers are the same as disclosed for the previous two drawings.

In the present drawing, each Bowser is given an individual moniker for direct association with its related parts.

When looking to the front of the opened Container (40), the front left-hand Bowser is therefore denoted as (2a), the front right-hand Bowser is denoted as (2b), the back left-hand Bowser is denoted as (2c) and the back right-hand Bowser is denoted as (2d).

Similarly, the front left-hand Charging-Bay is therefore denoted as (6a), the front right-hand Charging-Bay is denoted as (6b), the back left-hand Charging-Bay is denoted as (6c) and the back right-hand Charging-Bay is denoted as (6d).

By referring this drawing with the FIG. 25 drawing, it will be seen that both types of Conveyor (C60) are able to laterally travel near the air-gap formed between the Upper Stepped-Hopper (H1) and the Lower Stepped-Hopper (H3), for an endless train of Central Stepped-Hoppers (H2), that are attached the Conveyor (C60) to be continuously placed in that air-gap, for delivering Charged Cell-Modules to the Hopper (H3) or receiving Charged Cell-Modules from the Hopper (H1).

Only a limited number of Central Stepped Hoppers (H2) have been provided on the Elongate Conveyor (C60) to clearly highlight the teachings of the drawing.

By again referring this drawing with the FIG. 25 drawing, it will also be seen that both types of Conveyor (C61) are able to laterally travel near the air-gap formed between the Upper Stepped-Hopper (H4) and the Lower Stepped-Hopper (H6), for an endless train of Central Stepped-Hoppers (H5), that are attached the Conveyor (C61) to be continuously placed in that air-gap, for delivering Depleted Charged Cell-Modules to the Hopper (H6) or receiving Depleted Cell-Modules from the Hopper (H4).

Only a limited number of Central Stepped Hoppers (H5) have been provided on the Elongate Conveyor (C61) to clearly highlight the teachings of the drawing.

The Arrows that have been placed on the Conveyors (C60) and (C61) are deliberately bi-directional, to indicate that the Computer-Controllers (350) and/or (450) are able to control all movements of those Conveyors, for delivering Cell-Modules to a required position by the fastest or most efficient means.

It is anticipated that the electro-mechanical aspects of controlling the precise positioning of a Central Stepped-Hopper (H2) between the fixed Stepped-Hoppers (H1) and (H2) will be provided by computer controlled stepper-motors.

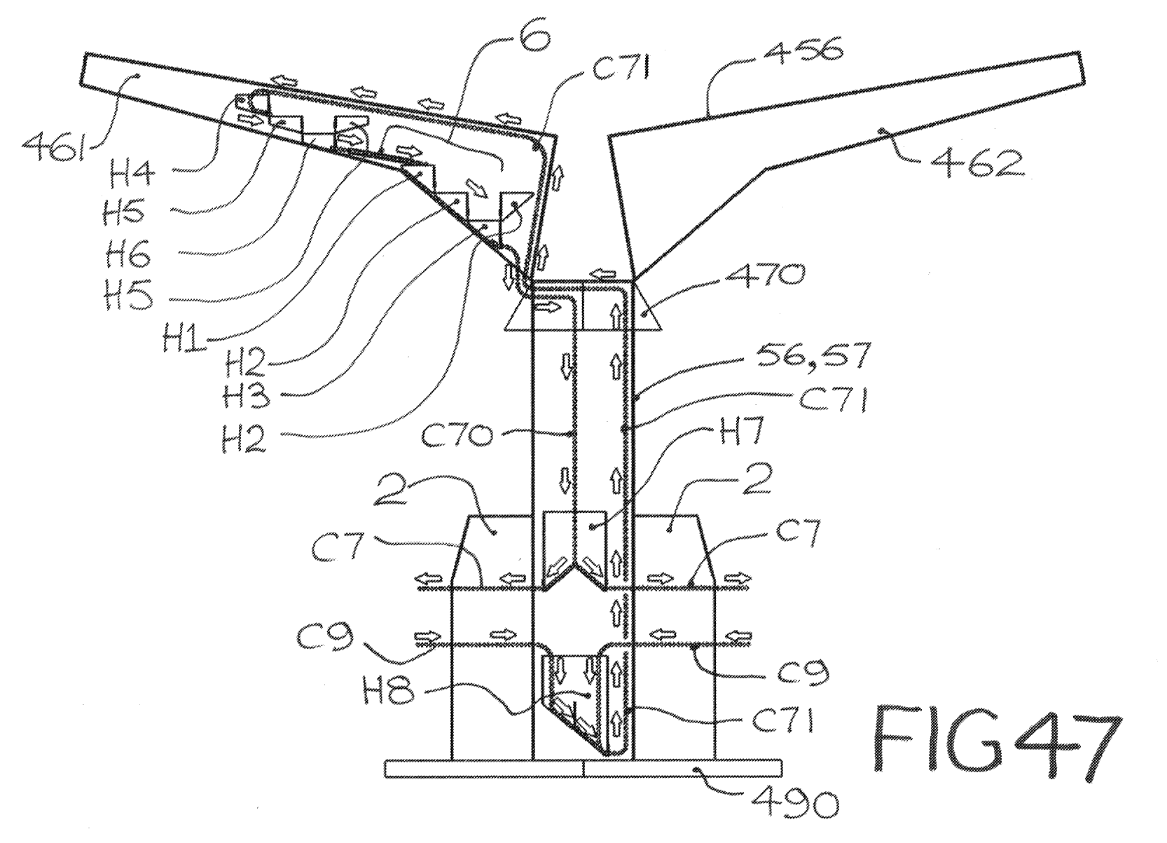

The FIG. 47 drawing shows substantial modifications to a Fourth Embodiments hub or central Charging-Bay (6), for use within the Enclosed Roof-Void (461) and/or the Enclosed Roof-Void (462) of a Container (40).

In the drawing, a schematic cutaway end-view of an opened Container (40) of the Stationary Part (A) of the invention is disclosed.

The left-hand side Gull-Wing type Enclosed Roof-Void (461) has a modified Charging-Bay (6) installed within.

In this modification, the vertical positions of the Depleted Stepped-Hoppers (H4), (H5) and (H6) have been reversed, compared with e.g. the FIG. 24 drawing.

The Arrow flows along both Conveyors (C9) shows that both the left-hand and right-hand Bowsers (2) are each connected to a Vehicle (1) for Depleted Cell-Modules to be returned to the Bowsers.

In this modification of a Bowser (2) with a Container (40), a Charging-Bay (6) is also provided with a Central Storage Hopper (H8) for receiving Depleted Cell-Modules from a plurality of Bowsers (2).

The Depleted Cell-Modules are shown entering the twinned Storage Hopper (H8) for then merging.

The Depleted Cell-Modules then sequentially exit Hopper (H8) by Computer-Controlled Gate means that co-ordinate with other Computer-Controlled means, where they are then sequentially conveyed in an upwards direction within a specially provided Conveyor (C71) that conveys them along the entire vertical length of the Enclosed Column-Void (56) or (57), through the Enclosed Central Roof-Void (470) and into the Enclosed Gull-Wing Roof-Void (461).

After being conveyed through the Roof-Void (461), the upper remote-end of the Conveyor (C71) sequentially delivers Depleted Cell-Modules to the Upper Stepped-Hopper (H4).

The drawing shows that the lowest faces of the Gull-Wing shaped Roof-Void (461) have been inclined from the horizontal to provide gravitational assistance to all the fixed Hoppers installed therein.

Depleted Cell-Modules are then released by previously disclosed Computer-Control means from the Upper Stepped Hopper (H4) into the Central Stepped-Hopper (H5).

Depleted Cell-Modules are then released by previously disclosed Computer-Control means from the Central Stepped Hopper (H5) into the Lower Stepped-Hopper (H6).

Depleted Cell-Modules are then released by previously disclosed Computer-Control means from the Lower Stepped Hopper (H6) into the Charging-Bay (6).

The freshly Charged Cell-Modules are then conveyed direct towards and into the Upper Stepper-Hopper (H1).

Charged Cell-Modules are then released by previously disclosed Computer-Control means from the Upper Stepped Hopper (H1) into the Central Stepped-Hopper (H2).

Charged Cell-Modules are then released by previously disclosed Computer-Control means from the Central Stepped Hopper (H2) into the Lower Stepped-Hopper (H3).

Charged Cell-Modules are then released by previously disclosed Computer-Control means from the Lower Stepped Hopper (H3) directly into the upper remote-end of a specially provided Conveyor (C70) that sequentially conveys them out of the Roof-Void (461), through the Central Roof-Void (470), through the vertical length of the Enclosed Column-Void (56) or (57), where the lower remote-end of Conveyor (C70) sequentially conveys each Charged cell-Module into a specially provided twinned Storage-Hopper (H7).

The inverted ‘M’ shaped contours of the lower parts of the twinned Storage-Hopper (H7), provides simple gravitational means for the contents of the Storage-Hopper to naturally bisect when the Hopper is filled above the central internal peak.

The Charged Cell-Modules are then released by Computer-Controlled Gate Means from the twinned Hopper (H7), where they are then sequentially conveyed along the two Conveyors (C9) for replacing the depleted Cell-Modules, that are being synchronously retrieved from each Vehicle (1).

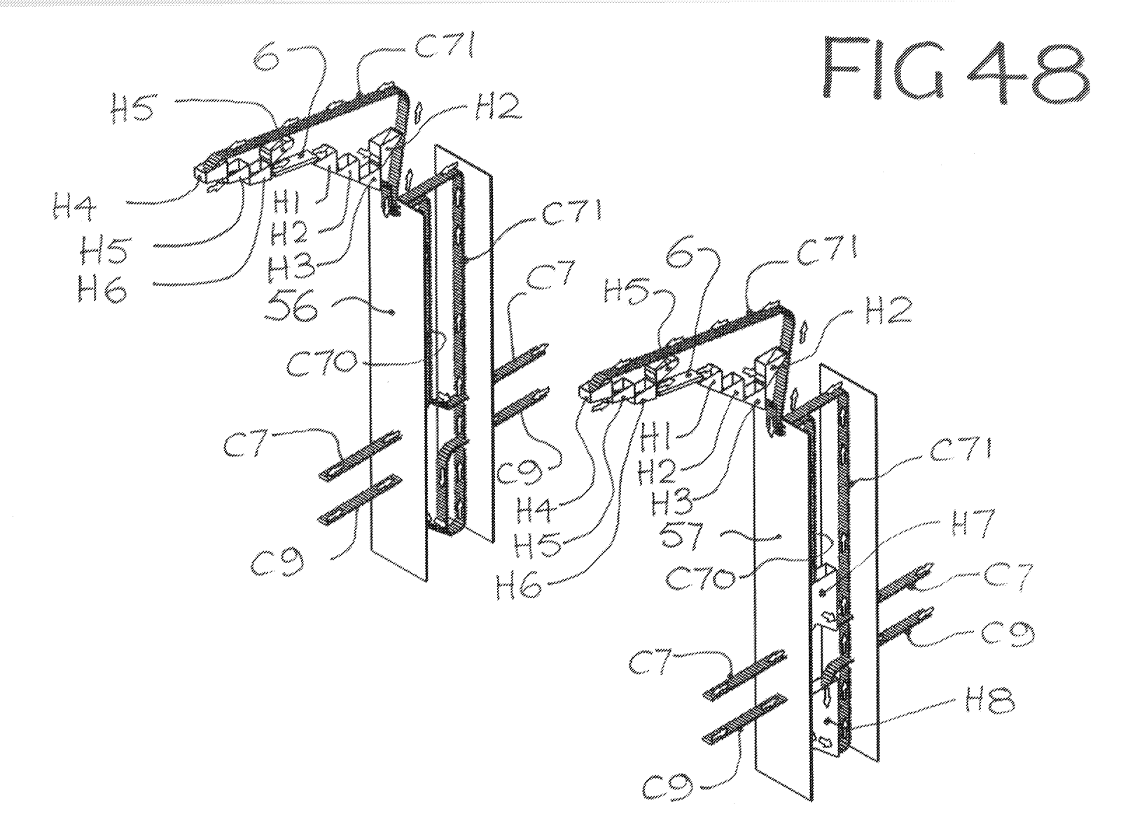

The FIG. 48 drawing shows in three-dimensions, two adjacently positioned Enclosed Cyclical Conveyor layouts as detailed for one layout in the FIG. 47 sectional drawing.

The first Enclosed Cyclical Conveyor layout is shown within that part of the Gull-Wing Roof-Void (461) that lies directly over the central parts of the Enclosed Column-Void (56) that is better shown in the FIG. 45 drawing.

The second Enclosed Cyclical Conveyor layout is shown within that part of the Gull-Wing Roof-Void (461) that lies directly over the central parts of the Enclosed Column-Void (57) that is also better shown in the FIG. 45 drawing.

The two Cyclical Conveyor layouts are different only insofar that the second layout shows the two Hoppers (H7) and (H8), whereas the first layout does not.

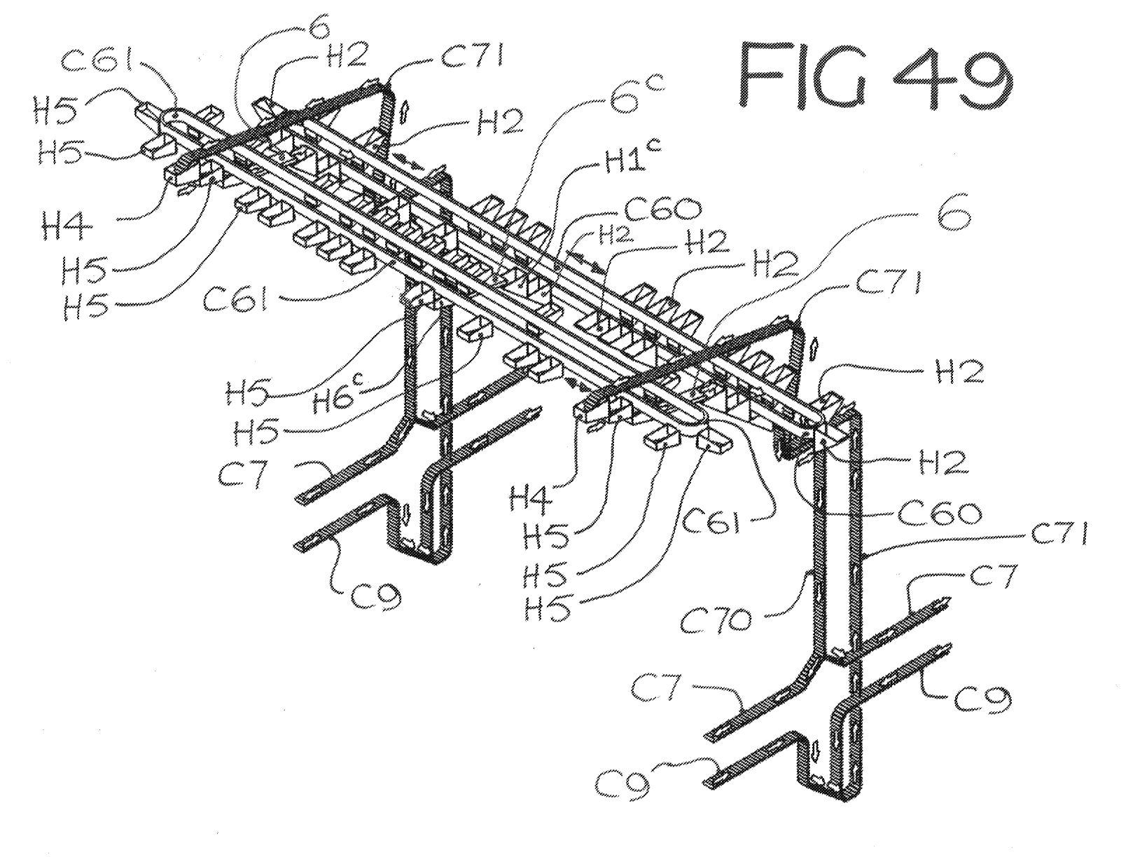

The drawing takes care to mark the positions of all the relevant components that cannot be clearly shown in the FIG. 49 drawing.

The FIG. 49 drawing shows in three-dimensions, the first and second Enclosed Cyclical Conveyor layouts, as laid out and detailed in the FIG. 48 drawing.

The only differences between the first and second Enclosed Cyclical Conveyor layouts in the FIG. 48 drawing and the FIG. 49 drawing are that the side panels of the Column-Voids (56) and (57) have been omitted, as have the Hoppers (H7) and (H8).

The drawing shows that the first Enclosed Cyclical Conveyor layout and the second Enclosed Cyclical Conveyor layout have been laterally connected by two horizontally disposed Elongate Conveyors (C60) and (C61) to form a central or hub Charging-Bay (6) within the Enclosed Roof-Void (461), not shown.

Referring first to the Elongate Conveyor (C60); an endless train of Central Stepped-Hoppers (H2) are adjacently attached the Elongate Conveyor (C60), for receiving Charged Cell-Modules from the first Enclosed Cyclical Conveyor layout and delivering them, via Computer-Controlled Conveyor (C60) rotation, to the second Enclosed Cyclical Conveyor layouts, or vice versa.

Referring secondly to the Elongate Conveyor (C61); an endless train of Central Stepped-Hoppers (H5) are adjacently attached the Elongate Conveyor (C61), for receiving Depleted Cell-Modules from the first Enclosed Cyclical Conveyor layout and delivering them, via Computer-Controlled Conveyor (C61) rotation, to the second Enclosed Cyclical Conveyor layouts, or vice versa.

A Central Charging-Bay (6c) is also shown installed between the first and second Enclosed Cyclical Conveyor layouts.

The Central Charging-Bay (6c) is only provided with a Stepped-Hopper (H6c) at its upper end and a Stepped-Hopper (H1c) at its lower end.

The Stepped-Hopper (H6c) is only able to receive Depleted Cell-Modules directly from a Hopper (H5) that is rotatably attached the Conveyor (C61) and from nowhere else.

The Stepped-Hopper (H1c) is only able to deliver Charged Cell-Modules directly to a Hopper (H2) that is rotatably attached the Conveyor (C60) and from nowhere else.

From this important disclosure, it should be understood that a large or small plurality of Central Charging-Bays (6c) may be installed between the first and second Enclosed Cyclical Conveyor layouts to provide substantial means for providing economic recharging independence for a Container (40) of the Eighth Embodiments of the invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. An enclosed two-part computer-controlled cyclical and sequential through-flow conveying, usage and metering System, for use in the electric vehicle motive power provision industries, for said two-part enclosed System to sequentially and choosably convey a very large number of small-volume rechargeable cell-modules by fast sequential conveyor-means in a metered through-flow sequential conveying manner within and between said two-part System wherein;
(a) the two-parts of said System are releasably interengagable by the use of matingly-co-operative interconnection means and wherein;
(b) the remote ends of the and each conveyor of said sequential conveyor-means are intermittently aligned, where required, with at least one combined through-flow or gated cell-module chamber installed within said System for said System to make best computer-controlled use of said combined chamber or chambers for each and every metered and monitored cell-module that is being conveyed, retained or otherwise used within said enclosed System, for each said cell-module to be computer-controlled in a choosably continuous direction, in a choosably interruptible direction and/or in a choosably haltable temporary position within said two parts of said System and between said two-parts of said System and wherein;
(c) the first part of said two-part enclosed conveying System is a generally Stationary-Part that is preferably but not exclusively incorporated within a service-station fuel replenishment environment and wherein;
(d) said first-part is provided with said cell-module conveying System installed within its enclosed body structure and wherein;
(e) said first-part is additionally provided with at least one cell-module recharging-bay and at least one metered-dispensing-bowser for the charging and metered dispensing of charged individual small-volume rechargeable cell-modules to the second part when said two parts of said System are releasably interengaged and wherein;
(f) the second-part of said two-part conveying System is a Movable-Part that includes a cell-module powered electric vehicle also having said two-part enclosed conveying System installed within its body structure for co-operating with the conveyors of said first part for sequentially receiving said individually metered charged cell-modules from said metered-dispensing-bowser of the first-part when said two parts are releasably interengaged and wherein;
(g) said second-part is additionally provided with at least one cell-module receiving-chamber for the receiving and placement of individual cell-modules therein for energy extraction of said charged cell-modules by said second-part and wherein;
(h) the first-part and the second-part of said two-part System each include co-operating sequential through-flow conveyor means and other means, including co-operating means for the sequential metering, monitoring, energy recharging and/or energy extraction of conveyed individual small-volume rechargeable cell-modules within and between said two-parts and wherein;
(i) the sequential conveying of a very large number of individual small-volume rechargeable cell-modules is achieved between said two parts when said two parts are releasably interengaged for sequential conveying and energy replenishment use, and wherein;
(j) the sequential conveying and energy replenishment use or energy extraction use of said cell-modules within each separated part is achieved when said two parts are not releasably interengaged.

2. At least one specialized cell-module conveyor for sequentially conveying individual small-volume rechargeable electric cell-modules within the System of claim 1 wherein;
said specialized cell-module conveyor provides sequential through-flow conveying means for sequentially conveying said cell-modules along said conveyor whilst also electrically connecting the electric terminals of each said cell-module to matingly co-operative electric terminals provided on said specialized conveyor for a choosable practical period of time while said cell-modules are being conveyed on said conveyor.

3. At least one specialized through-flow or gated chamber for use within the System of claim 1 wherein;
said chamber is provided with at least one movable-wall-portion installed within at least one wall for said movable-wall-portion to first move outward by computer-controlled means, including electro-mechanical means, to allow at least one individual cell-module to be precisely but easily positioned within said chamber for said movable-wall-section to then move inwards towards said cell-module, for matingly co-operative electric terminal connections provided on the internal parts of said movable-wall-portion to safely and securely matingly connect with electric terminal connections provided on said cell-module.

4. A combined through-flow or gated chamber, as claimed in claim 1, wherein;
said chamber is a through-flow chamber for the generally sequential through-flow of cell-modules through said chamber the gate of said chamber is opened by said computer-controlled System and wherein;
said chamber is a cell-module retaining chamber for the prevention of through-flow through said chamber when the gate of said chamber is closed by said computer-controlled System.

5. At least one metered-dispensing-bowser as claimed in claim 1 wherein;
the metered-dispensing of charged individual small-volume rechargeable cell-modules from said first-part to said second-part is a precise method for treating a small-volume rechargeable cell-module as an individual unit of metered-for-payment replenishable motive power via a dispensing bowser that adopts a similar metered dispensing manner that has been successfully adopted worldwide for treating a small-volume of liquid or gaseous fossil-fuel as an individual unit of metered-for-payment replenishable motive power via a conventional dispensing bowser.

6. An enclosed two-part computer controlled cyclical and sequential conveying and metering System, as claimed in claim 1 wherein;
said two parts are releasably interengaged by matingly co-operative male means and matingly co-operative female means wherein;
said first-part preferably includes matingly co-operative male nozzle-parts permanently attached said first-part by means of a flexible pipe arrangement and wherein;
said second-part preferably includes matingly co-operative female cavity-parts and/or female portal-parts permanently attached to the outer body of said second-part that includes a cell-module powered electric vehicle.

7. A Stationary-Part of an enclosed System as claimed in claim 1 wherein;
said Stationary-Part includes an externally provided electric motive power energy provision device for providing electric power for the replenishment of depleted or partly depleted rechargeable cell-modules and wherein;
said Stationary-Part includes a charged cell-module storage device and a metered electric energy cell-module dispensing-bowser device for providing fast motive power electrical energy dispensing use via a cell-module dispensing-and-receiving conveying and metering pump that is permanently attached said dispensing-bowser for dispensing and receiving pumped and/or conveyed small-volume solid objects in the form of said small-volume cell-modules and wherein;
said Stationary-Part is provided with releasably interengagable and matingly co-operative male components for said metering pump to be temporarily but firmly and safely connected to said Movable-Part via a flexible pipe device or a flexible hollow arm device which is external to said vehicle and wherein;
said flexible pipe device or said hollow arm device is permanently connected to said dispensing-bowser such that, when the said two-parts are releasably engaged, an enclosed two-part through-flow conveyor circuit is disclosed, along which said rechargeable cell-modules are movable, for said pluralities of charged said cell-modules to be sequentially transported from the Stationary-Part to the Movable-Part within said electric vehicle, and for similar said pluralities of depleted, part depleted and/or faulty said cell-modules to be synchronously and sequentially transported from the Movable-Part to the Stationary-Part and wherein;
said Stationary-Part generally comprises means for individually and plurally recharging cell-modules and means for the individual metered delivery of charged cell-modules to the Movable-Part and metered return of depleted, part depleted or faulty cell-modules from the Moveable-Part.

8. A Movable-Part of a System as claimed in claim 1 wherein;
said Movable-Part includes a cell-module powered electric vehicle having through-flow cell-module conveyors and through-flow cell-module chamber or chambers installed therein for making best extraction-of-power use of charged cell-modules that have been installed in said second part after being received from said first part and wherein;
said Movable-Part is provided with releasably interengagable and matingly co-operative female components for said vehicle to be temporarily but firmly and safely connected to said Stationary-Part when said vehicle is parked within accessible reach of said flexible pipe or said flexible arm of said Stationary-Part and wherein;
said Movable-Part provides practical means for individually and plurally extracting electrical energy from said charged cell-modules.

9. An enclosed two-part computer controlled System as claimed in claim 1 wherein;
said first-part defines an enclosed System whether or not said two-parts are releasably interengaged and wherein;
said second-part defines an enclosed System whether or not said two-parts are releasably interengaged and wherein;
said first-part and said second-part define an enclosed System when said two-parts are releasably interengaged and wherein;
said first part in isolation, said second part in isolation and said first and second part in releasable inter-engagement with each other are generally inaccessible to human reach.

10. A small-volume rechargeable electric cell-module and an enclosed two-part computer controlled cyclical and sequential conveying and metering System, as claimed in claim 1 wherein;
said small-volume rechargeable cell-module is provided with electric terminals that are electrically co-operable and matingly co-operable with terminals provided within said Stationary-Part and within said Movable-Part and wherein;
said small-volume rechargeable cell-module includes a known type of manufactured rechargeable cell, including but not limited to a lithium-ion cell, that has not been adapted for cyclical use within said System and wherein;
said small-volume rechargeable cell-module includes a known type of manufactured rechargeable cell, including but not limited to a lithium-ion cell, that has been specially adapted for cyclical use within said System and wherein;
said small-volume rechargeable cell-module includes a new type or new shape of rechargeable cell, including but not limited to a lithium-ion cell, that has been specially manufactured for cyclical use within said System and wherein;
the external body shape of each said Cell-Module is of suitable form for being efficiently conveyed many hundreds of times through the plural sequential through-flow paths of said System wherein said external body shape may be ruggedly rigid or ruggedly flexible and taking the general physical external body shape of a cylinder, a bullet, a capsule, an elongate box-form, a cuboid form, a pillow-form, a pellet form or hybrid variations thereof.

11. A small-volume rechargeable cell-module and an enclosed two-part computer controlled System as claimed in claim 1, wherein;
a functionally different type of small-volume rechargeable cell-module is provided that defines a specially manufactured rechargeable cell-module having a similar external form, similar external dimensions and similar terminal formation shapes to those terminals provided for an electrically rechargeable cell-module, but wherein;
the internal portions do not provide electric power but instead provide temperature cooling materials, heat retarding materials, fire retarding materials and/or fire extinguishing materials, for use within said Stationary-Part and/or said Movable-Part along the provided common conveyor circuits, whether or not said Stationary-Part and said Movable-Part are releasably interengaged and wherein;
said similar terminal shapes are specifically provided for releasing said temperature cooling materials, heat retarding materials, fire retarding materials and/or fire extinguishing materials into a precise position within said System when required, whether or not said Stationary-Part and said Movable-Part are releasably interengaged and wherein;
said similar terminal shapes are specifically provided for the recharging of said temperature cooling materials, heat retarding materials, fire retarding materials and/or fire extinguishing materials within such a cell-module after such a depleted or part-depleted cell-module or plurality of cell-modules have been returned to said Stationary-Part by previously claimed conveyor means for the cell-modules disclosed in claim 1.

12. Releasably interengagable means and matingly-co-operative interconnection means as claimed in claim 1, wherein;
said means are provided for the Stationary-Part of said System by the use of a cell-module dispensing nozzle of generally male form and wherein;
said means are provided for the Movable-Part of said System by the use of a cell-module nozzle-receiving-portal of generally female cavity form and wherein;
said nozzle is permanently attached the remote end of a flexible pipe device or flexible hollow arm device that is permanently attached said bowser of said Stationary-Part and wherein;
said portal is permanently attached the outer body of the vehicle of said Movable-Part and wherein;
said two-parts are releasably interengagable wherein said nozzle incorporates the use of separable matingly co-operative male components and wherein said portal incorporates the use of separable matingly co-operative female components and wherein;
said matingly co-operative male components of said first-part preferably have the general visual outer appearance of a conventional fuel dispensing nozzle that is permanently attached the remote end of a flexible dispensing pipe device whose other end is permanently attached said Stationary-Part and wherein;
said nozzle is preferably provided with a nozzle trigger device for human activation and human choice control of choosable pluralities of said cell-modules to be transferred between said two-parts and wherein;
said matingly co-operative female components of said second-part preferably have the general visual cavity form appearance of a conventional fuel receiving portal that is permanently attached to the outer body of said vehicle of the Movable-Part.

13. Releasably interengagable means and matingly-co-operative interconnection means as claimed in claim 1, wherein;
said means are provided for the Stationary-Part of said System by the use of a cell-module dispensing nozzle, wherein;
said nozzle provides terminal means for at least two cell-module conveyors to terminate near the remote end-portion of said nozzle for said remote end-portion to provide means for preventing cell-modules exiting or entering said end-portion when the nozzle is not releasably interengaged with said portal and wherein;
said nozzle provides terminal means for at least two cell-module conveyors to terminate near the remote end-portion of said nozzle for said end-portion to provide means for enabling cell-modules to exit or enter said end-portion when the nozzle is releasably interengaged with said portal and wherein;
said nozzle provides terminal means for at least four electrically separated electrical connectors to terminate near the remote end-portion of said nozzle for said end-portion to provide electrical connection means for the prevention of cell-modules exiting or entering said end-portion when the nozzle is not releasably interengaged with said portal and wherein;
said nozzle provides terminal means for at least four electrically separated electrical connectors to terminate near the remote end-portion of said nozzle for said end-portion to provide electrical connection means for the enabling of cell-modules exiting or entering said end-portion when the nozzle is releasably interengaged with said portal.

14. A small-volume cell-module-powered electric vehicle, as claimed in claim 1, wherein a method of replenishing said cell-module comprises the steps of connecting a nozzle of a cell-module dispensing bowser to a releasably interengagable nozzle portal of an electric vehicle, thereby completing a conveyor circuit for charged cell-modules to be sequentially transported between the cell-module dispensing bowser and the cell-module powered electric vehicle and for removing depleted and/or faulty cell-modules from the electric vehicle for conveying into the cell-module dispensing bowser.

15. Releasable inter-engagement means as claimed in claim 1 wherein additional Safety Features including magnetic connection safety features, optical alignment safety features and direct electrical connection safety features, including unwanted static spark generation as but one example, are provided for ensuring the safe transit of cell-modules between the Stationary-Part and the Moveable-Part only after the Stationary-Part's computer-controller and the Moveable-Part's computer-controller have agreed parameters that include safe inter-engaging of the Stationary-Part and the Moveable-Part.

16. Releasable inter-engagement means as claimed in claim 1 wherein Nozzle-Trigger Activation means are provided within said Stationary-Part for delivering a continuous or interruptible choosable metered plurality of Charged Cell-Modules to be transferred from a Stationary Part of the System to a Movable Part of the System, while a similar choosable plurality of Depleted Cell-Modules, Part-Depleted Cell-Modules and/or Faulty Cell-modules are synchronously transferred from the Moveable Part of the System to the Stationary Part of the System.

17. An enclosed two-part computer controlled System, as claimed in claim 1, wherein the transfer of cell-modules between the Stationary-Part and the Movable-Part is initiated and maintained by human activated Trigger-Switch-Control means that are installed within the body of said nozzle, and wherein said System includes;
a continuous externally provided electrical supply for maintaining the through-flow conveyor circuits and support apparatus that includes;
a cell-module dispensing bowser including a nozzle attached to an articulating hollow-arm device or a flexible dispensing pipe device, the nozzle having a nozzle trigger which initiates motion of said conveyor circuits;
a computer controller which controls the cyclic through flow of cell-modules through the bowser to and from the Movable-Part within the electric vehicle and;
a cell-module recharging bay receiving electric power from a power inlet supply device, depleted cell-modules being rechargeable at the cell-module charging bay.

18. An enclosed two-part computer controlled System, as claimed in claim 1, further comprising a user display to allow the user of the metered dispensing pump or the nozzle to receive information regarding a cyclic through-flow of the cell-modules to and from the Movable-Part and which may further comprise a user-interface having a bowser installed display which displays a remaining charge of the electric vehicle to an operator of the electric vehicle while the operator is operating the trigger of the nozzle.

19. An enclosed two-part computer controlled System as claimed in claim 1 wherein;
user sensitive, user supportive or user controlled electro-mechanical support means is provided for the user of the Stationary-Part of the System to deftly manipulate and control the precise positioning of the nozzle end of a heavy but flexible cell-module dispensing pipe when the user wishes to temporarily but precisely connect the nozzle of said pipe to said matingly co-operative portal of said vehicle for the purpose of metered cell-module replenishment and wherein,
said flexible pipe device may also include a flexible hollow arm device that is provided with electro-mechanical assistance means for human activation, manipulation and operation use for easily and readily supporting, controlling and deftly maneuvering the physical weight and momentum of said pipe device or said arm device for at least five distinct human involvement operations and wherein;
use of said pipe device or hollow arm device may include removing the remote nozzle-end of said pipe device or arm device from its parked position on a specially provided parking position on the outer body of the Stationary-Part's dispensing-bowser;
deftly maneuvering said nozzle-end towards said portal;
deftly positioning said nozzle-end within said portal for matingly co-operative releasable engagement therein;
deftly removing said nozzle-end from said portal for matingly co-operative releasable disengagement there-from;
for returning said nozzle-end and its attached pipe device or arm device to its parked position on the specially provided parking device on the outer body of the dispensing bowser.

20. An enclosed two-part computer controlled System as claimed in claim 1 wherein;
the conveyed paths of charged cell-modules, depleted or partly depleted cell-modules and faulty cell-modules between said stationary part and said movable part of the System are separated as much as is practically feasible, and wherein;
said flexible pipe device or said flexible hollow arm device is internally provided with three independent and separate conveyors for conveying cell-modules between said Stationary-Part and said Moveable-Part and wherein;
the first said independent and separate conveyor is disposed within said flexible pipe device or said flexible hollow arm device for dispensing charged cell-modules from the Stationary-Part to the Movable-Part and wherein;
the second said independent and separate conveyor is disposed within said flexible pipe device or said flexible hollow arm device for removing depleted or part-depleted cell-modules from said Moveable-Part to said Stationary-Part to and wherein;
the third said independent and separate conveyor is disposed within said flexible pipe device or said flexible hollow arm device for removing faulty cell-modules from said Moveable-Part to said Stationary-Part.

21. An enclosed two-part computer controlled System as claimed in claim 1 wherein;
the conveyed paths of charged cell-modules are separated as much as is practically feasible from the shared conveyed paths of depleted cell-modules, partly depleted cell-modules and/or faulty cell-modules between said stationary part and said movable part of the System, and wherein;
said flexible pipe device or said flexible hollow arm device is internally provided with only two independent and separate conveyors for conveying cell-modules between said Stationary-Part to said Moveable-Part and wherein;
the first said independent and separate conveyor is disposed within said flexible pipe device or said flexible hollow arm device for dispensing charged cell-modules from the Stationary-Part to the Movable-Part and wherein;
the second said independent and separate conveyor is disposed within said flexible pipe device or said flexible hollow arm device for removing depleted or part-depleted cell-modules and also for removing faulty cell-modules from said Moveable-Part to said Stationary-Part.

22. An enclosed two-part computer controlled System as claimed in claim 1, wherein a choosable plurality of individual charged small-volume rechargeable cell-modules may be sequentially transferred by individually metered dispensing means from the Stationary-Part to the Movable-Part whilst a similar plurality of individual depleted, partly depleted or faulty small-volume cell-modules may be synchronously transferred by individually metered dispensing means from the Movable-Part to the Stationary-Part when said two parts are releasably interengaged.

23. An enclosed two-part computer controlled cyclical and sequential conveying and metering System, as claimed in claim 1 wherein;
the Stationary-Part may provide a separate recharger-bay apparatus for the express purpose of recharging similar sized depleted cell-modules that are not of an electrical nature but are of a temperature cooling, a heat retarding, a fire retarding and/or a fire extinguishing nature, for such depleted or recharged cell-modules to then also be transported between the Stationary-Part and the Movable-Part along the provided common conveyor circuits, when the Stationary-Part and the Movable-Part are releasably interengaged and wherein:
whether or not a separate recharger bay is provided by said Stationary-Part, the dispensing of said cell-modules to the Movable-Part that are not of an electrical nature are provided.

24. An enclosed two-part computer controlled cyclical and sequential conveying and metering System, as claimed in claim 1 wherein the cell-module charging bay is in communication with a plurality of cell-module dispensing bowsers, providing each bowser with charged cell-modules and receiving depleted, partly depleted and/or faulty cell-modules from each bowser for recharging and for removing faulty cell-modules from said System.

25. An enclosed two-part computer controlled cyclical and sequential conveying and metering System, as claimed in claim 1, wherein the Movable-Part is a cell-module powered electric vehicle comprising;
a nozzle portal affixed the vehicle's outer body and releasably engagable with the Stationary-Part;
an on-board computer controller that is in direct communication with the computer controller of the Stationary-Part, for controlling the cyclic through-flow of cell-modules through the electric vehicle to and from the Stationary-Part;
a through-flow main-chamber incorporating a plurality of receiving bays for receiving the rechargeable cell-modules;
at least one entrance conveyor for transporting charged cell-modules from the nozzle portal to the through-flow or gated main-chamber;
at least one exit conveyor for transporting depleted, partly depleted and faulty cell-modules from the through-flow or gated main chamber to the nozzle portal;
at least one exit conveyor for transporting faulty cell-modules from the thermal-safety chamber to the nozzle portal;
at least two electric terminals provided within said portal for receiving electric power from the Stationary-Part via the Nozzle;
at least two electric terminals provided within said portal for transferring computer information between the Stationary-Part and the Movable-Part via the Nozzle and;
a power receiving and supply device for supplying power from cell-modules installed within cell-module receiving-bays installed within said through-flow main chamber for powering at least a driving motor of the electric vehicle and;
optional means for a purpose-built domestic-type or commercial-type cell-module charger to be connected with the portal of said vehicle said vehicle, for specialized electrical connection that may include an electrical polarity reversal provision, for the in-situ recharging of cell-modules to take place over a longer time period than would be the case for fast cell-module replenishment by nozzle means.

26. An enclosed two-part computer controlled System, as claimed in claim 1, further comprising at least one interrogation sensor within said Stationary-Part and at least one interrogation sensor within said Movable-Part which determines a status of a rechargeable cell-module within either part of said two-parts.

27. An enclosed two-part computer controlled System as claimed in claim 1 wherein said Stationary-Part provides an externally provided power supply to said vehicle, via said nozzle and said portal, when said two-parts are releasably interengaged, for providing electric power to said vehicle in the event of total battery depletion within said vehicle.

28. An enclosed two-part computer controlled System as claimed in claim 1 wherein said releasably interengaged two parts are defined by matingly co-operative Nozzle & Portal components wherein said nozzle and said portal provide directly connected terminal communication means when said two-parts are releasably interengaged.].

29. An enclosed two-part computer controlled System as claimed in claim 1, further comprising at least one through-flow or gated chamber that is a thermal safety chamber within said Movable-Part which stores faulty cell-modules as determined by the or each interrogation sensor and wherein any individual small-volume cell-module that is within the conveyors, or chambers of said Movable-Part that is deemed to be faulty by the or each interrogation sensor installed within said system of said Movable-Part, is immediately uninstalled from its present position and conveyed to said separate thermal safety chamber, for computer-controlled containment within said thermal safety chamber.

30. At least one separate cell-module fire-proof chamber, for computer-controlled use in said Movable-Part of claim 1 wherein;
the through-flow of any individual small-volume cell-module that is within the conveyors, the chambers or has already been installed within a through-flow or gated chamber that is a cell-module storage and usage chamber or a thermal safety chamber of said Movable-Part that is deemed to be faulty by interrogation sensors installed within said system or said Movable-Part, provides precise means for those deemed-to-be-faulty cell-modules to be immediately uninstalled and/or immediately conveyed to at least one through-flow or gated chamber that is a separate fire-proof chamber, for computer-controlled fire-proof and/or smoke-proof containment and toxin-proof containment within said fire-proof chamber and wherein;
entry of a cell-module into said fire-proof chamber also instigates removal of that cell-module from said System for prevention of its re-entry into said System, and wherein;
said fire-proof chamber provides means for preventing smoke, fire or noxious fumes emanating from a faulty cell-module entering at least the passenger compartment of said Movable-Part when said faulty cell-module has been installed within said fire-proof chamber by computer-controlled robotic means and wherein;
said fire-proof chamber further comprises at least one control gate provided in association with said Vehicle and/or said nozzle portal to prevent undesirable re-flow of faulty or damaged cell-modules between the electric vehicle and the stationary part and to assist in separated gate removal of a rejected cell-module from a vehicle by separate safety means that are not part of said System.

31. An enclosed two-part computer controlled System, as claimed in claim 1, further comprising a computer controlled robotic device installed within the through-flow main chamber, the thermal safety chamber and the fire proof chamber, configured to selectively move charged, depleted and/or faulty cell-modules into, within and from the through-flow main chamber for repositioning within said chambers of the electric vehicle or for being removed from the electric vehicle.

32. An enclosed System as claimed in claim 1 wherein;
human activation of said nozzle trigger begins computer-controlled through-flow conveyance means for a choosable plurality of said charged cell-modules to be individually metered as they are sequentially transferred from said Stationary-Part to said Movable-Part and wherein;
the same human activation of said nozzle trigger also begins synchronous computer-controlled through-flow conveyance means for a similar plurality of said depleted cell modules and/or part-depleted cell-modules and/or faulty cell-modules to also be individually metered as they are synchronously transferred from said Movable-Part to said Stationary-Part, for computer-controlled numerical cross-referencing purposes.

33. A method of recharging a small-volume cell-module-powered electric vehicle, by making use of the System as claimed in claim 1, wherein said method comprises providing a separable conveyor having a first conveyor of said Stationary-Part which extends into the electric vehicle of the Movable Part and a second conveyor part internal of the electric vehicle forming part of a cell-module supply, wherein, when coupled, small-volume rechargeable cell-modules in choosable pluralities are transportable on the interconnected first and second conveyor parts from the cell-module supply to the electric vehicle and vice versa.

34. A method as claimed in claim 1, wherein the interconnected first and second conveyor parts form contra-flowing cell-module paths in a side-by-side configuration along at least part of the separable conveyor.

35. A method as claimed in claim 1, wherein the contra-flowing cell-module paths are at and adjacent to an engagement area of the aligned and interengaged conveyors said first-part and said second-part.

36. A method as claimed in claim 1, wherein the first conveyor part in the electric vehicle terminates within a nozzle receiving portal of preferably female or cavity form, and the conveyor part of the Stationary-Part terminates within a matingly co-operative nozzle of preferably male or rod form, for the portal and nozzle to be releasably interengagable to complete the separable conveyor parts.

37. An enclosed two-part computer controlled System, as claimed in claim 1 wherein known prior art conveyor systems for conveying small objects in a generally one-way direction may be improved for use within said enclosed cyclical two-part System as a two-way conveying or delivery system and as a cyclical System for the metered conveying of cell-modules within said enclosed cyclical System that is generally inaccessible to human reach.

38. An individual small-volume rechargeable electric cell-module, as claimed in claim 1, wherein the physical volume of said individual small-volume cell-module represents the smallest precise practical meterable volume for; meterable measurement purposes; for meterable volume and; for financial accounting and payment demand purposes; in much the same way that a precise cylindrical volume of metered fossil fuel passing through a cylindrical pipe from a conventional fossil fuel forecourt metered dispensing pump into the portal of a fossil fuel vehicle represents the smallest practical volume for meterable measurement purposes; for meterable dispensing purposes and; for financial accounting and payment demand purposes.

39. An individual small-volume rechargeable electric cell-module, as claimed in claim 1, wherein the physical volume of said individual small-volume electric cell-module may be considered to be the same as the smallest measurable volume of through-flowing fossil fuel replenishment for; meterable dispensing purposes; for meterable measurement purposes; and for financial accounting and payment demand purposes.

40. An individual small-volume rechargeable electric cell-module, as claimed in claim 1, wherein each new or freshly charged individual small-volume electric cell-module may be treated as the smallest measurable volume of consistent motive power energy replenishment for individual conversion and/or individual amortization of said energy replenishment into an individual or plural demand for payment after transfer of one individual cell-module; or plural transfers of individual cell-modules from said Stationary-Part to said Movable-Part by meterable transfer means.

41. A method for making best use of a plurality of small-volume rechargeable cell-modules with a System as claimed in claim 1, wherein;
a single small-volume rechargeable Cell-Module represents the smallest unit of ‘metered-for-payment’ motive power energy replenishment for sequential transfer between said Stationary-Part and said Movable-Part, or said cell-module to provide practical means for said Cell-Modules to be treated as individual Flow-Units, just as small volumes of fossil fuel are conventionally treated as flow-units, so that a plurality of small-volume Cell-Modules can be easily sequentially conveyed though a small diameter tube or a small area hollow enclosure, in a similar manner to that known for sequentially conveying small volumes of liquid or gaseous fossil fuel.

42. An individual small-volume rechargeable electric cell-module, and a plurality of similar small-volume rechargeable electric cell-modules as claimed in claim 1 wherein; said cell-modules may be considered as a meterable propulsion fuel that is owned or provided by the cell-module dispensing bowser provider and not as physical cell-modules that are owned by the owner of said Movable-Part or said cell-module powered vehicle.

43. An individual small-volume rechargeable electric cell-module, as claimed in claim 1, wherein;
a Quality Control provision, including an individual identification device attached on or installed within each said cell-module's body for offering computer-controlled interrogation means for said interrogation sensors installed within said System to provide said System with accurate data about each and every cell-module within said System, wherein the two way transfer of said cell-modules between said Stationary-Part and said Movable-Part offers strictly adhered to consistency means and strictly adhered to improvements means for establishing and then maintaining a globally acceptable Quality Control means
for delivering a consistent energy provision from a finite and measurable number of sequentially delivered individual cell-modules to a cell-module powered electric vehicle that will be similar to the Octane Quality Control standards that have been globally established
for delivering a consistent energy provision from a finite and measurable amount of sequentially delivered fossil fuel to a conventional fossil fuel vehicle.

44. An individual small-volume rechargeable electric cell-module, as claimed in claim 1 wherein said Quality Control provision is deliverable by said Nozzle-Trigger Activation means.

45. An individual small-volume rechargeable electric cell-module, as claimed in claim 1 wherein a Quality Control provision is additionally provided wherein;
an individual small-volume rechargeable electric cell-module, or a plurality of individual small-volume rechargeable electric cell-modules
that have not been deemed faulty by the interrogation sensors installed within at least the Stationary-Part of said System
but have been interrogated by said sensors to understand that said cell-modules have not been manufactured by a preferred or licensed manufacturer may optionally be individually or plurally diverted by computer-controlled diversion conveyor means away from said cyclical System, before recharging, for removal or exit from said System.

46. An individual small-volume rechargeable electric cell-module, as claimed in claim 1 wherein a Quality Control Provision is additionally provided wherein;
at least one diversion conveyor is optionally provided within at least one storage hopper at said diversion conveyor's remote end
for storing cell-modules that have not been deemed faulty but have previously entered said System by way of a non authorized cell-module manufacturer or by way of a non authorized cell-module provider,
for containment of said non authorized cell-modules within said storage hopper prior to disposal, wherein
said removal or exit from said System can include return of non-authorized cell-modules to said non-authorized manufacturer or provider and wherein
said removal or exit from said System can include collection of non-authorized cell-modules by said non-authorized manufacturer or provider.

47. An enclosed two-part computer controlled System, as claimed in claim 1, wherein a Driver Alert provision, including a visual aid screen in or on said Stationary-Part and a computer-controlled algorithm provided in at least said computer controller of said Stationary-Part is able to interrogate the computer of the releasably interengaged Movable Part, in conjunction with the proposed next journey length of said Movable-Part, during engagement with said Stationary-Part, for said computer-controller in conjunction with the known local terrain, to advice the user of the interengaged nozzle-trigger of the minimum number of new or freshly charged individual cell-modules that will be needed for said proposed next journey length for the Movable-Part to safely complete said proposed next journey length after disengagement of said Stationary-Part from said Movable-Part.

48. An enclosed two-part computer controlled cyclical and sequential conveying and metering System, as claimed in claim 1 wherein said System provides practical enclosed cyclical conveying, metering and monitoring means for said cell-modules to be fast transferred between said Stationary-Part and said Movable-Part when said vehicle is statically parked reasonably adjacent but not necessarily precisely adjacent said metered dispensing bowser or said nozzle.

49. At least one through-flow or gated chamber, as claimed in claim 1 for said Movable-Part, wherein;
at least one said chamber is provided as a chamber for extracting electrical energy from cell-modules installed therein and wherein;
at least one said chamber is provided as a thermal-safety-chamber for positioning faulty or suspected faulty cell-modules therein, and wherein;
at least one said chamber is provided as a fire-proof-chamber for positioning overheating or otherwise deemed dangerous cell-modules therein and wherein;
said cell-modules are manipulated within said chambers by the computer-controlled use of at least one robotic device within each said chamber, and wherein;
each said robotic device has a grabbing-arm or similar device with a clamping-pad or similar device attached for grabbing and/or clamping onto any cell-module that is within said cell-module chamber, said thermal-safety chamber and said fire-proof chamber and wherein;
said robotic device is provided with means for moving said cell-module from any first position to any second or subsequent position within said cell-module chamber, said thermal-safety chamber and said fire-proof chamber and wherein;
said clamping pad of said robotic device is provided with thermic means or thermionic means for reading the surface temperature of a cell-module that said clamping pad is in reasonable direct contact with for accurately relaying that surface temperature to the computer-controller for the computer controller to direct the robotic device to take precise actions entirely dependant on the surface temperature reading of said cell-module and wherein;
said clamping pad of said robotic device is provided with touch sensitive means for understanding whether the physical shape of a cell-module, independent of its surface temperature, conforms to a physical norm, for the computer controller to direct the robotic device to take precise actions entirely dependant on the surface contours of said cell-module and wherein;
said clamping pad is instructed to either leave said cell-module where it has just been analysed, or move it from its current position towards said thermal safety chamber or said fire-proof chamber.

50. An enclosed two-part computer-controlled System, as claimed in claim 1, wherein;
said Movable-part is provided with a known type or proprietary type of rolling-road laboratory test-bed facility for the road wheels of said cell-module powered electric vehicle of said Movable-Part to be occasionally or permanently driving thereon and wherein;
said Movable-Part may be a factory produced cell-module powered vehicle, a factory produced vehicle adapted for being a cell-module powered electric vehicle or a laboratory test-bed cell-module powered electric vehicle and wherein;
said Stationary-Part is a laboratory quality Stationary-Part that is permanently attached said occasionally or permanently driving vehicle for the constant upgrading of experiential knowledge for obtaining, understanding and then providing best computer-controlled through-flow data for best applications and best usage of through-flow cell-modules as they are individually and plurally conveyed, used and otherwise exploited within both parts of an enclosed two-part computer controlled cyclical and sequential conveying and metering System. a rolling road device is additionally provided and having a Movable-Part including a practical cell-module vehicle placed thereon, and wherein;
said two parts may be permanently attached to each other for obtaining optimum through-flow understanding of cell-modules between and through both said parts that does not involve better understanding of the metered element and wherein;
said two parts may be releasably interengaged with each other for obtaining optimum through-flow understanding of cell-modules between and through both said parts that does involve better understanding of the metered element and wherein;
said two parts may be releasably interengaged with each other for obtaining optimum through-flow understanding of cell-modules between and through both said parts that also involves better understanding of the releasably inter-engaging components and elements and wherein;
said two parts provide practical means and priority intelligence means for best technical understanding of how cell-modules may efficiently through-flow within an enclosed two-part computer controlled cyclical and sequential conveying and metering System of claim 1 for best obtainment of efficient energy extraction of cell-modules, efficient energy replenishment of cell-modules and safe and secure connection and disconnection of said cell-modules within said System.

51. An enclosed two-part computer controlled cyclical and sequential conveying and metering System, as claimed in claim 1 wherein;
said System provides seamless transition means for the user of said Movable-Part to obtain sequential small-volumes of metered motive power cell-module replenishment for said vehicle in a roadside service station environment by the use of dispensing bowser means and nozzle trigger means
in a manner that parallels, replicates, mimics or improves upon the globally established, globally understood and globally accepted means for obtaining sequential small-volumes of metered motive power fossil-fuel replenishment for a conventional fossil fuel vehicle in a conventional roadside service station environment through the use of conventional dispensing bowser means and nozzle trigger means.

52. An enclosed two-part computer controlled cyclical and sequential conveying and metering System, as claimed in claim 1 wherein;
said System provides seamless transition means for the provider and/or supplier of said cell-modules and said Stationary-Part to provide metered motive power cell-module replenishment for said vehicle in a service station refuelling environment by the use of dispensing bowser means and by the use of nozzle trigger means and the use of dispensing and metering processes that parallel, replicate, mimic or improve upon the global established, globally understood and globally accepted means for obtaining metered motive power fossil-fuel replenishment for a conventional fossil fuel vehicle in an otherwise conventional roadside service station environment through the use of a visually recognised dispensing bowser means and a visually recognised dispensing nozzle with trigger activation means for trigger activated supply of a choosable amount of motive power energy replenishment from a nozzle directly into the portal of a vehicle.

53. An enclosed two-part computer controlled cyclical and sequential conveying and metering System, as claimed in claim 1, wherein;
an individual cell-module may be considered as a single solid object for individual solid pumping purposes and wherein;
a plurality of individual cell-modules may be considered as a mass of organised individual solid objects for sequential solid pumping purposes.

54. An enclosed two-part computer controlled System, as claimed in claim 1, that includes;
a method for providing a conveying relationship between at least one cell-module, at least one interrogation sensor, at least one conveyor, at least one recharging-bay and at least three adjacent through-flow or gated chambers that are all contained within a Stationary-Part of a two-part System and wherein;
said interrogation sensor is able to read at least the state of charge within each and every individually identifiable depleted, partly depleted and/or a faulty cell-module that is conveyed past said sensor, for said sensor to then direct each said individually identifiable cell-module towards a precise Station-Hopper by computer controlled conveyor means, for each said cell-module to then be purposely placed in an appropriate through-flow or gated chamber for said chamber to then provide computer-controlled gated exit means for the efficient directing of said depleted or partly depleted cell-module away from said chamber or chambers towards an appropriate recharging-bay or for said appropriate chamber to then provide computer-controlled gated exit means for the efficient removal of said faulty cell-module from said System.

55. An enclosed two-part computer controlled System, as claimed in claim 1, wherein methods for manipulating the precise positioning of a small-volume rechargeable cell-module within an enclosed two-part computer controlled cyclical and sequential conveying and metering System is provided, other than by conveying or pumping means, wherein;
said manipulation means may comprise computer controlled robotic handling and moving devices for gripping the rigid outer body parts or the electric terminal parts of each said cell-module and wherein;
said rigid outer body parts of each said cell-module may optionally include a rigid hollow body formation having; a circumferential groove, a circumferential lip or ridge; an incomplete circumferential groove; an incomplete circumferential lip or ridge, and other known matingly co-operative gripping devices for said cell-modules to be effectively manipulated and precisely positioned within said System by said robotic handling and moving devices and wherein;
said electric terminals of each said cell-module may optionally each include a rigid formation having; a circumferential groove, a circumferential lip or ridge; an incomplete circumferential groove; an incomplete circumferential lip or ridge, and other known gripping matingly co-operative devices for said cell-modules to be effectively manipulated and precisely positioned within said System by said robotic handling and moving devices.

56. Sequentially conveyed small-volume rechargeable cell-modules within an enclosed two-part computer controlled System, as claimed in claim 1, wherein methods for providing computer controlled identification-devices and computer controlled controlling-devices for identifying and monitoring each and every small-volume rechargeable cell-module that is contained within an enclosed two-part computer controlled cyclical and sequential conveying and metering System include;
providing at least one said identification-device and at least one said controlling-device within said System and include;
providing at least one said identification-device or at least one said controlling-device within or on each said cell-module that is situated within said System, and include;
providing computer controlled identification devices within said System that may comprise and/or may include computer controlled read/write devices that include the understanding of how many times an individual cell-module has been recharged within a System; the length of time between each recharge; the amount of energy extraction that has taken place between each recharge; the time taken to recharge; each type of cell-module powered vehicle that a cell-module has been installed within; the extent of energy extraction; the terrain that said vehicle has traveled through; the ambient temperature of that terrain and wherein;
said computer controlled identification devices provided on or within each said cell-module that is contained within said System includes means for understanding data and manipulating data relating to the entire conveyance and the entire energy extraction usage and recharging usage of each said cell-module from the moment of said cell-module's first installation within said System to the moment of its removal from said System.

57. The releasably interengagable and matingly co-operative interconnection means of a two-part System as claimed in claim 1 wherein;
said System is activated by a user operated nozzle trigger device after the nozzle of the Stationary-Part has been inserted in the matingly co-operative portal of the Movable-Part and releasably interengaged therein and wherein;
said user operated nozzle trigger device may only then be activated by the user and only then maintained by the user to provide a method for the computer-controlled replenishment of a choosable sequential plurality of individually metered charged small-volume cell-modules to then be dispensed from the Stationary-Part to the Movable-Part via said nozzle only when said nozzle trigger activation is maintained by said user or wherein;
said computer-controlled System may provide computer-controlled means to over-ride said nozzle trigger activation in certain circumstances that include a maximum number of cell-modules that the computer controller's database recognizes as being the maximum number of cell-modules that can be safely placed within the vehicle type that is currently releasably interengaged with said Stationary-Part.

58. A Movable-Part of a two-part conveying System as claimed in claim 1 wherein; said sequential conveyor-means and said through-flow gated retaining-chambers may be situated within suitable voids within the body of said Movable-Part, including but not limited to the roof void, the void below and behind the passenger seats, the voids either side of the windscreen, the voids within the within the front and rear portions of the vehicle, the voids above the wheel arches, the voids within the hinged doors, and the hinged trunk and hood, the elongate void between the two front seats and the void below the passenger compartment.

59. A Stationary-Part of a two-part conveying System as claimed in claim 1 wherein; said sequential conveyor-means and said through-flow gated retaining-chambers may be situated within suitable voids within the structural parts of said service station environment of the Stationary-Part, including but not limited to the roof void, the hollow floor void, the dispensing bowsers, the hollow roof support columns or walls and specially provided chambers provided between at least any two of said structural parts.

60. Sequentially conveyed small-volume rechargeable cell-modules, as claimed in claim 1, wherein a hollow, thin and rigid cell-module frame is provided for retaining a plurality of installed small-volume cell-modules therein, for providing a larger volume conglomerate cell-module that may itself be individually piped by enclosed pipe means between a Stationary-Part and a Movable-Part, for the purpose of fast refuelling a much larger cell-module powered vehicle such as a commercial vehicle.

61. A Stationary-Part of an enclosed System as claimed in claim 1, wherein said Stationary-Part is temporarily transportable for use as a readily available free-standing cell-module fuel replenishment service-station.

63. An enclosed two-part computer-controlled System, as claimed in claim 1, wherein;
said remote ends of any two conveyors that are intermittently aligned with a through-flow or gated chamber are defined as;
a supply-remote-end that sequentially conveys cell-modules directly towards an aligned through-flow or gated chamber and;
a removal-remote-end that sequentially conveys modules directly away from an aligned through-flow or gated chamber.

64. A single through-flow or gated chamber, as claimed in claim 1, that has been placed between the remote ends of two aligned conveyors and wherein;
said through-flow or gated chamber takes the generally form of an open top triangular hopper-shape having a sufficiently large top opening for receiving cell-modules en-mass as they sequentially exit the supply-remote-end of said aligned conveyor that is adjacent said open top and fall into said open top of said triangular hopper and wherein;
said cell-modules exit the supply remote-end and enter said open top by gravitational means with optional assistance means, including vibratory means, to be directed downwards with other cell-modules towards the constricted lower end of said hopper-shape in an orderly configuration and wherein;
the gate of said through-flow or gated chamber is computer-controlled by said computer-controlled System to choosably allow through-flow or choosably retain said cell-modules within said triangular chamber or is computer controlled to choosably release a choosable number of said cell-modules from the constricted lower end of said hopper onto the removal-remote-end of another said aligned conveyor for enabling further through-flow conveyance through said through-flow System such that;
said gate provides computer-controlled means for each and every metered and monitored cell-module to be conveyed in a choosably continuous direction, in a choosably interruptible direction and/or in a choosably haltable temporary position within said two parts of said System and between said two-parts of said System.

65. A single through-flow or gated chamber, as claimed in claim 1, that has been placed between the remote-ends of two aligned conveyors and wherein;
said through-flow or gated chamber takes the generally form of an enclosed-chamber and wherein;
said through-flow or gated chamber is provided with at least one computer-controlled entrance gate that opens by computer-controlled means to sequentially receive cell-modules as they exit the supply-remote end of a first aligned conveyor and wherein;
said through-flow or gated chamber is provided with internal means, including conveyor means, robotic means and movable wall-means for the efficient and accurate placement of said sequentially received cell-modules for installation within cell-module receiving-bays that are provided within said enclosed-chamber and wherein;
said through-flow or gated chamber is provided with internal means, including conveyor means and/or robotic means for the efficient uninstalling of said installed cell-modules from said cell-module receiving-bays and wherein;
said through-flow or gated chamber is provided with at least one computer-controlled exit gate that opens by computer-controlled means to sequentially remove said cell-modules from said enclosed-chamber for sequential entry onto the removal-remote-end of a second aligned conveyor.

66. At least one through-flow or gated chamber as claimed in claim 1 that independently provides means for each and every metered and monitored cell-module that is within said chamber to be computer-controlled in a choosably continuous direction, in a choosably interruptible direction and/or in a choosably haltable temporary position within said chamber.

67. At least one through-flow or gated chamber as claimed in claim 1 that independently provides means for each and every metered and monitored cell-module that has been held in a choosably haltable temporary position within said chamber that has been installed within said Movable-Part to have the charged energy stored within each cell-module extracted from that cell-module for energy provision use.

68. At least one through-flow or gated chamber as claimed in claim 1, wherein;
the through-flow of individual small-volume cell-modules through said chamber that has been installed in the Movable-Part provides interruptible through-flow means for an individual charged cell-module or in the alternative, a choosable plurality of individual charged cell-modules to be conveyed inside said chamber, for then being automatedly installed within individual cell-module receiving-bays that have been pre-installed within said chamber, for the energy stored in each said charged cell-module to be extracted by said Movable part for use in at least propelling said vehicle and wherein;
said depleted or part-depleted cell-modules are automatedly chosen to be uninstalled from said cell-module receiving-bays for their through-flow removal from said chamber for return to the Stationary-Part, when said Stationary-Part and said Movable-Part are releasably interengaged for two-way transfer of cell-modules between said Stationary-Part and said Movable-Part.

69. At least one through-flow or gated chamber as claimed in claim 1 that independently provides means for each and every metered and monitored cell-module that has been held in a choosably haltable temporary position within said chamber that has been installed within said Stationary-Part to have the depleted or partly depleted energy that was previously stored within each cell-module to be replenished by recharging means for later energy extraction use.

70. The remote ends of the conveyors as claimed in claim 1, wherein;
a single conveyor positioned within said Stationary-Part and/or within said Movable-Part may be replaced by two separated conveyors for providing practical means for at least one through-flow or gated chamber to be positioned in the gap between said two separated conveyors, for assisting in providing improved flow-control of cell-modules that are now able to be sequentially conveyed along a similar conveyor path having a through-flow or gated chamber installed therein.

71. A recharging-bay as claimed in claim 1, wherein;
each said recharging-bay of said first-part is provided with a plurality of adjacent through-flow or gated chambers, for the computer controlled gate-control conveying of depleted or partly depleted cell-modules as they sequentially pass through each adjacent through-flow or gated chamber towards each said recharging-bay and wherein;
each said recharging-bay of said first-part is also separately provided with a plurality of adjacent through-flow or gated chambers, for the computer controlled gate-control conveying of freshly charged cell-modules as they sequentially pass through each adjacent through-flow or gated chamber away from each said recharging-bay and wherein;
each through-flow or gated chamber, in isolation or in combination provides practical computer-controlled means for preventing cell-module bottlenecks and for preventing through-flow cell-module jams during periods of high usage of the Stationary-Part and for enabling mass transfer of cell-modules through uncongested parts of a cell-module charging bay during dwell periods or quiet periods of the Stationary-Part.

72. A recharging-bay as claimed in claim 1, wherein;
each said recharging-bay within said first-part is provided with a plurality of adjacent through-flow or gated chambers, wherein said plurality of adjacent chambers are adjacently positioned in a descending staircase-type positioning for said computer controlled gates to provide computer-controlled means for cell-modules to sequentially move in a downwards direction from the uppermost chamber to the lowest chamber for improved computer controlled conveying there through such that;
the said descending staircase-type stepped and gated chamber positioning additionally provides gravitational assistance in the efficient mass-flow and the efficient mass-interruption of said cell-modules through said recharging-bay and also between said Stationary-Part and said Moveable-Part, whether or not said Stationary-Part and said Movable-Part are releasably interengaged.

73. At least one through-flow or gated chamber as claimed in claim 1, wherein three through-flow or gated chambers are adjacently positioned within said Stationary-Part and/or within said Movable-Part to provide a descending staircase-type configuration wherein;
said three through-flow or gated chambers are preferably of triangular hopper shaped configuration and become stepped-chambers and wherein;
the function of the upper-stepped-chamber is to sequentially receive cell-modules from the supply-remote-end of a first conveyor as also previously defined for gated storage or for gated sequential release into the open top of the central-stepped-hopper and wherein;
the function of the central-stepped-chamber is to sequentially receive cell-modules from the upper-central-stepped-chamber for gated storage or for gated sequential release into the open top of the lower-stepped-hopper and wherein;
the function of the lower-stepped-chamber is to sequentially receive cell-modules from the central-stepped-chamber for gated storage or for gated sequential release onto the removal-remote-end of a second conveyor such that;
said descending staircase-type stepped gated chamber positionings additionally provide gravitational assistance in the efficient mass-flow and the efficient mass-interruption of said cell-modules through said recharging-bay and also between said Stationary-Part and said Moveable-Part, whether or not said Stationary-Part and said Movable-Part are releasably interengaged.

74. At least one through-flow or gated chamber, as claimed in claim 1, wherein three through-flow or gated chambers are adjacently positioned within said Stationary-Part and/or within said Movable-Part to provide a descending staircase-type configuration, as previously defined and wherein;
said central-stepped-chamber is a first central-stepped-chamber that is precisely positioned between an upper-stepped-chamber and a lower-stepped-chamber and wherein;
a first central-stepped-chamber is additionally provided with lateral displacement conveyor means for being laterally displaced, for being replaced by a second, third or subsequent central-stepped-chamber that is also attached said lateral displacement conveyor means.

75. At least one through-flow or gated chamber, as claimed in claim 1, wherein three through-flow or gated chambers are adjacently positioned within said Stationary-Part and/or within said Movable-Part to provide a descending staircase-type configuration, as previously defined, and wherein;
the lateral displacement conveyor means, as also previously defined, provides precision means for a first central-stepped-chamber that was previously positioned between an upper-stepped-chamber and a lower-stepped-chamber of a first conveyor route within said two-part System to be positioned between an upper-stepped-chamber and a lower-stepped-chamber of a second or subsequent conveyor route within said two-part System such that;
said lateral displacement conveyor means provides additional improvements for the efficient computer-controlled transfer of cell-modules from one conveyor route to another conveyor route and subsequent conveyor routes, as well as offering optional and optimum distribution and/or transfer between a first, second or subsequent recharging-bay installed within the same enclosed Stationary-Part, whether or not said Stationary-Part and said Movable-Part are releasably interengaged.

76. At least one through-flow gated retaining-chamber, as claimed in claim 1, wherein a plurality of at least two through-flow or gated chambers, as generally previously defined as triangular hoppers, are adjacently positioned within said Stationary-Part and/or within said Movable-Part to provide a generally horizontally disposed side-by-side gated chamber group configuration, or to provide a generally horizontally disposed end-by-end gated chamber group configuration, wherein;
conveyed cell-modules that sequentially exit the supply-remote-end end of a first conveyor, are then able to randomly or choosably enter the upper open portions of each or any of said plurality of Station-Hoppers, for individual cell-modules to then be choosably stored within said gated-chambers or choosably sequentially directed out of the constricted lower portions of said gated-chambers, for those so exiting cell-modules to be immediately available for;
optionally being automatedly packaged or otherwise contained within a larger Cell-Module containment device of hollow and rigid form, for the so packed cell-modules now contained within said larger Cell-Module containment device to then be again treated as a larger rechargeable cell-module for then being directed onto the front of said second so-divided conveyor, for use as a larger or conglomerate cell-module within said System or for;
optionally being directed onto separate conveyor paths that offer multiple conveying paths of sequentially conveyed cell-modules.

77. At least one cell-module recharging-bay cell-module charging bay, as claimed in claim 1, wherein;
(a) a first portion of said charging bay comprises a co-operating group of at least three generally upright and descending chambers, in a staircase type configuration, wherein both the containment and the release of charged cell-modules within and from each stepped chamber is provided by the use of at least one computer controlled exit gate for controlling the outflow of charged cell-modules from the lower parts of one hopper to the upper parts of a co-operating stepped hopper that is step-positioned directly beneath it and wherein;
(b) a second and separate portion of said charging bay comprises a co-operating group of at least three generally upright and descending stepped chambers, wherein both the containment and release of depleted or partly depleted cell-modules within each cell-module containment hopper is provided with at least one computer controllable exit gate for controlling the outflow of depleted or partly depleted cell-modules from the lower parts of one hopper to the upper parts of a co-operating descending stepped hopper that is directly beneath it and wherein;
(c) the centrally positioned stepped chamber or chambers are optionally provided with conveyor means to be moved with precision in a generally horizontal direction, for the so-moved central stepped chamber to be immediately replaced with another central stepped chamber and wherein;
(d) the so moved central stepped chamber is either conveyed to a precise part of the charging bay that is remote from the first charging bay or conveyed to another precise part of the charging bay area for that so moved chamber to then be precisely positioned between the upper stepped chamber and the lower stepped chamber of a second charging bay enclosed within said System and wherein;
(e) the so moved central stepped chamber provides precise means for best through-flow of cell-modules within said stationary part of said system to provide best practice for the mass through-flow, the mass interruption and the mass halting of chosen cell-modules within a single or plural charging bay provision and wherein;
(f) a first central stepped chamber in a first charging bay within a centralized charging bay arrangement is provided with conveyor means for being laterally moved in a direction perpendicular the generally downward flow direction of cell-modules traveling through its upper stepped chamber, for said first central stepped chamber to be replaced by a second central stepped chamber and/or a subsequent central stepped-chamber and wherein;
(g) a central stepped chamber in a second or subsequent charging bay within the same said charging bay arrangement is also provided with the same conveyor means for also being laterally moved in a direction perpendicular the generally downward flow direction of cell-modules traveling through its upper stepped chamber, for said central stepped chamber to be replaced by the first said central stepped chamber and/or a subsequent central stepped chamber.

78. A through-flow or gated chamber, as claimed in claim 1, wherein said chamber is provided within the Movable-Part of the System as a cell-module energy extraction chamber and wherein the through-flow of individual small-volume cell-modules through said chamber and the installing and uninstalling of cell-modules within said chamber provides structural and physical means for said cell-module chamber to not be of general cuboid form but to be of complex three-dimensional form, especially including the shape of a complex three-dimensional form used as a fossil fuel retaining chamber.

79. A through-flow gated retaining-chamber, as claimed in claim 1 wherein;
said chamber is provided within the Movable-Part of the System as a gated cell-module chamber of complex three-dimensional form, and also wherein;
said gated chamber may additionally be provided with portal-to-chamber conveyor connection means, such that said gated chamber and said portal may be connected together as a unit that replicates the same complex three dimensional outer form of a fossil fuel vehicle's fuel tank, a fossil fuel portal and a fossil fuel connection pipe, for said cell-module chamber to provide economic means to assist in the modification or conversion of a fossil fuel powered vehicle into a cell-module powered vehicle.

80. An enclosed two-part computer controlled System, as claimed in claim 1 wherein;
said energy replenishment is provided by at least one cell-module charging bay installed within said Stationary-Part of said System and wherein;
said charging bay is provided with at least one conveyor having electric terminal means installed thereon for automatedly making matingly co-operative electric terminal connections with each depleted or partly depleted cell-module as said cell-module is conveyed onto the first end of said conveyor for being sequentially charged as the central parts of said conveyor pass through said charging bay and for automatedly disconnecting said matingly co-operative electric terminal connections as the now freshly charged cell-module is conveyed way from the second end of said conveyor.

81. Conveyor means as claimed in claim 1 wherein said through-flow conveyors include endless belt rotating conveyor means, endless chain-link conveyor means, oscillating and vibratory conveyor means, vacuum tube conveyor means, pneumatic and hydraulic conveyor means, cash railway capsule conveyor means, rail and track carriage conveyor means, machine gun belt type conveyor means, magnetic means, chute means, hopper means and gravitational assistance means.

82. At least one specialized conveyor, as claimed in claim 2, wherein;
said matingly co-operative electric terminal connections are provided on specialized facets of said conveyor that are nearest the electric terminal connections provided on each said cell-module, at the moment when said cell-module joins with said conveyor; for each said specialized facet to be provided with an electric terminal connection that is matingly co-operable with an electric terminal provided on said cell-module and wherein; each said specialized facet is optionally provided with conventional or proprietary ‘First-Make-Last-Break’ (FMLB) technology to prevent unwanted spark generation while the matingly co-operative terminals of said conveyor and said cell-module are undergoing releasable engagement and to prevent unwanted spark generation while the matingly co-operative terminals of said conveyor and said cell-module are undergoing releasable disengagement and wherein;
the matingly co-operative terminals of said conveyor and said cell-module are optionally provided with computer controlled switching means for allowing or disallowing electrical flow between said matingly co-operative terminals while they are placed in releasable engagement with each other and wherein;
an individual cell-module invested within a specialized conveyor of said Stationary-Part is choosably conveyed thereon for having its cell terminals connected to matingly co-operative terminals provided on said specialized conveyor for cell-module energy replenishment purposes and wherein;
an individual cell-module invested within a specialized conveyor of said Movable-Part is choosably conveyed thereon for having its cell terminals connected to matingly co-operative terminals provide on said specialized conveyor for cell-module energy extraction purposes.

83. A sequential through-flow conveying System as claimed in claim 2, wherein;
at least one conveyor within said System may be a two-part conveyor wherein said two parts of said conveyor may include a left part and aright part or a top part and a bottom part that are brought together by conveying means to temporarily trap sequentially conveyed cell-modules between the two said parts for matingly co-operative terminals provided on the first half and second half of said conveyor to make safe and preferably spark-free releasably interengagable connections with matingly co-operative terminals provided on said cell-modules as said cell-modules are sequentially conveyed onto said two part conveyor and for the disengagement of said releasably interengagable connections when said cell-modules exit said two part conveyor.

84. A specialized through-flow or gated chamber, as claimed in claim 3, wherein;
at least one wall-portion of at least one wall may be outwardly movable by computer controlled electro-mechanical means for the precise purpose of enabling at least one cell-module to freely enter said gated retaining-chamber, for said wall-portion to then be inwardly movable by said computer controlled electro-mechanical means for matingly co-operative terminals provided on said wall-portion to make safe and preferably spark-free releasably interengagable connections with matingly co-operative terminals provided on said cell-module.

85. At least one specialized through-flow or gated chamber, as claimed in claim 3, wherein;
said matingly co-operative electric terminal connections provided on the internal parts of said movable-wall-section are optionally provided with conventional or proprietary ‘First-Make-Last-Break’ (FMLB) technology to prevent unwanted spark generation while the matingly co-operative terminals of said chamber and said cell-module are undergoing releasable engagement and to prevent unwanted spark generation while the matingly co-operative terminals of said chamber and said cell-module are undergoing releasable disengagement and wherein;
the matingly co-operative terminals of said chamber and said cell-module are optionally provided with computer controlled switching means for allowing or disallowing electrical flow between said matingly co-operative terminals while they are placed in releasable engagement with each other and wherein;
an individual cell-module invested within a specialized retaining chamber of said Stationary-Part is choosably halted therein for having its terminals connected to matingly co-operative terminals within said retaining chamber for cell-module energy replenishment purposes and wherein;
an individual cell-module invested within a specialized retaining chamber of said Movable-Part is choosably halted therein for having its terminals connected to matingly co-operative terminals within said retaining chamber for cell-module energy extraction purposes and wherein:
a method for reducing and preferably eliminating electric spark generation within said enclosed System is provided when at least two matingly co-operative electrical connecting terminals on at least two component-parts situated within said System are only electrically connectable by the additional provision of at least one ‘First-Make-Last-Break’ (FMLB) device permanently attached to at least one said component-part and particularly but not exclusively wherein said two matingly co-operative electrical connecting terminals are affixed said cell-module on one said component-part and affixed said cell-module receiving-bay on the other said component-part.

86. At least one specialized through-flow or gated chamber of the Movable-Part, as claimed in claim 3, wherein;
the or each said chamber is provided with at least one movable-wall-section installed within at least one wall for said movable-wall-section to first move outward by computer-controlled means to allow at least one individual charged cell-module to be precisely positioned within a cell-module receiving-bay of said chamber, for said movable-wall-section to then move inwards towards said cell-module, for matingly co-operative electric terminal connections provided on said movable-wall-section to safely and securely matingly connect with electric terminal connections provided on said cell-module for said chamber to extract the electrical energy stored within said cell-module by computer-controlled means for computer-controlled use of said extracted energy for the benefit of the movable-part.
